(19) United States
(12) Patent Application Publication
(10) Pub. No.: US 2026/0091271 A1
(43) Pub. Date: Apr. 2, 2026

(54) SYSTEMS AND METHODS FOR AI ENHANCED WORKOUTS

(71) Applicant: AMP FIT ISRAEL LTD, Tel Aviv (IL)

(72) Inventors: Amir LEVANON, Nir Banim (IL); Andrey KATZ, Ramat Gan (IL); Tal SOFFER, Ramat Gan (IL); Alex GORODETSKY, Hertzliya (IL); Gilad KOCH, Tel Aviv (IL); Dan SEMO, Tel Aviv (IL); Guy GVILI, Petah Tikva (IL); Shalom MECKENZIE, Savyon (IL)

(73) Assignee: AMP FIT ISRAEL LTD, Tel Aviv (IL)

(21) Appl. No.: 19/345,773

(22) Filed: Sep. 30, 2025

Related U.S. Application Data
(60) Provisional application No. 63/700,909, filed on Sep. 30, 2024.
(60) Provisional application No. 63/702,704, filed on Oct. 3, 2024.

(51) Int. Cl. A63B 24/00; A63B 71/06

(52) U.S. Cl. CPC A63B 24/0084; A63B 2024/0009; A63B 2024/0068; A63B 2071/065; A63B 2225/20

(57) ABSTRACT

Systems, methods, and computer readable media are disclosed for enabling guest mode gaming on a common exercise machine, which includes: providing selectable fitness movement types for performance on the common exercise machine; receiving a selection of a fitness movement type; associating a game with the selection; enabling presentation of the game; receiving a multi-exerciser mode selection; identifying a first user; receiving first signals characterizing a first set of fitness movements performed by the first user; correlating first movements of a graphical element with the first set; determining a first game success measure of the first user; identifying a second user; receiving second signals characterizing a second set of fitness movements performed by the second user; correlating graphical movements of a graphical element with the second set; determining a second game success measure of the second user; and presenting the first game success measure and the second game success measure.

This application claims the benefit of priority of U.S. Provisional Patent Application No. 63/700,909, filed on Sep. 30, 2024, and U.S. Provisional Patent Application No. 63/702,704, filed on Oct. 3, 2024, which are incorporated herein by reference in their entireties.

### TECHNICAL FIELD

The present disclosure relates to exercise machines in general, and software for enhancing exercise routines in particular.

### BACKGROUND

Adhering to an exercise regimen is an important factor for maintaining physical health, improving cardiovascular fitness, building strength, and supporting mental well-being. Consistency is particularly important, as the benefits of exercise compound over time, reducing the risk of chronic illnesses, enhancing mobility, and improving mood through the release of endorphins. Beyond physical health, structured exercise can also boost cognitive performance, help regulate sleep patterns, and provide a sense of discipline and accomplishment. However, despite these well-documented benefits, many individuals struggle to maintain regular workout habits due to factors such as lack of motivation, perceived monotony, or competing priorities. For instance, the routineness of exercise regimes can discourage users from adhering to an exercise routine.

Gamifying exercise routines can transform workouts from a task into an engaging, rewarding experience. By incorporating elements such as challenges, points, leaderboards, and progress tracking, gamification taps into psychological drivers like competition, achievement, and reward anticipation. These interactive features not only make workouts more enjoyable but also encourage adherence by providing instant feedback and visible progress toward goals. Social components, such as team challenges or friendly competitions, further enhance motivation by fostering community and accountability. In essence, gamification leverages the principles of play and behavioral reinforcement to turn exercise into a compelling habit rather than an obligation. However, since each exercise trainee may have different preferences, a generic approach to gamifying exercise routines may be insufficient.

### SUMMARY

Embodiments consistent with the present disclosure provide systems and methods generally relating to managing and securing a computer network. The disclosed systems and methods may be implemented using conventional and/or specialized hardware. Some embodiments may involve a combination of conventional and/or specialized hardware and/or software, such as a machine constructed and/or programmed specifically for performing functions associated with the disclosed method steps.

Consistent with disclosed embodiments, systems and methods are provided for enabling variable workout gamification. Enabling variable workout gamification may include providing first selectable indications of a plurality of candidate fitness movements; receiving a first selection of at least one particular candidate fitness movement from the plurality of candidate fitness movements; providing second selectable indications of a plurality of electronic games; receiving a second selection of a particular electronic game from the plurality of electronic games; associating the particular electronic game with the at least one particular candidate fitness movement; enabling presentation of the particular electronic game via a display; and enabling interaction with the particular electronic game in response to detection of the at least one particular candidate fitness movement.

Consistent with disclosed embodiments, systems and methods are provided for automated group identification and aggregation of guidance. Automated group identification and aggregation of guidance may include receiving associations between a plurality of trainees and a common wellness specialist; receiving, over a plurality of communication channels, sensor data associated with performance of exercises by the plurality of trainees; analyzing the sensor data to identify at least one subgroup within the plurality of trainees, wherein individual trainees within the at least one subgroup share at least one sensor-data-related commonality; characterizing the at least one subgroup to the common wellness specialist; receiving from the common wellness specialist, feedback associated with the at least one sensor-data-related commonality; and providing over the plurality of communications channels the feedback to each trainee in the at least one subgroup.

Consistent with disclosed embodiments, systems and methods are provided for enabling guest mode gaming on a common exercise machine. Enabling guest mode gaming on a common exercise machine may include providing selectable indications of a plurality of candidate fitness movement types for performance on the common exercise machine; receiving a selection of at least one of the candidate fitness movement types; associating a game with the selected at least one candidate fitness movement type, the game having at least one interactive graphical element configured to move a plurality of times during gameplay in response to a plurality of fitness movements associated with the selected at least one candidate fitness movement type; enabling presentation of the game via at least one display; receiving a multi-exerciser mode selection enabling a plurality of individuals to perform the plurality of fitness movements; identifying a first user of the common exercise machine; receiving first signals characterizing a first set of the plurality of fitness movements performed by the first user on the common exercise machine; correlating first graphical movements of the at least one graphical element with the first set of the plurality of fitness movements by the first user; determining a first game success measure of the first user; identifying a second user of the common exercise machine; receiving second signals characterizing a second set of the plurality of fitness movements performed by the second user on the common exercise machine; correlating second graphical movements of the at least one graphical element with the second set of the plurality of fitness movements by the second user; determining a second game success measure of the second user; and presenting the first game success measure and the second game success measure on the at least one display.

Consistent with disclosed embodiments, systems and methods are provided for an exercise machine with an integrated holder for a mobile communications device. The exercise machine may include a frame; a load mechanism associated with the frame; an exercise interface mechanically connected to the load mechanism, the exercise interface being configured to permit a user to exert a counterforce to a load exerted by the load mechanism, wherein the frame and the exercise interface are configured to define an exercise region adjacent the frame for occupation by the user exerting the counterforce; an adjustable holder for the mobile communications device, the adjustable holder being associated with the frame, wherein the adjustable holder is configured to align with the frame to aim an image sensor of the mobile communications device such that when the mobile communications device is seated in the adjustable holder while aligned with the frame, the image sensor is aimed at the exercise region; and at least one processor configured to transmit signals for aligning the adjustable holder with the frame.

Consistent with disclosed embodiments, systems and methods are provided for performing automated composite video construction. Performing automated composite video construction may include receiving at least one variable including at least one of a fitness goal, a performance indication, or a user preference associated with at least one user; using at least one neural network to determine a personalized workout regime for the at least one user, wherein the determined personalized workout regime corresponds to the at least one variable; accessing a data structure storing a plurality of movement video clip segments for use as building blocks to construct a composite workout video corresponding to the personalized workout regime, wherein each movement video clip segment is associated with a targeted muscle group; using the at least one neural network to select a subset of the plurality of movement video clip segments for constructing the composite workout video; stitching the selected subset of movement video clip segments into the composite workout video; and outputting the composite workout video for presentation to the at least one user

Consistent with disclosed embodiments, systems and methods are provided for executing a randomized exercise routine. Executing a randomized exercise routine may include receiving, from a user, a selection of an exercise routine associated with electronic exercise equipment; identifying one or more basic characteristics of the selected exercise routine; utilizing a randomization engine to randomly modify at least one exercise parameter associated with the selected exercise routine, wherein the at least one exercise parameter is selected from the group consisting of: a tempo, a resistance, a rest time, a holding time, and an exercise sequence, wherein the at least one exercise parameter is randomly modified based on the identified basic characteristics of the selected exercise routine; building a randomized exercise routine comprising the at least one randomly modified exercise parameter; and presenting the randomized exercise routine to the user.

Consistent with disclosed embodiments, systems and methods are provided for executing voice-cloned guidance during exercise programs. Executing voice-cloned guidance during exercise programs may include receiving from a trainee associated with an electronic exercise machine, a selection associated with a particular distinctive voice for presenting exercise feedback; electronically receiving sensor data associated with use by the trainee of the electronic exercise machine; analyzing the sensor data to determine trainee performance; generating the exercise feedback based on the trainee performance; accessing a data pool containing characterizing information associated with a plurality of distinctive voices including characterizing information for the particular distinctive voice; applying to the exercise feedback the characterizing information for the particular distinctive voice to thereby construct an audio file synthesizing the exercise feedback in the particular distinctive voice; and causing the audio file synthesizing the exercise feedback in the particular distinctive voice to be presented to the trainee.

Consistent with disclosed embodiments, systems and methods are provided for correlating a musical presentation with an electronic exercise equipment routine. Correlating a musical presentation with an electronic exercise equipment routine may include identifying a first exercise block including a first set of movement types; determining a first exertion level for the first exercise block based on first information associated with the first set of movement types; identifying a second exercise block including a second set of movement types; determining a second exertion level for the second exercise block based on second information associated with the second set of movement types; accessing a data pool storing music; selecting a first music track from the data pool, the first music track having a first tempo corresponding to the first exertion level; streaming the first music track for presentation at a location of the exercise machine during performance of the first exercise block; selecting a second music track from the data pool, the second music track having a second tempo corresponding to the second exertion level; and streaming the second music track for presentation at the location of the exercise machine during performance of the second exercise block.

Consistent with disclosed embodiments, systems and methods are provided for performing voice-induced resistance change operations. Performing voice-induced resistance change operations may include implementing a first resistance force via an electronically-controlled exercise machine; while the first resistive force is countered by a user of the electronically-controlled exercise machine via interaction with an accessory through which the first resistance force is exerted, monitoring audio in an environment of the electronically-controlled exercise machine; during monitoring and while the first resistance force is countered by the user of the electronically-controlled exercise machine via the interaction with the accessory, receiving an audio signal from the environment of the user; processing the received audio signal to identify a resistance force change command; and implementing the resistance force change command while the first resistance force is countered by the user of the electronically-controlled exercise machine via interaction with the accessory through which the first resistance force is exerted, to thereby change the first resistance force to a second resistance force while the user maintains force exertion on the accessory.

### BRIEF DESCRIPTION OF THE DRAWINGS

FIG. 1 is an exemplary schematic diagram of a computing device, consistent with some disclosed embodiments.

FIG. 2 is a perspective view of an exemplary electronic exercise machine (in use), consistent with some disclosed embodiments.

FIG. 3 is an exemplary block diagram representing circuitry associated with an electronic exercise machine, consistent with some disclosed embodiments.

FIG. 4 is an exemplary schematic diagram of a system enabling communication between exercise equipment and a computing device via a communications network, consistent with some disclosed embodiments.

FIG. 5 is a series of front views of mobile communications device presenting an exemplary real-time sequence of images of a user performing a first gamified exercise routine, consistent with some disclosed embodiments.

FIG. 6 is a front view of a mobile communications device presenting an exemplary user interface for a second gamified exercise routine, consistent with some disclosed embodiments.

FIG. 7 is a series of front views of a mobile communications device presenting an exemplary real-time sequence of images of a user performing a third gamified exercise routine, consistent with some disclosed embodiments.

FIG. 8A is a flow chart of a process for performing a first gamified exercise routine, consistent with some disclosed embodiments.

FIG. 8B shows an exemplary interface for movement selection and game selection, consistent with some disclosed embodiments.

FIG. 8C is a schematic illustration of a trainee performing a gamified set, consistent with some disclosed embodiments.

FIG. 9A is a schematic illustration of a plurality of trainees for automated group identification and wellness guidance, consistent with disclosed embodiments.

FIG. 9B is another schematic illustration of plurality of trainees exercising via automated group identification and wellness guidance, consistent with disclosed embodiments.

FIG. 9C is a flowchart of example process for performing automated group identification and guidance, consistent with disclosed embodiments.

FIG. 10A is a perspective view of a user performing an exemplary guest mode gaming operation with an exercise machine, consistent with some disclosed embodiments.

FIG. 10B is a screen shot of a first exemplary display of an exercise interface, consistent with some disclosed embodiments.

FIG. 10C is a screen shot of a second exemplary display of an exercise interface, consistent with some disclosed embodiments.

FIG. 10D is a screen shot of a third exemplary display of an exercise interface, consistent with some disclosed embodiments.

FIG. 10E is a screen shot of a fourth exemplary display of an exercise interface, consistent with some disclosed embodiments.

FIG. 10F is a screen shot of a fifth exemplary display of an exercise interface, consistent with some disclosed embodiments.

FIG. 10G is a screen shot of a sixth exemplary display of an exercise interface, consistent with some disclosed embodiments.

FIG. 10H is a screen shot of a seventh exemplary display of an exercise interface, consistent with some disclosed embodiments.

FIG. 10I is a screen shot of an eighth exemplary display of an exercise interface, consistent with some disclosed embodiments.

FIG. 10J is a screen shot of a ninth exemplary display of an exercise interface, consistent with some disclosed embodiments.

FIG. 10K is a screen shot of a tenth exemplary display of an exercise interface, consistent with some disclosed embodiments.

FIGS. 10L and 10M illustrate a flowchart of an example process for guest mode gaming on an exercise platform, consistent with some disclosed embodiments.

FIG. 11A is a perspective view of an exercise machine with an integrated holder for a mobile communications device, consistent with some disclosed embodiments.

FIG. 11B is a perspective view of an adjustable holder for a plurality of mobile communications devices for use with the exercise machine of FIG. 11A, consistent with some disclosed embodiments.

FIG. 11C is a front view of a touchscreen interface of a mobile device depicting guidelines for adjusting an image capture characteristic for an image sensor, consistent with some disclosed embodiments.

FIG. 11D is a flowchart of an example process for aligning an adjustable holder for a mobile communications device with a frame of an exercise machine, consistent with some disclosed embodiments.

FIG. 12A is a network diagram for enabling performance of automated composite video construction operations, consistent with some disclosed embodiments.

FIG. 12B is an exemplary screen shot of an exercise machine display, consistent with some disclosed embodiments.

FIG. 12C is an exemplary perspective view of a user engaging with an exercise machine, consistent with some disclosed embodiments.

FIG. 12D is a flowchart of an example process for performing automated composite video construction operations, consistent with some disclosed embodiments.

FIG. 13A is an exemplary block diagram representing circuitry associated with an electronic exercise machine, consistent with some disclosed embodiments.

FIG. 13B is an exemplary schematic diagram of an exercise machine, consistent with some disclosed embodiments.

FIG. 14 is a perspective view of an exemplary electronic exercise machine, consistent with some disclosed embodiments.

FIG. 15 is a perspective view of an exemplary electronic exercise machine, consistent with some disclosed embodiments.

FIG. 16 is an exemplary schematic diagram of a system enabling communication between exercise equipment and a computing device via a communications network, consistent with some disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions, or modifications may be made to the components illustrated in the drawings, and the illustrative methods described herein may be modified by substituting, reordering, removing, or adding steps to the disclosed methods. Accordingly, the following detailed description is not limited to the specific embodiments and examples, but is inclusive of general principles described herein and illustrated in the figures in addition to the general principles encompassed by the appended claims.

Various aspects of this disclosure are disclosed in various paragraphs arranged for organizational purposes only and are not meant to suggest that separate paragraphs or paragraphs remote from each other correspond to a separate disclosure. Rather, it is to be understood that inventive aspects of this disclosure may lie in combinations of any aspects presented herein, regardless of their location in this disclosure.

This disclosure employs open-ended permissive language, indicating for example, that some embodiments “may” employ, involve, or include specific features. The use of the term “may,” and other open-ended terminology is intended to indicate that although not every embodiment may employ the specific disclosed feature, at least one embodiment employs the specific disclosed feature.

Some embodiments described herein involve an exercise machine. An exercise machine may refer to a mechanical apparatus or electromechanical apparatus that may be used to perform physical exercise. For example, an exercise machine may include an electronic exercise machine, as described in the succeeding paragraph. Examples of exercise machines may include wall-mountable resistance devices, free standing resistance devices, treadmills, stationary bicycles, elliptical machines, weight machines, other resistance machines, and/or any other machine designed to engage a user in physical exercise.

Some disclosed embodiments involve an electronic exercise machine. An electronic exercise machine may refer to an exercise machine including a resistance motor associated with electronics for controlling the resistance. The electronics may control an amount of resistance applied during a weight resistance exercise by regulating, for example, a level, a frequency, a duration, a speed, a duty cycle, a range of motion, an exercise type, an operational mode, and/or any other attribute associated with resistance applied by a resistance motor. In some embodiments, electronics, including for example, at least one processor, may control force applied by a resistance motor in response to one or more user inputs.

In some embodiments, an electronic exercise machine may be associated with a user interface. Such a user interface may include one or more of an electronic display, a touch-sensitive screen, a microphone, a speaker, a haptic interface, a light emitting diode (LED), one or more adjustable dials, knobs, buttons, switches, and/or levers and/or any other type of manipulatable control enabling user inputs and/or information display. For example, a user may provide one or more inputs via a user interface associated with an electronic exercise machine to initiate, select, modify, share, and/or terminate an exercise routine. Such an interface may initiate signals to at least one processor associated with an electronic exercise machine. In a similar manner, the at least one processor may transmit one or more signals to convey information via a user interface to a user of an electronic exercise machine.

Some disclosed embodiments involve an electronic wall-mountable exercise machine. An electronic wall-mountable exercise machine may refer to an electronic exercise machine including a frame (e.g., a vertically wall-mountable beam) for attachment to a wall via a plurality of supporting brackets. The frame and brackets may be made of durable metal (e.g., steel and/or aluminum) for sturdiness and may support a pulley system, allowing a first end of a cable to be connected to a resistance motor and a second end of the cable to be connected to exercise equipment. In some embodiments, an electronic wall-mountable exercise machine may include a user interface (e.g., including one or more adjustable dials, knobs, buttons, switches, and/or levers) allowing interaction with a controller of the wall-mountable exercise machine, e.g., to receive feedback and/or customize a workout to meet a fitness level and/or goal. For example, a dial may allow adjusting a resistance of a resistance motor, and a button may allow changing a direction and/or mode for exerting a force on a cable.

Some disclosed embodiments involve an electromagnet. An electromagnet may refer to a temporary magnet created by intermittent electrical currents. For example, an electromagnet may be formed by passing an electrical current through an electrically conductive wire wrapped around a piece of magnetic metal to produce an electromagnetic field. Some examples of electrically conductive wires may include copper, steel, and/or aluminum wires. Some examples of magnetic metal may include cast iron, wrought iron, galvanized steel, ferritic and martensitic stainless steel. The strength of an electromagnetic field produced by an electromagnet may be increased, decreased, or terminated by controlling a level of electrical current through the wire. Electromagnetic fields produced by one or more electromagnets may be used to introduce resistance to mechanical motion. Overcoming such resistance may require an application of a mechanical force.

Some disclosed embodiments involve a motor (e.g., a resistance motor). Such a motor may include a one or more electromagnets configured to apply a variable electromagnetic field as resistance. For example, a level of resistance produced by a resistance motor may correspond to an amount of weight (e.g., “digital weight”) needed to be overcome by muscles during performance of a weight-bearing exercise. A resistance motor may be associated with at least one processor configured to control a level of electrical current flowing therethrough, allowing the at least one processor to control attributes associated with resistance or digital weight produced by the resistance motor. In some embodiments, a resistance motor may be associated with a lower bracket configured to connect a bottom end of a vertical wall-mountable beam to a wall. For example, a resistance motor may be located inside a housing configured as a lower bracket for connecting a vertical wall-mountable beam to a wall. A lower bracket may be made of durable metal, such as stainless or galvanized steel, or aluminum.

Some disclosed embodiments may involve a cable. A cable may include a rope, cord, chain, belt, and/or any other band or cordage having a tensile strength for withstanding repeated applications of tension. A cable may include a plurality of fibers (e.g., stainless, and/or galvanized steel) that may be combined and twisted to form an elongated structure, and may optionally include a coating such as nylon and/or PVC to reduce friction and wear. In some embodiments, a cable may have a tensile strength suitable for withstanding a resistance force associated with a resistance motor of an electronic exercise machine. For instance, a first end of a cable may connect to a resistive motor and a second end of the cable may connect to a moveable arm of an electronic exercise machine, allowing for a mechanical force applied to move the arm to be at least partially resisted by the resistive motor.

Some disclosed embodiments may involve a pulley or a pulley system. Either such term refers to a mechanical device including at least one wheel that acts to change the direction of a force applied to a cable circumscribing the wheel. The wheel may have a grooved edge or rim around which the cable passes. The pulley may be supported by a frame or shell (e.g., a block) for guiding a cable around the wheel such that rotation of the wheel may cause a direction of the cable to change (e.g., such that a downwards motion on one end of the cable may cause a corresponding upwards motion on the other end of the cable and the reverse). In some embodiments, a vertical wall-mountable beam may include a pulley located at an upper section thereof. A pulley of a vertical wall-mountable beam may be associated with an upper bracket configured to affix an upper end of the vertical wall-mountable beam to a wall. For example, a pulley may be located inside a housing configured as an upper bracket for connecting a vertical wall-mountable beam to a wall. The upper bracket may be made of durable metal, such as stainless or galvanized steel, or aluminum.

Some disclosed embodiments involve a power source. A power source may include any element, device, or system for providing electrical energy to an electrical load or a circuit. Examples of power sources include one or more batteries (e.g., a lead-acid battery, a lithium-ion battery, a nickel-metal hydride battery, a nickel-cadmium battery), fuel cells, generators, capacitors, power converters, or connections (e.g., an electrical wall outlet) to an external source of electrical energy (e.g., an electric grid or other mechanism for supplying electricity). A power source may further include combinations of any of the foregoing.

Some disclosed embodiments may involve signals. A signal may refer to information encoded for transmission via a physical medium. Signals may include electrical or electromagnetic waves that carry information such as voice, video, or data. Signals can take various forms, including analog signals and digital signals. Other signal examples include radio signals, optical signals, microwave signals, infrared signals, ultrasonic signals, or any other wave or other conveyance that carries information. Non-limiting examples of signals include signals in the electromagnetic radiation spectrum (e.g., AM or FM radio, Wi-Fi, Bluetooth, radar, visible light, lidar, IR, Zigbee, Z-wave, and/or GPS signals), audio or ultrasonic signals, electrical signals (e.g., voltage, current, or electrical charge signals), electronic signals (e.g., as digital data), tactile signals (e.g., touch), and/or any other type of information encoded for transmission between two entities via a physical medium.

A transmitter may include an electronic device for sending signals and/or data over distance. A transmitter may encode information to a format suitable for transmission through a medium. A transmitter may send information as electromagnetic radiation (e.g., radio and/or optical waves and/or pulses), electric signals, magnetic signals, audio signals, mechanical vibrations, ultrasound signals, and/or any other type of signal. Some examples of transmitters may include Bluetooth and/or Wi-Fi antennas, and/or optical transmitters. In some embodiments, a sensor may be configured with a transmitter to transmit signals encoding sensed data to at least one processor. In some embodiments, a computing device (e.g., a mobile communications device) may include at least one transmitter.

A receiver refers to a device or circuit that accepts and processes incoming signals. These signals can be in the form of radio waves, electrical pulses, or optical signals, depending on the specific design or implementation. By way of example, a receiver may decode information formatted for transmission through a medium to digital form for ingestion by at least one processor. Alternatively, received information may not require decoding. A receiver may alternatively receive information as electromagnetic radiation, electric signals, magnetic signals, audio signals, mechanical vibrations, ultrasound signals, and/or any other type of ingested information. Some examples of receivers may include Bluetooth and/or Wi-Fi antennas, and/or optical sensors. A computing device may include at least one receiver.

Some embodiments may involve at least one sensor. Some examples of sensors may include a camera (e.g., an image sensor), a motion sensor (e.g., an inertial measuring unit), a voltage and/or current sensor, an ultrasound sensor, a touch-sensitive sensor, a positioning sensor (e.g., an indoor and/or outdoor positioning sensor), encoder sensor, potentiometer, load cell, accelerometer, laser displacement sensor, inductive proximity sensor and/or any other device capable of outputting a signal indicative of physical movement.

Some disclosed embodiments involve a speaker. A speaker may include any element or device capable of outputting sound. For example, a speaker may include one or more transducers for converting electromagnetic waves into sound waves. At least one processor may transmit signals to a speaker to cause information to be rendered as sound.

Some disclosed embodiments involve a light indicator. A light indicator may include any element or device that emits light in order to convey information. (e.g., indicating that a machine is powered on, indicating a mode of operation, indicating proper or improper usage, or indicating any other information. A light indicator may include a single light source (e.g., an LED), an array of light sources, (e.g., an LED array associated with different colors). At least one processor may transmit signals to a light indicator to cause information to be rendered visually.

Some disclosed embodiments involve an electronic display. An electronic display may include an output device for visually presenting information, allowing users to interact with and/or view data, applications, and/or multimedia content. An electronic display includes any device or element capable of generating a visible image from electrical signals. For example, a display may include a monitor and/or screen that converts digital signals into images, text, and/or videos by activating one or more pixels or voxels. Some examples of electronic displays may include a screen (e.g., LCD or dot-matrix screen), an electroluminescent (EL) display, a liquid crystal display (LCD), light-emitting diode (LED)-backlit Liquid crystal display (LCD), a light-emitting diode (LED) display, an organic light-emitting diode (OLED) display, an active matrix organic light-emitting diode (AMOLED) display, a plasma (P) display, a quantum dot (QD) display, a touch screen, a light indicator, a light source, and/or any other type of technology for rendering information visually. A display may include a two dimensional display or a three-dimensional display (e.g., associated with a wearable display). At least one processor may transmit signals to an electronic display to cause information to be displayed visually.

Some embodiments may involve a computing device. A computing device as used herein may include any type of device capable of executing instructions using at least one processor. Such a computing device may include a smartphone, a tablet, a smartwatch, a personal digital assistant, a desktop computer, a laptop computer, an IoT device, a dedicated terminal, a wearable computing device, a client device, a server, and/or any other electronic device that enables computation. A computing device may include at least one processor, at least one memory, a transceiver (e.g., including a transmitter and a receiver), and an input/output unit, all interconnected via one more buses. An electronic exercise machine may include one or more computing devices to control operation of the electronic exercise machine.

The at least one processor may include any physical device or group of devices having electric circuitry that performs a logic operation on an input or inputs. For example, the at least one processor may include one or more integrated circuits (IC), including application-specific integrated circuit (ASIC), microchips, microcontrollers, microprocessors, all, or part of a central processing unit (CPU), graphics processing unit (GPU), digital signal processor (DSP), field-programmable gate array (FPGA), server, virtual server, or other circuits suitable for executing instructions or performing logic operations. In some embodiments, the at least one processor may include a remote processing unit (e.g., a “cloud computing” resource) accessible via a communications network.

The at least one memory may include a Random Access Memory (RAM), a Read-Only Memory (ROM), a hard disk, an optical disk, a magnetic medium, a flash memory, other permanent, fixed, or volatile memory, or any other mechanism capable of storing instructions. Such a memory may be pre-loaded with instructions for execution by at least one processor. In some embodiments, the at least one memory may include a remote storage (e.g., “cloud” storage) accessible via a communications network.

In some embodiments, a computing device may include a communications device capable of exchanging data using a wired and/or wireless communications network. Such a communications network may include one or more of a digital communications network, an analog communication network, and/or any other communications network configured to convey data. Some examples of communications networks may include the Internet, a private data network, a virtual private network using a public network, a Wi-Fi network, a LAN, or WAN network, and/or any combination thereof. In some embodiments, a network may include one or more physical links used to exchange data, such as Ethernet, coaxial cables, twisted pair cables, fiber optics, or any other suitable physical medium for exchanging data. A network may also include a public switched telephone network (“PSTN”) and/or a wireless cellular network. A network may be a secured network or unsecured network. In other embodiments, one or more components of the system may communicate directly through a dedicated communication network. Direct communications may use any suitable technologies, including, for example, BLUETOOTH™, BLUETOOTH LET (BLE), Wi-Fi, near field communications (NFC), or other suitable communication methods that provide a medium for exchanging data and/or information between separate entities.

Some disclosed embodiments involve a mobile communications device. A mobile communications device is a portable electronic instrument designed to facilitate information transmission to other devices or networks. Mobile communications devices may, for example, use cellular or other wireless and/or wired networks to transmit information such as voice and/or other data. For example, such transmissions may be in the form of voice calls, text messages, internet access, and application usage. Mobile communications devices come in various forms, such as smartphones, tablets, laptop computers, IoT devices, wearable electronics (such as smart watches, smart rings, fitness trackers, smart glasses, smart clothing, smart jewelry, smart headphones, wearable digital assistants), and portable wireless hotspots. Depending on configuration and intended use, they may include features such as a touchscreen interface, a built-in camera, Wi-Fi, NFC, and/or Bluetooth connectivity, and GPS navigation.

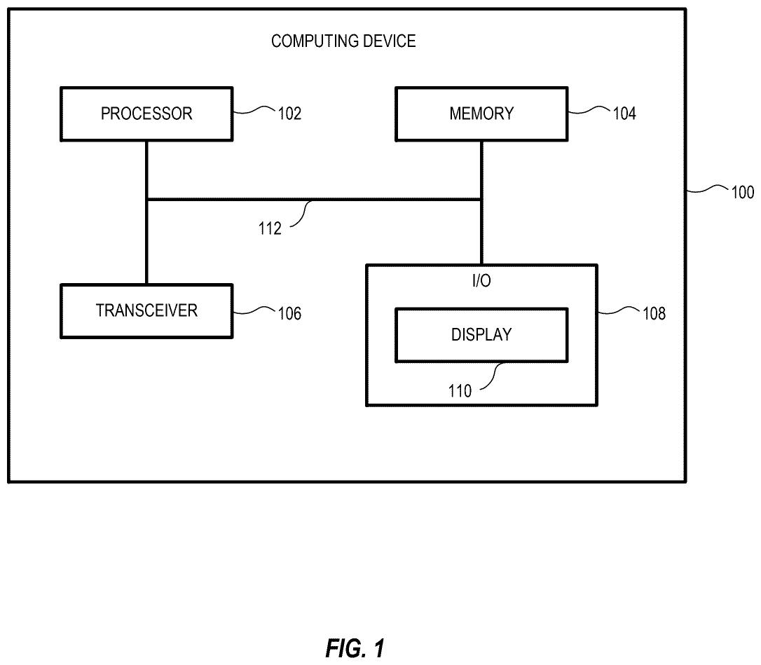

By way of a non-limiting example, reference is made to FIG. 1 illustrating an exemplary schematic diagram of a computing device 100, consistent with some disclosed embodiments. Computing device 100 may include at least one processor 102, at least one memory 104 (e.g., a non-transitory computer readable medium), a transceiver 106 (e.g., including a transmitter and a receiver), and an input/output (I/O) unit 108. At least one processor 102, at least one memory 104, transceiver 106, and input/output unit 108 may be interconnected via a bus 112. In some embodiments, input/output unit 108 may include a display 110. Display 110 may include one or more touch sensitive surfaces, permitting computing device 100 to receive inputs from a user, and present outputs to a user.

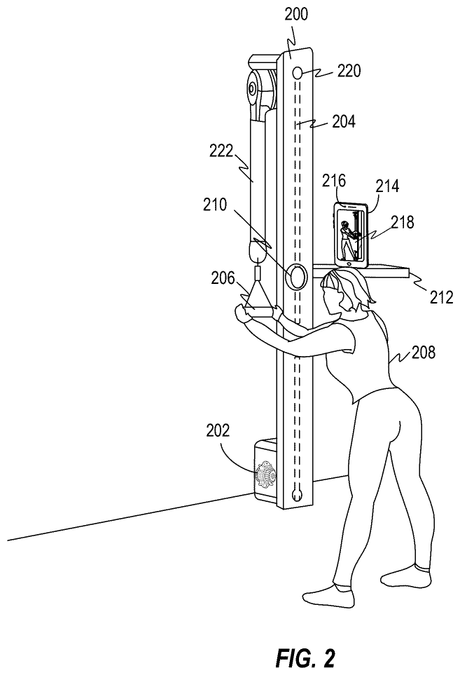

By way of a non-limiting example, reference is made to FIG. 2 illustrating an exemplary electronic exercise machine 200, consistent with some disclosed embodiments. Electronic exercise machine 200 may include at least a motor 202, a cable 204, a pulley system 220, an arm 222, and an exercise interface 206. A first end of cable 204 may be mechanically connected to motor 202 via a spool (not shown). A second end of cable 204 may exit arm 222 and connect to exercise interface 206. Cable 204 may run through electronic exercise machine 200 via pulley system 220 thereby connecting motor 202 to arm 222 and exercise interface 206, permitting a user 208 to exert exercise forces at least partially countering a resistance force exerted by motor 202 by manipulating exercise interface 206.

Electronic exercise machine 200 may include a user interface 210 for receiving and/or sending of data for controlling one or more settings of electronic exercise machine 200, such as a resistance level exerted by motor 202, an exercise mode, type, and/or duration, and/or any other setting and/or parameter for controlling operation of electronic exercise machine 200. For example, user interface 210 may include a touch screen, one or more mechanical and/or virtual dials, switches, buttons, levers, keypads, and/or any other type of user interface for controlling electronic exercise machine 200. User interface 210 may include an electronic display for presenting information to user 208 of electronic exercise machine 200. In some embodiments, electronic exercise machine 200 may include a shelf 212 for supporting a mobile communications device 214 paired to electronic exercise machine 200. Mobile communications device 214 may include an image sensor (e.g., a camera) 216 and a display 218. Display 218 may be a touch screen display for receiving and/or presenting data from/to user 208. For example, display 218 may present a series of images (e.g., a video stream) captured by image sensor 216 of user 208 performing an exercise routine. In some embodiments, electronic exercise machine 200 may be wall-mountable.

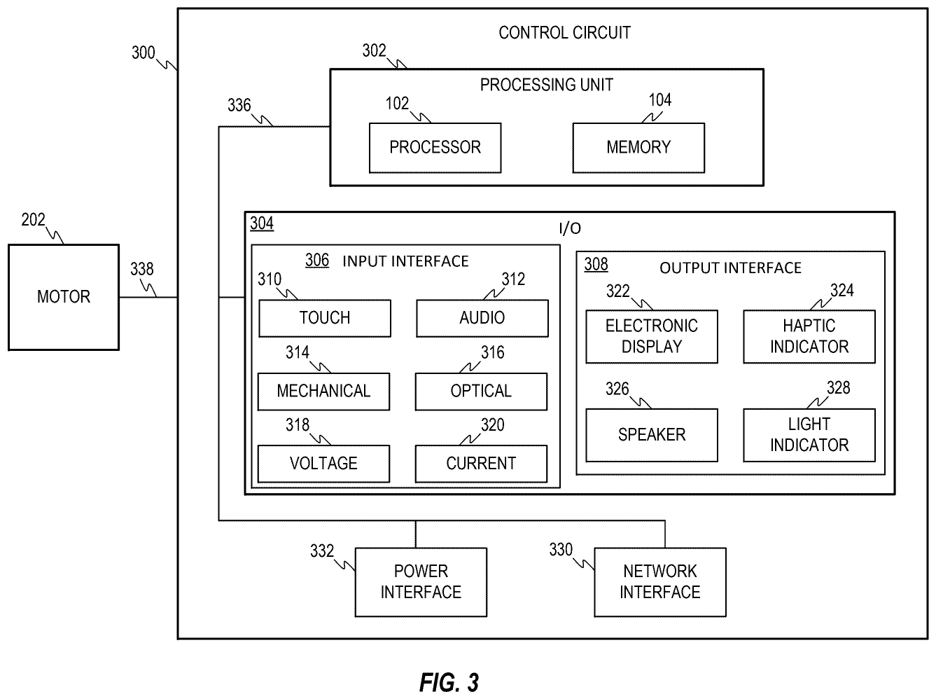

By way of a non-limiting example, reference is made to FIG. 3 illustrating an exemplary block diagram representing circuitry 300 associated with an electronic exercise machine, consistent with some disclosed embodiments. Circuitry 300 may include a processing unit 302. Processing unit 302 may include a computing device 100 of FIG. 1, and may include at least one processor 102 and memory 104. Memory 104 may store information (e.g., data) in one or more data structures. At least one processor 102 may receive and/or transmit signals for controlling a resistance force exerted by motor 202 on cable 204 of FIG. 2. Circuity 300 may include an input/output (I/O) unit 304. I/O unit 304 may include an input interface 306 for receiving data and an output interface 308 for outputting data. Input interface 306 may include one or more sensors for detecting signals associated with controlling electronic exercise machine 200, such as a touch sensor 310 (e.g., associated with user interface 210), an audio sensor 312 (e.g., a microphone), a mechanical sensor 314, an optical sensor 316, a voltage sensor 318, a current sensor 320, and/or any other type of sensor for detecting signals associated with operating an electronic exercise machine such as exercise machine 200. Touch sensor 310 and audio sensor 312 may sense touch and audio input by user 208 via user interface 210. Mechanical sensor 314 and/or optical sensor 316 may detect motion and/or stoppage of motion associated with cable 204. Voltage sensor 318 and current sensor 320 may sense electrical characteristics associated with the operation of motor 202, such as resistance level and/or load. Output interface 308 may include an electronic display 322, a haptic indicator 324, a speaker 326, a light indicator 328, and/or any other type of output interface for presenting data to user 208. Circuitry 300 may include a network interface 330 for pairing electronic exercise machine 200 to another computing device (e.g., to mobile communications device 214 and/or a cloud server), a power interface 332 such as a battery or an interface to a residential or commercial wiring system). Network interface 330 may send and/or receive signals, such as electromagnetic signals (e.g., AM or FM radio, Wi-Fi, Bluetooth, radar, visible light, lidar, IR, Zigbee, Z-wave, and/or GPS signals), sound or ultrasonic signals, electrical signals (e.g., voltage, current, or electrical charge signals), electronic signals (e.g., as digital data), tactile signals (e.g., touch), and/or any other type of signals that convey information.

Some disclosed embodiments involve a communications network. A network (e.g., a communications network) may include any type of physical, wired, wireless computer, or hybrid arrangement of interconnected devices used to exchange data. Such a network may include one or more of a digital communications network, an analog communication network, and/or any other communications network configured to convey data. For example, a communications network may be the Internet, a private data network, a virtual private network using a public network, a Wi-Fi network, a LAN or WAN network, a combination of one or more of the foregoing, and/or other suitable connections that may enable information exchange among or between various system components. In some embodiments, a communications network may include one or more physical links used to exchange data, such as Ethernet, coaxial cables, twisted pair cables, fiber optics, or any other suitable physical medium for exchanging data. A communications network may also include a public switched telephone network (“PSTN”) and/or a wireless cellular network. A communications network may be secured or unsecured network. In other embodiments, one or more system components may communicate directly through a dedicated communications network. Direct communications may use any suitable technologies, including, for example, BLUETOOTH™, BLUETOOTH LET (BLE), Wi-Fi, near field communications (NFC), or other suitable communication methods that provide a medium for exchanging data and/or information between separate entities.

A network may include one or more network devices (e.g., nodes) interconnected by physical (wired), wireless, and/or hybrid communication channels. Some examples of network devices may include a router, a switch, a hub, a booster, a modem, an Access Point (AP), and/or any other type of network device. A router may connect different networks and/or subnetworks together. A router may forward data packets to an intended IP address via a connecting network and/or may permit multiple network devices to use a common network connection. A switch may connect multiple devices within a common network and may facilitate in managing data traffic. A hub may connect multiple networked device together, e.g., in a hub-and-spokes configuration and/or a star network architecture. A modem may convert digital data stored in memory on a computing device in a first format to a second format suitable for transmission via a wired and/or wireless medium, e.g., for accessing a network. An AP may permit one or more wireless devices to connect to a wired network. A network may additionally include one or more end devices, such as one or more computing devices, mobile communication devices, servers, printers, cameras, VoIP phones, IoT devices, and/or any other type of computing device associated with a transmitter and/or receiver. A network may be associated with one or more network protocols, such as TCP/IP (Transmission Control Protocol/Internet Protocol), HTTP/HTTPS (Hypertext Transfer Protocol Secure), FTP (File Transfer Protocol), SMTP (Simple Mail Transfer Protocol), DNS (Domain Name System), DHCP (Dynamic Host Configuration Protocol), and/or any other network protocol. A network may provide one or more services, such as a DNS service for resolving domain names to IP addresses, a DHCP service for automatically assigning an IP address to a networked computing device, one or more authentication services (e.g., LDAP or Lightweight Directory Access Protocol, or RADIUS or Remote Authentication Dial-In User Service), and/or user services such as email, file sharing, web hosting, streaming, and/or any other type of service. A network may additionally provide one or more security services, such as hardware and/or software implemented firewalls, Intrusion Detection/Prevention Systems (IDS/IPS), and/or Antivirus, VPNs, and/or encryption tools.

Some disclosed embodiments involve a network interface. A network interface may include electronic circuitry and/or software code enabling at least one processor to communicate with another processor or processors via a network according to a communications protocol (e.g., Transmission Control Protocol/Internet Protocol or TCP/IP). Such circuitry may include, for example, at least one processor, a memory, one or more antennae configured to send and/or receive wireless signals from other devices, one or more wires and/or cables configured to send and/or receive wired signals from other devices, a plurality of physical and/or virtual ports, one or more software interface layers for implementing one or more communications protocols (e.g., lower layer protocols such as TCP, User Datagram Protocol (UDP), IP, and Internet Control Message Protocol (ICMP), and application layer protocols, such as Hypertext Transfer Protocol (HTTP), Secure Socket Shell (SSH), Transport Layer Security (TLS), and Secure Sockets Layer (SSL), and/or any other component required to enable networked communication between a plurality of computing devices.

Some embodiments involve establishment of a communication link (e.g., a network connection) between a plurality of computing devices, enabling an exchange of data and/or resources therebetween. Such a communication link may be enabled using wired or wireless media and one or more communication protocols, such as TCP/IP.

In some embodiments, a communications network may be associated with a client-server model, allowing a cloud service to provide data storage and/or computational services to one or more client devices via the communications network. For example, a cloud service may store data and software associated with one or more electronic exercise machines and/or mobile communications devices (e.g., client devices) and/or execute program code instructions associated with using one or more electronic exercise machines. For example, a cloud server may store data and/or execute program code instructions for implementing a plurality of operational modes for an electronic exercise machine (e.g., in association with one or more exercise routines), creating an interface between a mobile communications device and one or more electronic exercise machines, and/or pairing two or more modular electronic exercise machines.

A server refers to a computing device interconnected with additional computing devices in a computing network for providing access to one or more services, data, additional computing devices (e.g., client devices and/or additional servers), and/or any other type of computing resource. A server may receive and handle requests from client devices, for example, to access a database, run an application, perform computations, connect to additional networked devices, perform security operations, provide software upgrades, and/or any other computing and/or network operation. Servers may include a web server for hosting one or more websites, a file server for storing and/or sharing files over a network, a database server for managing and/or providing access to one or more databases, a mail server for handing electronic email communication, a DNS server for resolving domain names with Internet Protocol (IP) addresses, a DHCP (Dynamic Host Configuration Protocol) server, a VPN (Virtual Private Network) server, a Firewall and/or Proxy server, a directory server for managing user authentication, and/or any other type of server. A server may include a physical computing device, and/or a virtual server implemented using software. A server may provide continuous service within a network. A server may be dedicated to serving particular types of requests and/or clients, and/or may be hosted on a cloud platform, and may be scalable on demand. For example, a server may receive a request from a client device to access a webpage of a website. In response to the request, the server may access a database storing data for the webpage, format the data for the webpage for rendering on the client device, and transmit the formatted data to the client device over the network. The client device may use the data to present the webpage on an associated display.

A client device refers to a computing device that may request services and/or access to resources from a server over a networked connection and receive a response to the request from the server. Some examples of client devices may include a desktop computer, a laptop, a mobile communications device, an Internet of Things (IoT) device, an electronic exercise machine, and/or a smart TV. For example, a client device may request from a server to access to one or more databases, data structures, a software upgrade, a webpage, an electronic message, a shared file, a video stream, and/or any other type of data. A client device may request access to one or more services from a server, such as an email service, a messaging service, a VoIP (Voice over IP) service, a web hosting service, an application hosting service, a streaming service, a file sharing service, a cloud storage service, a backup service, a security service, a connectivity service, a firewall service, and/or any other type of service available over a network. In some embodiments, a client device (e.g., an electronic exercise machine and/or a mobile communications device paired thereto) may request service from a server to control and/or operate the electronic exercise machine.

Some disclosed embodiments involve a data structure or data. Structured data may include any collection of data values and relationships among them. The data may be stored linearly, horizontally, hierarchically, relationally, non-relationally, uni-dimensionally, multidimensionally, operationally, in an ordered manner, in an unordered manner, in an object-oriented manner, in a centralized manner, in a decentralized manner, in a distributed manner, in a custom manner, or in any manner enabling data access. By way of non-limiting examples, data structures may include an array, an associative array, a linked list, a binary tree, a balanced tree, a heap, a stack, a queue, a set, a hash table, a record, a tagged union, ER model, and a graph. For example, a data structure may include an XML database, an RDBMS database, an SQL database or NoSQL alternatives for data storage/search such as, for example, MongoDB, Redis, Couchbase, Datastax Enterprise Graph, Elastic Search, Splunk, Solr, Cassandra, Amazon DynamoDB, Scylla, HBase, and Neo4J. A data structure may be a component of the disclosed system or a remote computing component (e.g., a cloud-based data structure). Data in the data structure may be stored in contiguous or non-contiguous memory. Moreover, a data structure, as used herein, does not require information to be co-located. It may be distributed across multiple servers, for example, that may be owned or operated by the same or different entities. As used herein, the term “data structure” may include a data pool or may be included in a data pool. A data pool may include a data structure, a data set, a database, a data lake, a data repository, or any other form of information storage whether distributed or undistributed and whether structured or unstructured. It is further to be understood that the term “data structure” as used herein in the singular is inclusive of plural data structures. A data structure may also include any hardware, software, firmware, or combination thereof for storing and facilitating the retrieval of information.

By way of other examples, a data structure may include semi-structured database. A semi-structured database may combine elements of structured and unstructured data. Some types of semi-structured databases may include an ontological database, a semantic database, a NoSQL database, and/or databases based on a hierarchical and/or graph-based schema. A semi-structured database may be based on one or more technologies, such as a Resource Description Framework (RDF) and/or a Web Ontology Language (OWL), JavaScript Object Notation (JSON) formatting, and/or any other form of data. Some examples of semi-structured databases may include MongoDB®, CouchDB®, Cassandra®, Neo4j®, Amazon DynamoDB®, Elasticsearch, Firebase Realtime Database®, Apache HBase®, MarkLogic®, and/or OrientDB®.

A data pool may include a centralized repository and/or collection of data, such as a data warehouse, a data lake, and/or a cloud-based data repository. A data pool may include structured, semi-structured, and/or unstructured data. A data pool may consolidate data from different sources, ensuring that the data may be available for analysis, reporting, decision-making, and other data-driven activities. Data pools may provide a rich data set for training machine learning models, by permitting aggregation of diverse data sets generated by differing data sources at different times and different contexts.

Some disclosed embodiments involve a cloud service. A cloud service is a product that enables access to computing resources, such as servers, storage, and applications, over a network such as the internet. Cloud services are typically provided by third-party vendors who manage and maintain the underlying infrastructure allowing users to access and use the services via the internet. Non-limiting examples of types of cloud services, include Infrastructure as a Service (IaaS), Platform as a Service (PaaS), and Software as a Service (SaaS). In some embodiments, a cloud service may execute program code instructions to implement one or more virtual machines.

For example, a cloud server may store data and execute program code instructions associated with performances of exercise routines (e.g., with or without an electronic exercise machine). For example, a cloud server may store results or achievements and/or provide feedback associated with performances of exercise routines (e.g., by a single or by multiple users), provide instructions for using an electronic exercise machine and/or for implementing differing modes of operation of an electronic exercise machine, facilitate interactions between remote users performing exercise routines (e.g., with or without an electronic exercise machine), and/or provide any other service associated with performances of exercise routines.

Some disclosed embodiments involve machine learning. Machine learning refers to a branch of artificial intelligence utilizing algorithms to navigate through large collections of data in an iterative manner to converge to a solution. Machine learning may include supervised learning, unsupervised learning, and reinforcement learning. Supervised learning may use annotated (e.g., tagged) data sets, whereas unsupervised learning may use unclassified (e.g., non-annotated) data sets. Reinforcement learning may occur in an absence of data, and may use trial-and-error, and environmental feedback to reach a conclusion. In some embodiments, machine learning algorithms (also referred to as machine learning models) may be trained using training examples. Some nonlimiting examples of such machine learning algorithms may include classification algorithms, data regressions algorithms, mathematical embedding algorithms, natural language processing algorithms, support vector machines, random forests, nearest neighbors algorithms, deep learning algorithms, artificial neural network algorithms, convolutional neural network algorithms, recursive neural network algorithms, linear machine learning models, non-linear machine learning models, ensemble algorithms, and so forth. For example, a trained machine learning algorithm may include an inference model, such as a predictive model, a classification model, a regression model, a clustering model, a segmentation model, an artificial neural network (such as a deep neural network, a convolutional neural network, a recursive neural network, etc.), a random forest, a support vector machine, and so forth. In some examples, the training examples may include example inputs together with the desired outputs corresponding to the example inputs. Further, in some examples, training machine learning algorithms using the training examples may generate a trained machine learning algorithm, and the trained machine learning algorithm may be used to estimate outputs for inputs not included in the training examples. In some examples, engineers, scientists, processes and machines that train machine learning algorithms may further use validation examples and/or test examples. For example, validation examples and/or test examples may include example inputs together with the desired outputs corresponding to the example inputs, a trained machine learning algorithm and/or an intermediately trained machine learning algorithm may be used to estimate outputs for the example inputs of the validation examples and/or test examples, the estimated outputs may be compared to the corresponding desired outputs, and the trained machine learning algorithm and/or the intermediately trained machine learning algorithm may be evaluated based on a result of the comparison. In some examples, a machine learning algorithm may have parameters and hyper parameters, where the hyper parameters are set manually by a person or automatically by a process external to the machine learning algorithm (such as a hyper parameter search algorithm), and the parameters of the machine learning algorithm are set by the machine learning algorithm according to the training examples. In some implementations, the hyper-parameters are set according to the training examples and the validation examples, and the parameters are set according to the training examples and the selected hyper-parameters.

In some examples, a trained machine learning algorithm may be used as an inference model that when provided with an input generates an inferred output. For example, a trained machine learning algorithm may include a classification algorithm, the input may include a sample, and the inferred output may include a classification of the sample (such as an inferred label, an inferred tag, and so forth). In another example, a trained machine learning algorithm may include a regression model, the input may include a sample, and the inferred output may include an inferred value for the sample. In yet another example, a trained machine learning algorithm may include a clustering model, the input may include a sample, and the inferred output may include an assignment of the sample to at least one cluster. In some examples, the trained machine learning algorithm may include one or more formulas and/or one or more functions and/or one or more rules and/or one or more procedures, the input may be used as input to the formulas and/or functions and/or rules and/or procedures, and the inferred output may be based on the outputs of the formulas and/or functions and/or rules and/or procedures (for example, selecting one of the outputs of the formulas and/or functions and/or rules and/or procedures, using a statistical measure of the outputs of the formulas and/or functions and/or rules and/or procedures, and so forth).

In some embodiments, artificial neural networks may be configured to analyze inputs and generate corresponding outputs. Some non-limiting examples of such artificial neural networks may include shallow artificial neural networks, deep artificial neural networks, feedback artificial neural networks, feed forward artificial neural networks, autoencoder artificial neural networks, probabilistic artificial neural networks, time delay artificial neural networks, convolutional artificial neural networks, recurrent artificial neural networks, long/short term memory artificial neural networks, and so forth. In some examples, an artificial neural network may be configured manually. For example, a structure of the artificial neural network may be selected manually, a type of an artificial neuron of the artificial neural network may be selected manually, a parameter of the artificial neural network (such as a parameter of an artificial neuron of the artificial neural network) may be selected manually, and so forth. In some examples, an artificial neural network may be configured using a machine learning algorithm. For example, a user may select hyper-parameters for the artificial neural network and/or the machine learning algorithm, and the machine learning algorithm may use the hyper-parameters and training examples to determine the parameters of the artificial neural network, for example using back propagation, using gradient descent, using stochastic gradient descent, using mini-batch gradient descent, and so forth. In some examples, an artificial neural network may be created from two or more other artificial neural networks by combining the two or more other artificial neural networks into a single artificial neural network.

In some embodiments, a software agent, such as an Artificial Intelligence or AI agent may perform one or more machine learning and/or deep learning operations, e.g., on an artificial intelligence network. The AI agent may be installed on a client device, a server device, a cloud service, a router, and/or any other device and may be executed by one or more associated processors. The AI agent may be enlisted to analyze data. The data may be stored locally and/or remotely and may include data collected in real-time (e.g., current data) and/or data collected over time (e.g., historic data). On receiving a query and/or other input, the AI agent may output one or more predictions, inferences, extrapolations, and/or any other output.

Determining refers to arriving at an outcome. It may include, for example, undertaking an equality comparison to check whether two values are the same or are in a predetermined range. For example, the check may involve an equality operator like == in many languages (e.g., Python, JavaScript, C++). If the values are the same, the comparison evaluates to true; otherwise, it evaluates to false. Determining may additionally or alternatively include making a measurement, comparison, estimation, and/or calculation to arrive at a conclusive outcome.

Detecting refers to sensing, perceiving, discovering, recognizing, and/or identifying. Detecting may include identifying, recognizing, and/or discovering something by monitoring for patterns, signals, and/or anomalies that indicate certain events and/or conditions. Detection may be performed by a sensor, a receiver (e.g., a port and/or an antenna), and/or at least one processor and may involve sensing a change in state from one time period to a subsequent time period.

Transmitting (e.g., signals) refers to conveying information over a distance. Transmitting may be performed on a wired channel (e.g., a twisted pair cable, a coaxial cable, and/or a fiber optic cable) and/or using a wireless channel (e.g., Wi-Fi, Bluetooth, satellite, and/or cellular). Transmitting may involve obtaining digitally encoded data, formatting the data for a communications channel and transmitting the formatted data to a transmitter (e.g., an output port and/or antenna) connected to a network, to enable sending the formatted data to an associated receiver. In some embodiments, transmitting may include encrypting data prior to sending the data.

Receiving (e.g., signals) refers to obtaining, acquiring, and/or otherwise gaining access to information over a distance. Receiving may be performed on a wired and/or wireless channel. Receiving may involve connecting to a network, detecting an incoming signal at a receiver (e.g., an input port and/or antenna), and/or formatting the signal for storage in memory as digital data. In some embodiments, receiving may include decrypting received data.

Identifying refers to recognizing, ascertaining, and/or discovering. Identifying may involve determining a match (e.g., within a threshold) between two or more items, and/or associating an item with an (e.g., uniquely) identifying code and/or index.

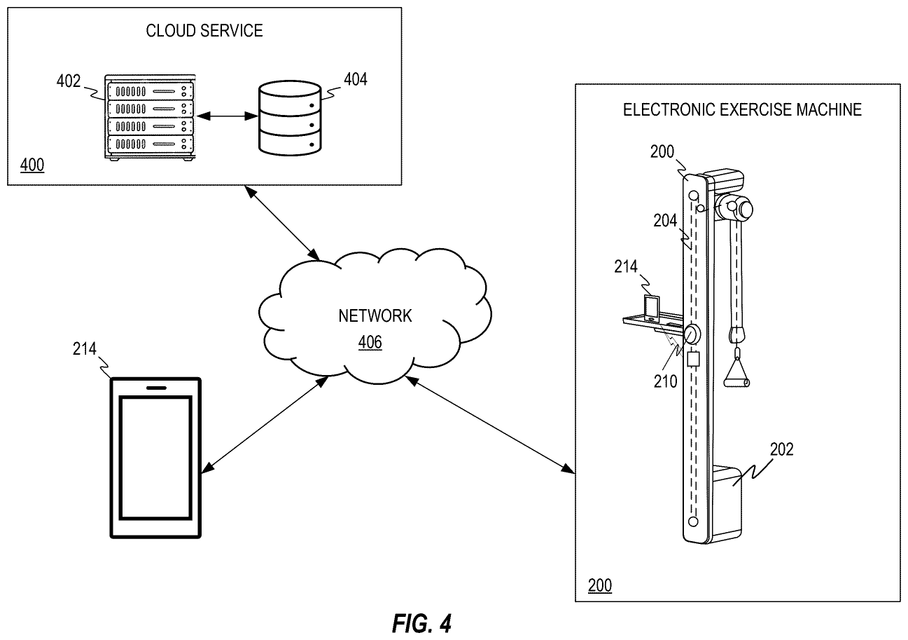

By way of a non-limiting example, reference is made to FIG. 4, which is a schematic illustration of a cloud service 400 associated with electronic exercise machine 200 and/or mobile communications device 214, consistent with some embodiments of the present disclosure. Cloud service 400 includes at least one server 402 and a data repository 404.

Cloud service 400 may communicate via a communications network 406. At least one server 402, electronic exercise machine 200, and mobile communications device 214 may each include one or more instances of computing device 100 of FIG. 1. Data repository 404 may store and/or correspond to any of the data structures previously described. Communications network 406 may include a local network, such as a Bluetooth and/or Wi-Fi channel connecting mobile communications device 214 with electronic exercise machine 200, and/or a remote network connecting mobile communications device 214 and/or electronic exercise machine 200 with cloud service 400. Cloud service 400 may receive data sensed by one or more sensors associated with electronic exercise machine 200 and/or mobile communications device 214 and a request to process and/or analyze the sensed data and/or retrieve associated historical and/or inferred data from data repository 404. Cloud service 400 may fulfill the request and transmit a corresponding response to electronic exercise machine 200 and/or mobile communications device 214 via communications network 406. For example, cloud service 400 may receive a sequence of images of user 208 performing an exercise routine using electronic exercise machine 200 and captured by image sensor 216 (illustrated in FIG. 2) of mobile communications device 214. Cloud service 400 may analyze the images and transmit signals to electronic exercise machine 200 for adjusting a resistance level and/or mode for motor 202 based on the analysis.

Some disclosed embodiments involve gamifying one or more exercise routines. To gamify may refer to the application of game-design elements and principles in a non-game context for the purpose of engaging participants, enhancing motivation, and encouraging desired behaviors. Such game-design elements may include point scoring, a leaderboard ranking participants based on performance, badges for rewarding participants, challenges for motivating participants, and/or progress tracking to create a more interactive and rewarding experience. For example, a gamified physical exertion session may include game-design elements for motivating a participant to exert more energy and/or exercise for a longer period than a non-gamified physical exertion session. Gamifying a physical exertion session may help participants persist longer and perform more intensely during an exercise routine compared to a non-gamified physical exertion session. For instance, a physical exertion session may be gamified as a video game rendered on an electronic display, such that a user experience associated with performance of the physical exertion session is similar to a user experience associated with playing a video game. Gamifying an exercise routine may additionally introduce social engagement with other exercising users via multi-player modes to exploit team dynamics and/or competition for motivating users.

Gamifying a physical exertion session may alleviate negative user experiences associated with physical exertion, such as tediousness, boredom, stress, and/or fatigue. For example, a workout session involving multiple repetitive movements may become boring, causing a user to lose interest. A gamified physical exertion session may cause a user experience for an exercise routine to mimic user experiences typically associated with playing games (e.g., video games). For instance, a gamified physical exertion routine may include a display of colorful graphics and allocation of points and/or awards such that the user experience associated with completing multiple repetitive movements may be similar to a user experience associated with playing a video game. This may cause a user's motivation to complete such an exercise routine to be greater than for a similar exercise routine that is non-gamified. Additionally or alternatively, gamification of exercise routines may encourage a user to perform multiple repetitive movements at a desired pace, duration, and/or range of motion to achieve a fitness goal.

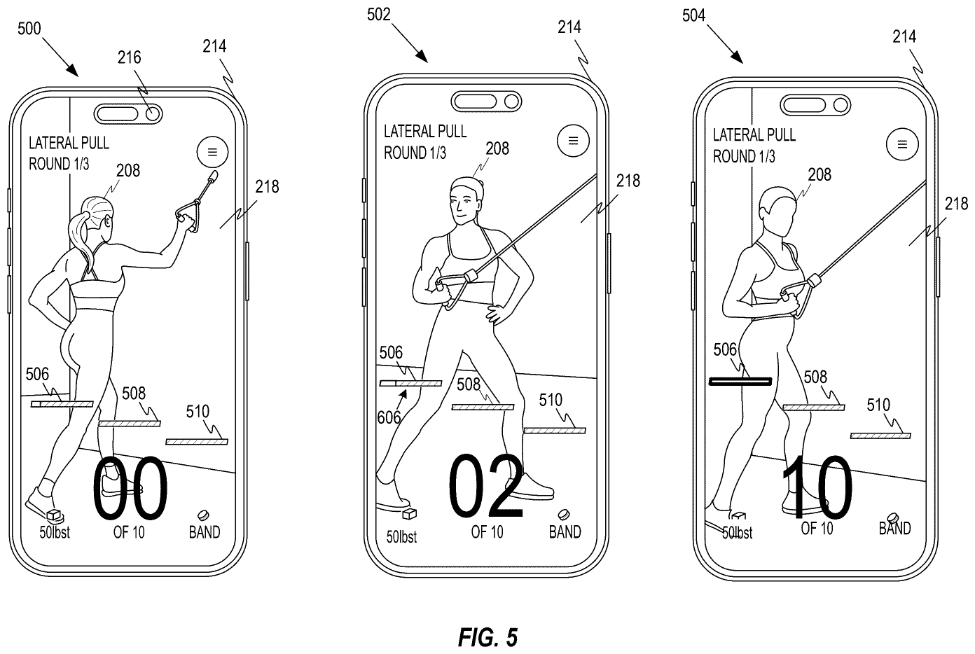

By way of a non-limiting example, FIG. 5 is a series of front views of mobile communications device 214 presenting an exemplary real-time sequence of images 500, 502 and 504 of user 208 performing a first gamified exercise routine, consistent with some disclosed embodiments. At least one processor (e.g., processor 102 associated with any of mobile communications device 214, electronic exercise machine 200, and/or cloud service 400) may receive images 500, 502 and 504 from image sensor 216 of mobile communications device 214 in real-time, and analyze images 500, 502 and 504 to provide visual feedback to user 208 via display 218. The at least one processor may overlay progress bars 506, 508, and 510 on images 500, 502, and 504 to depict progress of the exercise routine by progressively filling in progress bars 506, 508, and 510 after each completed repetition of the exercise routine. User 208 may accrue points for the first gamified exercise routine after completing a threshold number of exercise repetitions, tracked by progress bars 506, 508, and 510.

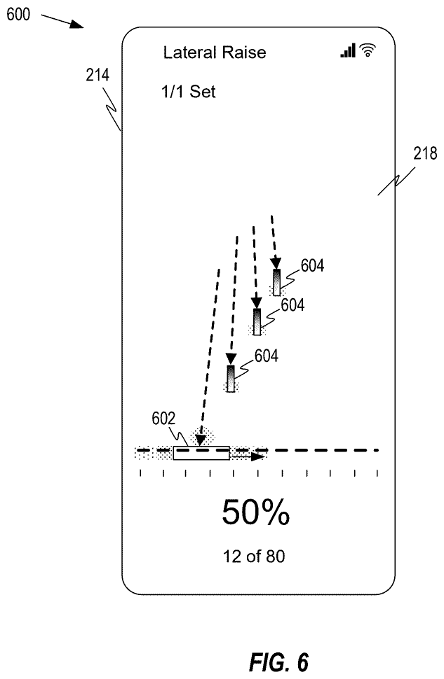

By way of another non-limiting example, FIG. 6 is a front view of mobile communications device 214 presenting an exemplary user interface 600 for a second gamified exercise routine, consistent with some disclosed embodiments. At least one processor (e.g., processor 102 associated with any of mobile communications device 214, electronic exercise machine 200, and/or cloud service 400) may receive signals (e.g., optical and/or mechanical signals) indicative of motion of cable 204 of electronic exercise machine 200 as user 208 pulls and/or releases exercise interface 206. The at least one processor may use the signals to visually track the pulling and/or releasing motion by displaying a graphic paddle 602 moving across display 218 of mobile communications device 214. The at least one processor may motivate user 208 to pace the pulling and/or releasing motion on exercise interface 206 to cause paddle 602 to collide with one or more graphic elements 604 for accruing points.

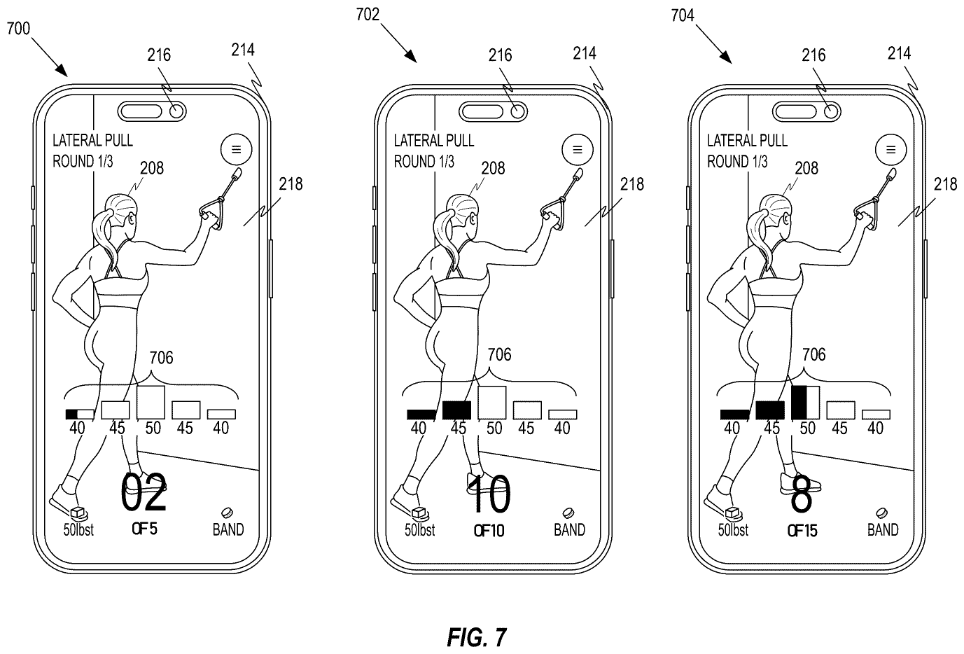

By way of a non-limiting example, FIG. 7 is a series of front views of mobile communications device 214 presenting an exemplary real-time sequence of images 700, 702 and 704 of user 208 performing a third gamified exercise routine, consistent with some disclosed embodiments. At least one processor (e.g., processor 102 associated with any of mobile communications device 214, electronic exercise machine 200, and/or cloud service 400) may receive images 700, 702 and 704 from image sensor 216 in real-time, and analyze images 700, 702 and 704 to provide visual feedback to user 208 via display 218. The at least one processor may overlay graphic indicators 706 on display 218 of mobile communications device 214 to track performance of an exercise routine according to a pyramid pattern. Indicators 706 may depict progress of a first block of an exercise routine performed at a baseline exertion level, followed by subsequent exercise blocks performed at step increases in exertion until a peak exertion level is achieved. Following completion of a block at the peak exertion level, indicators 706 may depict performance of subsequent exercise blocks at step decreases in exertion until the baseline exertion level is reached. For instance, such an exercise routine may begin with five repetitions, increase to ten repetitions, increase again to fifteen repetitions, then decrease back to ten repetitions, and revert back to five repetitions. Such a pyramid pattern may facilitate building strength and endurance while adding variety to a workout routine.

Some disclosed embodiments relate to enabling variable workout gamification. A workout refers to any structured or intentional physical activity intended to improve fitness. A workout may generally encompass everything from light movement to intense exertion, serving purposes that range from stress relief to physical conditioning. Workout may, in some cases, refer to a structured session of exercise designed with particular goals—such as building strength, enhancing cardiovascular endurance, increasing flexibility, improving athletic performance, etc. In some cases, a workout may be designed to facilitate weight loss or maintenance, improve strength, enhance the cardiovascular system, or hone athletic abilities. The disclosed embodiments relate to a workout for strength or weight training, performed by a user manipulating a part of an exercise machine that moves a certain amount of weight or overcomes a resistance created by the exercise machine. The workout may include, for example, arm or leg movements designed for strengthening one or more muscles of the user.

Gamification refers to applying game elements to an activity. Gamification may involve associating certain aspects of an activity with points, badges, leaderboards, levels, and rewards. The implementation of the gamification may be designed to motivate, engage, and influence behavior of a user such as a trainee. Workout gamification refers to the application of game-like elements to workout or physical exercise to increase participation, motivation, competition, engagement, or consistency. It may involve transforming a workout routine into experiences that feel more interactive, rewarding, or competitive, for example, by introducing goals, feedback, and incentives that mirror those found in games. Workout gamification may refer to a personalized program that integrates biometric data, adaptive difficulty, and real-time feedback to create a customized, game-like progression system tailored to an individual's fitness goals and behavioral patterns. In some cases, workout gamification may refer to the use of digital platforms or apps that track performance and reward users with points, badges, or rankings based on their activity. For example, workout gamification may include a leaderboard, competition, progress bars, scoring points, obtaining badges, taking on challenges, winning rewards, receiving kudos, difficulty levels, tiered objectives, time constraints, streaks, unlockable features, or any other element that impacts a user's perception of the purpose, progress, pressure, position, or play related to their workout.

Variable refers to an ability of something to change, differ, or fluctuate over time or across conditions. It may refer to the presence of change, diversity, or inconsistency within a system, behavior, or set of outcomes. In some instances, variable may refer to a range or spread of data points indicating how much individual values deviate from an average. It may refer to the ability of a user to change one or both of the workout or game elements. For example, variability may include changing the workout type, workout intensity, weight associated with an exercise, motion, movement, degree of difficulty, point values, challenges, objectives, workout length, number of users, or any other change that impacts a user's workout experience.

Enabling refers to directly or indirectly activating, permitting, facilitating, or making operable a function, feature, component, or system through one or more mechanisms, conditions, or configurations. For example, enabling may include activating a module, service, or interface; granting access to a resource, capability, or dataset; configuring parameters; permitting execution of a command, set of instructions, process, algorithm, or workflow; facilitating interoperability; triggering conditional logic to make a feature available; or any other implementation that permits utilization of a resource. In another example, enabling may refer to an act of making something possible, easier, or more likely to happen. In yet other examples, enabling may refer to creating conditions that allow a process or system to function. Enabling, in some examples, may also include activating features or integrating systems that allow new functionalities or features. For example, it may refer to turning on or turning off a portion of a feature or a feature in its entirety. In some examples, enabling may refer to or involve, designing and/or deploying adaptive systems that personalize challenges, rewards, and feedback based on user behavior and fitness data, thereby transforming workouts into engaging, game-like experiences that drive sustained participation and progress.

Enabling variable workout gamification may, in some embodiments, involve the integration of dynamic, game-like elements into exercise routines, where variables—such as intensity, duration, type of exercise, feedback mechanisms, user interaction, etc. —can be adjusted in real time or based on user input. This may make workouts more engaging, personalized, and motivating by transforming them into interactive experiences that resemble games.

Some disclosed embodiments involve providing first selectable indications of a plurality of candidate fitness movements. Fitness movements refers to one or more bodily movements, motions, or gestures that focus on one or more wellness or fitness categories. Fitness movements may focus on wellness or fitness categories such as strength, speed, endurance, agility, flexibility, and/or power. For example, fitness movements may include squatting, hinging, lunging, pushing, pulling, rotating, and locomotion motions including throwing, pull-ups, chin-ups, sit-ups, push-ups, running, walking, bench press, seated row, latissimus pulldown, face pull, chest fly, press down, triceps extension, shoulder press, bicep curl, triceps kickback, crunch, hip abduction, hip adduction, kickback, calf raise, lateral rotation, lateral raise, reverse fly, chest press, pull down, frontal raise, upright row, pull through, side bend, wood choppers, shrugging, pull throughs, stretching, and any other motion that involves squatting, hinging, lunging, pushing, or pulling.

In the present context, “candidate” fitness movements refers to the fitness movements that are available for selection. These are fitness movements that the system recognizes as valid and appropriate for the user to choose from. “Candidate” fitness movements may indicate that the fitness movement is not yet active or selected, but is eligible for selection.

The term “indications” refer to any visual, auditory, or tactile cues that communicates information. Indications may refer to interface elements that communicate information to a user. For example, these indications may convey available actions that enable a user to respond. Indications may, in general, have any form. In some embodiments, they may take the form of graphical elements such as icons, buttons, highlights, or overlays that signal interactivity or status. Indications may range from general cues that orient users within a system to specific, dynamic signals that guide precise actions. In some embodiments, the indications may be context-sensitive and layered and may adapting to the user's actions or the interface mode.

“Selectable” refers to the property of an item, element, or option that allows it to be chosen or activated. Selectable indications refer to interface elements that signal their availability for user interaction. It may indicate to the user that an indication is available for selection or interaction. Selectable indication may refer to interface elements that are visually or functionally distinguished from non-selectable ones, for example through cues like color, illumination, highlighting, animation, or placement within a designated selection area. In some cases, these elements may change state upon interaction, such as becoming active, triggering a function, or displaying additional content. Selectable indication may include a user input such as a command, instruction, speech, manipulation, tap, press, click, motion, or any other gesture initiated by or through a user to interact with something. Selectable indication may involve a user choosing to engage in a specific movement, selecting an exercise to perform or workout to complete, choosing an exercise machine, selecting how much weight to lift, or deciding when or how long to exercise.

The term “first,” “second” and similar ordinal references in the present disclosure are used to distinguish between different items, elements, or sets. For example, a second set of selectable indications may be distinguished from a first set that is presented either before or after the second set. The use of these terms does not necessarily imply a specific temporal order unless explicitly stated. Rather, they serve to identify distinct components relative to one another. Depending on the implementation, the first and second sets may be presented, received, or otherwise occur simultaneously, in succession, and/or in any order. This terminology is intended to facilitate clarity in describing multiple related elements or operations throughout the disclosure.

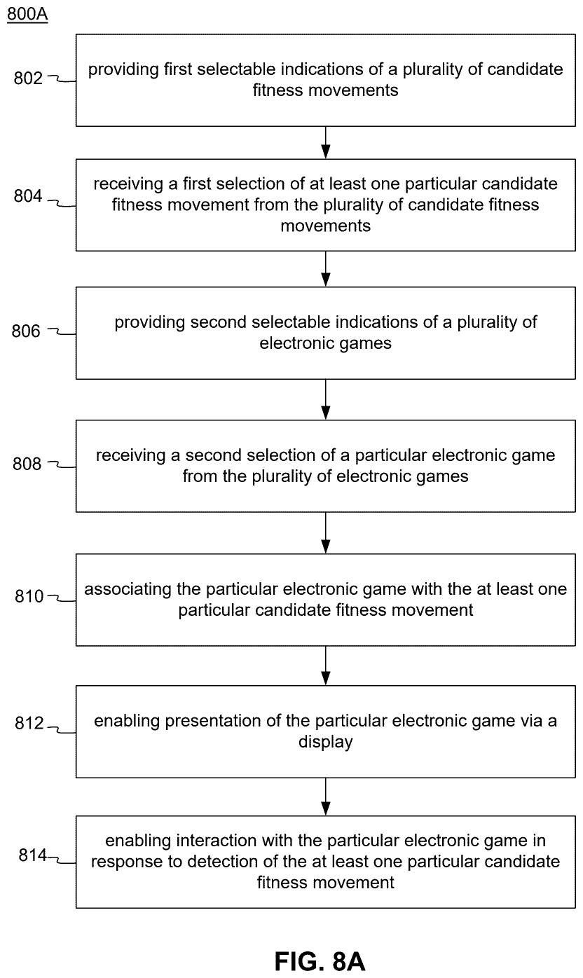

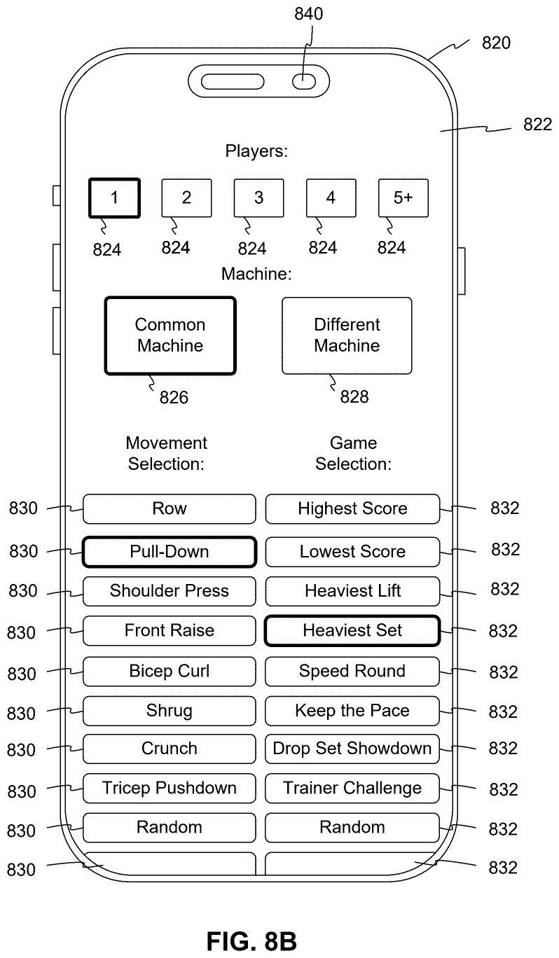

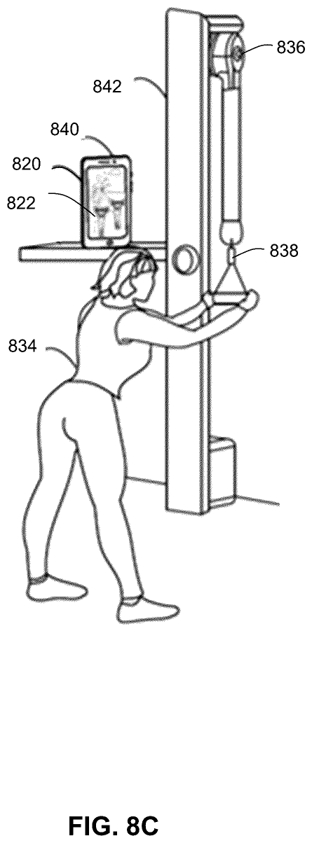

Providing first selectable indications of a plurality of candidate fitness movements refers to one presentation of interactive cues that represent multiple potential options for selection. For example, it may include displaying a set of visual or functional signals that inform the user which items are available for interaction. These indications may be designed to be selectable, meaning they are not merely informational but are intended to be acted upon—chosen, activated, or engaged with by a user choosing one or more of a desired candidate fitness movement. By way of nonlimiting example, FIG. 8B shows an exemplary interface for movement selection and game selection, consistent with disclosed embodiments. As shown, list that includes multiple candidate fitness movements 830 may be provided that a user may select by touching, tapping, pressing, or providing any other input indicative of identifying an option for one or more processors to take action upon.

Some disclosed embodiments involve receiving a first selection of at least one particular candidate fitness movement from the plurality of candidate fitness movements. Receiving refers to acquiring, accepting, or obtaining something. Receiving may involve acquiring data signals, instructions, or any other form of input from an internal or external source and may be by, for example, wired, wireless, optical, or other transmission mediums. Receiving may also refer to the initial detection and decoding of a signal or data stream, the acknowledgement of a transmission, or the storage of incoming information into a storage device. Selection refers to a choice, election, or pick. A selection of a candidate fitness movement is therefore one such movement chosen, elected or picketed from a group. It may involve a user-initiated input that identifies a particular item—such as a candidate movement—from among a plurality of available choices. The term “particular” refers to a specific item identified or distinguished from among a broader set of options. It may indicate that the selection pertains to one or more defined elements-rather than any general or unspecified member of the group. When used in the phrase “at least one particular candidate fitness movement,” a selection may indicate that the at least one processor is not merely receiving a generic selection, but rather a deliberate choice of one or more distinct movements that were previously presented as candidates.

Receiving a first selection of at least one particular candidate fitness movement may include receiving input, indicating the choice of one or more of particular candidate fitness movements (for example, throwing, pull-ups, chin-ups, sit-ups, push-ups, running, walking, walking, bench press, seated row, latissimus pulldown, face pull, chest fly, press down, triceps extension, shoulder press, bicep curl, triceps kickback, crunch, hip abduction, hip adduction, kickback, calf raise, lateral rotation, lateral raise, reverse fly, chest press, pull down, frontal raise, upright row, pull through, side bend, wood choppers, shrugging, pull throughs, and any other motion that involves squatting, hinging, lunging, pushing, pulling, rotating, or locomotion). In some embodiments, one or more processors receive a first selection corresponding to at least one particular candidate fitness movement from among a plurality of previously presented options. The candidate fitness movements may be presented via one or more selectable indications, each representing a distinct movement available for user selection. Upon receiving the first selection, the processor(s) identifies the selected movement and may initiate further processing, such as storing the selection, updating the user interface, or preparing to execute or display the selected movement. The first selection may be received through any suitable input mechanism, including but not limited to touch, gesture, voice, or remote control interaction.

Some disclosed embodiments involve providing second selectable indications of a plurality of electronic games. Selectable indications may be understood as described and exemplified elsewhere in this disclosure. Electronic games refer to interactive experiences that are at least in part digital, and that are designed for entertainment, challenge, and/or simulation, where a user provides an input and receives visual or auditory feedback via an electronic display. The feedback may include both visual and/or auditory output. Electronic games may be governed by a set of programmed rules and logic, and they may include elements such as scoring, progression, rewards, or competition. They may include graphical user interfaces (GUIs), animations, and sound effects, and may be designed for single or multiple players. In some embodiments, electronic games may be downloadable or preinstalled software executable by one or more processors, such as one or more processors of an exercise machine and/or a device in communication with the exercise machine such as a mobile device. The electronic game software may enhance the functionality of the associated devices by enabling a user to engage with a software-based or hardware-based interface to, for example, execute game logic, receive feedback, or accomplish one or more goals. Electronic games may be implemented via electronic, digital, or computational means. Electronic games may include strategy games, pattern games, educational games, rhythm games, boxing games, puzzle games, racing games, dancing games, endurance games, speed games, agility games, strength games, power games, sports games, challenge games, circuit games, solo games, team games, scoring games, highest score games, lowest score games, elimination games, or any other objective-based game.

In some embodiments, providing second selectable indications of a plurality of electronic games involves generation and display of a graphical user interface having the indications of the plurality of electronic games. The indications may be icons, virtual buttons, graphical elements associated with physical hardware, buttons, or any other suitable mechanisms for conveying a set of interactive options. The provided indications may be selectable due to one or more processors detecting an input associated with a user identifying one or more of the indications of the plurality of electronic games, and the one or more processors may execute a command or operation in response to the detected input. An indication may be selectable if a physical button is associated with the indication, or if a portion of a touch-sensitive display is associated with the indication. An indication may also be selectable if the user is able to identify it to one or more processors by tactile input, voice input, and other techniques for selecting an item on a display.

Some disclosed embodiments involve receiving a second selection of a particular electronic game from the plurality of electronic games. The terms receiving, electronic game, and preferred may be understood as described and exemplified elsewhere in this disclosure. Receiving a second selection of a particular electronic game from the plurality of electronic games refers to receiving another user input that identifies a particular item from a previously presented set of options. In some embodiments, the processor(s) receives a second selection corresponding to a particular electronic game from among a plurality of electronic games. The second selection may be received through any suitable input mechanism, including but not limited to touch, gesture, voice command, or remote-control interaction. The particular electronic game selected may be identified by the system for subsequent processing, such as launching the game, updating the user interface, or storing the selection for future reference.

Some disclosed embodiments involve associating the particular electronic game with the at least one particular candidate fitness movement. Associating refers to an act or process of establishing a relationship or connection between two or more entities, elements, components, or data structures. Associating may involve establishing a functional, logical, structural, or referential connection. For example, associating may include unidirectional connection, bidirectional connection, temporary connection, persistent connection, direct linkage, indirect linkage, mapping, referencing, tagging, grouping, or any other mechanism that enables one thing to be identified, accessed, or utilized in conjunction with another thing. Associating may additionally or alternatively involve pairing an electronic game to a candidate fitness movement or pairing a candidate fitness movement to an electronic game.

Associating the particular electronic game with the at least one particular candidate fitness movement may include relating a particular electronic game (such as, for example, a strategy game, pattern game, educational game, rhythm game, boxing game, puzzle game, racing game, dancing game, endurance game, speed game, agility game, strength game, power game, sports game, challenge game, circuit game, solo game, team game, highest score game, lowest score game, elimination game, or any other objective-based game) with at least one particular candidate fitness movement (such as the exemplary fitness movements previously mentioned.)

An association of a game and a fitness movement may be established based on user input, predefined mappings, contextual relevance, or system-generated recommendations. Such a linkage may enable one or more processors to relate the selected electronic game to a specific fitness movement, thereby facilitating coordinated execution, display, or tracking of both elements. The association may be stored, updated, or utilized to personalize user experiences, synchronize interactive content, or support adaptive functionality within the system. In some embodiments, one or more electronic games may be unassociated with one or more candidate fitness movements.

The above-described association may be established through various mechanisms, including predefined mappings stored in memory, user-defined preferences, contextual rules, or dynamic selection algorithms. For example, one or more processors may have access to a database that links specific electronic games to corresponding fitness movements based on gameplay characteristics, movement patterns, or intended physical engagement. Alternatively, the association may be generated in real time based on user selections, historical usage data, or adaptive learning models that infer suitable pairings. In some embodiments, the association may be used to synchronize the execution of the electronic game with the performance of the fitness movement, enabling coordinated interaction, tracking, or feedback. In some implementations, the association may also support personalized recommendations, session planning, or progress monitoring, thereby enhancing the overall user experience and system functionality.

Some disclosed embodiments involve enabling presentation of the particular electronic game via a display. A display refers to an output device for visually presenting information, as described and exemplified herein. The display may include any suitable visual output device, such as a screen integrated into a console, monitor, mobile device, digital glasses, or any other wearable or non-wearable interface. Other display examples include holographic displays, volumetric displays, free-space displays, airborne displays, augmented reality projection displays and mid-air projection displays, By way of non-limiting example, a FIG. 7 illustrates an exemplary display 218 of mobile communications device 214.

Presentation refers to a process of rendering, transmitting, or making available one or more forms of content, data, or information. A presentation may involve delivering content in a visual, auditory, tactile, and/or symbolic format. It may involve delivering the content to one or more recipients, which may include a user, system, device, or process. For example, presentation may involve hardware implementations, software implementations, displaying content on a graphical user interface, emitting audio signals, generating haptic feedback, transmitting data packets, activating or rendering interactive physical or virtual elements, sequencing or formatting content, or any other conveyance of content. It may include transmitting information about the progress, quality, length, or difficulty of a workout or electronic game to a user. By way of non-limiting example and with reference to FIG. 5, content related to an electronic game, exercise, workout, and/or candidate fitness movement and/or resulting leaderboards, points, or achievements may be presented to user 208 on mobile communications device 214.

Enabling presentation of the particular electronic game via a display may include facilitating the presentation or displaying of the particular electronic game on some sort of visible medium. Enabling presentation refers to one or more of rendering graphical content, initiating game logic, providing, running, transmitting, and/or implementing code for causing visuals to appear on a display, and/or activating user interface elements associated with the selected electronic game. One or more microprocessors may retrieve the necessary game data and resources from local or remote storage and configure the display parameters to accommodate the game's visual and interactive requirements. This presentation may allow the user to view, interact with, and engage in gameplay through the designated display interface.

By way of a non-limiting example, FIG. 5 is a series of front views of mobile communications device 214 presenting an exemplary real-time sequence of images 500, 502 and 504 of user 208 performing a first gamified exercise routine, consistent with some disclosed embodiments. At least one processor (e.g., processor 102 associated with any of mobile communications device 214, electronic exercise machine 200, and/or cloud service 400) may receive images 500, 502 and 504 from image sensor 216 of mobile communications device 214 in real-time, and analyze images 500, 502 and 504 to provide visual feedback to user 208 via display 218. The at least one processor may overlay progress bars 506, 508, and 510 on images 500, 502, and 504 to depict progress of the exercise routine by progressively filling in progress bars 506, 508, and 510 after each completed repetition of the exercise routine. User 208 may accrue points for the first gamified exercise routine after completing a threshold number of exercise repetitions, tracked by progress bars 506, 508, and 510.

By way of further non-limiting example, FIG. 7 is a series of front views of mobile communications device 214 presenting an exemplary real-time sequence of images 700, 702 and 704 of user 208 performing a third gamified exercise routine, consistent with some disclosed embodiments. At least one processor (e.g., processor 102 associated with any of mobile communications device 214, electronic exercise machine 200, and/or cloud service 400) may receive images 700, 702 and 704 from image sensor 216 in real-time, and analyze images 700, 702 and 704 to provide visual feedback to user 208 via display 218. The at least one processor may overlay graphic indicators 706 on display 218 of mobile communications device 214 to track performance of an exercise routine according to a pyramid pattern. Indicators 706 may depict progress of a first block of an exercise routine performed at a baseline exertion level, followed by subsequent exercise blocks performed at step increases in exertion until a peak exertion level is achieved. Following completion of a block at the peak exertion level, indicators 706 may depict performance of subsequent exercise blocks at step decreases in exertion until the baseline exertion level is reached. For instance, such an exercise routine may begin with five repetitions, increase to ten repetitions, increase again to fifteen repetitions, then decrease back to ten repetitions, and revert back to five repetitions. Such a pyramid pattern may facilitate building strength and endurance while adding variety to a workout routine.

Some disclosed embodiments involve enabling interaction with the particular electronic game in response to detection of the at least one particular candidate fitness movement. The terms, enabling, electronic game, detection, and candidate fitness movement may be understood as described and exemplified elsewhere in this disclosure. Interaction refers to an engagement occurring between two or more entities, which entities may include users, systems, components, interfaces, processes, or devices. For example, interaction may include an exchange, communication, responsive behavior, or any other call and response like activity, and may be synchronous, asynchronous, direct, mediated, manual, automated, protocol-based, physical, digital, hybrid, governed by rules, governed by algorithms, governed by a model, or any other technique for moderating activity. It may include an exchange between two people, between a person and their body, or between a person and a device or machine such as a computing device or an exercise machine.

Enabling interaction with the particular electronic game in response to detection of the at least one particular candidate fitness movement sensing that a particular candidate fitness movement has occurred, and executing a corresponding outcome or reaction in the electronic game. In some embodiments, one or more microprocessors enable interaction with the particular electronic game in response to detection of at least one particular candidate fitness movement. Upon detecting the performance or initiation of the candidate fitness movement—using sensors, input devices, or other monitoring mechanisms on an electronic exercise machine, for example, —the one or more processors may activate or modify the electronic game to reflect the detected movement. This interaction may include triggering in-game actions, updating game states, providing feedback, or adjusting gameplay parameters based on the characteristics of the detected movement. The one or more processors may utilize real-time data processing to ensure that the interaction is responsive and synchronized with the user's physical activity. This capability allows the electronic game to dynamically respond to user behavior, thereby enhancing engagement, personalization, and the overall interactive experience.

By way of nonlimiting example, FIG. 8A illustrates a flowchart of an exemplary process for providing gamified sets, consistent with disclosed embodiments. The process may be performed by one or more processors as disclosed herein. As illustrated in FIG. 8A, process 800A may include a step 802 of providing first selectable indications of a plurality of candidate fitness movements. At step 8A-104 the one or more processors may receive a first selection of at least one particular candidate fitness movement from the plurality of candidate fitness movements. At step 806 the one or more processors may provide second selectable indications of a plurality of electronic games. At step 808 the one or more processors may receive a second selection of a particular electronic game from the plurality of electronic games. At step 810, the one or more processors may associate the particular electronic game with the at least one particular candidate fitness movement. At step 812, the one or more processors may enable presentation of the particular electronic game via a display. At step 814 of the one or more processors may enable interaction with the particular electronic game in response to detection of the at least one particular candidate fitness movement.

Some disclosed embodiments involve detection of the at least one particular candidate fitness movement occurring by sensing cable movement. Detection refers to identifying the presence of something. Detection may involve a process, operation, or capability of identifying the presence, absence, occurrence, or characteristics of one or more target entities, signals, conditions, patterns, events, or states. For example, detection may involve recognizing, sensing, distinguishing, differentiating, diagnosing, characterizing, determining, or any other method of sensing. Detecting may involve a machine or device recognizing that a user is performing a particular movement or motion. It may involve identifying a flaw in a system or movement. Sensing refers to the process of detecting, perceiving, or becoming aware of stimuli. For example, sensing may involve detecting physical, environmental, or informational stimuli such as changes in the physical condition such as temperature, motion, or light. Additionally or alternatively, sensing may include detecting motion of a user performing an exercise such as a bodyweight movement, stretch, lift, push, pull, rotation, extension, or any other bodily movement including movements with and without exercise equipment. The sensing may occur upon detection of motion of a piece of exercise equipment such as free weights, exercise machines, exercise machine components, cables, or resistance bands. Additionally or alternatively, the sensing may occur as the result of bodily movement of a human performing an exercise. In another example, sensing may involve detecting the movement or motion (e.g., direction, force exerted, acceleration, deceleration, angle, and/or bending of a cable (e.g., a strong, flexible wire, braided wire, rope, or cord that connects an exercise machine's weight stack or resistance mechanism to handles, pulleys, or other moving parts. The cable may include metal wire, polymeric material, or any other tensile material and may be sheathed, coated, reinforced, or have any other protective mechanism to maintain durability. Cables may be part of exercise equipment such as a cable machine, functional trainer, cable crossover, pulley machine.

Cable movement may involve a series of pullies or spools around which the cable is wound and manipulated during performance of one or more candidate fitness movements. Cable movement may occur as the result of bodily movements associated with cable-based exercise systems. Sensing cable movement refers to detecting physical changes in a cable. Such changes may include, for example, changes in the position, tension, displacement, speed, or vibration in a cable. Cable movement may be detected or sensed using mechanical sensing, such as by servo motors, encoders, or pull wires. Additionally or alternatively, sensing cable movement may involve optical sensing, such as by image sensors (e.g., one or more cameras) fiber optic shape sensors embedded in the cable to measure real-time shape, position, strain, or curvature changes of the cable. Sensing cable movement may additionally or alternatively involve electrical sensing, such as by signal transmission and feedback mechanisms to monitor cable behavior or position.

Detection of the at least one particular candidate fitness movement occurring by sensing cable movement may involve identifying changes in the cable of an exercise machine a user is interacting with and recognizing the changes are caused by the interaction, such as because the user is engaged in a bodily movement associated with a cable-based exercise system.

By way of non-limiting example, FIG. 8C is a schematic illustration of a trainee performing a gamified set, consistent with disclosed embodiments. FIG. 8C shows cable 838 as part of exercise machine 842 that user 834 may interact with as they workout or may associate with a candidate fitness movement. Exercise machine 842 may be an electronic wall-mountable exercise machine, as described herein. User 834 may decide to increase the resistance or difficulty of one or more candidate fitness movements by utilizing exercise machine 842 and cables 838.

Some disclosed embodiments involve sensing occurring via an image sensor. An image sensor refers to a device, component, or system configured to detect, capture, and convert optical information into electronic signals. The electrical signals may represent visual data. An image sensor may involve sensing light, electromagnetic radiation, photons, light intensity, color, movement, object displacement, object alignment, object dimensions, edges, or any other visually perceived characteristic. An image sensor may be involved with detecting that a user has moved, how long they have been moving, or how far they moved. It may be involved with detecting that exercise machine or a component of an exercise machine, such as a cable, has moved, how long it has been moving, or how far it has moved. By way of non-limiting example, FIGS. 5 and 7 illustrate an image sensor 216 capturing the motion of a user 208 and exercise machine to determine that user 208 is performing a candidate fitness movement. Similarly, FIGS. 8B and 8C illustrate an image sensor 840 and 840. The image sensor may be part of a mobile device such as a camera of a smart phone and may capture a motion or sequence of motions of user 834 performing candidate fitness movements. The candidate fitness movements may involve the motion of cable 838 and the rotation of spool 836 of exercise equipment such as an electronic wall-mountable exercise machine. Sensing cable movement occurring via an image sensor may include recognizing that a user is in a different position than they started in, a cable or a cable accessory moves to a different position than a starting position, a movement of a weight stack or pulley to a different position, or any other visually perceived change associated with the candidate fitness movement.

Some disclosed embodiments include a sensor for determining rotation of a spool on which a cable is wound. This may occur using optical sensors that measure angular rotation of a shaft or spool, or electrical sensors capable of detecting angular rotation. A Spool refers to a structural component used to support, contain, dispense, or manage a length of flexible material (i.e., around which a cable may be wound and unwound). Features of rotation that can be detected include speed, direction, acceleration, deceleration, quantity (distance of cable movement), and intermittency of movement. These various features can be derived from angular signals associated with rotation of the spool on which the cable is wound, or rotation of an associated axle or device connected to the axle . . . . A spool may be used on a cable machine, functional trainer, cable crossover, pulley machine, weight resistance machine, or any other cable-based exercise system to contain the cable and control its direction through the machine during an exercise. Determining rotation of a spool may refer to identifying the rate or extent to which a spool is rotating due to a cable being dispensed from or wound about it as a user interacts with a cable-based exercise system. The rotation of the spool may be determined by ascertaining, identifying, or calculating an extent to which a spool has moved about its central axis.

Cable movement may be associated with a spool, meaning as the spool turns, cable is either let out or taken up. The movement of the cable may be associated with the spool in that functional, logical, structural, or referential connections may relate them. For example, a counterclockwise rotation of the spool by “X” amount, may correspond to a distance “Y” of pulled cable. Similar correlations may exist for the other features of cable movement discussed earlier. Sensing occurring via a sensor for determining rotation of a spool on which a cable associated with the cable movement is wound may refer to recognizing the movement of a cable of an exercise machine based on whether and how much a spool it is wound about is rotating (and/or how fast the spool rotates, the direction of rotation, and the acceleration and deceleration of the rotation. This data may be obtained from one or more of a rotary encoder, optical interrupt sensor, Hall Effect sensor, optical rotational sensor, string pot, and/or resolver sensor,

By way of non-limiting example, FIG. 8C shows a user 834 such as a trainee, performing an exercise movement with an exercise machine 842. The exercise machine 842 includes a spool 836 over which a cable 838 moves during the exercise movement. As the cable 838 moves, spool 842 rotates to dispense or retract cable 838. Cable 838 may be wound about a spool 836. A cable 838 may be wound and unwound from the spool 836 numerous times per exercise as a user 834 completes their candidate fitness movements. Thus, rotation of spool 842 occurs as the user 834 manipulates the cable 838 while performing one or more candidate fitness movements. A rotation of the spool 836 may be detected using one or more mechanisms within spool 842 or outside of spool 842. For example, the rotation of spool 842 may be sensed by an image sensor 840, or may be determined by some other visual, mechanical, electrical, electromechanical sensing mechanisms. Information associated with the determined rotation may be presented on a display 822 of a mobile communications device 820 for a user 834 to view.

Some disclosed embodiments involve detection of one or more particular candidate fitness movements occurring by sensing resistance. This refers to determining a fitness movement based on sensed resistance, as differing movements may exhibit differing resistance profiles. Resistance may be sensed using the various techniques described elsewhere herein. In the context of a resistance motor, the flow of electricity from and/or to the motor may be an indicator of resistance, and that indicator may itself correlate to a particular fitness movement. Resistance, as used in this context, may include one or more of the characteristics of exercise movement opposing a load, as described throughout this disclosure.

Detection of the at least one particular candidate fitness movement occurring by sensing resistance may include determining that a candidate fitness movement has been performed based on detecting a change in resistance experienced by an exercise machine or its components. In some embodiments, one or more processors may sense an amount of resistance applied to one or more parts of the exercise equipment, such as a force applied by the user to a cable accessory of the exercise machine. The one or more processors may interpret the sensed resistance in order to detect the at least one particular candidate fitness movement. For example, the one or more processors may determine that an amount of resistance has exceeded a threshold level associated with the at least one particular candidate fitness movement. As another example, the one or more processors may recognize one or more patterns in the sensed resistance and detect the at least one particular candidate fitness movement based on the recognized pattern of sensed resistance.

The correlation between sensed resistance (e.g., sensed resistance profiles) and particular candidate movements may be stored in a data structure such that upon detection of a particular profile, the associated candidate movement by be ascertained. This may occur with or without the aid of artificial intelligence. Alternatively, artificial intelligence may be used in the absence of such a dedicated data structure to ascertain the candidate movement from the sensed resistance. It is to be understood that in this context, sensed resistance may include a series of signals or associated measurements obtained over time (e.g., a profile), and may include one or more of the characteristics or features of cable movement previously described.

Some disclosed embodiments involve sensing resistance to forces exerted by a motor. A motor in the context of a resistance machine refers to a device that creates resistance that the user must overcome, simulating weight or tension. Such a motor is typically electronically controlled to generate variable resistance in response to user input or pre-programmed exercise parameters. The motor applies torque opposing the user's motion, thereby simulating adjustable levels of physical exertion. The resistance motor may be operatively coupled to a spool, pulley, or other mechanical interface, and may utilize feedback from sensors to dynamically modulate resistance in real time. In some examples, the motor may be a brushless DC motor or servo motor capable of precise torque control and low-noise operation. In other examples, a motor may include a brushed motor, hydraulic motor, pneumatic motor, electric motor, variable speed motor, or any other motor type.

It Sensing resistance to forces exerted by a motor may involve detecting or quantifying opposing forces or loads encountered by a motor during its operation or as a result of the motor operating.

Some disclosed embodiments involve enabling, at discretion of a user, a plurality of electronic games to be associated with a single fitness movement. Discretion of a user refers to the user's decision as to what should be done in a situation. Discretion of a user may involve one or more inputs from a user or identification of preferences in a situation. It may involve the user choosing to associate an electronic game with a fitness movement or a fitness movement with an electronic game. Enabling, at discretion of a user, a plurality of electronic games to be associated with a single fitness movement refers to providing the code, GUI, of software in general to enable a user to connect or link one or more electronic games to a single fitness movement such that performing the fitness movement causes interaction with one or more electronic games. In some embodiments, one or more processors may receive input via a touchscreen, button(s), or other input device(s), causing the one or more processors to perform operations for linking a plurality of electronic games with a single fitness movement. For example, a graphical user interface may display a series of movement representations (e.g., a representation of a lat pull or a bicep curl), and upon selection of the representation, the movement may be linked to a previously selected game, such that as the user performs the movement, a corresponding reaction or movement occurs in the game. Similarly, the graphical interface may allow the user to select a game after the movement is either selected or detected, and the linkage may occur as a result.

A single game may perform differently depending on the game/movement combination. For example, movement of an icon, avatar or other graphical element on a screen may occur at a different pace depending on the selected movement. If a lat pull is longer than a bicep curl (in terms of cable movement), a shorter pull in the bicep context may cause an icon or avatar on the screen to move a greater distance than would occur with the same distance of cable movement in a lat pull. The relationships may be prestored in memory. Alternatively, the cable movement to graphical element correlations may be determined on a case-by-case basis. For example, if the game involves a paddle, the system may learn that a particular user's cable distance pull on a lat bar is 0.95 meters, causing the full movement of the paddle across the screen to correspond to 0.95 meters (or whatever happens to be typical for the particular user.) This feature enables operation of games to change (be customized) to individual users.

By way of non-limiting example, FIG. 8B shows a graphical user interface that enables a user to select one or more electronic games 832 to be associated with a fitness movement 830. As shown in FIG. 8B, display 822 may present a graphical user interface which can receive inputs from a user associated with one or more fitness movements (830) and one or more games (832). As illustrated in FIG. 8B, a user may identify as player 1 in the graphical user interface via selection of button 824. Player 1 may select one of movement buttons 830 to identify a movement such as a “pull down.” Player 1 may also select one or more games buttons 832, to associate a plurality of games with an exercise movement. As shown, a “heaviest set” game is selected, and one or more other game buttons 830 may be selected for association with the movement selected via movement buttons 830.

Some disclosed embodiments involve enabling, at discretion of a user, a plurality of fitness movements to be associated with a single electronic game. For example, linkages may be made (as described earlier) between more than one fitness movement and a single game. In this way, if the user prefers a particular game, the game can remain the same as the user switches between movements. Even though the game remains the same, the customization option discussed earlier may cause gameplay within the same game to differ from exercise movement to exercise movement. (E.g., 0.95 meters of cable movement in the lat context corresponds to the same movement on the screen of 0.5 meters of movement in the bicep context.)

In some embodiments where the user desires to focus on a limited range of movement, an even smaller cable length movement may cause a more significant movement of the graphical element on the display. To achieve this, the user interface may enable the user to customize a desired range of motion prior to beginning gameplay.

As discussed previously, the linkages and other user inputs can occur when one or more processors perform operations to connect or link the selected fitness movements with the selected electronic game. The association may be made via storage of one or more electronic records, an entry in a database or memory structure, generation or modification of stored data or metadata associated with the fitness movements and/or the single electronic game, or by other techniques for connecting or linking items. In some embodiments, a graphical user interface such as a touchscreen may receive input indicative of a user's decision to connect or link one or more fitness movements to a single electronic game such that performing one or more fitness movements causes interaction with the single electronic game.

By way of non-limiting example, FIG. 8B shows a graphical user interface enabling a user to select one or more fitness movements 830 for association with an electronic game 832.

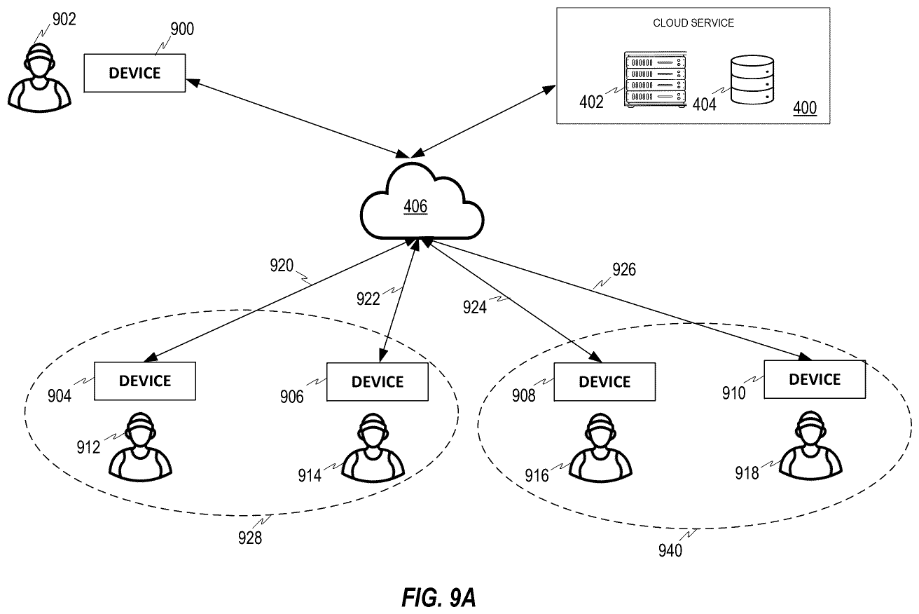

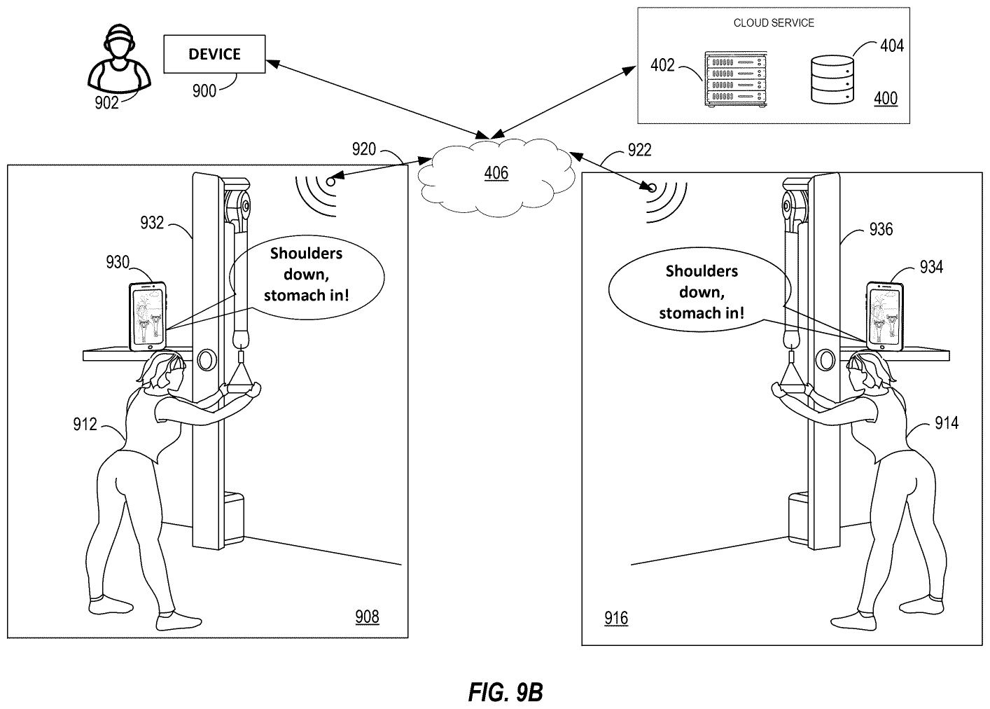

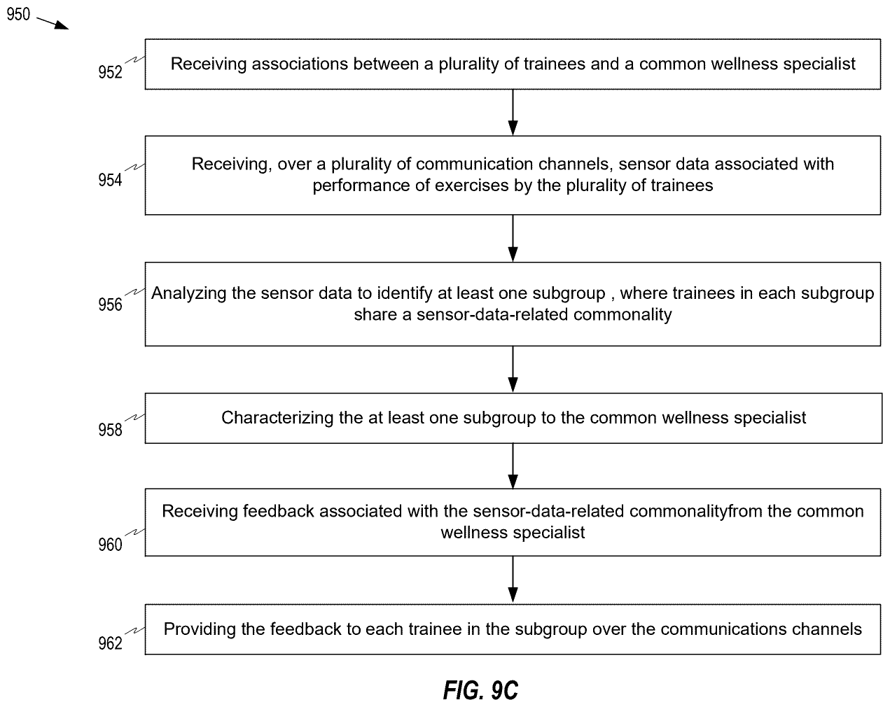

Some disclosed embodiments involve fitness movement selection being received from a trainer and the electronic game selection being received from a user. A trainer refers to an individual, system, or module configured to facilitate, guide, instruct, or optimize the performance and learning of a user. A trainer may include a teacher, professional, coach, computer program, or any other human or virtual assistant designed to assist a user. The trainer may have the ability to select movements, leaving the gameplay decision to the user. When the trainer is remote, one or more processors may receive a selection of a fitness movement from a trainer. This may occur over a network from a trainer interface (trainer client), while the game selection occurs over a network from a user interface (user client). In some embodiments where the trainer and the user are co-located, both selections may occur via a common interface (or via separate interfaces, such as the mobile devices of the trainer and the user, both influencing the workout over a network. In yet additional embodiments, the trainer may be one or more computer programs or algorithms executed locally at the exercise machine or by a remote computing system in communication via a network. By way of non-limiting example, FIG. 9B illustrates a trainer 902 that may be located remotely from exercise machine 932 and may provide selection of a fitness movement for users 912 and/or 914 to perform.

Some disclosed embodiments involve an electronic game being enabled for play by two users of a common exercise machine. This refers to an ability of two people to use the same exercise machine with the benefits of gameplay for each. By way of non-limiting example, FIG. 8C shows an exercise machine 842 where the exercise machine 842 is a cable-based exercise system in a wall-mountable exercise machine. In this context, gameplay may include two users separately going about their regimens while each playing their selected games, or the two users challenging each other, and/or competing to achieve greater points. Thus, playing may include challenging an opponent, games, taking turns, racing to an objective, or any other activity characterized by spontaneity, creativity, physical or cognitive stimulation, or mutual responsiveness. Playing may include competing in or engaging in similar exercise another person or with and/or against oneself. Play may involve one or more users interacting with one or more exercise machines for recreational engagement with one or more electronic games. To achieve this, a user interface may be configured for: selection of one or multiple players; selection of usage modes with multiple players (e.g., competition or individual workouts taking turns), and/or game selection for multiplayer competition. In multiplayer mode as with the single player mode described earlier, motion on a screen may be customized to the player, such that a taller player's graphical element may require greater cable movement than that of a shorter player's cable movement in order to achieve the same distance of graphical movement of a graphical element on a display.

By way of non-limiting example, FIG. 8B shows a graphical user interface where the user can select their desired number of players 824 and that those players are using a common exercise machine 826. Additionally, with respect to FIG. 8C, a second user may participate in a game enabled for play by two users and perform the exercise movements of a selected game using the same exercise machine 842 as the user. The two users may participate in a single session of an electronic game performed using the common exercise machine, during which one or more processors may mediate the game play.

Some disclosed embodiments involve an electronic game enabled for play by two users of different exercise machines. Different exercise machines refers to separate machines, such that gameplay occurs when each user interacts during a session with differing machines. Different exercise machines may include separate exercise machines of the same type, separate exercise machines of different types, or any other exercise machines that differ in any material way. An electronic game enabled for play by two users of different exercise machines may involve two users working out using separate machines, but playing the same electronic game with or against one another. This may occur when the users are both in contact with a common server that mediates gameplay. The server may receive game selections from one or both users, share performance information between users, and/or share game scores between users. The server may enable timed games, where each user remote from each other is presented with a common time clock, and need to complete a common set of movements in a time displayed to both. Alternatively, with timed games, the server may enable competing remote users to compete in a timed competition during offset or non-overlapping periods, with each user being given the same amount of time to complete the prescribed movements.

By way of non-limiting example, FIG. 8B shows a graphical user interface where the user can select their desired number of players 824. The graphical user interface may also provide one or more user selectable indications of whether the users (players) are using a common machine (826) or different exercise machines (828).

Some disclosed embodiments involve different exercise machines being different in location and structure. Location refers to a position, site, or area. Location may include a position on a floor plan, a floor in a building, an orientation of an object, a place inside of a building, a geographical spot on a map, a street, a city, a town, an address, or any other describable place where a person, place, or thing can reside. Location may include the address for a gymnasium or recreational facility. Structure refers to a constructed physical entity. A structure may include a building or another construction of framing in a spatial configuration of walls and open space. In some embodiments, a structure may include a gymnasium, recreational facility, building, house, apartment, office, room, shed, tent, or dwelling. Different exercise machines being different in location and structure may refer to two or more exercise machines at different sites or geographical positions or may refer to two or more exercise machines being at different buildings such as different gyms, different branches of the same gym, different homes or offices, or any other combination of exercise machines being in a different structure or location.

Some disclosed embodiments involve the plurality of electronic games including a gamification of the at least one particular candidate fitness movement. Gamification refers to the application of game design elements and principles to non-game contexts. Gamification may include game design elements such as points, badges, leaderboards, levels, and rewards. Gamification may involve motivating, engaging, and influencing behavior. It may include transforming routine or complex tasks into more interactive and enjoyable experiences by tapping into users' competitive, achievement-driven, and progress driven mindsets. Gamification may also be similar to gamifying or gamified exercise/workout, as described and exemplified elsewhere. Electronic games including a gamification of the at least one particular candidate fitness movement may involve a predetermined or preset gamification of one or more candidate fitness movements. For example, a candidate fitness movement may have one or more game elements associated with certain aspects of the movement, such as a predetermined amount of points associated with a repetition, or points or rewards associated with proper posture and form for the candidate fitness movement. In some embodiments, an amount of rewards or points may be associated with the user maintaining a certain pace of movement, such as completing a repetition within a particular time frame so as not to promote rushing through the repetitions or moving too slowly. The particular time frame may have at least one of an upper time threshold or a lower time threshold associated with the rewards. In some embodiments, one or more processors may be configured to retrieve information associated with a graphical depiction of the candidate fitness movement that displays a game-like interface, such as by displaying avatars competing in an event, or displaying shapes moving across a screen that correspond to the user's performance of the candidate fitness movement. The display of graphical elements may be generated or altered based on one or more of analyzed image data of the user performing the candidate fitness movement, sensors associated with a movement or parameter of the user, or sensors associated with a movement of the electronic exercise machine, as disclosed and exemplified herein. By way of non-limiting example, FIG. 8B shows a graphical user interface where the user can gamify one more candidate fitness movements by selecting one or more movement selections 830 and one or more electronic game selections 832 to associate a candidate fitness movement with an electronic game or associate an electronic game with a candidate fitness movement. By way of further non-limiting example, FIG. 6 shows an illustration of a graphical user interface depicting a gamification of a lateral raise movement. As shown, a graphic elements 604 may be generated and displayed as a guide for the user to set their movement cadence and speed of the lateral raise movement. A paddle 602 may move on the screen depending on the user's movement speed and/or position of a cable accessory, to move the paddle across the screen to collide with the moving graphic elements 604. In this way, a candidate fitness movement such as a lateral raise may be gamified and into an electronic game.

Some disclosed embodiments involve the plurality of electronic games being unassociated with the at least one particular candidate fitness movement. A game being unassociated refers to an act or process of removing, dissolving, or terminating a previously established relationship, linkage, or connection between two or more entities, components, or elements. Disassociating may involve one or more processors undoing a previously-established relationship, connection, or pairing so that two or more entities are no longer connected or linked. For example, if a user no longer prefers to play a certain game that is a preset or user-selected default, the user may disassociate the two so that the movement and the game are no longer linked. This can occur in various contexts. In one context, the user may have a routine that involves a series of movements associated with a common game. If the user has an injury making a movement undesirable or if the trainer removes a certain movement from a regimen, the game can remain playable with the particular movement removed from gameplay (disassociated).

Thus, the plurality of electronic games being disassociated with the at least one particular candidate fitness movement may involve modifying, deleting, or otherwise undoing a connection or link between the plurality of electronic games from one or more candidate fitness movements that were previously linked. For example one or more processors may modify or delete an electronic record or data that associated information for a candidate fitness movement with information for an electronic game. Operations associated with un-associating may be initiated via a user input, such as an input to a graphical user interface. In some embodiments, instructions for disassociating may be received via a network connection from a remote computing system, such as from a cloud server or from a device associated with a trainer. In some embodiments, un-associating may involve one or more processors modifying or deleting a connection between electronic games and one or more candidate fitness movements based on one or more rulesets, such as the expiration of a timer or a rule that causes the games and candidate fitness movement(s) to become disassociated. By way of non-limiting example, FIG. 8B shows a graphical user interface configured to receive one or more inputs associated with deselecting one or more movement selections 830 and/or one or more electronic game selections 832 to disassociate one or more candidate fitness movements and electronic games.

Some disclosed embodiments involve particular electronic games including a gamified drop set routine. A drop set routine refers to a training technique with multiple steps of reducing load or resistances. A drop set may involve a user performing a sequence of repetitions of a particular movement at a given load or resistance level until reaching muscular fatigue. Once the electronic exercise machine recognizes that the user has fatigued and cannot perform additional repetitions within a certain cadence or with proper form, the electronic exercise machine may automatically reduce the load or resistance to a first lower level so that the user may continue performing additional repetitions without rest. This may occur when signals are received indicating that the user is fatigued (e.g., cable motion stops or slows below a threshold). Upon determining that the user has reached fatigue at the first lower level, the electronic exercise machine may automatically drop the weight or resistance to a second lower level. This may occur by sending a signal to a resistance motor to reduce a load. One or more processors associated with the electronic exercise machine may continue this process iteratively. By way of nonlimiting example, FIG. 7 shows a user 208 performing a drop set routine by performing five sets of fitness movements on a cable machine where the resistance, load, or intensity starts low, reaches a high point in the third set, and ends low. In such an example, display 218 presents indicators 706 to relay the user's progress in the drop set routine or workout as they complete fitness movements. By way of non-limiting example, FIG. 8B shows a graphical user interface where the user can gamify a candidate fitness movement by associating a movement selection 830 and a drop set electronic game selection 832.

Some disclosed embodiments involve particular electronic games including a feature for pacing the at least one particular candidate fitness movement. Pacing refers to regulation, control, or modulation of the rate, rhythm, or timing of an activity, process, or movement. Pacing may be temporal, rhythmic, adaptive, instructional, systematic, gamified, or any other technique to control the rate of activity. Pacing the at least one particular candidate fitness movement may include regulating the rate of completion of a particular candidate fitness movement to force a level of exertion, extending the length of a workout, shortening the length of a workout, controlling the intensity or focus of specific portions of a candidate fitness movement, or any other reason for regulating an activity.

By way of non-limiting example, FIG. 6 is a front view of mobile communications device 214 presenting an exemplary user interface 600 for a second gamified exercise routine, consistent with some disclosed embodiments. FIG. 6 shows an electronic game associated with one or more candidate fitness movements involving graphic paddles 602 and graphic elements 604 which may be automated moving elements moving downwards across display 218. At least one processor (e.g., processor 102 associated with any of mobile communications device 214, electronic exercise machine 200, and/or cloud service 400) may receive signals (e.g., optical and/or mechanical signals) indicative of motion of cable 204 of electronic exercise machine 200 as user 208 pulls and/or releases exercise interface 206. The at least one processor may use the signals to visually track the pulling and/or releasing motion by displaying a graphic paddle 602 moving across display 218 of mobile communications device 214. The movement speed of graphic elements 602 may influence the speed at which the user 208 completes the candidate fitness movement such that the speed the user 208 completes the candidate fitness movement is equivalent to the speed at which graphic paddle 602 moves across the display, and the user 208 controls the pace of the candidate fitness movement so that each graphic element 604 collides with graphic paddle 602. The at least one processor may motivate user 208 to pace the pulling and/or releasing motion on exercise interface 206 to cause paddle 602 to collide with one or more graphic elements 604 for accruing points. Particular electronic games including a feature for pacing the at least one particular candidate fitness movement may include using gamification to control the rate at which a user completes a fitness movement, workout, repetition, set, challenge, objective, goal, or game. By way of non-limiting example, FIG. 8B shows a graphical user interface where the user can gamify a candidate fitness movement by associating a movement selection 830 and a pacing electronic game selection 832.

Some disclosed embodiments involve the particular electronic game altering the at least one particular candidate fitness movement according to a pattern. Altering refers to any modification, adjustment, or change made to a component, parameter, structure, or process. Altering may include substitutions, deletions, additions, modifications or any other material change applied to a component, parameter, structure, or process. Altering may involve changing what movement a user performs or is required to perform. It may include changing fitness movements from a movement involving the upper body of the user to a movement involving the lower body of the user. A pattern refers to a discernible and repeatable arrangement, configuration, or sequence of elements, features, or operations that may be spatial, temporal, logical, or functional. Patterns may involve path, shape, movement, length, speed, direction, distance, intensity, or any other repeatable or discernable sequence type. Patterns may include similarities or differences if the number of repetitions or styles of an exercise. Altering the at least one particular candidate fitness movement according to a pattern may refer to guiding the user to perform a candidate fitness movement in a specific manner in one set according to the objectives of the electronic game and then having the user to perform the candidate fitness movement in a different manner in one set according to the objectives of the electronic game.

Some disclosed embodiments involve automated group identification and aggregation of guidance. Automated group identification refers to dynamic detection and/or selection of individuals (or their electronic devices) based on one or more shared characteristics. In one example, it may involve detection of associations between individuals, and/or classifications of sets and/or clusters. Associations between individuals may include relationships, affinities, and/or connections that exist among people, and may be based on shared characteristics, experiences, goals, and/or interests. Associations may include common pursuits such as improving fitness, losing weight, and/or training for a competition; shared affiliations such as membership in the same club, gym, and/or organization, and/or following the same wellness specialist; demographic similarities such as similarities in age, location, socio-economic status, preferences, and/or other personal information; behavioral similarities such as engagement in similar exercise routines, participation in similar events, and/or use of similar types of equipment; similar technological links such as subscriptions to the same multimedia channels or social media accounts, and/or use of connected devices within a shared platform. A classified set and/or cluster refers to a collection of distinct elements (e.g., data records) sharing one or more attributes and/or metrics. A set or cluster may include a subset within a larger group, each member in the set sharing a trait, and members excluded from the set lacking the trait. Automated group identification may be performed by at least one processor absent labeling and/or categorization by a human. For example, at least one processor may analyze data associated with a plurality of users and identify one or more characteristics shared by a portion of the users. One or more users that share one or more characteristics may then be associated with a group or subgroup. The shared characteristics may be associated with personal information, such as age, gender, location, preferences, personal hobbies, vital signs (e.g., a heart rate, blood pressure, respiratory rate, and/or body temperature), clinical parameters (e.g., asthma, allergies), physiological markers, health metrics, biological indicators, and/or any other characteristic associated with wellness. Additionally or alternatively, the shared characteristics may be based on a type of exercise machine used, existence of a user account, membership in a health club, subscription to a multimedia channel and/or social media account, and/or any other attribute for grouping individuals. Guidance refers to directional assistance to accomplish something, and may include advice, counsel, support, mentoring, suggestions, tips, and/or directions. In some embodiments, guidance may include providing a soundtrack, links to additional content, and/or any other type of assistance for achieving a wellness goal. Aggregation of guidance refers to clustering, batching, and/or combining guidance for a plurality of users. For example, two individuals categorized in a common group or subgroup based on one or more shared characteristics may both benefit from the same guidance. Guidance suitable to both the individuals may be aggregated and provided to both individuals such that each individual receives substantially the same guidance. The aggregation may permit an individual expert to provide substantially similar guidance to multiple users, instead of generating guidance for each individual user. Automated group identification may ensure that the guidance is relevant to each member in the group of users receiving the guidance. Aggregation of guidance for automatically identified groups may enhance guidance quality by tailoring guidance to address specific needs and/or preferences of members included in a group, improve engagement and/or motivation to exercise and keep up with other members of the group, streamline workflows for wellness experts, and/or improve data utilization.

By way of a non-limiting example, reference is made to FIG. 9A, which is a schematic illustration of a plurality of trainees for automated group identification and wellness guidance, consistent with some disclosed embodiments. Cloud service 400 including at least one server 402 and data repository 404 may communicate over network 406 with at least one device 900 associated with a common wellness specialist 902, and a plurality of devices 904, 906, 908, and 910 associated with a plurality of trainees 912, 914, 916, and 918 via plurality of communication channels 920, 922, 924, and 926, respectively. In some embodiments, each of devices 900, 904, 906, 908, and 910 may include a mobile communications device and/or an electronic exercise machine (e.g., corresponding to mobile communications device 216 and/or electronic exercise machine 200 in FIG. 2). Plurality of devices 904, 906, 908, and 910 and associated plurality of trainees 912, 914, 916, and 918 may be distributed in differing locations and may communicate with cloud service 400 and/or at least one device 900 via communication channels 920, 922, 924, and 926, respectively. At least one processor (e.g., processor 102 in FIG. 1) associated with at least one device 900 and/or cloud service 400 may receive data associated with trainees 912, 914, 916, and 918 from devices 904, 906, 908, and 910 via plurality of communication channels 920, 922, 924, and 926, respectively, and analyze the data to determine shared traits between trainees 912, 914, 916, and 918. The at least one processor may use the shared traits to automatically identify one or more groups, such as a subgroup 928 including trainees 912 and 914, and a subgroup 940 including trainees 916 and 918. For example, exercises performed by trainees 916 and 918 may be of a different type and/or differing exertion level than exercises performed by trainees 912 and 914.

By way of another non-limiting example, reference is made to FIG. 9B, which is a schematic illustration of plurality of trainees 912 and 914 exercising via automated group identification and guidance, consistent with some disclosed embodiments. At least one device 904 of FIG. 9A associated with trainee 912 may include a mobile communications device 930 and an electronic exercise machine 932, and at least one device 906 associated with trainee 914 may include a mobile communications device 934 and an electronic exercise machine 936. Mobile communications devices 930 and 934 may correspond to (e.g., may be structurally and functionally similar to) mobile communications device 216 of FIG. 2, and electronic exercise machines 932 and 936 may correspond to electronic exercise machine 200. Mobile communications device 930 may be paired to electronic exercise machine 932 and may communicate with device 900 and/or cloud service 400 via communications channel 920. Similarly, mobile communications device 934 may be paired to electronic exercise machine 936 and may communicate with device 900 and/or cloud service 400 via communications channel 922. At least one processor (e.g., processor 102 in FIG. 1 associated with device 900 and/or cloud service 400) may receive, over plurality of communication channels 920 and 922, sensor data associated with performance of exercises by the plurality of trainees using electronic exercise machines 932 and 936. For example, the sensor data may include audio and/or video data captured by mobile communications devices 930 and/or 934 as trainees 912 and 914 exercise, and/or cable and/or motor data captured by one or more sensors included in electronic exercise machines 932 and/or 936. At least one processor may analyze the sensor data to identify at least one subgroup 928 based on similarities between electronic exercise machines 932 and 936 (e.g., at least one sensor-data-related commonality), and may characterize subgroup 928 based on the similarities to common wellness specialist 902. For instance, electronic exercise machines 932 and 936 may be associated the same manufacturer associated with cloud service 400 and may receive similar software updates, and/or provide similar features.

Some disclosed embodiments involve receiving associations between a plurality of trainees and a common wellness specialist. A trainee refers to an individual undertaking a regimen aimed at improving health, wellbeing, or fitness. A trainee may follow a routine that may include cardiovascular workouts, strength training, flexibility exercises, mind-body practices (e.g., yoga, meditation, and/or mindfulness), and/or any other routine for improving physical and/or mental health. A trainee may train under the guidance of a coach and/or trainer to enhance physical capabilities, such as to improve performance, focus, and/or concentration, build muscle mass, lose weight, prepare for a competition, and/or achieve any other wellness goal. A wellness specialist refers to an individual who advises, coaches, and/or trains individuals and/or groups to promote physical, mental, and/or emotional well-being. A wellness specialist may design and/or implement programs for improving the overall wellbeing of trainees, and/or monitor progress thereof. Such programs may include physical exercise routines, mind-body practices, health education, coaching, nutrition and/or hydration advice, and/or holistic care tailored to a specific population. A wellness specialist may use assessments of health and/or lifestyle characteristics of a trainee such as biometric screening, fitness evaluations, and/or stress assessments, to create a personalized wellness plan. Such a personalized wellness plan may include one or more fitness routines, nutrition guidance, mindfulness practices, and/or stress management techniques. Additionally or alternatively, a wellness specialist may lead workshops and give seminars to promote physical and/or mental wellbeing. A common wellness specialist refers to a wellness specialist shared by a plurality of trainees. Associations between a plurality of trainees and a common wellness specialist refers to relationships, affinities, and/or affiliations between multiple trainees and a common wellness specialist. Such associations may be based on preferences of the trainees and/or common wellness specialist, a history of participation in wellness training and/or expertise, a history of similar and/or shared online activity, membership in one or more organizations, geographical proximity, similarities based on socio-economic and/or demographic data, and/or any other type of common aspect. Receiving associations between a plurality of trainees and a common wellness specialist refers to receiving (as described elsewhere herein) associations between at least two trainees and the same wellness specialist. For example, the trainees may have a history of performing exercises, pursuing goals and/or hobbies, and/or participating in events that are an expertise of the common wellness specialist. Additionally or alternatively, the trainees may have similar preferences, subscribe to one or more channels and/or follow one or more social media accounts associated with the common wellness specialist and/or additional wellness specialists. Additionally or alternatively, the trainees may fall into the same socio-economic, location, and/or demographic category as the common wellness specialist, and/or may be members of the same club, and/or share any other association with the common wellness specialist.

By way of a non-limiting example, in FIG. 9A, at least one processor (e.g., processor 102 in FIG. 1) associated with at least one device 900 and/or cloud service 400 may receive associations between plurality of trainees 912 to 918 and common wellness specialist 902. For example, the associations may include data indicating that trainees 912, 914, 916 and 918 subscribe to a video channel produced by a specialist having the same expertise as the common wellness specialist 902.

Some disclosed embodiments involve receiving, over a plurality of communication channels, sensor data associated with performance of exercises by the plurality of trainees. A communication channel refers to a virtual and/or physical link for conveying information between two or more computing devices. A communication channel may include wired and/or wireless links. Wired links may include one or more of an electronic cable and/or bus, an optical fiber. Wireless links may include a channel for wirelessly conveying electromagnetic signals (e.g., short, medium, and/or long wave radio, microwave, infrared, and/or optical signals), a protocol (e.g., Wi-Fi, Bluetooth, Zigbee, Transmission Control Protocol or TCP, Internet Protocol or IP, HyperText Transfer Protocol Secure, or HTTP Secure, NFC or Near Field Communication, Secure Sockets Layer/Transport Layer Security or SSL/TLS, Secure IP or IPSec, Secure Shell or SSH), and/or any other technology for conveying information over distance. Sensor data refers to information associated with one or more sensors (described elsewhere herein). Sensor data may include information detected by one or more sensors, and/or associated metadata (e.g., a timestamp, location data, an associated device and/or user identifier, and/or any other type of information). Performance of exercises by a plurality of trainees refers to physical training activities undertaken by multiple trainees. For example, a plurality of sensors may collect data while a plurality of trainees perform exercise routines and convert the sensed data to a form suitable for transmission over a communication channel. The data may include image data captured by one or more cameras, audio data captured by one or more microphones, motion data associated with one or more exercise machine cables, electric (e.g., power, voltage, and/or current) data associated with an exercise machine motor, biometric data captured by one or more wearable sensors, and/or any other type of data chronicling and/or recounting performance of exercises by the plurality of trainees. The trainees may be located in differing locations from each other. The sensors may transmit the sensed data over differing communication links to at least one processor.

In some disclosed embodiments, the sensor data includes a plurality of performance-related resistance measurements. Resistance, in the context of exercise, refers to a force requiring muscular contractions to overcome it. Resistance may be generated by an external load, such as dumbbells, barbells, and/or a resistance motor, and/or through a trainee's own body weight, gravity, elastic and/or springy materials. Resistance may challenge the muscles, prompting adaptations such as increased strength, endurance, and/or flexibility. Performance-related resistance measurements refers to data derived from indications, readings, and/or recordings associated with resistance. For example, performance-related resistance measurements may be obtained by one or more sensors linked to a resistance motor of an electronic exercise machine. Performance-related resistance measurements may include an average resistance level for performing exercises, a maximum and/or minimum resistance level, a preferred and/or recommended resistance level, a targeted resistance level, and/or any other resistance level measurement. Sensors may detect resistance levels associated with performance of exercise routines and provide the resistance levels to at least one processor for analysis. Such sensors may include image data capturing a resistance level on a weight machine and/or free weight, biometric sensors detecting muscular strain, sensors associated with a motor and/or cable of an electronic exercise machine, and/or any other type of sensor for detecting resistance.

By way of a non-limiting example, in FIG. 9A, at least one processor (e.g., processor 102 in FIG. 1 associated with device 900 and/or cloud service 400) may receive, over plurality of communication channels 920-926, sensor data associated with performance of exercises by plurality of trainees 912-918, respectively. For example, at least some of the sensor data may include one or more multimedia streams of one or more of trainees 912-918 performing exercises, and which may be captured by optical sensor 316 (in FIG. 3) and/or audio sensor 312 (in FIG. 3) included in one or more of devices 904-910. Additionally or alternatively, at least some of the sensor data may indicate motion of a cable and/or motor (e.g., cable 204 and/or motor 202 in FIG. 2) of one or more electronic exercise machines included in one or more of devices 904-910 as one or more of trainees 912-918 perform exercise routines on one of the respective electronic exercise machines.

In some embodiments, the sensor data may include a plurality of performance-related resistance measurements associated with motor 202 of electronic exercise machines 932 and/or 936, e.g., the determination that trainees 912 and 914 lift weights between 40 and 60 kg may be based on sensors detecting resistance levels consistent with weights of between 40 and 60 kg for electronic exercise machines 932 and/or 936.

Some disclosed embodiments involve analyzing the sensor data to identify at least one subgroup within the plurality of trainees. Analyzing sensor data may include examining, investigating, organizing, and/or interpreting sensor data to extract insights, identify patterns, and/or support decision-making. Analyzing may additionally or alternatively involve determining and/or applying mathematical or statistical algorithms and/or correlations between data sets, identifying patterns and/or features (e.g., using artificial intelligence). A subgroup refers to a smaller, and/or distinct portion of a larger group. In some embodiments, members of a subgroup may share one or more traits and/or characteristics that may differentiate the members from individuals excluded from the subgroup. To identify refers to discern, learn, determine, and/or recognize. At least one processor may analyze, examine and/or interpret the sensor data associated with a plurality of trainees, discern traits common only to a portion of the trainees, and identify a subgroup that includes that portion of the trainees based on the discerned common traits. For instance, at least one processor may identify a subgroup based on a common fitness capability, a goal, a preference, and/or any other trait of some of the plurality of trainees.

In some disclosed embodiments, individual trainees within the at least one subgroup share at least one sensor-data-related commonality. Individual trainees within a subgroup refers to distinct trainees included the subgroup. A sensor-data-related commonality refers to a similarity of or common type of information associated with sensor data. For example, two trainees performing substantially similar exercise routines detectable by one or more sensors may generate similar types of data. Some examples of sensor-data-related commonalities may include an exercise type, duration and/or intensity, time of day during which an exercise routine is performed, a type of exercise equipment used, and/or characteristic of the trainees (e.g., age, gender, weight, height, experience, fitness level, and/or goal), location data (e.g., public versus home gym), a preferred language, aa dialect, and/or cultural norm, user preferences (e.g., an exercise schedule, an accompanying soundtrack), and/or any other information characterizing exercises performed by trainees and detectable by one or more sensors. In some embodiments, a sensor data commonality may be based on image analysis of one or more images. Thus, a sensor based commonality may include a gender, relative height and/or weight of a plurality of trainees. Trainees sharing at least one sensor-data-related commonality may include individual trainees associated with similar or common type of information derived from sensor data. For example, at least one processor may receive, over a plurality of separate channels, multiple video streams of a plurality of trainees performing exercises. The at least one processor may analyze the video streams to determine similarities between exercises performed by a subset of the trainees, and designate the similarities as sensor-data-related commonalities shared by the subset of trainees.

In some disclosed embodiments, the at least one sensor-data-related commonality is associated with a sensor data threshold. A sensor data threshold refers to a boundary, limit, floor, and/or ceiling associated with sensor data. Differing subgroups of trainees may be organized according to capabilities, with each subgroup associated with a corresponding performance range delimited by one or more sensor data thresholds. Upon receiving sensor data from a specific trainee, at least one processor may compare the sensor data to one or more thresholds to determine a subgroup for assigning the specific trainee. For example, at least one processor may define sensor data thresholds for a plurality of weightlifting subgroups as 0-25 kg, 25-50 kg, 50-75 kg, and 75-100 kg. Upon receiving sensor data indicative of a resistance level of a motor from a plurality of trainees, the at least one processor may assign each trainee to one of the weightlifting subgroups after comparing the sensor data to the thresholds. Thus, a first trainee lifting 40 kg weights may be assigned to the 25-50 kg subgroup, and a second trainee lifting 80 kg weights may be assigned to the 75-100 kg subgroup.

By way of a non-limiting example, in FIG. 9A, at least one processor (e.g., processor 102 in FIG. 1 associated with device 900 and/or cloud service 400) may analyze the sensor data to identify at least one subgroup 928 within the plurality of trainees 912-918. For example, at least one processor may determine that the sensor data received from trainees 912 and 914 indicate performance of substantially similar exercises that are an expertise of common wellness specialist 902, and at similar levels of exertion and for similar durations. On the other hand, the sensor data received from trainees 916 and 918 may indicate performance of different exercises at a different level of exertion and duration. Individual trainees 912 and 914 included in at least one subgroup 928 may share at least one sensor-data-related commonality, such as concurrent use of similar exercise machines to perform similar exercise routines at similar exertion levels and similar durations. Subgroup 928 may have different sensor-data-related commonalities than subgroup 940.

By way of a non-limiting example, in FIGS. 9A-9B, at least one sensor-data-related commonality is associated with a sensor data threshold. For example, based on historical sensor data associated with electronic exercise machines 932 and 936, trainee 912 and trainee 914 may lift weights ranging between 40 and 60 kg. At least one processor may include trainee 912 and trainee 914 in a subgroup for weightlifting between 40 and 60 kg.

Some disclosed embodiments involve characterizing the at least one subgroup to the common wellness specialist. Characterizing a subgroup to a common wellness specialist refers to describing, portraying, and/or classifying commonalities or shared attributes of the members of the subgroup to the common wellness specialist. For instance, at least one processor may use the sensor data to provide a summary and/or assessment of attributes shared by individuals in the subgroup to the common wellness specialist, permitting the common wellness specialist to determine exercise guidance relevant for the trainees in the subgroup, as opposed to separately determining guidance for each individual trainee. By way of example, based on the received sensor data, at least one processor may characterize a first subgroup as women under 30 focused on improving strength (e.g., first sensor-data-related commonalities), and characterize a second subgroup as middle aged adults focused on improving endurance (e.g., second sensor-data-related commonalities).

By way of a non-limiting example, in FIG. 9A, at least one processor (e.g., processor 102 in FIG. 1 associated with device 900 and/or cloud service 400) may characterize subgroup 928 to common wellness specialist 902. For example, the characterization may indicate that trainees 912 and 914 in subgroup 928 subscribe to the exercise channel produced by common wellness specialist 902, and that trainees 912 and 914 engage in substantially similar strength training exercises at substantially the same exertion levels and durations using substantially similar exercise machines.

In some disclosed embodiments, characterizing the at least one subgroup to the common wellness specialist includes receiving input from the common wellness specialist. Receiving input refers to detecting, obtaining, and/or accessing one or more signals caused to be generated by the common wellness specialist. This may occur, for example, via a user interface, such as a touch screen, an optical sensor, a microphone, a virtual and/or physical keyboard, and/or any other type of user interface for receiving information. The input from the common wellness specialist may include, for example, information indicating preferences and/or an expertise of the wellness specialist, characteristics of the wellness specialist (e.g., age, gender, language), historical information, selected identities of one or more trainees, and/or any other type of input that may be used to characterize the at least one subgroup. For example, the common wellness specialist may indicate that she specialized in yoga for senior citizens. At least one processor may use this input to identify a subgroup of trainees who are senior citizens and have indicated an interest in yoga.

In some disclosed embodiments, characterizing the at least one subgroup is based on at least one of statistics of additional subgroups, or historical data. Statistics refers to measures that summarize information about sets of data and may indicate how similar and/or how different individuals data items are within a data set. Some examples of statistical measures may include a mean, median, standard deviation, and/or skew. Additionally or alternatively, statistics may include methods for collecting, organizing, analyzing, and/or interpreting data. Statistics of additional subgroups refers to statistical measures associated with one or more subgroups other than the subgroup characterized for the common wellness specialist. For example, the additional subgroups may include prior subgroups characterized for the common wellness specialist or a different specialist. The statistics may be associated with ages and/or fitness levels of trainees, a record of performed exercises, a record of successes and/or failures following different training guidance regimens, and/or any other information relevant to characterizing subgroups for a common wellness specialist. Historical data refers to data collected in the past and/or over time. Historical data may include records of exercises performed previously by various trainees, and may include sensor data, data inputted by one or more trainees and/or wellness specialists (e.g., user preferences), metadata (e.g., timestamps, location data, device and/or user identifying information), and/or any other type of data collected over time, and/or feedback associated with prior subgroups. In some embodiments, at least one processor may identify one or more subgroups at least partially on feedback received in association with additional subgroups, e.g., the feedback may include a level of satisfaction indicating if the additional subgroups were based on relevant criterion, and/or if trainees included in any of the additional subgroups were sufficiently similar to benefit from common feedback provided to each member included therein.

By way of a non-limiting example, in FIGS. 9A-9B, to characterize at least one subgroup 928 to common wellness specialist 902, at least one processor (e.g., processor 102 in FIG. 1 associated with device 900 and/or cloud service 400) may receive input from common wellness specialist 902. For example, the input may include a request by the common wellness specialist 902 to include trainees exercising using electronic exercise machines and/or subscribing to a particular exercise channel in a particular subgroup. In response to the request, at least one processor may include trainees 912 and 914 using similar electronic exercise machines 932 and 936 in subgroup 928. In some embodiments, at least one processor may base at least one subgroup 928 on at least one of statistics of an additional subgroup (e.g., subgroup 940), or historical data, e.g., stored in cloud service 400. For example, historical data may indicate that trainees 912 and 914 were previously included in a subgroup for a medium to advanced fitness level, prompting their inclusion in subgroup 928.

Some disclosed embodiments involve receiving from the common wellness specialist, feedback associated with the at least one sensor-data-related commonality. Feedback associated with the sensor-data-related commonality refers to information in response and/or in reaction to the sensor-data-related commonality. The feedback may include, for example, a greeting and/or introduction, a demo, an evaluation, an assessment, a directive, guidelines, instructions, an encouraging and/or motivating message, and/or any other information in response to the sensor-data-related commonality. In some embodiments, the feedback may be based on information previously received from the trainees in the subgroup, and/or other trainees. The feedback may include text, graphics, audio and/or video data. In some embodiments, the feedback may identify the trainees in the subgroup, and/or include information associated with the sensor-data-related commonality shared by the trainees in the subgroup. For example, in response to receiving a characterization of a subgroup of women training to improve overall strength (e.g., based on data acquired from one or more images sensors and resistance level sensors), the common wellness specialist may provide weight exercise instructions suitable for women training to improve overall strength. The feedback may include encouraging tips and/or inspirational coaching language geared to women, strength training instructions for improving overall strength, cautions and/or warnings for avoiding injury, and/or reminders to hydrate, rest, and/or stretch. Similarly, in response to receiving a characterization of a subgroup of men training to strengthen the legs to participate in endurance competitions, the common wellness specialist may list a schedule of upcoming endurance races, and provide a training routine for improving leg strength geared to men. Feedback provided by the common wellness specialist to each subgroup may be enhanced and/or improved by the characterizations derived from the sensor data.

By way of a non-limiting example, in FIGS. 9A-9B, at least one processor (e.g., processor 102 in FIG. 1 associated with device 900 and/or cloud service 400) may receive from common wellness specialist 902, feedback associated with the at least one sensor-data-related commonality. For example, the sensor-data-related commonality may include exercise type, exertion level, and/or intensity, and the feedback may include a video demonstrating strength training exercises corresponding to the exercise type, exertion level, and/or intensity indicated by the sensor-data-related commonality shared by trainees 912 and 914.

Some disclosed embodiments involve providing over the plurality of communications channels the feedback to each trainee in the at least one subgroup. Providing over a plurality of communication channels refers to transmitting and/or communicating data over the plurality of communication channels. In some embodiments, at least one processor may format the feedback differently for at least some of the communication channels (e.g., depending on the receiving device type and/or operating system used, and/or available bandwidth). At least one processor may transmit the formatted feedback to each trainee in the subgroup. Thus, each trainee in a subgroup may receive substantially the same feedback. The feedback may be tailored to the members of the subgroup based on the at least one sensor-data-related commonality, determined based on the sensor data.

By way of a non-limiting example, in FIG. 9A, at least one processor (e.g., processor 102 in FIG. 1 associated with device 900 and/or cloud service 400) may provide over plurality of communications channels 920 and 922, the feedback from the common wellness specialist 902 to device 904 of trainee 912 and to device 906 of trainee 914 in at least one subgroup 928.

By way of another non-limiting example, in FIG. 9B, at least one processor (e.g., processor 102 in FIG. 1 associated with device 900 and/or cloud service 400) may provide over plurality of communications channels 920 and 922, feedback to mobile communications device 930 and/or electronic exercise machine 932 of trainee 912, and to mobile communications device 934 and/or electronic exercise machine 936 of trainee 914. For example, the feedback may include a video for playing on mobile communications devices 930 and 934 and/or on a user interface integrated with electronic exercise machines 932 and/or 936 to pace weight lifting exercises.

In some disclosed embodiments, the provision of the feedback to each trainee in the at least one subgroup occurs substantially simultaneously over the plurality of communications channels. Simultaneously refers to concurrently, in unison, and/or at the same time. For example, the trainees in the subgroup may be participating in an online class, and the feedback may be provided at approximately the same time to participants in the class included in a subgroup via a plurality of communication channels associated with that subgroup. Substantially simultaneously refers to a characteristic where the feedback is transmitted at approximately the same time to mobile devices of the participants in the subgroup, such that they may concurrently participate in an activity, even if there is some delay in transmission or receipt. Alternatively, at least one processor may provide the feedback over at least some of the communications channels at different times, e.g., based on schedules of one of more of the trainees in the subgroup.

Some disclosed embodiments involve, prior to receiving the feedback from the common wellness specialist, providing to the common wellness specialist, recommended feedback for providing to each trainee in the at least one subgroup. Prior to receiving the feedback from the common wellness specialist refers to before obtaining feedback from the common wellness specialist. For example, at least one processor may predict and/or extrapolate one or more recommendations for the common wellness specialist, before receiving human-generated recommendations from the common wellness specialist. Recommended feedback refers to advised, suggested, and/or proposed feedback. For example, at least one processor may use artificial intelligence to determine recommended feedback based on one or more of the at least one sensor-data-related commonality, a history of one or more of the trainees in the subgroup, one or more user preferences, information received from one or more of the trainees and/or the wellness specialist during previous interactions between the trainees and the wellness specialist, and/or any other information relevant for determining feedback for the trainees in the subgroup. Providing recommended feedback to the common wellness specialist refers to sending, transmitting, and/or otherwise granting the common wellness specialist access to the recommended feedback. At least one processor may transmit recommended feedback to a device of the common wellness specialist and/or provide a key and/or code to access a data structure storing the recommended feedback.

Some disclosed embodiments involve receiving at least one modification to the recommended feedback from the common wellness specialist. A modification refers to a change, an alteration, a correction, and/or an adaptation. The modification may include additional information, such as a greeting, background music, a training focus and/or exercise emphasis, fitness tips, one or more precautions and/or safety measures, a reminder to hydrate or rest. The modification may be based on information previously received from one or more of the trainees (e.g., during a previous exercise session), an enhancement to the recommended feedback, and/or any other type of modification. For example, the common wellness specialist may determine that portions of the recommended feedback may be unsuitable and/or inappropriate for at least some of the trainees in the subgroup, and may introduce modifications to improve the suitability and/or appropriateness. The modification may include a request to switch the feedback from a multimedia format to text or the reverse, to increase or decrease the volume, to add a music soundtrack, to add a pacing beat, and/or any other type of modification to feedback.

By way of a non-limiting example, in FIGS. 9A-9B, the provision of the feedback to each of trainees 912 and 914 in at least one subgroup 928 may occur substantially simultaneously over plurality of communications channels 920 and 922. In some disclosed embodiments, prior to receiving the feedback from common wellness specialist 902, at least one processor (e.g., processor 102 in FIG. 1 associated with device 900 and/or cloud service 400) may provide recommended feedback to common wellness specialist 902, for providing to trainees 912 and 914 in at least one subgroup 928. In some embodiments, at least one processor may receive at least one modification to the recommended feedback from common wellness specialist 902. For example, cloud service 400 may use artificial intelligence to determine exercise instructions based on the sensor data received from devices 904 and/or 906, common wellness specialist 902 may customize the feedback for trainees 912 and 914 based on a prior interaction with trainees 912 and 914.

Some disclosed embodiments involve synthesizing a voice of the common wellness specialist. Synthesizing a voice of a common wellness specialist refers to reproducing speech simulating vocal sounds of the common wellness specialist. Synthesizing the voice may include sampling and/or analyzing an audio segment associated with the common wellness specialist to extract vocal characteristics, and applying the extracted characteristics to digitally generate an audio file configured to, upon playback, simulate speech as if produced by the common wellness specialist. Some examples of vocal characteristics may include a tone, a pitch, a cadence, a timbre, an accent, an inflection, a delivery, a resonance, and/or any other vocal characteristic. In some embodiments, the synthesized voice may be a synthesization of the actual voice of the wellness specialist. In other embodiments, the synthesized voice may be voice used by the common wellness specialist in communications with trainees, different from the real voice of the wellness specialist.

In some disclosed embodiments, providing over the plurality of communications channels the feedback to each trainee in the at least one subgroup includes providing the feedback in the synthesized voice of the common wellness specialist. Providing the feedback in the synthesized voice of the common wellness specialist refers to transmitting audio files electronically to the trainees. This can occur, for example, by transmitting across a plurality of communication channels, electronic data simulating speech of the common wellness specialist. Consequently, upon receiving and playing an audio file, audio stream, or other forms of audio data, each trainee in the subgroup may hear feedback as though spoken by the common wellness specialist.

In some disclosed embodiments, the feedback differs across the plurality of communications channels. Thus, the feedback may include dissimilar audio transmissions along at least two of the communications channels. At least one processor may customize, personalize, and/or otherwise modify one or more of the audio files for at least some of the trainees in the subgroup. For example, upon determining that some of the trainees in the subgroup are experiencing difficulty completing a fitness routine, the common wellness specialist may modify the feedback by reducing a recommended duration for the exercise routine for the trainees experiencing difficulties, while maintaining the same feedback for other trainees who are not experiencing difficulties.

In some disclosed embodiments, feedback differences are based on unique characteristics of each individual trainee in the at least one subgroup. Unique characteristics of each individual trainee in the at least one subgroup refers to individualized and/or personalized traits and/or attributes of the individual trainees in the subgroup. Such unique characteristics may include individual preferences, capabilities, goals, tastes, disabilities, talents, and/or any other type of characteristic. For example, feedback for a trainee focusing on weight loss may differ from feedback for a trainee focusing on strength training, even if both the trainees are included in the same subgroup based on weightlifting capability. As another example, one trainee may prefer breathing guidance (e.g., “exhale slowly during the repetition”) whereas another trainee may prefer motivational mentoring (e.g., “two more reps and you've reached your goal!”). As a further example, a trainee may have an injury requiring customization of an exercise routine.

By way of a non-limiting example, in FIGS. 9A-9B, at least one processor (e.g., processor 102 in FIG. 1 associated with device 900 and/or cloud service 400) may synthesize a voice of common wellness specialist 902. In some embodiments, at least one processor may provide over plurality of communications channels 920 and 922 the feedback to trainee 912 and trainee 914 in at least one subgroup 928 in the synthesized voice of the common wellness specialist 902. The synthesized voice may be played via a speaker (e.g., speaker 326 in FIG. 3) included in mobile communications devices 930 and 934 and/or included in electronic exercise machines 932 and 936. In some embodiments, the feedback may differ across plurality of communications channels 920 and 922. That is, different feedback may be provided in communications channel 920 as compared to communications channels 922. In some embodiments, feedback differences may be based on unique characteristics of trainee 912 and trainee 914 in at least one subgroup 928. For example, feedback for trainee 912 may include tips for addressing an injury of trainee 912, whereas feedback for trainee 914 may include tips for improving flexibility due to stiffness of trainee 914.

Some disclosed embodiments involve retrieving from a data pool the unique characteristics of each individual trainee in the at least one subgroup. A data pool may be understood as described elsewhere herein. Retrieving from a data pool unique characteristics an individual trainee may include accessing, querying, and/or reading unique characteristics from the data pool. In some embodiments, retrieving unique characteristics from a data pool for an individual trainee may include using artificial intelligence to learn and/or infer unique characteristics from data stored in association with the individual trainee and/or stored in association with similar trainees.

In some disclosed embodiments, the feedback is consistent across at least some of the plurality of communications channels. Consistent, as used herein, refers to analogous, parallel, equivalent, and/or substantially similar. At least some of a plurality of communications channels refers to at least two communications channels. Thus, at least some of the trainees may receive substantially the same feedback from the common wellness specialist. Consistent feedback across at least some channels may permit the common wellness specialist to interact with more trainees than if the feedback were different across each channel.

In some disclosed embodiments, at least a portion of the feedback is configured for receipt by an electronic exercise machine in order to cause an automatic adjustment to the electronic exercise machine. An electronic exercise machine may be understood as described elsewhere herein. To cause an automatic adjustment to an electronic exercise machine refers to triggering a modification of one or more settings of the electronic exercise machine. For example, at least one processor may receive a portion of the feedback, and use the received feedback to determine signals for adjusting a resistance level, a mode, and/or timing for a motor of an electronic exercise machine. Additionally or alternatively, at least one processor may determine signals for adjusting a user interface, an accessory, and/or any other adjustable aspect of an electronic exercise machine. Thus, instead of the trainees having to adjust settings on their electronic exercise machines during a workout, at least one processor may automatically determine and/or implement an adjustment.

By way of a non-limiting example, in FIGS. 9A-9B, at least one processor (e.g., processor 102 in FIG. 1 associated with device 900 and/or cloud service 400) may retrieve from a data pool (e.g., maintained in data repository 404) unique characteristics for each individual trainee 912 and 914 in at least one subgroup 928. In some disclosed embodiments, the feedback provided to trainees 912 and 914 may be consistent across communications channels 920 and 922 (e.g., “Shoulders down, stomach in!”). In some embodiments, at least a portion of the feedback provided to trainees 912 and 914 may be received by electronic exercise machine 932 and/or 936 to cause an automatic adjustment to electronic exercise machine 932 and/or 936. For example, the feedback may include electronic signals for adjusting one or more settings of electronic exercise machine 932 and/or 936, such as a resistance level, schedule, timing, and/or use mode associated with motor 202.

In some disclosed embodiments, the feedback is provided as a message or an email. A message refers to a unit of digital information transmitted between devices and/or systems over a communication channel. A message may include structured data, such as content and/or a payload (e.g., the core message being transmitted), and metadata, such as sender and/or recipient identifiers, timestamps, and/or routing information. Some examples of messages may include text messages, instant messages, and/or machine-to-machine communication signals. Email (i.e., electronic mail) refers to an electronic message enabling generation, transmission, and/or reception of digital text-based communications over a computer network, such as the Internet. An email may include a header (e.g., including sender and/or recipient identifiers, a subject, a date, and/or routing data) and a body (e.g., the content and/or payload of the message). In some instances, an email may include attachments, such as documents, images, and/or additional electronic files.

In some disclosed embodiments, the feedback from the common wellness specialist is predetermined by the wellness specialist and stored in memory. Predetermined refers to being set and/or established in advance of a current session and/or time period. The predetermined feedback may include text, audio, and/or video content, and/or settings for adjusting an electronic exercise machine. The predetermined feedback may be inputted by the common wellness specialist (e.g., using a microphone, camera, keyboard, and/or any other type of input device) and/or may be at least partially generated using artificial intelligence. For example, the common wellness specialist may record a video of an exercise class in advance of a schedule session with a subgroup, and use artificial intelligence to edit the video and add a soundtrack. Stored in memory refers to written and/or recorded on a computer readable medium. The memory storing the predetermined feedback may be associated with a cloud server, a device of the common wellness specialist, and/or one or more devices of the trainees (e.g., an exercise machine and/or a mobile communications device), and/or may be accessible via query.

Some disclosed embodiments involve retrieving the feedback from memory for provision over the plurality of communication channels. Retrieving from memory refers to accessing, reading, and/or querying local and/or remote memory. Retrieving from memory may require establishment of a communication channel, and/or successful authentication and/or registration by the common wellness specialist and/or the trainees included in the subgroup. In some disclosed embodiments, retrieving and transmission occur automatically based on predetermined rules. For provision refers to for transmitting, sending, providing, and/or granting access to. Predetermined rules refers to directives, regulations, and/or precepts set and/or established in advance of their application to a particular use case. For example, a predetermined rule may require common wellness specialist and/or each trainee in the subgroup to maintain an active account with a cloud service, and/or may require successful login to receive feedback. As another example, a predetermined rule may require that each trainee in the subgroup use a similar electronic exercise machine. As another example, a predetermined rule may require that each trainee pair a mobile communications device with an exercise machine and/or install an application associated with the paired exercise machine on the mobile communications device.

By way of a non-limiting example, in FIGS. 9A-9B, at least one processor (e.g., processor 102 in FIG. 1 associated with device 900 and/or cloud service 400) may provide the feedback as a message or an email, e.g., for receipt by mobile communications devices 930 and/or 934. In some embodiments, the feedback from common wellness specialist 902 may be predetermined by common wellness specialist 902 and stored in memory of device 900 and/or in data repository 404. For example, common wellness specialists may upload a soundtrack and pre-recorded pacing feedback to data repository 404. Server 402 may transmit the soundtrack and pre-recorded pacing feedback for playing on mobile communications devices 930 and/or 934 via communications channels 920 and/or 922. In some embodiments, at least one processor may retrieve the feedback from memory (e.g., data repository 404) for provision over plurality of communication channels 920 and 922. In some embodiments, retrieving and transmission may occur automatically based on predetermined rules, e.g., requiring trainees 912 and 914 to register for an exercise session with common wellness specialist 902.

FIG. 9C is a flowchart of example process 950 for performing automated group identification and guidance, consistent with embodiments of the present disclosure. In some embodiments, process 950 may be performed by at least one processor (e.g., processor 102 in FIG. 1) to perform operations or functions described herein. In some embodiments, some aspects of process 950 may be implemented as software (e.g., program codes or instructions) that are stored in a memory (e.g., memory 104) or a non-transitory computer readable medium. In some embodiments, some aspects of process 1100 may be implemented as hardware (e.g., a specific-purpose circuit). In some embodiments, process 950 may be implemented as a combination of software and hardware.

Process 950 may include a step 952 of receiving associations between a plurality of trainees and a common wellness specialist. By way of a non-limiting example, in FIG. 9A, at least one processor (e.g., processor 102 in FIG. 1 associated with device 900 and/or cloud service 400) may receive associations between plurality of trainees 912-918 and common wellness specialist 902.

Process 950 may include a step 954 of receiving, over a plurality of communication channels, sensor data associated with performance of exercises by the plurality of trainees. By way of a non-limiting example, in FIG. 9A, at least one processor (e.g., processor 102 in FIG. 1 associated with device 900 and/or cloud service 400) may receive, over a plurality of communication channels 920-926, sensor data associated with performance of exercises by plurality of trainees 912-918. For example, the sensor data may be detected by one or more sensors included in devices 904-910.

Process 950 may include a step 956 of analyzing the sensor data to identify at least one subgroup within the plurality of trainees, wherein individual trainees within the at least one subgroup share at least one sensor-data-related commonality. By way of a non-limiting example, in FIG. 9A, at least one processor (e.g., processor 102 in FIG. 1 associated with device 900 and/or cloud service 400) may analyze the sensor data to identify at least one subgroup 728 within plurality of trainees 912-918. Individual trainees 912 and 914 within subgroup 728 may share a first sensor-data-related commonality (e.g., use of similar electronic exercise machines), and individual trainees 916 and 918 within at least one subgroup 740 may share a second sensor-data-related commonality (e.g., use of free weights).

Process 950 may include a step 958 of characterizing the at least one subgroup to the common wellness specialist. By way of a non-limiting example, in FIG. 9A, at least one processor (e.g., processor 102 in FIG. 1 associated with device 900 and/or cloud service 400) may characterize subgroups 928 and 940 to common wellness specialist 902.

Process 950 may include a step 960 of receiving from the common wellness specialist, feedback associated with the at least one sensor-data-related commonality. By way of a non-limiting example, in FIG. 9A, at least one processor (e.g., processor 102 in FIG. 1 associated with device 900 and/or cloud service 400) may receive from common wellness specialist 902, feedback associated with the at least one sensor-data-related commonality.

Process 950 may include a step 962 of providing over the plurality of communications channels the feedback to each trainee in the at least one subgroup. By way of a non-limiting example, in FIGS. 9A-9B, at least one processor (e.g., processor 102 in FIG. 1 associated with device 900 and/or cloud service 400) may provide over plurality of communications channels 920 and 922 the feedback to trainees 912 and 914 in subgroup 928.

Some disclosed embodiments involve a guest-mode feature using a piece exercise equipment. In the guest mode, an exercise machine can distinguish between different users and tracks each user's performance, imparting a competitive aspect to the performance of exercise routines.

Some disclosed embodiments involve performing operations for enabling guest mode gaming on a common exercise machine. Performing operations refers to executing, carrying out, or completing a specific operation, instruction, or set of instructions. For example, performing operations may include executing operations stored in a memory by a processor. Enabling refers to activating, turning on, or making available a feature, function, or mode. For example, enabling may include changing a system's state so that a mode is active and operational, thereby making the mode available to one or more users. Further, enabling may include activating, turning on, or making available a feature, function, or mode in response to a user input. A processor may enable a mode in response to a user selecting said mode, for example, by tapping an icon on a user interface.

A mode refers to a specific state, configuration, or way in which a system, device, or application operates. A guest refers to a user who is not the primary or registered user of an account, system, or device. For example, a guest may include a person who is allowed temporary access to a system, place, or service without having full privileges or ownership. For example, a guest may be a user of the exercise machine that does not own and/or has a registered account with the exercise machine. Further, data associated with a guest's usage of the exercise machine, such as a game success measure, may be stored locally in a memory of the exercise machine and may not be stored in a cloud-based data pool.

Enabling a guest mode may refer to activating or turning on a temporary or limited form of access for a user who is not the primary or registered user of an account, system, or device. For example, guest mode may include a toggleable or selectable mode of operation for a device in which a guest user may interact or utilize said device without being associated with a permanent or registered account. Gaming refers to playing, participating, or otherwise interacting with an electronic game on a device. For example, gaming may include interacting with a user interface and/or device to achieve some effect in an electronic game executed by the user interface and/or device. Consequently, guest mode gaming may include playing or otherwise interacting with a game without signing into a permanent account. For example, guest mode gaming may include tracking and/or displaying temporary progress, making available limited features, and/or not saving data once the session ends for a guest user.

An exercise machine refers to a mechanical apparatus or electromechanical apparatus that may be used to perform physical exercise, as described and exemplified elsewhere in this disclosure. Common refers to a characteristic of being capable of being shared or used collectively by a plurality of people or users. For example, a common exercise machine may include an exercise machine that may be used or shared between two or more people. The two or more people may utilize the common exercise machine at a same time, for example by interacting with different or the same components. Additionally or alternatively, the two or more people may take turns (i.e., one at a time) utilizing the common exercise machine.

Performance (e.g., implementation) of operations for enabling guest mode gaming on a common exercise machine by at least one processor may ensure that a common exercise machine may perform guest mode gaming operations for one or more guest users of the common exercise machine.

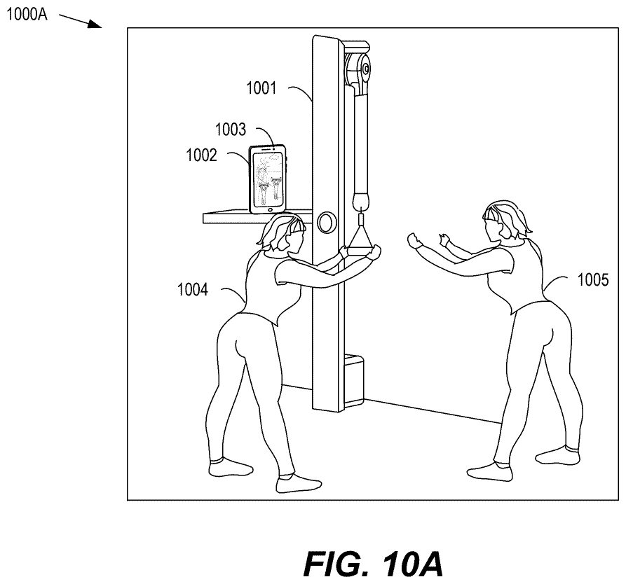

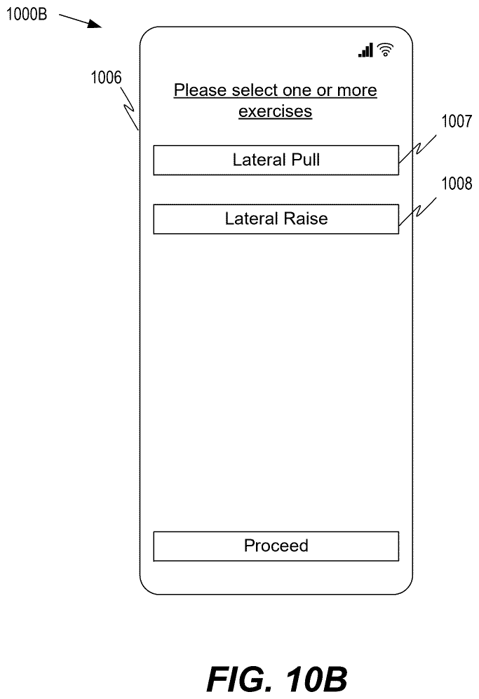

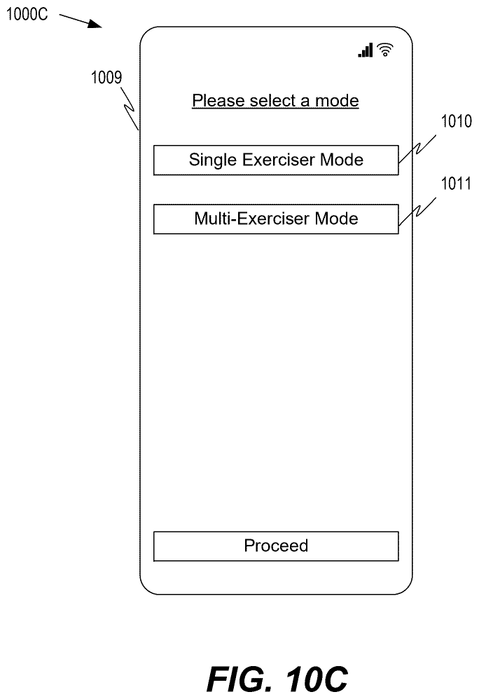

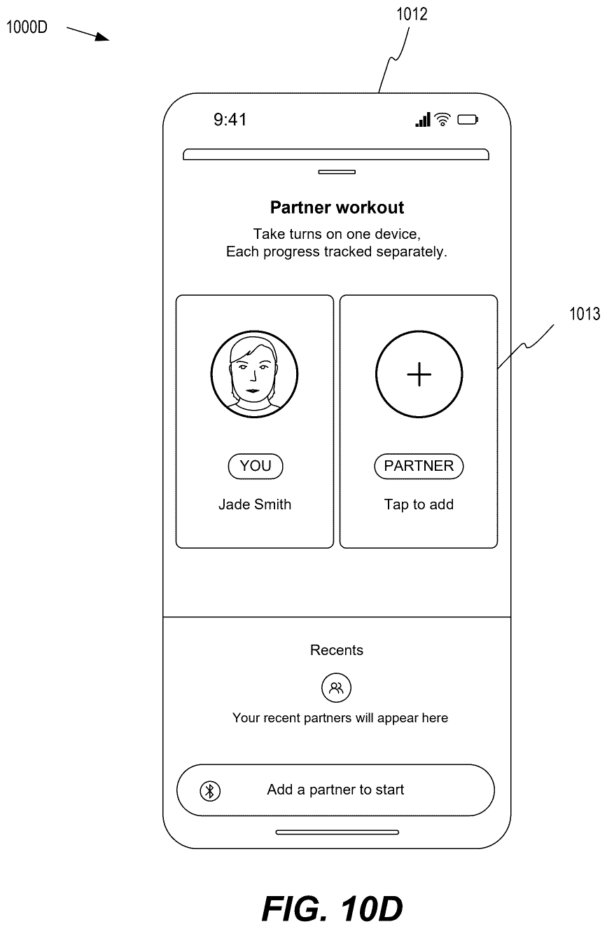

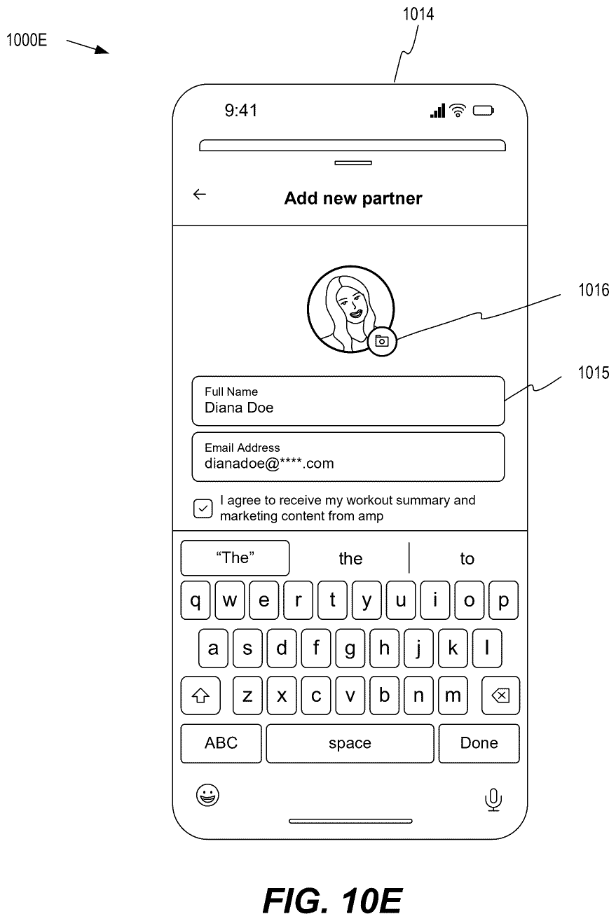

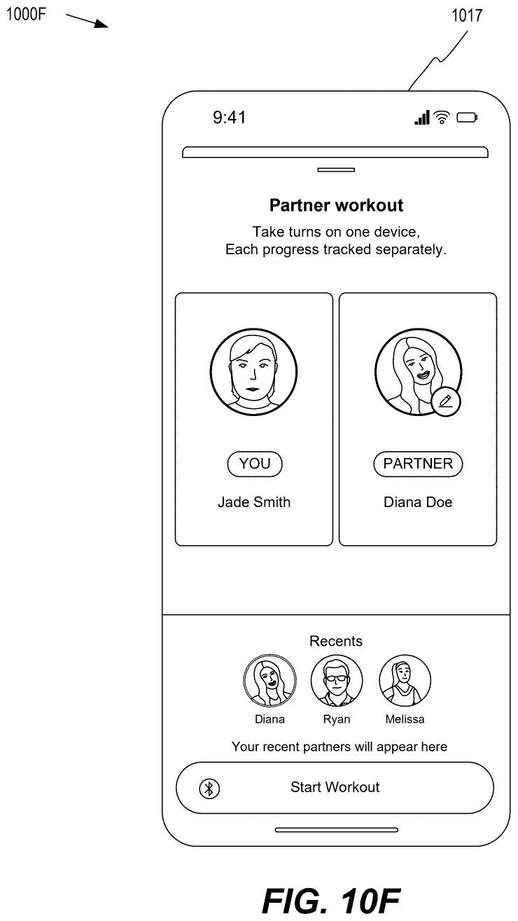

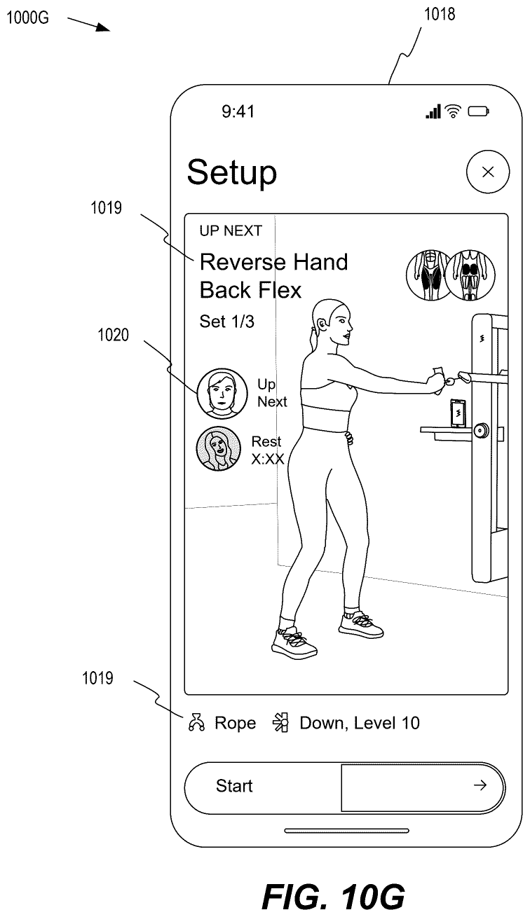

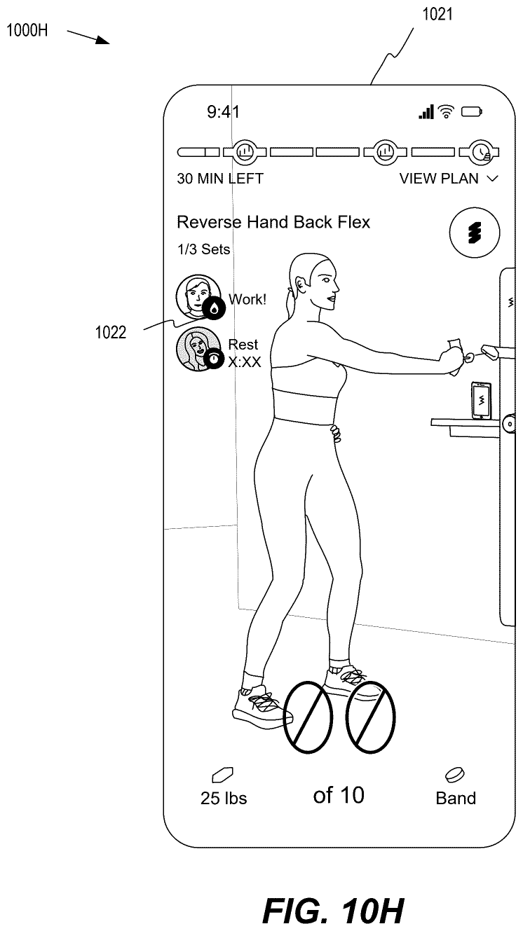

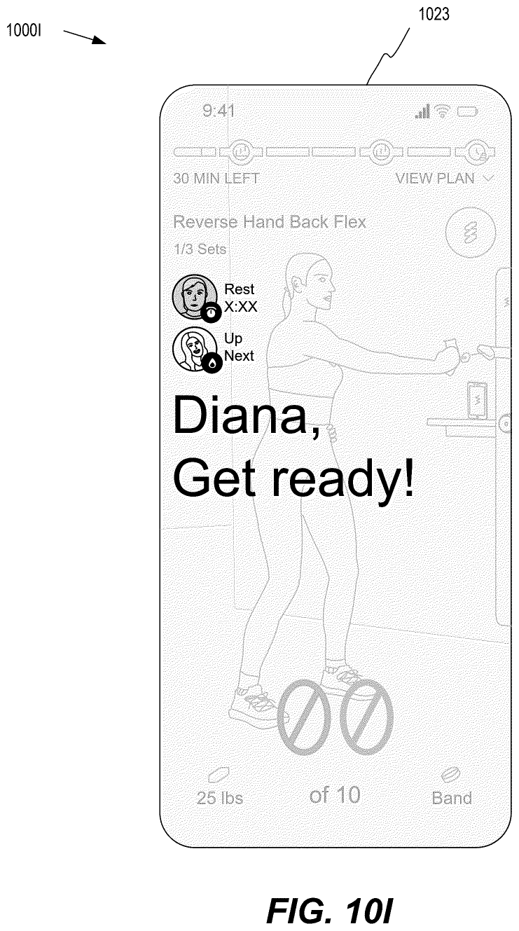

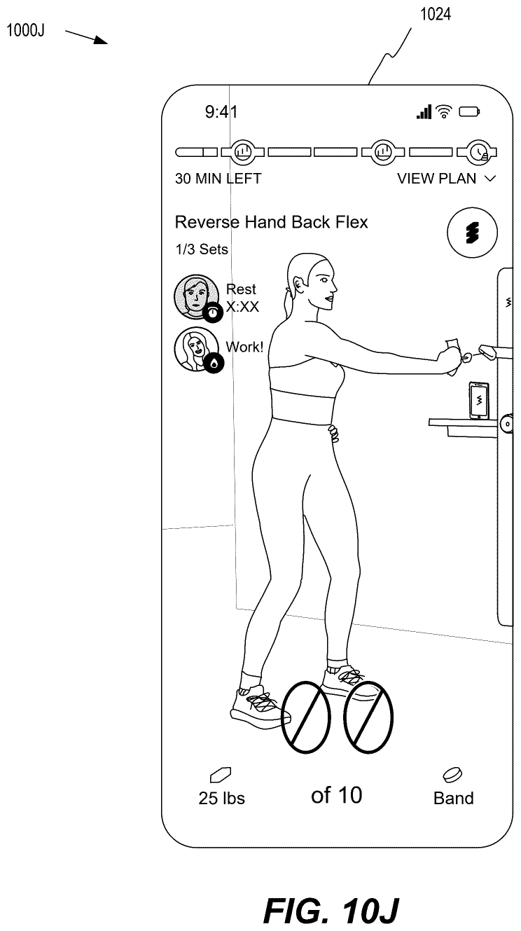

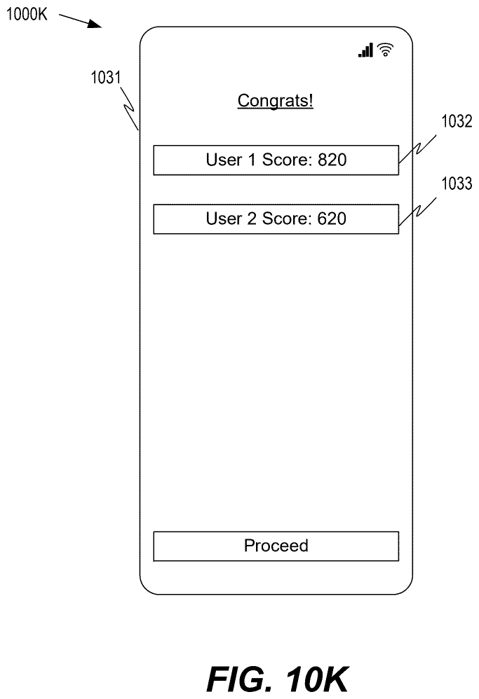

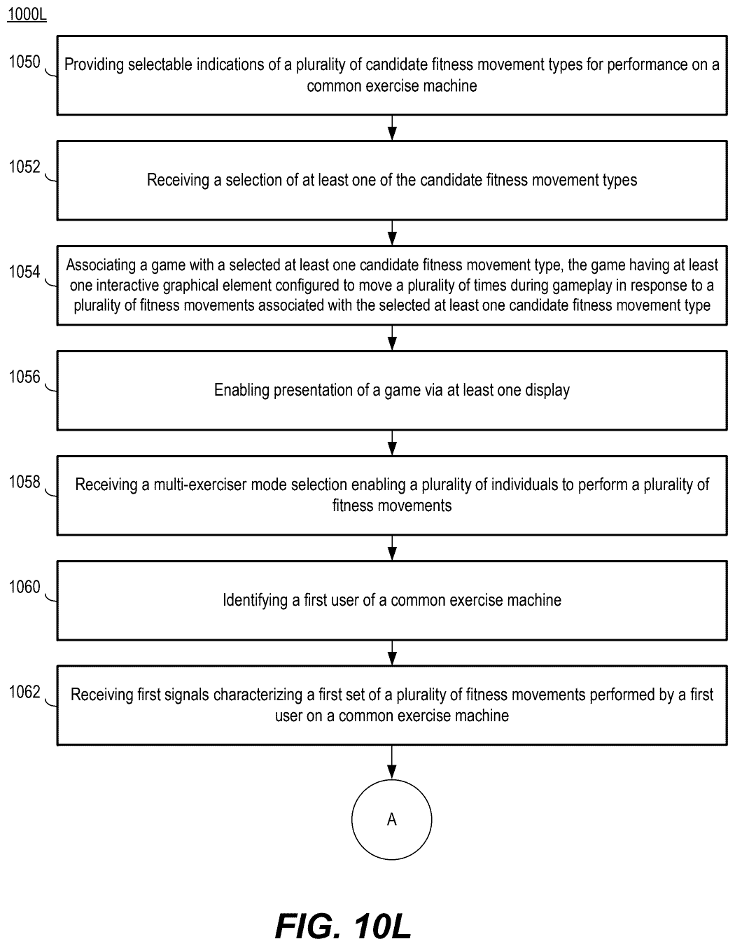

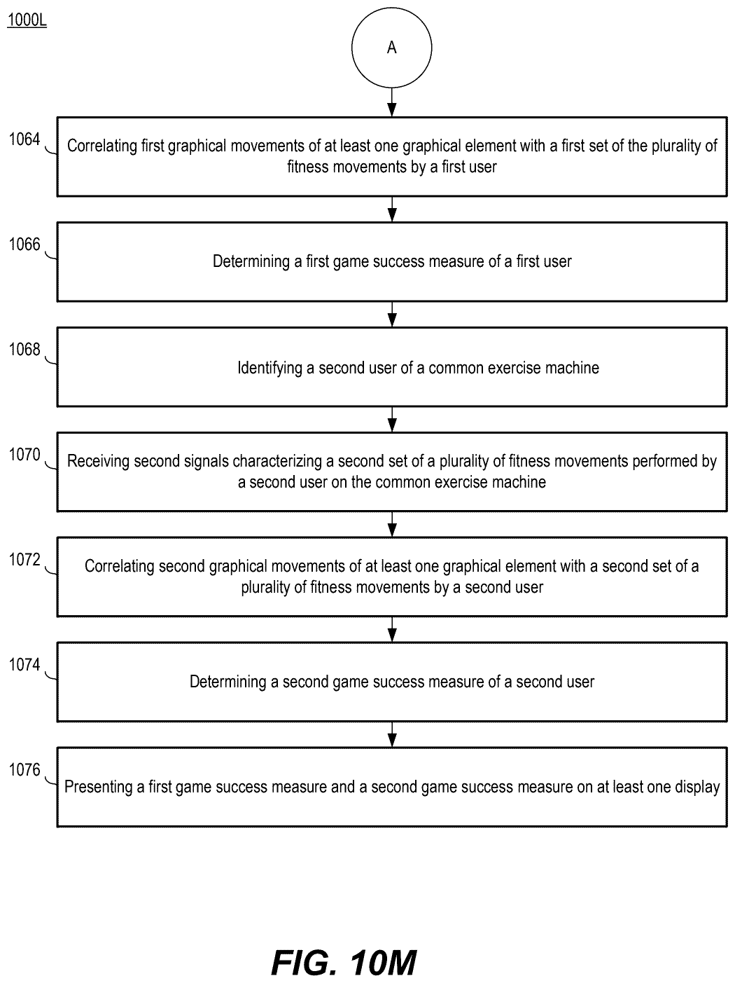

By way of non-limiting example and with reference to FIG. 10A, system 1000A may include an exercise machine 1001 and a device 1002. Exercise machine 1001 may be configured to perform operations for enabling guest mode gaming, for example, via one or more processors included in or operatively connected to exercise machine 1001 and/or device 1001. Device 1002 may be a user's mobile device. For example, device 1002 may be implemented as a smartphone, a tablet, a laptop, or any other suitable processing device. Further, system 1000A may include any number of users, such as first user 1004 and second user 1005 illustrated in FIG. 10A or any other number of users (e.g., 1, 3, 5, etc.). In the example illustrated in FIG. 10A, exercise machine 1001 may be considered a common exercise machine for first user 1004 and second user 1005.

Some disclosed embodiments involve providing selectable indications of a plurality of candidate fitness movement types for performance on a common exercise machine. Providing refers to giving, supplying, or making something available. For example, providing may include displaying information on a display. Selectable refers to a characteristic of being able to be chosen from a set of possibilities. An indication refers to a sign, symbol, or marker. For example, an indication may include an icon displayed on a display or user interface. Additionally or alternatively, an indication may include a depiction of how to do something. For example, an indication of a push-up may include an image or video of a person performing a push-up. Further, a selectable indication may include a visible sign, symbol, or marker displayed on a screen with which a user can interact. For example, the user may interact with the selectable indication by choosing, clicking, tapping, pressing, or any other suitable interaction. Thus, providing selectable indications may include outputting, for display on a display or user interface, one or more icons that, when interacted with by a user, causes a selection associated with said icon.

A plurality refers to two or more. For example, a plurality may include two, three, five, a hundred, or any other number greater than or equal to two. A fitness movement refers to a physical action or exercise that involves moving part or all of the body to achieve a training effect. For example, a fitness movement may include a bicep curl, a lateral raise, a lateral pull, or any other exercise. A fitness movement type refers to a category that groups similar fitness movements based on their mechanics, function, or training goal. For example, a fitness category of pull movements may include bicep curls, lateral pulls, or any other fitness movement that involves pulling or performing a pulling motion. Candidate refers to a characteristic of being considered as a possible choice, option, or solution. For example, a candidate fitness movement type may include any fitness movement type that is possible, as the result of one or more filters applied by a user. Additionally or alternatively, a candidate fitness movement type for performance on an exercise machine may include a fitness movement type that is capable of being performed on the exercise machine, for example, due to the configuration or components of the exercise machine.

Thus, providing selectable indications of a plurality of candidate fitness movement types for performance on a common exercise machine by at least one processor may ensure that a common exercise machine displays a list of possible fitness movement types. A user may be able to select one of the displayed indications to select a type of fitness movement that the user wishes to perform using the common exercise machine.

By way of non-limiting example and with reference to FIG. 10A, device 1002 may be configured to display, to first user 1004 and/or second user 1005, a list of indications that can be selected and whose associated fitness movement type is capable of being performed on exercise machine 1001. For example, a user may select an indication (e.g., 1007, 1008) by touching, tapping, swiping, pressing, or any other suitable interaction. Further with reference to FIG. 10B, device 1000B may include a display 1006. Display 1006 may display, to a user, selectable indications 1007, 1008 of a plurality of candidate fitness movement types.

Some disclosed embodiments involve receiving a selection of at least one of the candidate fitness movement types. Receiving refers to obtaining, acquiring, and/or otherwise gaining access to information, as described and exemplified elsewhere in this disclosure. A selection refers to the act of choosing an option or mode from a set of possibilities. For example, a selection may include the selecting of an option by a user from a list of one or more options. Further, receiving a selection may include accepting, registering, or being provided with the item or choice that someone has chosen. For example, a user interface may receive a selection by detecting a user interaction at a particular selectable indication or graphical icon, such as by tapping on or pressing on the particular selectable indication or graphical icon on a user interface displayed on a display. Consequently, receiving a selection of at least one of the candidate fitness movement types by at least one processor may be understood to include any manner of receiving a user input indicating at least one desired fitness movement type from a set of one or more candidate fitness movement types.

By way of non-limiting example and with reference to FIG. 10B, display 1006 may display a first selectable indication 1007 associated with a first candidate fitness movement type and a second selectable indication 1008 associated with a second candidate fitness movement type. A user may select one or more of the displayed candidate fitness movement types on the display 1006. For example, a user may select one or more of selectable indication 1007, 1008 by touching, tapping, swiping, pressing, or any other suitable interaction with a user interface displayed on display 1006. Additionally or alternatively, in some embodiments, a selectable indication may visually change when selected by a user. For example, in response to or after being selected, a selectable indication may become darker, become lighter, change colors, become patterned or shaded, or any other suitable visual change. A user may select one or more of the displayed selectable indications before confirming their selections.

Some disclosed embodiments involve associating a game with the selected at least one candidate fitness movement type, the game having at least one interactive graphical element configured to move a plurality of times during gameplay in response to a plurality of fitness movements associated with the selected at least one candidate fitness movement type.

Associating refers to linking, connecting, or relating one thing to another in thought, function, or purpose. For example, a processor may be configured to associate an element, datum, or variable with another element, datum, or variable and may store said association in a memory. The processor may make an association based on a stored data structure or table that maps one variable or value with one or more other variables or values. A game refers to a structured activity or form of play. For example, a game may include an electronic or video game configured to be played by interacting with a device. For example, the device may include a computer, console, mobile device, an exercise machine, or any other suitable processing device. Consequently, associating a game with a selected at least one candidate fitness movement type may include linking, connecting, or relating a game at least one candidate movement type. For example, a processor may, based on the selected at least one candidate fitness movement type, determine a game that can be played while the user performs fitness movements of the selected at least one candidate fitness movement type. The processor may do so, for example, by referencing a look-up table, based on an association algorithm, based on a machine learning algorithm, performing analysis or calculations, executing a model, or by executing instructions configured to allow the processor to determine the game. By way of non-limiting example, a game about ringing a bell in a belltower may be associated with fitness movements involving pulling down motions. Additionally or alternatively, the game may be associated with one or more movement types based on a selection of a user. For example, multiple games may be available for selection, and a user might select a preferred game for association with one or more movements.

Interactive refers to a characteristic of allowing or requiring active participation from a user or participant. A graphical element refers to a visual object or component in a user interface or display. Thus, an interactive graphical element may include a visual component that the user can actively engage with, where the system, software, and/or process is configured to respond to the interaction. For example, an interactive graphical element may include a graphical element configured to respond when triggered. A user may trigger a graphical element, for example, by tapping, swiping, clicking or selecting the graphical element. Moving refers to changing position or location. For example, moving may include a visual element, such as an interactive graphical element, changing its position on a display. Further, moving a plurality of times may include at least two instances of moving. That is, a visual element may move from a first position to a second position and then move from the second position to a third position. Gameplay refers to the interactive experience and mechanics of a game defining how it is played and how players engage with it. For example, gameplay may include the playing of a game by one or more users. During gameplay may include any duration of time that at least partially coincides with the playing of a game. In response to a plurality of fitness movements may refer to performing an action based on a detected or performed fitness movement. For example, a sensor or camera may detect a user performing fitness movements. The sensor or camera may send a signal to a processor executing the game to move a graphical element. Consequently, a game having at least one interactive graphical element configured to move a plurality of times during gameplay in response to a plurality of fitness movements associated with the selected at least one candidate fitness movement type may be understood to include a game that involves moving at least one graphical element on a display when a user performs a fitness movement.

Some disclosed embodiments involve providing selectable indications of a plurality of electronic games. A selectable indication of an electronic game may include a visible sign, symbol, or marker displayed on a screen with which a user can interact to select an electronic game. For example, the user can interact by choosing, clicking, tapping, pressing, or any other suitable interaction with a user interface. In some embodiments, enabling guest mode gaming on a common exercise machine includes receiving a selection of the game from the plurality of electronic games. For example, a processor may output for display one or more icons each associated with a different electronic game that may be played by performing fitness movements, including fitness movements performed on or using an exercise machine.

Some disclosed embodiments involve enabling presentation of the game via at least one display. Presentation refers to the act of displaying, showing, or making something visible to a user. Enabling presentation may include, for example, executing, by a processor, code that generates a visual output on a display. A display refers to an output device for visually presenting information, allowing users to interact with and/or view data, applications, and/or multimedia content, as described and exemplified elsewhere in this disclosure. Consequently, enabling presentation of the game via at least one display by at least one processor may include sending one or more signals or commands to a display to display the game. The signals may be transmitted by the at least one processor wirelessly or via wires to an external display device, mobile device, or computer.

By way of non-limiting example and with reference to FIG. 6, device 600 may include a display 214 presenting a game 218 associated with a fitness movement type. For example and as illustrated in FIG. 6, game 218 may be associated with the fitness movement type “lateral raise.” The game may include one or more moving graphical elements, as further described and exemplified below.

Some disclosed embodiments involve receiving a multi-exerciser mode selection enabling a plurality of individuals to perform the plurality of fitness movements. A multi-exerciser mode refers to a configuration in which a plurality of users may participate. For example, each user may participate simultaneously or in an alternating manner. Consequently, receiving a multi-exerciser mode selection enabling a plurality of individuals to perform the plurality of fitness movements may include receiving a command to operate in a mode that permits a plurality of users to participate.

By way of non-limiting example and with reference to FIG. 10C, device 1000C may include a display 1009 configured to display a first mode indication 1010 associated with a single exerciser mode and a second mode indication 1011 associated with a multi-exerciser mode. A user may select one of the displayed mode indications, for example by touching, tapping, swiping, pressing, etc., on display 1006. For example, in some embodiments, a selectable indication may visually change when selected by a user. The visual change may include, for example, becoming darker, becoming lighter, changing colors, or any other suitable visual change. A multi-exerciser mode may permit multiple users to exercise using an exercise machine, including both guest users and registered users.

By way of non-limiting example and with reference to FIG. 10D, device 1000D may include a display 1012 configured to display a multi-exerciser mode (or “partner workout” mode) set up or initialization. For example, display 1012 may include a selectable indication 1013. Responsive to detecting a user interaction with selectable indication 1013, device 1000D may initiate a registration process for a partner or guest user.

Some disclosed embodiments involve identifying a first user of the common exercise machine. Identifying refers to recognizing, ascertaining, and/or discovering, as described and exemplified elsewhere in this disclosure. A user refers to a person who interacts with or operates a system, device, application, or service. For example, a user may include a person who is, has, or will interact with an exercise machine. Additionally or alternatively, a user may include a person who has created an account or profile with a system, application, or service and can be identified based on account credentials (i.e., a “registered user”). For example, a user may include a person with a registered account associated with the exercise machine. Consequently, identifying a user of the common exercise machine may include, for example, comparing account credentials as input by a user against a data structure to determine an account associated with the user. For example, account credentials may include a username, a password, an email, any combination of the foregoing, or any other suitable account credential.

Some disclosed embodiments involve receiving first signals characterizing a first set of the plurality of fitness movements performed by the first user on the common exercise machine. A signal refers to information encoded for transmission via a physical medium, as described and exemplified elsewhere in this disclosure. A set refers to a collection of one or more distinct objects, elements, or items considered as a single entity. For example, a set of a plurality of fitness movements may include an exercise set, which may include a group of consecutive repetitions of a particular exercise. Characterizing refers to describing, defining, or identifying the distinctive features, properties, or qualities of something. For example, a signal characterizing a set of a plurality of fitness movements may include a signal containing information indicating how a set of a plurality of fitness movements are performed by a user. The characterizations may include a speed, an accuracy, a force, and/or any other characteristic associated with how a user is performing the fitness movement. The signal may originate from a sensor or a camera operatively connected to at least one processor. Thus, receiving first signals characterizing a first set of the plurality of fitness movements performed by the first user on the common exercise machine may include, for example, receiving, from a sensor or a camera, signals containing data indicating how a user is performing fitness movements. For example, a camera may capture visual data of the user performing a fitness movement and may transmit the captured data as signals to at least one processor.

By way of non-limiting example and with reference to FIG. 10A, device 1002 may include a camera 1003. Camera 1003 may be configured to capture visual data of a user performing a fitness movement with exercise machine 1001. For example, camera 1003 may capture images and/or videos of first user 1004 and/or second user 1005 performing a fitness movement with exercise machine 1001. Camera 1003 may transmit the visual data as signals to at least one processor, such as a processor associated with exercise machine 1001 and/or processing circuitry of device 1002.

By way of non-limiting example and with reference to FIG. 10H, device 1000H may include a display 1021. Display 1021 may display an indication of how to perform a fitness movement. For example, display 1021 may display an individual performing a fitness movement to be performed by an active user. Display 1021 may also display a progress of the set of fitness movements, weight(s) associated with the fitness movement, repetition(s) associated with the fitness movement, and/or any other suitable information associated with the active user's performance of the fitness movement.

Some disclosed embodiments involve correlating first graphical movements of the at least one graphical element with the first set of the plurality of fitness movements by the first user. Correlating refers to establishing a relationship, connection, or association between two or more things. For example, correlating may include determining whether and how two variables or sets of data change together. A graphical movement refers to the visual displacement or motion of a graphical element on a display or screen. For example, graphical movements of a graphical element may include the movement of a graphical element from one position on a display to another. Consequently, correlating first graphical movements of the at least one graphical element with the first set of the plurality of fitness movements by the first user may include, for example, coordinating graphical movement of at least one graphical element with fitness movements performed by a user. For example, signals characterizing how a user performs a fitness movement may cause a processor to move a graphical element in a particular direction or to a particular location.

By way of non-limiting example and with reference to FIG. 6, device 600 may include a display 214 of a game 218 having graphical elements 602, 604. Based on fitness movements performed by a user and captured by a sensor or camera (e.g., camera 1003 depicted in FIG. 10A), at least one processor may move one or more of graphical elements 602, 604. For example, as a user performs a lateral raise fitness movement, one or more graphical elements may move. Further, the movement of the one or more graphical elements may correspond to the fitness movement performed by the user. For example and with respect to a lateral raise fitness movement, as a user abducts by raising their arm(s), one or more graphical elements may move upwards on a screen. Further, as a user adducts by lowering their arm(s), one or more graphical elements may move downwards on a screen. Additionally or alternatively, the graphical elements may move in a different direction than the user's movements. For example, as the user abducts by raising their arm(s), one or more graphical elements may move downwards or sideways. In general, it may be understood that the one or more graphical elements may move in any direction, such as upwards, downwards, leftwards, rightwards, or diagonally, based on the fitness movement performed by the user, including during a same game.

Some disclosed embodiments involve determining a first game success measure of the first user. Determining refers to arriving at an outcome, as described and exemplified elsewhere in this disclosure. A game success measure refers to a metric or criterion used to evaluate how well a player performs in a game. For example, a game success measure may include a score indicating one or more of: the number of repetitions of a fitness movement completed by a user compared to a total number of intended repetitions of that fitness movement in a given set (e.g., 90% of lateral raises performed), a timing of repetitions of a fitness movement (e.g., performing a fitness movement too quickly or too slowly compared to a predetermined range may decrease the score), an amount of effort of a fitness movement (e.g., as determined based on a sensor measuring the amount of force a user is exerting), a resistance applied (e.g., amount of weight or resistance lifted), or any other suitable criterion. Consequently, determining a first game success measure of the first user may include, for example, determining a score indicating how well a user performed one or more fitness movements. In some examples, at least one processor may determine the score based on a stored algorithm, a look-up table, a correlation, an analytical or numerical model, a machine learning model, or a set of instructions, using received signals characterizing the fitness movements of a user. For example, the signals characterizing the fitness movements of the user may be received from a sensor, such as a force sensor, or a camera. Further, the at least one processor may store the game success measure in a memory location associated with the user, associated with an exercise machine, a user device, or any combination of the foregoing. In this way, a user and/or the at least one processor may track their performance or progression in performing a fitness movement based on historical game success measures.

Some disclosed embodiments involve identifying a second user of the common exercise machine. For example, identifying a second user of the common exercise machine may be understood to be similar to identifying a first user of the common exercise machine, as described and exemplified above, except involving a second user that is different than the previously identified first user. Identifying the second user may include receiving an input, in a multi-exerciser mode, indicating a second user is a guest user.

By way of non-limiting example and with reference to FIG. 10E, device 1000E may include a display 1014 configured to display a second user registration. For example, display 1014 may include one or more fields 1015 and/or an interactable icon 1016. A user may interact with one or more fields 1015 by inputting the requested information. For example, a user may type or may utilize text-to-speech to enter the user's name and/or email address. A user may interact with interactable icon 1016 to set a profile picture. For example, a user may tap or touch interactable icon 1016. Responsive to detecting a user input with interactable icon 1016, device 1000E may prompt the user to upload a photo and/or to take a photo to use as a profile image. Device 1000E may store all received information from the user in a memory location associated with that user. Device 1000E may also store information in that memory location indicating the user is a guest user for a particular exercise machine. For example, the information may be stored in a local memory of device 1000E, in a local memory of an exercise machine (e.g., exercise machine 1001 depicted in FIG. 10A), a database, and/or in a cloud-based data storage system.

By way of non-limiting example and with reference to FIG. 10F, device 1000F may include a display 1017 configured to display a user confirmation. For example, after identifying the first user and the second user (e.g., guest user), display 1017 may display one or more or each of the identified users. In this way, the users can confirm the identified users or may have an opportunity to provide different identifying information to replace an identified user with or to add another user. Additionally or alternatively, the users can remove an identified user from being a participant in the multi-exerciser workout.

By way of non-limiting example and with reference to FIG. 10G, device 1000G may include a display 1018 configured to display a workout setup. For example, after confirming the participating users in the workout, display 1018 may display information 1019 associated with a workout to be performed by a user. For example, information 1019 may indicate a fitness movement, a number of sets, a particular piece of exercise equipment, or any other suitable information relating to the workout. Additionally or alternatively, display 1018 may include an indication 1020 of an active user. For example, display 1018 may emphasize a graphical icon associated with a user designated to perform the next exercise (e.g., an active user) by focusing the graphical icon. Focusing a graphical icon may include a textual indication, a graphical indication, bolding, increasing a size, increasing a contrast, or any other suitable modification to a graphical icon so that the graphical icon stands out. For example, a textual indication may include one or more words indicating a user is an active user, such as “Work!” as depicted in FIG. 10H. A graphical indication may include any depiction indicating a user is an active user, such as graphical indication 1022 depicted in FIG. 10H. Additionally or alternatively, focusing a graphical icon may include increasing a transparency and/or decreasing a size of a graphical icon associated with a user not designated to perform the next exercise (e.g., a resting user).

By way of non-limiting example and with reference to FIG. 10I, device 1000I may include a display 1023 configured to display a switch prompt. For example, after a first user completes a first set of fitness movements, display 1023 may instruct a second user to prepare to perform a set of fitness movements.

Some disclosed embodiments involve receiving second signals characterizing a second set of the plurality of fitness movements performed by the second user on the common exercise machine. For example, receiving second signals characterizing a second set of the plurality of fitness movements performed by the second user on the common exercise machine may be understood to be similar to receiving first signals characterizing a first set of a plurality of fitness movements by a first user, as described and exemplified above, except involving a second user different from the previously identified first user. Further, the first user may be a registered user and the second user may be a guest user.

By way of non-limiting example and with reference to FIG. 10J, device 1000J may include a display 1024. Display 1024 may display an indication of how to perform a fitness movement. For example, display 1024 may display an individual performing a fitness movement to be performed by an active user. Display 1024 may also display a progress of the set of fitness movements, weight(s) associated with the fitness movement, repetition(s) associated with the fitness movement, and/or any other suitable information associated with the active user's performance of the fitness movement. Display 1024 may be understood to be similar to display 1021 depicted in FIG. 10H except as focusing a second user.

Some disclosed embodiments involve correlating second graphical movements of the at least one graphical element with the second set of the plurality of fitness movements by the second user. For example, correlating second graphical movements of the at least one graphical element with the second set of the plurality of fitness movements by the second user may be understood to be similar to correlating first graphical movements of at least one graphical element with a first set of a plurality of fitness movements by a first user, as described and exemplified above, except involving a second user different from the previously identified first user. Further, the first user may be a registered user and the second user may be a guest user.

Some disclosed embodiments involve determining a second game success measure of the second user. For example, determining a second game success measure of a second user may be understood to be similar to determining a first game success measure of a first user, as described and exemplified above, except involving a second user different from the previously identified first user. Further, the first user may be a registered user and the second user may be a guest user.

Some disclosed embodiments involve retrieving, from a data pool, game histories associated with the first user and the second user. A data pool refers to a repository and/or collection of data, such as a data warehouse, a data lake, and/or a cloud-based data repository, as described and exemplified elsewhere in this disclosure. A game history refers to the recorded data and information about a user's past interactions, performances, or activities within a game. For example, a game history associated with a user may include historical data associated with a user, a game, and the user's performance of fitness movements during that game. Further, a game history may include historical game data from any number of different games for a same user. In some embodiments, the data pool may include game histories from only registered users and not guest users. Additionally or alternatively, an exercise machine may store game histories associated with guest users in a local memory or data pool (e.g., only accessible by the exercise machine).

Some disclosed embodiments involve using the game histories to determine the first game success measure and the second game success measure. For example, at least one processor may utilize game history data associated with a user to determine a game success measure. In this example, the at least one processor may compare a current performance of a fitness movement by a user with historical data associated with the user (i.e., game history data). An improvement in current performance compared to historical performance may improve a game success measure, and a regression in current performance compared to historical performance may worsen a game success measure. A current performance may include a score based on one or more of the above-discussion criteria. At least one processor may compare the current score with a game history including a historical score using same or similar criteria. Responsive to determining that the current score is higher than the historical score, the at least one processor may increase the score. For example, if a user currently performs thirty lateral raises and the game histories associated with the user indicates that the user historically has performed a maximum of twenty-five lateral raises, the at least one processor may increase the game success measure (e.g., score). Similarly, if a user currently performs twenty-five lateral raises and the game histories associated with the user indicates that the user historically has performed a maximum of thirty lateral raises, the at least one processor may decrease the game success measure (e.g., score). In some embodiments, the at least one processor may utilize a maximum, a minimum, a mode, an average, or any other suitable representation of one or more game histories when performing the determination of the game success measure.

Some disclosed embodiments involve presenting the first game success measure and the second game success measure on the at least one display. For example, presenting the first game success measure and the second game success measure on the at least one display may include displaying, on a display or user interface, the first game success measure associated with the first user and the second game success measure associated with the second user.

By way of non-limiting example and with reference to FIG. 10K, device 1000K may include a display 1031 of a first game success measure 1032 and a second game success measure 1033.

In some embodiments, the at least one display includes a common display of the common exercise machine. A common display may include a display that may be used or shared between two or more people. For example, a common display of a common exercise machine may include a display screen or a mobile device operatively connected to an exercise machine. The mobile device may include, for example, a smartphone, a tablet, a laptop, or any other suitable portable electronic device.

By way of non-limiting example and with reference to FIG. 10A, exercise machine 1001 may be operatively connected to device 1002 acting as a common display of exercise machine 1001 for first user 1004 and second user 1005.

Some disclosed embodiments involve pairing the common exercise machine with at least two mobile communication devices. Pairing refers to establishing a connection or link between two devices so they can communicate or work together. For example, pairing may include Bluetooth pairing, Wi-Fi Direct pairing, or via any other suitable means of wireless connection. Additionally or alternatively, pairing may include wire-based connections between two devices. A mobile communication device refers to a portable electronic device that allows a user to send, receive, and/or interact with data, voice, or multimedia communications over a wireless network. For example, a mobile communication device may include a smartphone, a tablet, a wearable device, or any other device capable of performing communication operations. The wearable device may include, for example, a smartwatch.

In some embodiments, the at least one display includes at least two displays. For example, the two displays may include a first display associated with a first user and a second display associated with a second user. By way of non-limiting example, a first user may use a first display (e.g., smartphone, tablet, smartwatch) and a second user may use a second, separate display (e.g., smartphone, tablet, smartwatch). The first display may include, for example, a smartphone, a tablet, or a smartwatch associated with the first user. The second display may include, for example, a smartphone, a tablet, or a smartwatch associated with the second user.

In some embodiments, presenting the first game success measure and the second game success measure on the at least one display includes presenting the first game success measure and the second game success measure on the at least two displays. For example, the first user's display may display only the first game success measure and not the second game success measure, while the second user's display may display only the second game success measure and not the first game success measure. Additionally or alternatively, each display may present each game success measure.

In some embodiments, a first of the two mobile communications device is associated with an owner of the common exercise machine and is configured to automatically pair with the common exercise machine. An owner refers to a person that has legal or effective possession, control, or primary rights over an object, property, or resource. For example, an owner of an exercise machine may include the person whose identity is associated with the exercise machine. Further, the owner of the exercise machine may include a registered user of the exercise machine. Automatically refers to occurring or being performed by a system or process without the need for direct human intervention. For example, automatically pairing may include pairing two devices when the two devices are on and/or nearby each other. The two devices may be initially paired and may store each other's identifier(s) in a memory for future recognition. An identifier may include a MAC address, a device ID, a key, or any other suitable identifier. Further, the two devices may be in a pairing mode in which the device is continuously searching for a previously paired device. Continuously may include, for example, constantly or at a predetermined interval, such as every 30 seconds. In this way, when a mobile communication device associated with an owner of an exercise machine and the exercise machine are both powered on and nearby each other, the two devices may because automatically paired.

In some embodiments, a second of the two mobile communications devices is associated with a guest. In some embodiments, the second of the two mobile communications devices is configured to pair with the common exercise machine upon authorization by the first of the two mobile communications devices. Authorization refers to the granting or verifying of permission for a person, device, or system to access resources, perform actions, or interact with another system or device. For example, authorization by the first of the two mobile communications devices may include sending, by the mobile communication device associated with the owner of the exercise machine, an authorization permitting a second mobile communication device associated with a guest to pair with the exercise machine. The exercise machine may be configured to pair with a mobile communication device associated with a guest only if an authorization from a mobile communication device associated with the owner is received first. By way of non-limiting example, the authorization may include inputting a generated or provided code from the mobile communication device associated with the owner into the exercise machine and/or the mobile communication device associated with the guest.

FIGS. 10L and 10M illustrate a flowchart of an example process for guest mode gaming on an exercise platform, consistent with some disclosed embodiments. In some disclosed embodiments, process 1000L may be performed by at least one processor (e.g., processor 102 in FIG. 1) to perform operations or functions described herein. In some disclosed embodiments, some aspects of process 1000L may be implemented as software (e.g., program codes or instructions) that are stored in a memory (e.g., memory 104 in FIG. 1) or a non-transitory computer readable medium. In disclosed some embodiments, some aspects of process 1000L may be implemented as hardware (e.g., a specific-purpose circuit). In some disclosed embodiments, process 1000L may be implemented as a combination of software and hardware.

Referring to FIG. 10L, process 1000L may include a step 1050 of providing selectable indications of a plurality of candidate fitness movement types for performance on a common exercise machine. By way of non-limiting example, in FIG. 10A, at least one processor of exercise machine 1001 may provide, to a display of device 1002, selectable indications of a plurality of candidate fitness movement types for performance on a common exercise machine.

Process 1000L may include a step 1052 of receiving a selection of at least one of the candidate fitness movement types. By way of non-limiting example, in FIG. 10A, at least one processor of exercise machine 1001 may receive, via a user interface of device 1002, a selection of at least one candidate fitness movement type.

Process 1000L may include a step 1054 of associating a game with a selected at least one candidate fitness movement type, the game having at least one interactive graphical element configured to move a plurality of times during gameplay in response to a plurality of fitness movements associated with the selected at least one candidate fitness movement type. By way of non-limiting example, in FIG. 10A, at least one processor of exercise machine 1001 may associate a game with the selected at least one candidate fitness movement type. The at least one processor may access a data structure or database storing one or more games and associated candidate fitness movements. The at least one processor may determine an associated game based on the received selection of at least one candidate fitness movement.

Process 1000L may include a step 1056 of enabling presentation of a game via at least one display. By way of non-limiting example, in FIG. 10A, at least one processor of exercise machine 1001 may output, to a display of device 1002, presentation of a game.

Process 1000L may include a step 1058 of receiving a multi-exerciser mode selection enabling a plurality of individuals to perform a plurality of fitness movements. By way of non-limiting example, in FIG. 10A, at least one processor of exercise machine 1001 may receive, via a user interface of device 1002, a selection of a multi-exerciser mode.

Process 1000L may include a step 1060 of identifying a first user of a common exercise machine. By way of non-limiting example, in FIG. 10A, at least one processor of exercise machine 1001 may identify a first user of exercise machine 1001. For example, first user 1004 may input user or account information into device 1002. The at least one processor of exercise machine 1001 may compare the received information with a data structure or database of registered accounts to identify the user.

Process 1000L may include a step 1062 of receiving first signals characterizing a first set of a plurality of fitness movements performed by a first user on a common exercise machine. By way of non-limiting example, in FIG. 10A, at least one processor of exercise machine 1001 may receive, from camera 1003 of device 1002, signals characterizing the fitness movements performed by first user 1004.

Process 1000L may include a step 1064 of correlating first graphical movements of at least one graphical element with a first set of the plurality of fitness movements by a first user. By way of non-limiting example, in FIG. 10A, at least one processor of exercise machine 1001 may move at least one graphical element displayed on device 1002 based on the received signals characterizing the fitness movements performed by first user 1004.

Process 1000L may include a step 1066 of determining a first game success measure of a first user. By way of non-limiting example, in FIG. 10A, at least one processor of exercise machine 1001 may determine a first game success measure of first user 1004 by calculating a score indicating how well first user 1004 performed the fitness movements. The at least one processor may use received first signals characterizing the performance of the fitness movements by first user 1004 to calculate the score.

Process 1000L may include a step 1068 of identifying a second user of a common exercise machine. By way of non-limiting example, in FIG. 10A, at least one processor of exercise machine 1001 may identify a second user of exercise machine 1001. For example, second user 1005 may input information into device 1002 self-identifying as a guest or temporary user.

Process 1000L may include a step 1070 of receiving second signals characterizing a second set of a plurality of fitness movements performed by a second user on the common exercise machine. By way of non-limiting example, in FIG. 10A, at least one processor of exercise machine 1001 may receive, from camera 1003 of device 1002, signals characterizing the fitness movements performed by second user 1005.

Process 1000L may include a step 1072 of correlating second graphical movements of at least one graphical element with a second set of a plurality of fitness movements by a second user. By way of non-limiting example, in FIG. 10A, at least one processor of exercise machine 1001 may move at least one graphical element displayed on device 1002 based on the received signals characterizing the fitness movements performed by first user 1005.

Process 1000L may include a step 1074 of determining a second game success measure of a second user. By way of non-limiting example, in FIG. 10A, at least one processor of exercise machine 1001 may determine a second game success measure of second user 1005 by calculating a score indicating how well first user 1005 performed the fitness movements. The at least one processor may use received second signals characterizing the performance of the fitness movements by second user 1005 to calculated the score.

Process 1000L may include a step 1076 of presenting a first game success measure and a second game success measure on at least one display. By way of non-limiting example, in FIG. 10A, at least one processor of exercise machine 1001 may output, to a display of device 1002, the determined first game success measure associated with first user 1004 and the determined second game success measure associated with second user 1005.

Digital tracking of exercise routines may require careful positioning and/or alignment of a camera or image sensor in proximity to an exercise region. Disclosed embodiments include software for providing indications to a user for positioning a mobile communications device with respect to a frame of an exercise machine to permit movement tracking during performance of an exercise routine. In some embodiments, the holder for the mobile communications device may be integrally formed with the exercise machine. Alternatively, the adjustable holder may be provided separately and connected to the exercise machine using one or more attachment mechanisms, for example, clamps, brackets, screws, bolts, rivets, adhesives, magnets, via an interference fit, by welding or brazing, or using any other method of attachment.

Some disclosed embodiments involve an exercise machine with an integrated holder for a mobile communications device. Integrated refers to being attached, incorporated, affixed to, built-in, or being specially adapted for affixation. Holder refers to a device or structure for mounting and/or supporting an object. A holder may include, for example, a base, a support, a clamp, a bracket, and/or any other type of apparatus to which a mobile communications device and/or a camera may be attached. A holder for a mobile communications device may additionally or alternatively include a receptable, a cradle, a device mount, a phone rest and/or dock, and/or any other type of stand for supporting a mobile communications device. A mobile communications device (e.g., a mobile computing device) refers to a portable computing device capable of transmitting and receiving information to and from other devices and/or networks. Mobile communications devices may, for example, use cellular or other wireless and/or wired networks to transmit information such as voice and/or other data. For example, such transmissions may be in the form of voice calls, text messages, internet access, and application usage. Mobile communications devices come in various forms, such as smartphones, tablets, laptop computers, IoT devices, wearable electronics (such as smart watches, smart rings, fitness trackers, smart glasses, smart clothing, smart jewelry, smart headphones, wearable digital assistants), digital cameras, and portable wireless hotspots. Depending on configuration and intended use, mobile communications devices may include features such as a touchscreen interface, a built-in camera, Wi-Fi, NFC, and/or Bluetooth connectivity, and/or GPS navigation. An exercise machine with an integrated holder for a mobile communications device refers to an exercise machine (as described elsewhere in this disclosure) connected to and/or built-in with a support for a mobile communications device. The holder may be connected to an exercise machine using an attachment mechanism as described above. Additionally or alternatively, the holder may be integrally formed with the exercise machine as a permanent and/or unified element.

Some disclosed embodiments involve a frame. A frame refers to a rigid structure for supporting one or more components, for example, a pulley. The frame may include one or more beams, pillars, or another type of rigid structure that provides strength and structural integrity to exercise equipment. The frame may be formed to provide structural support and bracing for exercise equipment, and may be designed to withstand physical forces exerted upon the exercise equipment during an exertion. In some embodiments, a frame may include a single beam configured to be oriented vertically, with an attached shelf extending from the side of the beam, and perpendicular to the beam or at an angle to the beam. The beam may be an elongated piece of rigid material. In some embodiments, a frame may include a vertically wall-mountable beam attachable to a wall via one or more supporting brackets. The frame and brackets may be made of durable metal (e.g., steel and/or aluminum) for sturdiness and may support a pulley system, allowing a first end of a cable to be connected to a resistance motor and a second end of the cable to be connected to exercise equipment.

Some disclosed embodiments involve a load mechanism associated with the frame. A load mechanism refers to a component that provides resistance and/or weight against other forces. A load mechanism for an exercise machine may include one or more weight plates, bars, springs, resistance motor, and/or bands connected to a frame of an exercise machine. In some embodiments, a load mechanism may be associated with a cable routed through a pulley mechanism, where one end of the cable may be attached to the load mechanism (e.g., a resistance motor or weight plates) and the other end of the cable may be attached to an accessory. A load mechanism may permit a user to perform exertions, such as lifting, pulling, and/or pushing against a measurable and/or adjustable resistance.

Some disclosed embodiments involve an exercise interface mechanically connected to the load mechanism. An exercise interface refers to a mechanical linkage for use between a user and a load mechanism of an exercise machine. An exercise interface may be configured for manipulation and/or handling by a user exerting an exercise force, and may transfer exercise forces applied by the user to at least partially overcome a load of the load mechanism. An exercise interface may include one or more accessories, such as a handle, ring, paddle, rope, ball, bar, chain, strap, loop, and/or cuff. Mechanically connected refers to physically linked and/or attached (or adapted for the same). An exercise interface may mechanically connect to a load mechanism via a cable, chain, rod, and/or any other type of mechanical connection. For example, a distal end of an exercise interface may be physically attached to a first end of a cable, e.g., via a metal ring, and a proximal end of the exercise interface may be configured for engagement by a user. The second end of the cable may be connected to a weight stack or resistance motor. Exercise forces applied by a user maneuvering the proximal end of the exercise interface may be transferred via the cable, causing elevation of the weight stack or rotation of the resistance motor.

In some disclosed embodiments, the exercise interface is configured to permit a user to exert a counterforce to a load exerted by the load mechanism. To exert a counterforce refers to applying and/or wielding effort and/or power for resisting and/or overcoming a load. A load exerted by a load mechanism refers to resistance applied by the load mechanism against a force exerted by a user. An exercise interface configured to permit a user to exert a counterforce to a load exerted by a load mechanism refers to an exercise interface connected to the load mechanism and arranged in a manner to permit engagement with the user. For example, such an exercise interface may include a handle, ring, bar, ball, rope, pedal, paddle, and/or lever for engagement with a human body (e.g., a hand, arm, head, neck, waist, leg, and/or foot), allowing the user to exert a pushing, pressing, and/or pulling force that may be at least partially resisted by the load mechanism via the cable. Mechanical motion may occur when a counterforce exerted by the user is greater than a load exerted by the load mechanism. Such mechanical motion may include rotation of a resistance motor, elevation of a weight stack, compression of a spring, extension of a band, and/or any other type of mechanical motion.

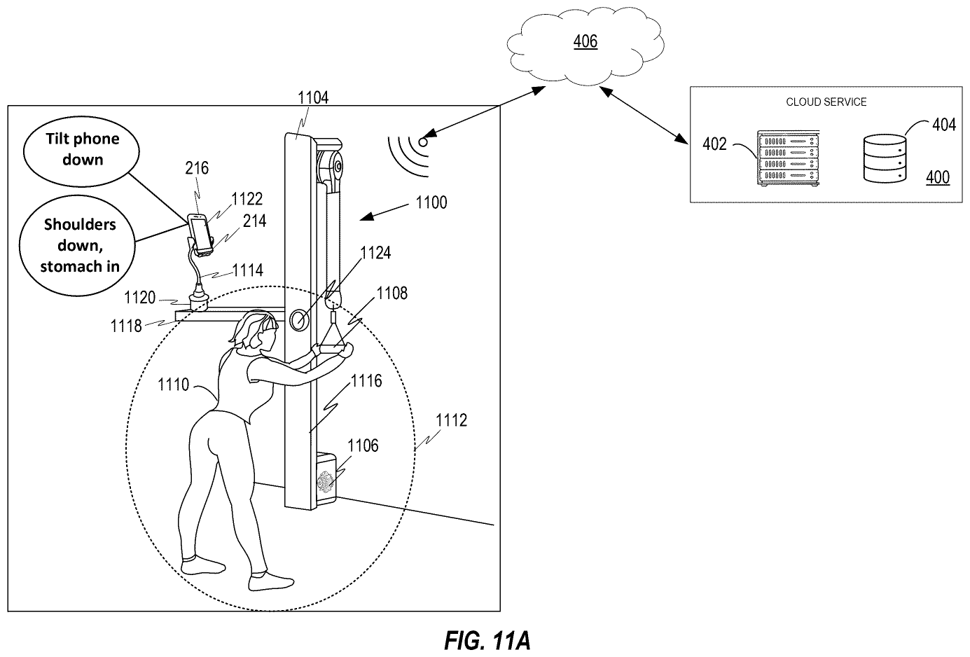

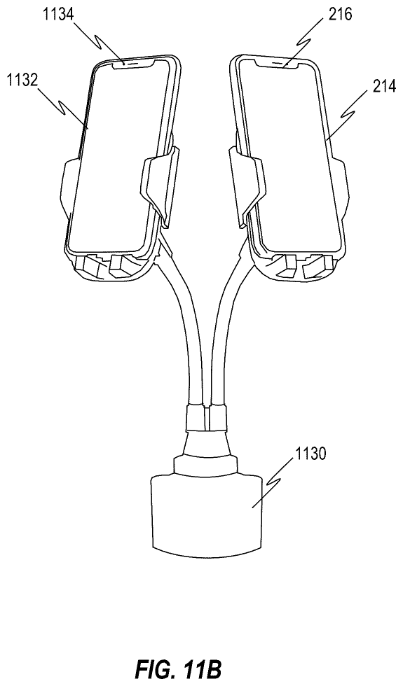

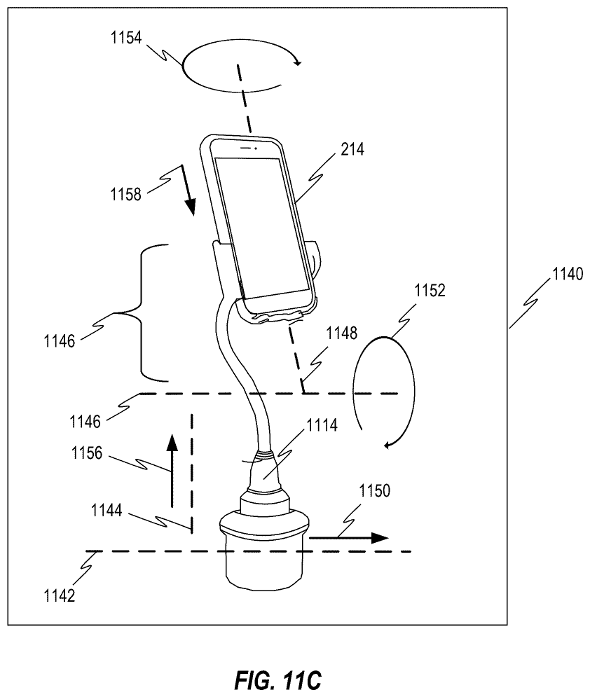

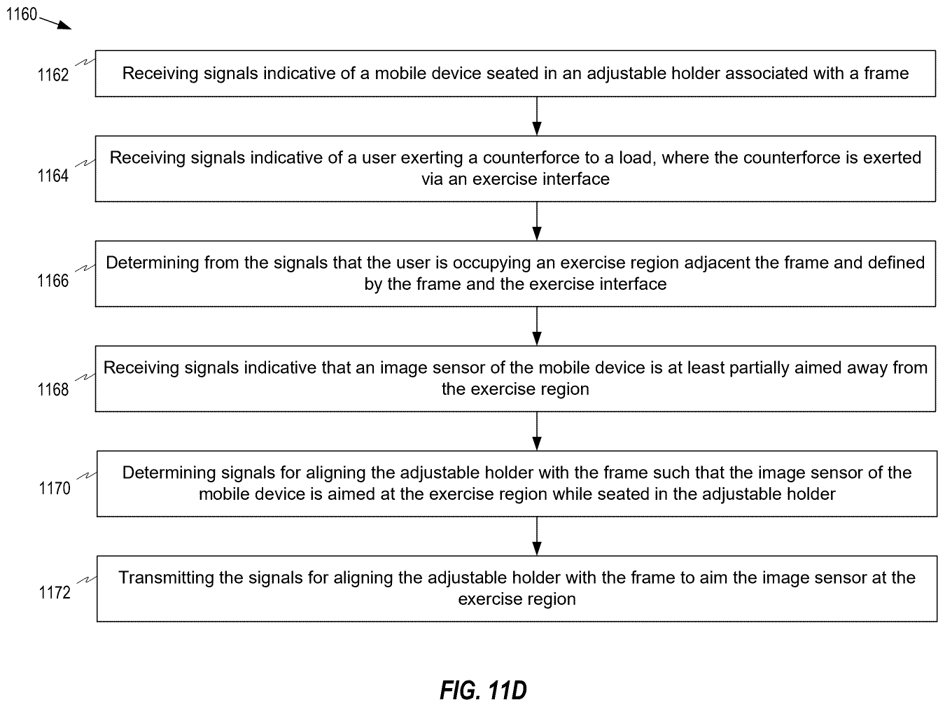

By way of a non-limiting example, reference is made to FIG. 11A, which is a perspective view of an exercise machine 1100 with an integrated holder 1120 for mobile communications device 214, consistent with disclosed embodiments. Exercise machine 1100 may correspond to (e.g., may be structurally and functionally similar to) electronic exercise machine 200 in FIG. 2. Holder 1120 may be integrally formed with exercise machine 1100, and/or may connect to exercise machine 1100 using one or more clamps, brackets, screws, and/or bolts. Exercise machine 1100 may include a frame 1104 (e.g., including at least one vertical wall-mountable beam), a load mechanism 1106 associated with frame 1104, and an exercise interface 1108 mechanically connected to load mechanism 1106 (e.g., via cable 204 in FIG. 2). Exercise interface 1108 may permit a user 1110 to exert a counterforce to a load exerted by load mechanism 1106.

In some disclosed embodiments, the frame and the exercise interface are configured to define an exercise region adjacent the frame for occupation by the user exerting the counterforce. To define, as used herein, may include to encompass, delimit, bound, and/or demarcate. An exercise region refers to a physical area and/or space where a user may be positioned when performing exercise exertions. Adjacent refers to nearby, bordering, next to, and/or in a vicinity of something. For occupation by a user refers to filling by the physical presence of the user. Thus, a frame of an exercise machine and an exercise interface may demarcate a region for a user to stand, sit, and/or lie down while manipulating an exercise interface to perform physical exertions. When a user is located outside the exercise region, the user may fail to reach the exercise interface, and/or may be required to assume a form and/or posture that may lead to strain and/or injury while engaging with the exercise interface, and/or may fail to engage one or more targeted muscles. Ensuring that a user is located inside the exercise region may permit the user to engage with the exercise interface and exert counterforces to a load mechanism while assuming a form and/or posture to avoid injury and to permit engaging one or more targeted muscles.

Some disclosed embodiments involve an adjustable holder for a mobile communications device. An adjustable holder refers to a moveable and/or adaptable holder (as described earlier) for supporting a mobile communications device. An adjustable holder for a mobile communications device may be manipulated to accommodate differing orientations and/or directions to ensure that a mobile communications device positioned therein remains stable, accessible, and properly aligned for image sensor-based monitoring and/or control throughout an exercise session. An adjustable holder for a mobile communications device may include a base for anchoring the holder to a frame of an exercise machine and/or an associated shelf, and a support for securing the position of the mobile communications device. The support may include a cradle and/or dock, and may include locking mechanisms such as screws, rivets, and/or quick-release levers to affix the mobile communications device firmly during use. In some embodiments the support may be cushioned and/or lined for device protection. An adjustable holder for a mobile communications device may additionally include one or more joints, hinges, flexible rods, telescopic arms, sliding rails, and/or extendable clamps permitting pivoting, tilting, and/or rotation of a mobile communications device seated therein to modify the orientation for optimal viewing and/or tracking, for accommodating varying device sizes, and/or for adjusting a distance of the mobile communications device to an exercise region.

In some disclosed embodiments, the adjustable holder is associated with the frame. An adjustable holder associated with a frame refers to an adjustable holder associated or associable with the frame, and positionable in relation to the frame. The adjustable holder may be mechanically connected to the frame, configured for connection to the frame, and/or mounted adjacent the frame (e.g., on a shelf and/or bracket mounted in proximity and/or connected to the frame). The association of the adjustable holder with a frame of an exercise machine may permit a camera or image sensor of a mobile communications device positioned in the adjustable holder to capture images of a user exercising using the exercise machine.

In some disclosed embodiments, the adjustable holder is configured to align with the frame to aim an image sensor of the mobile communications device such that when the mobile communications device is seated in the adjustable holder while aligned with the frame, the image sensor is aimed at the exercise region. An image sensor refers to a device capable of detecting and converting optical signals in the near-infrared, infrared, visible, and ultraviolet spectrums into electrical signals. Examples of image sensors may include digital cameras, phone cameras, semiconductor Charge-Coupled Devices (CCDs), active pixel sensors in Complementary Metal-Oxide-Semiconductor (CMOS), or N-type metal-oxide-semiconductor (NMOS, Live MOS). In some embodiments, an image sensor may be integrated with a transmitter for transmitting electric signals, associated with detected optical signals, to at least one processor. To align an adjustable holder with a frame refers to orient and/or arrange an adjustable holder in relation to the frame such that a position and/or orientation of the adjustable holder is coordinated with the position and/or orientation of the frame. To aim an image sensor of a mobile communications device refers to point, direct, and/or focus the image sensor of the mobile communications device. When the mobile communications device is seated in the adjustable holder while aligned with the frame refers to during a time that the mobile communications device is placed, lodged, and/or ensconced in the adjustable holder while the adjustable holder is oriented in relation to the frame. An image sensor aimed at an exercise region refers to an image sensor oriented and/or directed to the exercise region, such that images captured by the image sensor include the exercise region. For example, an adjustable holder may be maneuvered relative to the frame, such that when a mobile communications device is seated in the adjustable holder, an associated image sensor may capture images of an exercise region adjacent the frame.

By way of a non-limiting example, in FIG. 11A, frame 1104 and exercise interface 1108 may define an exercise region 1112 adjacent frame 1104 for occupation by user 1110 exerting the counterforce on load mechanism 1106. Exercise machine 1100 may include an adjustable holder 1114 for mobile communications device 214. Adjustable holder 1114 may be associated with frame 1104. Adjustable holder 1114 may align with frame 1104 to aim image sensor 216 of mobile communications device 214 such that when the mobile communications device 214 is seated in adjustable holder 1114 while aligned with frame 1104, image sensor 216 may be aimed at exercise region 1112 and/or arranged to be able to capture images of exercise region 1112.

Some disclosed embodiments involve at least one processor configured to transmit signals for aligning the adjustable holder with the frame. At least one processor and signals may be understood as described elsewhere in this disclosure. To transmit signals refers to sending and/or conveying signals, for example using a transmitter, as described elsewhere in this disclosure. Signals for aligning the adjustable holder with the frame refers to signals carrying information that may be used to orient the adjustable holder relative to the frame. Aligning the adjustable holder thus may focus a camera of a mobile communications device seated in the adjustable holder to point to an exercise region at least partially defined by the frame. Additionally or alternatively, the signal may convey instructions for aligning the adjustable holder so that an image sensor on a device held by the adjustable holder may capture an exercise region. Such signals may convey textual instructions on the device itself (e.g., “move the device to point the camera toward the exercise region,” “move the device up and to the right”); the signals may convey directionality arrows on the device itself to aid in adjustment, and/or the signals may convey the same or similar information audibly. In addition, the signals may cause the device to display a current image from the image sensor to aid a user in making orientational adjustments.

By way of a non-limiting example, in FIG. 11A, at least one processor (e.g., corresponding to processor 102 in FIG. 1 and associated with mobile communications device 214, exercise machine 1100 and/or cloud service 400) may transmit signals for aligning adjustable holder 1114 with frame 1104.

In some disclosed embodiments, the frame includes a main body and a shelf extending from the main body, and wherein the holder is associated with the shelf. A main body refers to a primary structural component of an exercise machine. A main body may provide strength, stability, and/or support for a user, a load, and/or one or more moveable mechanisms connected to the main body during performance of exercise activities. A main body may anchor and/or house a cable associated with a motor and may serve as a foundation for supporting additional components, such as a shelf, holders, and/or hooks for supporting accessories. A shelf extending from a main body refers to a ledge and/or surface projecting and/or protruding from the main body. For example, a main body may include one or more vertically aligned pillars and/or columns, and a horizontally aligned shelf may be connected to the one or more vertically aligned pillars using an attachment mechanism as described above. In some embodiments, an exercise machine having a main body and a shelf extending therefrom may include a T-shaped wall mountable exercise machine, where the “T-shape” may be oriented sideways. In some embodiments, a main body may include a plank, one or more beams, a platform, and/or any other type of structural component. A holder associated with a shelf refers to a holder that is attached or attachable to the shelf. The holder may include an attachment mechanism as described above, permitting attachment of the holder to the shelf.

In some disclosed embodiments, the holder is configured to support the mobile communications device. To support a mobile communications device refers to holding, securing, stabilizing, and/or bracing a mobile communications device. For example, a holder may support a mobile communications device in an orientation for aiming an image sensor in a particular direction. The holder may support the mobile communications device in an vertical (e.g., portrait) and/or horizontal (e.g., landscape) orientation, at a particular position (e.g., vertical, horizontal, and/or depth position), at an upwards or downwards tilt relative to a horizontal axis, at an angle relative to a vertical axis (e.g., straight ahead, rightwards, or leftwards), at an angle relative to a depth axis (e.g., rotated clockwise or counterclockwise) and/or any other position and/or orientation. The holder may secure and/or lock the mobile communications device in a particular position and/or orientation to cause an exercise region to be located within a field of view of the image sensor and thereby permit capture of images of the exercise region. A field of view refers to an observable area, images of which may be captured by an image sensor. A field of view may include a portion of a scene that is visible through a camera lens. Adjusting a position and/or angle of an image sensor may change the field of view, allowing the image sensor to include more or less of the surrounding area in its images. A wider field of view may capture a broader scene, while a narrower field may focus on a smaller, more specific area.

By way of a non-limiting example, in FIG. 11A, frame 1104 may include a main body 1116 and a shelf 1118 extending from main body 1116. Adjustable holder 1114 may be associated with shelf 1118. For example, adjustable holder 1114 may be integrally formed with shelf 1118 and/or may be connected to shelf 1118 using an attachment mechanism as described above. In some embodiments, adjustable holder 1114 may support mobile communications device 214.

In some disclosed embodiments, the holder is configured to accommodate a plurality of different mobile communications devices. A plurality of different mobile communications devices refers to two or more mobile communications devices. Some examples of mobile communications devices may include a mobile phone (e.g., a smartphone), a tablet, a laptop, an e-reader, a fitness tracker, a wearable device, a personal digital assistant (PDA), a portable media player (PMP), and/or a digital camera. A holder configured to accommodate a plurality of different mobile communications devices may include a plurality of cradles, clamps, docks, or other grasping devices each for holding one of the plurality of devices. For example, such a holder may concurrently support two different mobile communications devices, permitting concurrently aiming image sensors of the two mobile communications devices at the same exercise region, and concurrent image acquisition of the exercise region from two or more perspectives for stitching together to construct three-dimensional images of the exercise region. This may permit rendering three-dimensional images and/or videos of a user performing exercise routines while occupying the exercise region. Additionally or alternatively, the holder may permit concurrent support of and/or charging of two different mobile communications devices while a user performs exercise routines.

By way of a non-limiting example, reference is made to FIG. 11B which is a perspective view of an adjustable holder 1130 for a plurality of mobile communications devices 214 and 1132 for use with exercise machine 1100 of FIG. 11A, consistent with some disclosed embodiments. Mobile communications device 1132 may correspond to (e.g., may be structurally and functionally similar to) mobile communications device 214 and may include an image sensor 1134 corresponding to image sensor 216. Adjustable holder 1130 may include adjustable arms 1136 and 1138 (e.g., including flexible wires and/or chords) which may be manipulated to cause image sensors 216 and 1134 to point to exercise region 1112 in FIG. 11A. In some embodiments, at least one processor (e.g., processor 102 in FIG. 1 associated with exercise machine 1100 and/or cloud service 400) may use images acquired using image sensors 216 and 1134 to generate three-dimensional images for tracking user 1110 performing exercises.

Some disclosed embodiments involve a charger for charging the mobile communications device when the mobile communications device is seated in the holder. A charger for charging the mobile communications device refers to a connection for providing power to recharge a battery of a mobile electronic device such as a smartphone, tablet, smartwatch, headphone, laptop, a portable media player, and/or any other mobile electronic device. A charger may allow a user to replenish the power in a mobile device. The charger may be wireless or wired. The charger may be integrated and/or incorporated with a holder and/or an associated shelf. For example, a shelf and/or holder associated therewith may include one or more of a built in charging antenna, USB port(s), USBC ports, lightening ports, power outlets or any other wired or wireless electronic connection. The charger may be coupled to a wall outlet and/or to a power supply of the exercise machine. When the mobile communications device is seated in the holder refers to during the time that the mobile communications device is supported by the holder. Seating a mobile communications device in a holder may cause a charging port of the mobile communications device to engage with an electrical port of a charger, permitting electrical energy to flow from the charger to a battery of the mobile communications device. In some embodiments, a holder may include a plurality of chargers for concurrently charging a plurality of mobile communications devices.

By way of a non-limiting example, in FIG. 11A, exercise machine 1100 may be associated with a charger 1120 for charging mobile communications device 214 when mobile communications device 214 is seated in adjustable holder 1114. Charger 1120 may be integrated with adjustable holder 1114 and may connect to a power supply associated with exercise machine 1100. The power supply may include a wall outlet connected to an electrical grid and/or a battery included in exercise machine 1100.

In some disclosed embodiments, the exercise machine is an electronic exercise machine configured to pair with the mobile communications device to thereby enable control of the electronic exercise machine via the mobile communications device. An electronic exercise machine may be understood as described elsewhere in this disclosure. Pairing may involve establishment of a wireless communications channel between two or more devices for enabling bidirectional data transfer. Pairing an electronic exercise machine with a mobile communications device may involve implementation of a discovery stage, a connection protocol, and/or an authentication protocol. Some technologies for enabling pairing of an electronic exercise machine with a mobile communications device may include Bluetooth and Near Fields Communication NFC) technology. Pairing may permit a mobile communications device to receive signals, indicative of cable and/or motor motion caused by exercise movements, from a processor associated with the electronic exercise machine, and/or permit a processor of the exercise machine to receive user inputs and/or image data acquired via the mobile communications device. To enable control of an electronic exercise machine via a mobile communications device may include permitting regulation and/or control of the electronic exercise machine using a processor of the mobile communications device. Control of the exercise machine may include one or more of switching the electronic exercise machine on/off, increase/decrease a resistance level, switching a mode of use, a timing, a schedule, and/or controlling any other operational aspect of the electronic exercise machine. For example, at least one processor of a mobile communications device may receive input to control an exercise machine from a user via a user interface (e.g., a touchscreen, microphone, and/or any other user interface) and/or determine signals for controlling the exercise machine based on one or more user preferences and/or a history. The at least one processor may use the user input and/or determined signals to transmit control signals to at least one processor of the exercise machine for controlling the exercise machine via the pairing. The at least one processor of the exercise machine may apply the control signals to control the exercise machine.

By way of a non-limiting example, in FIG. 11A, exercise machine 1100 may be an electronic exercise machine (e.g., including load mechanism 1106 corresponding to motor 202) paired with mobile communications device 214. The pairing may enable user 1110 and/or at least one processor (e.g., associated with mobile communications device 214 and/or cloud service 400) to control electronic exercise machine 1100 via mobile communications device 214. For example, user 1110 may utter a voice command “Reduce Resistance by 10 kg” detectable by a microphone (e.g., audio sensor 312 in FIG. 3) integrated with mobile communications device 214. At least one processor (e.g., processor 102 in FIG. 1 associated with mobile communications device 214, cloud service 400, and/or electronic exercise machine 1100) may analyze an audio signal generated by the voice command and determine signals to apply the voice command to electronic exercise machine 1100, e.g., by transmitting signals to motor 202 for reducing the resistance applied by motor 202 by 10 kg. In some embodiments, at least one processor may use artificial intelligence to interpret a voice command uttered by user 1110 for determining a signal to control the operation of exercise machine 1100. Additionally or alternatively, user 1110 may input a command using a touchscreen interface 1122 of mobile communications device 214.

In some disclosed embodiments, the exercise machine is an electronic exercise machine configured to pair with the mobile communications device and to receive images from the image sensor for use in connection with an exercise regime. To receive images from an image sensor refers to gaining access to and/or obtaining visual data captured by the image sensor. The images may include individual snapshots and/or a video stream. At least one processor associated with the electronic exercise machine may receive the images in real time, and/or following a delay. An exercise regime refers to a plan and/or program of physical activities intended to improve fitness, health, strength, endurance, flexibility, and/or any other physical capacity. An exercise regime may include a schedule and/or routine that outlines specific types and/or sequences of exercise to be performed, at a specified intensity, duration, and/or frequency. An exercise regime may include periods for resting, stretching, hydrating, breathing, and/or meditating. Some examples of exercise regimes may include stretching, aerobic exercise, resistance training, cardiovascular workouts, flexibility exercises, and/or sport-specific drills. For use in connection with an exercise regime may refer to implementing and/or applying to an exercise regime. For example, at least one processor may use the images to identify types of exercises included in the exercise regime and provide feedback for improving implementation of the identified exercise types, e.g., by providing guidance to improve a posture, form, pace, breathing, and/or any other type of improvement. As another example, at least one processor may use the images to provide feedback for pacing the user performing an exercise regime, e.g., by transmitting an audio file for counting repetitions. As a further example, at least one processor may use the images to provide guidance to adjust one or more setting of the electronic exercise machine, such as a height, angle, and/or horizontal position of an exercise interface.

In some disclosed embodiments, the use includes monitoring exercise movement. Monitoring exercise movement refers to detecting, tracking, and/or analyzing physical actions and/or postures undertaken by a user while exercising. Monitoring may occur over a time period, and may include continual acquisition and analysis of image data over the time period using one or more image sensors. At least one processor associated with an electronic exercise machine may receive image data (e.g., a live video stream) of a user interacting with an exercise interface connected to a load mechanism from an image sensor of a mobile communications device via a paired connection. The at least one processor may monitor exercise movements by analyzing the images using image processing and/or motion tracking techniques to identify one or more characteristics of exercise movement, such as a form, a posture, and/or position of a user, an exercise movement type, a pace, a speed, an exertion level, a strain, a number or repetitions and/or sets, a range of motion, an alignment, consistency of movements, and/or any other characteristic of an exercise movement. In some embodiments, monitoring may additionally include acquisition and/or analysis of motion data acquired using one or more motion sensors (e.g., integrated with a wearable device). The at least one processor may use results of the monitoring to identify one or more pointers and/or tips for improving an exercise movement, for example, by comparing the identified characteristics to one or more reference and/or benchmark metrics stored in memory. In some embodiments, at least one processor may provide one or more identified pointers and/or tips to the user as feedback, e.g., as audio, video, and/or text data. In some embodiments at least one processor may additionally or alternatively receive biometric data from a user performing exercise movements from one or more biometric sensors (e.g., included in a wearable device) and use the biometric data to monitor exercise movements of the user.

By way of a non-limiting example, in FIG. 11A, exercise machine 1100 may be an electronic exercise machine (e.g., corresponding to electronic exercise machine 200 in FIG. 2) paired with mobile communications device 214. At least one processor (e.g., processor 102 in FIG. 1 associated with exercise machine 1100 and/or cloud service 400) may receive images from image sensor 216 for use in connection with an exercise regime performed by user 1110. In some embodiments, the use may include monitoring exercise movements by user 1110. For example, at least one processor may use the images to track how many repetitions and/or sets have been completed by user 1110 and at what pace. Additionally or alternatively, at least one processor may use the images to assess a posture and/or position of user 1110 relative to exercise interface 1108 and/or exercise machine 1100. The at least one processor may use the images to provide feedback to user 1110, e.g., to track a count of completed repetitions, pace a set of repetitions, correct a posture, and/or positioning of user 1110 (e.g., to move closer to exercise machine 1100 and/or straighten a posture). At least one processor may provide the feedback via a user interface associated with mobile communications device 214 and/or a user interface 1124 of exercise machine 1100, e.g., as audio, visual, multimedia, text, and/or haptic feedback.

In some disclosed embodiments, the use includes providing instructions to the user. Instructions to a user may include directions, guidelines, recommendations, and/or procedures for following by the user. Such instructions may include, for example, a recommendation to adjust a component of an exercise machine, e.g., to manually adjust a resistance and/or timing setting for a resistance motor, a positions and/or alignment for a mechanical component of the exercise machine (e.g., to raise, lower, and/or rotate an exercise interface), to adjust a position and/or posture of the user, to modify a pace, a number and/or type of exercise repetitions, and/or any other type of instruction. Such instructions may additionally include a warning to avoid injury and/or over-exertion, a reminder to hydrate, stretch, rest, and/or breathe. In some embodiments, at least one processor may continually receive image data for continually monitoring the user for providing feedback to the user. For instance, upon providing instructions to a user to correct a posture, at least one processor may use image data to determine if the instructions were fulfilled and provide feedback to the user based on the determination.

In some disclosed embodiments, the use includes altering the exercise regime. Altering an exercise regime refers to changing and/or modifying the exercise regime. Altering an exercise regime may include adding, removing, and/or replacing one or more exercise movement types included in the exercise regime, increasing or decreasing a number of repetitions and/or sets for one or more exercise movement types, increasing or decreasing a pace for performing the exercise regime, introducing one or more rest and/or stretching intervals to the exercise regime, and/or increasing or decreasing a resistance level for one or more exercise movement types. Altering an exercise regime may additionally include modifying a sequence and/or combination of exercise movements, e.g., to target different muscle groups and/or improve variety, increasing or decreasing a total duration for the exercise regime, altering a positions and/or posture of the user, and/or any altering any other aspect of an exercise regime.

By way of a non-limiting example, in FIG. 11A, the use may include providing instructions to user 1110. For example, upon analyzing images acquired by image sensor 216 of mobile communications device 214, at least one processor (e.g., processor 102 in FIG. 1 associated with mobile communications device 214, exercise machine 1100, and/or cloud service 400) may determine instructions based on the analysis and transmit signals for causing a speaker (e.g., speaker 326 in FIG. 3) to audibly present the instructions to user 1110. For example, the instructions may include a recommendation to user 1110 to adjust a posture (e.g., “Shoulders down, stomach in”) and/or a location relative to exercise interface 1108, e.g., to reduce strain and/or focus on a particular muscle group, and/or to center user 1110 in a field of view of image sensor 216. As another example, the instructions may audibly pace and/or coach user 1110 while performing exercise repetitions. In some embodiments, the use may include altering an exercise regime. At least one processor may use images received from mobile communications device 214 to determine alterations to an exercise regime, such as by adding a new exercise type and/or removing a previously scheduled exercise type. For example, at least one processor may use the images to determine that a particular exercise type is too easy/difficult, and may determine recommendations for alterations that increase/decrease the difficulty of the particular exercise type. The at least one processor may transmit signals for causing a speaker (e.g., speaker 326 in FIG. 3) to audibly present the recommendations to user 1110.

In some disclosed embodiments, at least one processor is further configured to transmit signals for adjusting at least one image capture characteristic. An image capture characteristic refers to an attribute associated with acquisition of image data. Some examples of image capture characteristics may include timing of image capture, exposure, shutter speed, frame rate, field of view, saturation, depth of view, and/or selection of one or more particular image sensors from a plurality of available images sensors. For example, at least one processor may receive data indicating a current orientation and position of an image sensor of a mobile communications device relative to an exercise region. The data may include captured images, user inputs via touchscreen, motion data, and/or any other type of data. The at least one processor may analyze the data to determine if the image sensor is partially or fully aimed away from the exercise region. The at least one processor may perform an optical analysis by simulating one or more optical paths to reference the spatial arrangement between the mobile communications device, the adjustable holder, and the exercise region. The at least one processor may calculate one or more adjustments, such as directions and/or extents of rotational angles and/or directions and/or distances of translational movements for centering the field of view. The at least one processor may generate guidance signals and/or visual cues to help a user reposition the mobile communications device, which when implemented, may permit the image sensor to capture the exercise region while remaining securely seated in the adjustable holder.

In some disclosed embodiments, the at least one image capture characteristic includes an alignment of the adjustable holder with the frame. An alignment of an adjustable holder with a frame refers to an orientation and/or position of the adjustable holder relative to the frame of the exercise machine. Aligning an adjustable holder with respect to a frame may include arranging the adjustable holder such that the relative positions, orientations, and/or reference points on the adjustable holder and frame correspond to a desired configuration. For example, a reference point on an adjustable holder for a mobile communications device may coincide with an image sensor of a mobile communications device seated therein, such that adjusting an alignment of the holder relative to the frame causes a corresponding alignment of the image sensor. An alignment of an adjustable holder relative to a frame may be adjusted with respect to a depth axis (e.g., movement in the forward or backwards directions along a X-axis), a horizontal axis (e.g., movement in the left or right directions along an Y-axis), a vertical axis (e.g., movement in the up or down directions along a Z-axis), a pitch (e.g., rotation about the X-axis), roll (e.g., rotation about the Y-axis), yaw (e.g., rotation about the Z-axis). Adjusting an adjustable holder may thus modify an angle of the adjustable holder relative to the reference axis associated with the frame, and/or a distance between a reference point on the adjustable holder and a reference point on the frame. To this end, an adjustable holder may include and/or be associated with one or more tracks and/or telescopic arms to permit linear translation along any of the X-axis, Y-axis, or Z-axis, and/or rotary or pivot components to permit rotation about any of the X-axis, Y-axis, or Z-axis. Such rotary components may include one or more flexible and/or bendable rods, hinges, bearings, axles, and/or any other type of rotatable component. The alignment of the adjustable holder with the frame may affect a field of view, focus, illumination, presence or absence of shadows and/or obstructions, a perspective, and/or any other image capture attribute of a camera associated with a mobile communications device seated in the adjustable holder.

By way of a non-limiting example, in FIG. 11A, at least one processor (e.g., processor 102 in FIG. 1 associated with mobile communications device 214, exercise machine 1100, and/or cloud service 400) may transmit signals for adjusting at least one image capture characteristic of image sensor 216 of mobile communications device 214. The signals may cause a visual and/or audible presentation of instructions to user 1110 via mobile communications device 214 and/or user interface 1124 of exercise machine 1100 to implement the adjustments. In some embodiments, the at least one image capture characteristic includes an alignment of adjustable holder 1114 with frame 1104.

By way of another non-limiting example, reference is made to FIG. 11C, which is a front view 1140 of touchscreen interface 1122 of mobile communications device 214 depicting guidelines for adjusting an image capture characteristic for an image sensor, consistent with disclosed embodiments. At least one processor (e.g., processor 102 in FIG. 1 associated with mobile communications device 214, exercise machine 1100, and/or cloud service 400) may transmit signals for causing view 1140 to be displayed on touchscreen interface 1122 of mobile communications device 214. Front view 1140 may include a virtual depiction of adjustable holder 1114 supporting mobile communications device 214 and one or more guidelines, markers and/or cues for adjusting at least one image capture characteristic of image sensor 216 of mobile communications device 214. For example, the guidelines may include one or more virtual axes 1142, 1144, 1146, and 1148, and/or one or more virtual arrows 1150, 1152, 1154, 1156, and 1158 indicating translational and/or rotational motions for implementing on mobile communications device 214 and/or adjustable holder 1114. In some embodiments, the at least one image capture characteristic may include an alignment of adjustable holder 1114 with frame 1104 of FIG. 11A. At least one processor may transmit signals to cause virtual axis 1144 and virtual arrow 1156 to be displayed on touchscreen interface 1122 of mobile communications device 214 to guide user 1110 to extend a height of adjustable holder 1114 (e.g., using an associated telescopic mechanism) and modify an alignment of an upper portion of adjustable holder 1114 with frame 1104. Adjusting the upper portion of adjustable holder 1114 thus may adjust an alignment of image sensor 216 of mobile communications device 214 seated in the upper portion of adjustable holder 1114 with frame 1104.

In some disclosed embodiments, the signals include recommendations to a user to adjust at least one of an angle of the adjustable holder relative to the frame, a physical positioning of the adjustable holder relative to the frame, or a location for seating the mobile communications device within the adjustable holder. An angle of an adjustable holder relative to a frame refers to an orientation of the holder positioned relative to the frame of the exercise machine. An angle of an object relative to another object may describe a tilt, incline, pitch, roll, and/or yaw, and/or lack thereof relative to one or more references axes corresponding to a vertical, horizontal, and/or depth direction. Recommendations to adjust an angle of an adjustable holder may include guidelines and/or cues to rotate and/or pivot the adjustable holder about one or more reference axes. Adjusting an angle of a holder for a mobile communications device may cause a corresponding adjustment to an image sensor of the mobile communications device seated therein, and may alter a field of view, focus, illumination, presence or lack of obstructions and/or shadows, and/or any other image sensing characteristic of the image sensor. The recommendations may include a specific angle and/or direction of rotation (e.g., measured in degrees) and/or a specific translation and/or direction (e.g., measured in centimeters or inches).

A physical positioning of an adjustable holder relative to a frame refers to a spatial arrangement and/or orientation of the adjustable holder with respect to the frame of the exercise machine. A physical positioning may include a distance between an adjustable holder and one or more references points on the frame, and/or a relative tilt between the adjustable holder an axis of the frame. Adjusting a physical positioning of an adjustable holder relative to a frame may cause a corresponding adjustment to an image sensor of a mobile communications device seated therein, and may alter a field of view, focus and/or any other image sensing characteristic of the image sensor. Recommendations to adjust a positioning of an adjustable holder relative to a frame may include guidelines to move the holder closer or further from the frame (e.g., by sliding the holder horizontally along a shelf), raise or lower the holder relative to a reference point on the frame (e.g., using a telescopic arm), move the holder forwards or backwards relative to a reference point on the frame (e.g., using a spring), and/or remove the holder from a current mounting position to a different mounting position relative to the frame. Adjusting a physical positioning of the holder relative to a frame of an exercise machine may improve image capture by an image sensor of a mobile communications device seated in the holder, improve accessibility and/or reduce strain of a user interacting with the mobile communications device seated in the holder, and/or ensure that the mobile communications device remains stable and/or secure during exercise to reduce risk of damage.

A location for seating a mobile communications device within an adjustable holder refers to a position, orientation, and/or spatial arrangement of the device when placed into the holder. Recommendations to adjust a location for seating a mobile communications device within a holder may include guidelines for translational and/or rotational adjustments along and/or about a vertical, horizontal, and/or depth axis relative to the holder. For example, the recommendations may include guidelines for sliding, tilting, rotating, or repositioning the device within the holder, e.g., to position an image sensor of the mobile communications device for a particular exercise type and/or user height. Adjusting a location for seating a mobile communications device in the holder may adjust a position and/or orientation of an associated image sensor e.g., to direct image capture towards an exercise region without having to adjust a position and/or orientation of the holder relative to the frame, and/or to further enhance image capture of the exercise region after adjusting the position and/or orientation of the holder relative to the frame, and/or may fine tune an adjustment made to the position and/or orientation of the holder. Additionally or alternatively, adjusting a location for seating a mobile communications device based on the recommendations may improve stability of the mobile communications device may within the holder, and may ensure a secure fit within the holder, reducing movements and/or vibrations during image capture which may improve image quality, and/or reduce a risk of accidentally dropping the device. Additionally or alternatively, adjusting a location for seating a mobile communications device based on the recommendations may improve user accessibility, and may permit the user to interact with an interface of the mobile communications device while performing exercise movements. Additionally or alternatively, adjusting a location for seating a mobile communications device based on the recommendations may focus a field of view of an associated image sensor on an exercise region, reduce glare, improve image quality, reduce shadows and/or obstructions, increase pixel density of the exercise region, and/or reduce background clutter, to thereby improve image analysis for monitoring the exercise regime.

Recommendations to a user refers to guidelines, suggestions, and/or tips for implementation by the user. The recommendations may be presented visually, audibly, graphically, and/or as text, for example, on a visual display of a mobile communications device. The recommendations may include, for example, graphical features, markers, and/or cues, such as virtual axes and/or arrows, overlaid on an image (e.g., of the adjustable holder and/or of the mobile communications device) for guiding the user to adjust the holder in accordance with the recommendations. Implementation of the adjustments according to the recommendations may improve image capture by the image sensor of the mobile communications device seated in the holder, for instance by focusing the field of view on the exercise region, adjusting the field of view for a particular exercise type and/or user height, removing one or more obstructions from the field of view, reducing one or more shadows, increasing the number of pixels associated with the exercise region, and/or decreasing the number of pixels associated with content other than the exercise region. Additionally or alternatively, the adjustment may improve accessibility and/or reduce strain of a user interacting with the mobile communications device while exercising. Upon determining that the user implemented the recommended adjustments, at least one processor may transmit signals to convey the successful implementation to the user, e.g., as audio, visual, text, and/or haptic feedback. At least one processor may use improvements in image capture due to implementation of the recommended adjustment to improve tracking of an exercise regimen performed a user occupying the exercise region.

In some embodiments, at least one processor may utilize data acquired by an image sensor, an inertial measurement unit (IMU), and/or a positioning unit (e.g., Global Positioning System) associated with the adjustable holder and/or the mobile communications device to determine the recommended adjustments and/or if the user successfully implemented the recommended adjustments. For example, at least one processor may request that the user seat the mobile communications device in the adjustable holder prior to determining the recommended adjustments, and may use data acquired in real-time by an IMU and/or image sensor of the mobile communications device to determine the recommendations, and/or continually acquire data from the IMU and/or image sensor to provide feedback to the user while implementing the recommended adjustments.

For example, at least one processor may transmit signals to visually present recommendations on a visual display of a mobile communications device for translating the holder 3 cm towards the frame in the horizontal direction (e.g., bringing the holder closer to the frame), rotating the holder 10° about a horizontal direction (e.g., to tilt the holder downwards to include the entire body of the user within the field of view of the camera), rotating the holder 20° about a vertical axis (e.g., to turn the holder to the right to include the body of the user in the field of view of the camera), and extending the mobile communications device seated within the adjustable holder forwards by 2 cm.

By way of a non-limiting example, in FIG. 11C, the signals may include recommendations to user 1110 to adjust at least one of an angle of adjustable holder 1114 relative to frame 1104, a physical positioning of adjustable holder 1114 relative to frame 1104, or a location for seating mobile communications device 214 within adjustable holder 1114. For instance, virtual axis 1148 and virtual arrow 1154 displayed on touchscreen interface 1122 of mobile communications device 214 may guide user 1110 to rotate the upper portion of adjustable holder 1114 clockwise about a vertical axis by 10°, causing a corresponding rotation to camera 216 of image sensor 216 of mobile communications device 214 seated therein. As another example, virtual axis 1142 and virtual arrow 1150 displayed on touchscreen interface 1122 of mobile communications device 214 may guide user 1110 to shift adjustable holder 1114 towards frame 1104 by 2 centimeters, causing a corresponding adjustment of the physical positioning of mobile communications device 214 relative to frame 1104. As a further example, virtual arrow 1158 displayed on touchscreen interface 1122 of mobile communications device 214 may guide user 1110 to push mobile communications device 214 downwards thereby adjusting a location for seating mobile communications device 214 within adjustable holder 1114.

In some disclosed embodiments, the image capture characteristics are associated with the image sensor, and include at least one of an angle, a depth of view, or a selection of a particular image sensor from a plurality of image sensors associated with the mobile communications device. Image capture characteristics associated with an image sensor refers to attributes related to acquiring images using a camera, such as a camera associated with the mobile communications device. An angle (e.g., associated with an image sensor) refers to a direction at which the image sensor may be pointing and may define a field of view. Adjusting an angle of an image sensor may adjust the content captured by the image sensor, and may cause removal of some previously captured content and acquisition of newly captured content. A depth of view (e.g., of an image sensor) refers to one or more distances (e.g., a range of distances) within which an object may appear in focus when captured by the image sensor. A greater depth of view may permit nearby and distant objects within the exercise region to be resolved clearly in a captured image, whereas a shallower depth of view may focus attention on a narrower plane, e.g., to highlight specific movements and/or body positions. Adjusting a depth of view based on recommendations from at least one processor may improve image quality for differing types of exercises, and/or user heights, and may enhance the effectiveness of movement analysis and feedback provided by the processor.

By way of a non-limiting example, in FIG. 11A, the image capture characteristics may be associated with image sensor 216, and may include at least one of an angle, a depth of view, or a selection of a particular image sensor 216 from a plurality of image sensors associated with the mobile communications device 214.

FIG. 11D is a flowchart of an example process 1160 for aligning an adjustable holder for a mobile communications device with a frame of an exercise machine, consistent with embodiments of the present disclosure. In some embodiments, process 1160 may be performed by at least one processor (e.g., processor 102 in FIG. 1 of mobile communications device 214, exercise machine 200, and/or cloud service 400) to perform operations or functions described herein. In some embodiments, some aspects of process 1160 may be implemented as software (e.g., program codes or instructions) that are stored in a memory (e.g., memory 104) or a non-transitory computer readable medium. In some embodiments, some aspects of process 1160 may be implemented as hardware (e.g., a specific-purpose circuit). In some embodiments, process 1160 may be implemented as a combination of software and hardware.

Process 1160 may include a step 1162 of receiving first signals indicative of a mobile device seated in an adjustable holder, wherein the adjustable holder is associated with a frame. Receiving signals indicative of a mobile device seated in an adjustable holder may include obtaining and/or accessing signals (as described elsewhere herein) conveying information confirming that a mobile device is secured by an adjustable holder, as described elsewhere herein. For example, seating a mobile device in a holder may establish an electrical connection between the mobile device and the adjustable holder, causing transmission of electrical signals to at least one processor. As another example, an image sensor (e.g., associated with a frame of an exercise machine) may capture images of a mobile device seated in an adjustable holder and transmit image signals to at least one processor. By way of a non-limiting example, in FIG. 11A, at least one processor (e.g., processor 102 in FIG. 1 of mobile communications device 214, exercise machine 200, and/or cloud service 400) may receive first signals indicative of mobile device 214 seated in adjustable holder 1114. Adjustable holder 1114 may be associated with frame 1104 of exercise machine 1100.

Process 1160 may include a step 1164 of receiving second signals indicative of a user exerting a counterforce to a load exerted by a load mechanism associated with the frame of the exercise machine, wherein the counterforce is exerted via an exercise interface mechanically connected to the load mechanism. By way of a non-limiting example, in FIG. 11A, at least one processor (e.g., processor 102 in FIG. 1 of mobile communications device 214, exercise machine 200, and/or cloud service 400) may receive signals indicative of user 1110 exerting a counterforce to a load exerted by a load mechanism (e.g., load mechanism 1106) associated with frame 1104 of exercise machine 1100. For example, the at least one processor may receive the signals from a sensor associated with load mechanism 1106 and/or from image sensor 216. User 1110 may exert the counterforce via exercise interface 1108 mechanically connected to the load mechanism.

Process 1160 may include a step 1166 of determining from the second signals that the user is occupying an exercise region adjacent the frame and defined by the frame and the exercise interface. By way of a non-limiting example, in FIG. 11A, at least one processor (e.g., processor 102 in FIG. 1 of mobile communications device 214, exercise machine 200, and/or cloud service 400) may determine from the signals that user 1110 may be occupying exercise region 1112 adjacent frame 1104 and defined by frame 1104 and exercise interface 1108, e.g., based on image analysis of image data included in the signals.

Process 1160 may include a step 1168 of receiving third signals indicative that an image sensor of the mobile communications device is at least partially aimed away from the exercise region. An image sensor at least partially aimed away from an exercise region refers to an image sensor pointing in a direction other than the exercise region. For example, the arrangement of the image sensor relative to the exercise region may cause the field of view to include only a portion of the exercise region, or exclude the exercise region entirely. Consequently, images captured by the image sensor may fail to fully capture the exercise region. By way of a non-limiting example, in FIG. 11A, at least one processor (e.g., processor 102 in FIG. 1 of mobile communications device 214, exercise machine 200, and/or cloud service 400) may receive signals indicative that image sensor 216 of mobile communications device 214 is at least partially aimed away from exercise region 1112.

Process 1160 may include a step 1170 of determining fourth signals for aligning the adjustable holder with the frame such that the image sensor of the mobile communications device is aimed at the exercise region while the mobile communications device remains seated in the adjustable holder. Determining signals for aligning an adjustable holder with a frame such that an image sensor of a mobile communications device is aimed at an exercise region while the mobile communications device remains seated in the adjustable holder refers to computing signals for arranging the adjustable holder such that the image sensor of the mobile communications device seated therein points to the exercise region. Determining such signals may include receiving data indicative of a current alignment of the adjustable holder with the frame, determining a modified alignment for the adjustable holder such that images captured by the image sensor when the mobile device is seated in the frame under the modified alignment include a greater portion of the exercise region than images captured by the image sensor when the mobile device is seated in the frame under the current alignment, and determining adjustments for achieving the modified alignment. For example, at least one processor may receive captured images, user inputs via touchscreen, motion data, and/or any other type of data indicative of the current alignment of the adjustable holder with the frame. The at least one processor may use the data to perform an optical analysis and simulate one or more optical paths referencing a spatial arrangement of the adjustable holder, the image sensor of the mobile device seated in the adjustable holder, the frame, and the exercise region. The at least one processor may calculate adjustments to the current alignment of the adjustable holder that when implemented, center the exercise region in the field of view of the image sensor. The at least one processor may generate signals for instructing a user to implement the adjustments. By way of a non-limiting example, in FIG. 11A, at least one processor (e.g., processor 102 in FIG. 1 of mobile communications device 214, exercise machine 200, and/or cloud service 400) may determine signals for aligning adjustable holder 1114 with frame 1104 such that image sensor 216 of mobile communications device 214 may be aimed at exercise region 1112 while mobile communications device 214 remains seated in adjustable holder 1114. For example, in FIG. 11C, the signals may be used to display one or more of virtual axes 1142, 1144, 1146, and 1148, or virtual arrows 1150, 1152, 1154, 1156, and 1158 on touchscreen interface 1122 to guide user 1110 to implement the alignment.

Process 1160 may include a step 1172 of transmitting the fourth signals for aligning the adjustable holder with the frame to thereby aim the image sensor of the mobile communications device at the exercise region. By way of a non-limiting example, in FIG. 11A, at least one processor (e.g., processor 102 in FIG. 1 of mobile communications device 214, exercise machine 200, and/or cloud service 400) may transmit signals for aligning adjustable holder 1114 with frame 1104 to thereby aim image sensor 216 of mobile communications device 214 at exercise region 1112. For example, the signals may cause a display of virtual axes 1142, 1144, 1146, and 1148, and/or virtual arrows 1150, 1152, 1154, 1156, and 1158 on touchscreen interface 1122 to guide user 1110 to implement the alignment.

Some disclosed embodiments involve stitching together video clips of individual movements to construct a workout video. A library may store a plurality of pre-recorded video clips depicting movement segments. Different combinations of the pre-recorded video clips may be stitched together, enabling construction of an unlimited number of workout videos. Trainers may upload specific movement clips, which may be easier to record that lengthier workout videos. Executable software may be provided to select and stich different movement clips to construct a seamless workout video, and ensure smooth transitions between the various movements. The executable software may adjust the pace and/or difficulty of each workout as necessary to match a user's fitness level and goals. In some embodiments, artificial intelligence may be used to customize a workout to achieve a user's desired goal. In some embodiments, the executable software may continuously monitor a user's performance using data received from one or more sensors. The executable software may use the data to dynamically adjust a workout video during the workout, e.g., by dynamically adjusting the sequence, intensity, and/or duration of the movements in real-time to provide a personalized and adaptive workout experience. After the workout, the executable software may provide feedback on the user's performance and may suggest adjustments for future workout sessions. Additionally or alternatively, the user may manually adjust preferences based on personal experience. Such customized workouts stitched from individual movement clips may be applicable for personalized training, rehabilitation (e.g., for patients recovering from injuries who require a workout program that can be adapted to their changing physical capabilities, including avoiding or focusing on certain movements), group workouts based on common criteria, personalized gamification, and/or any other personalized workout application.

Some disclosed embodiments involve performing automated composite video construction operations. Performing refers to carrying out, executing, or doing a task or action. For example, performing operations may refer to executing, carrying out, or completing a specific operation, instruction, or set of instructions, as described and exemplified elsewhere in this disclosure. Automated refers to a characteristic of an object or thing that is associated with, involves, or utilizes automating. For example, automating may include using technology, systems, devices, or tools to perform tasks with minimal or no human intervention. Further, automating may include using a program or tool designed to carry out digital tasks on a processor without requiring a person to manually intervene and/or perform one or more steps. Construction refers to a process of creating, assembling, or building something by combining parts, materials, or components into a larger, organized whole. For example, constructing may involve assembling digital components, such as data, into a larger, cohesive product. Further, automated construction may include a process of using at least one processor to create a thing or object with minimal or no human intervention or input.

Composite refers to a characteristic of being made up of two or more distinct parts, materials, or elements combined to create a new whole. For example, a composite material may be formed by combining two or more substances. Further, composite data may include data formed by combining two or more data or variables into a single file. A video refers to a sequence of moving images that is recorded, generated, or transmitted digitally or electronically. For example, a video may include a series of still images or frames shown quickly in succession, thereby creating an illusion of motion. A video may be stored electronically as an MP4 file, a MOV file, an AVI file, a WMV file, an MKV file, an FLV file, a WEBM file, an MPEG file, or any other suitable means for storing a video electronically. A composite video may include a video formed by combining two or more shorter videos. For example, a composite video may include a single video file that includes a first video followed by a second video. Thus, performance (e.g., implementation) of automated composite video construction operations refers to constructing a composite video in an automated manner with minimal or no direct human interaction, intervention, or input.

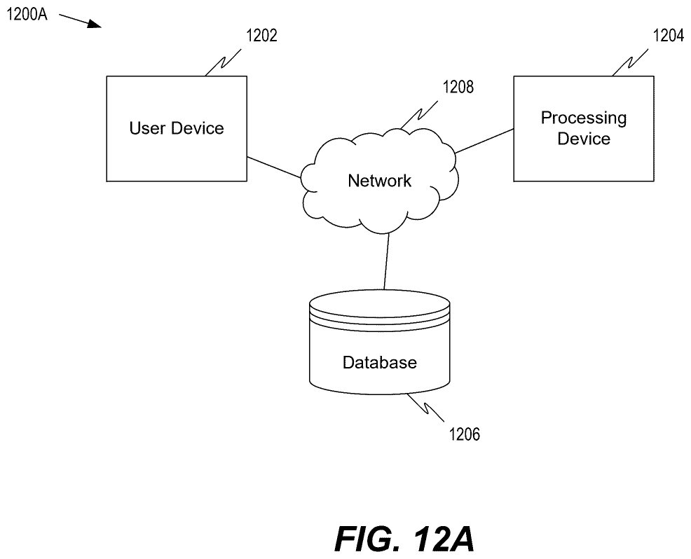

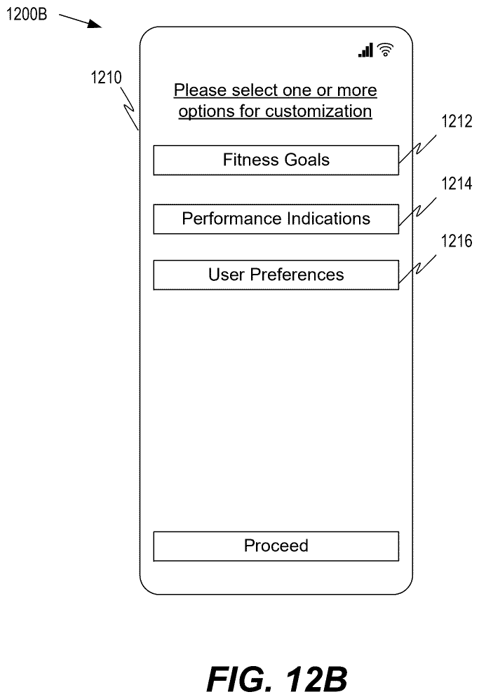

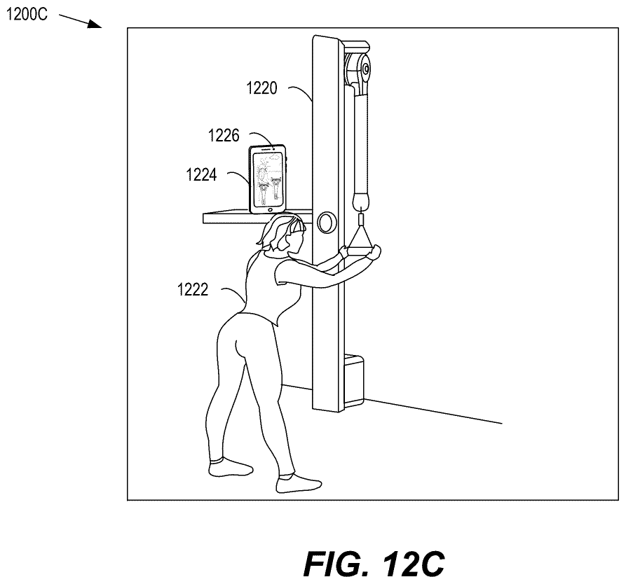

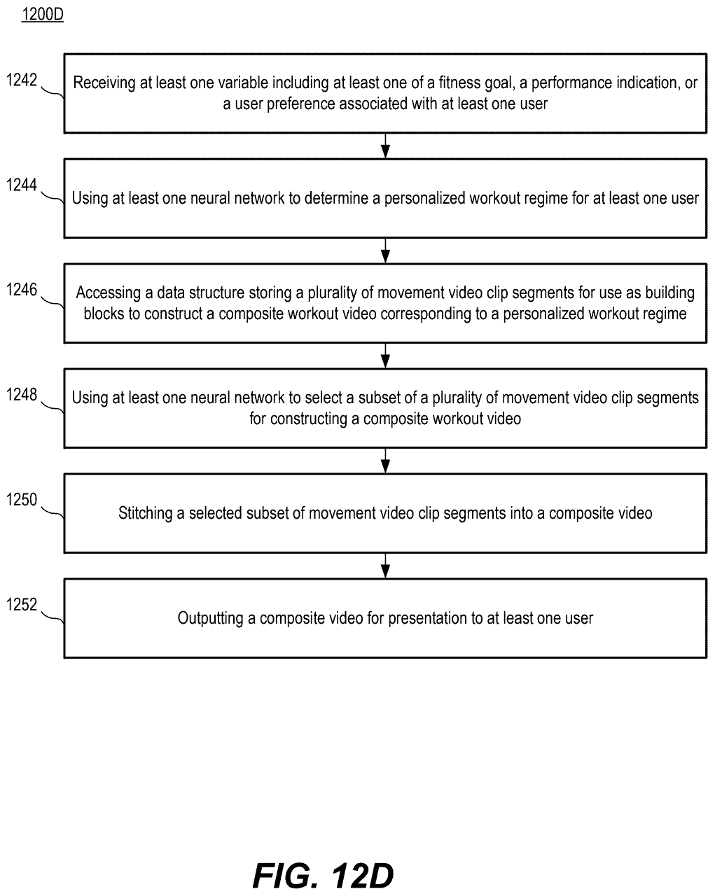

By way of non-limiting example and with reference to FIG. 12A, processing device 1204 may be configured to perform automated composite video construction operations, as further described and exemplified below.

Some disclosed embodiments involve receiving at least one variable including at least one of a fitness goal, a performance indication, or a user preference associated with at least one user. Receiving refers to refers to obtaining, acquiring, and/or otherwise gaining access to information, as described and exemplified elsewhere in this disclosure. A variable refers something that can change or vary. Examples of variables include a selection of an exercise type, an exercise routine, a resistance setting, a numerical value (e.g., a number of repetitions), a duration, or any other measure or selection associated with exercise or machine usage. For example, receiving at least one variable may include receiving a user input that causes at least one processor to create a variable. A user may interact with a device, such as a user interface associated with an exercise machine, to create or modify one or more values associated with at least one variable.

A fitness goal refers to a specific objective related to improving, maintaining, or achieving a certain level of physical health, strength, endurance, or overall well-being. For example, a fitness goal may include performing a certain number of repetitions of an exercise, a number of calories desired to be burned, a target weight or resistance associated with performance of an exercise, or any other suitable fitness goal.

A performance indication may refer to a visual and/or audible representation of an exercise movement. For example, a performance indication may include a textual representation of an exercise movement, an image of an individual performing an exercise movement, a video of an individual performing an exercise movement, or any combination of the foregoing.

A preference refers to a choice, tendency, or inclination toward one option over another. For example, a preference may be based on a personal need, a want, and/or a priority. A user refers to a person who interacts with or operates a system, device, application, or service, as described and exemplified elsewhere in this disclosure. For example, a user preference may refer to a setting or an option selected by the user to customize how a system, app, or device behaves. A user preference may include, for example, a type of exercise the user wishes to perform, a type of exercise the user does not wish to perform, a maximum desired duration of a workout, a desired muscle or muscle group to be exercised, any combination of the foregoing, or any other suitable user preference.

Additionally or alternatively, in some embodiments, a user preference may include an indication of a particular piece of exercise equipment. An indication refers to a selection, sign, symbol, or piece of information, as described and exemplified elsewhere in this disclosure. For example, an indication may include a user input or selection that conveys a user's desire. Exercise equipment refers to a tool, machine, or device designed to support or facilitate physical activity, training, or fitness exercises. For example, exercise equipment may include an exercise system including one or more components that are each configured to be used to perform one or more exercise movements. A piece refers to a unit, portion, part, or segment. Particular refers to a characteristic of being specific or distinct from others. For example, an indication of a particular piece of exercise equipment may include information signaling or specifying a specific type or item of exercise equipment that the user wants or prefers to use. For example, a user may interact with a user interface to select one or more preferred pieces of exercise equipment and/or one or more pieces of undesired pieces of exercise equipment.

Thus, receiving at least one variable including at least one of a fitness goal, a performance indication, or a user preference associated with at least one user may involve obtaining information, including one or more of preferences, desires, and goals as an input for automated composite video construction operations.

By way of non-limiting example and with reference to FIG. 12B, user device 1200B may include a display 1210 displaying a fitness goals option 1212, a performance indications option 1214, and a user preferences option 1216. A user may select an option by, for example, touching, tapping, swiping, holding, or any other suitable interaction. Responsive to receiving a user interaction at an option, user device 1200B may permit the user to enter information associated with the selected option. User device 1200B may create or modify one or more variables associated with the selected option. For example, responsive to a user inputting that a fitness goal is to perform thirty repetitions of a lateral raise exercise, user device 1200B may create a fitness goal variable indicating thirty lateral raise repetitions.

In some embodiments, at least one variable may include at least one fitness goal determined based on stored historical information about at least one user. Historical refers to a characteristic of being related to the past, to events that have already happened, and/or to the record of past events. Stored refers to a characteristic of being kept or held in a place. For example, electronically or digitally stored data may include data that is placed, retained, and/or maintained in a particular format or memory location, including, for example, a data structure or database. Information refers to data, facts, or knowledge provided or learned about something. For example, information may be stored electronically as data, including data stored in one or more data structures. Further, historical information may include any information related to or about a past event. For example, historical information about a user may include data associated with the user's past performance of one or more exercise movements.

Additionally or alternatively, in some embodiments, historical information may include at least one of a range of motion, velocity, resistance, acceleration, endurance level, strength level, aggregate volume, user feedback, or time series data associated with at least one user. A range of motion refers to a full movement potential of a joint or muscle in a specific direction. Further, a range of motion may be measured in degrees. For example, a range of motion associated with a user may include how far a user can move, such as how far an elbow can bend from fully extended to fully flexed. A velocity refers to a speed of movement in a specific direction. For example, a velocity associated with a user may include the speed at which the user performs an exercise movement.

A resistance refers to a force or load that opposes movement. For example, resistance during exercise may include an opposing force, such as provided by dumbbells, resistance bands, a resistance motor, and/or gravity. Further, an exercise machine may provide or induce resistance using, for example, magnets (e.g., magnetic resistance), electromagnets (e.g., electromagnetic resistance), motors (e.g., motor-driven resistance), or any other suitable force or load providing means. For example, resistance associated with a user may include a level or amount of resistance at which the user historically performs an exercise. An acceleration refers to a rate at which velocity changes over time. For example, an acceleration during an exercise may include how quickly a user's movements speed up or slow down. For example, an acceleration associated with a user may include an acceleration at which the user historically performs an exercise.

An endurance level refers to an ability of muscles or the cardiovascular system to sustain effort over time. For example, an endurance level associated with a user may indicate how long or how many times that user can perform one or more exercises. A strength level refers to an amount of force a muscle or group of muscles can generate. For example, a strength level associated with a user may indicate how much resistance or force the user can overcome while performing an exercise. An aggregate volume refers to total amount of work or activity performed. For example, an aggregate volume associated with a user may indicate a total number of sets, repetitions, and/or load a user has performed for one or more exercises.

User feedback refers to information provided by the user about their experience, performance, or preferences. For example, user feedback associated with a user may indicate user-provided information such as a fitness goal, a performance indication, and/or a user preference, as described and exemplified elsewhere in this disclosure. Time series data refers to information collected at multiple time points. For example, time series data associated with a user may indicate a user's progression over time in one or more tracked or stored variables, such as a range of motion, a velocity, a resistance, an acceleration, an endurance level, a strength level, and/or an aggregate volume.

In some embodiments, at least one variable may be associated with at least one of a fitness level, a desired workout type, or a workout constraint. A fitness level refers to a state of an individual's physical ability. For example, a fitness level of a user may include the user's strength, endurance, flexibility, and/or overall performance of one or more exercises. For example, a fitness level may include a measured or determined amount of force a user is capable of generating or performing during an exercise. A workout refers to a session of physical activity aimed at improving fitness, health, or performance. A type refers to a category, kind, or classification of something. For example, a workout type may include a category of exercises that share one or more characteristics. Further, a workout type may include exercises that focus on same or similar muscle groups. Desired refers to a characteristic of being wanted, preferred, and/or intended. For example, a desired workout type may include a workout type that the user wishes or wants to perform. A constraint refers to a limitation, restriction, or rule that restricts options or actions. Further, a workout constraint may include a restriction on a workout. For example, a workout constraint may include a maximum duration; pieces of exercise equipment or movements to avoid or not use; and/or physical limitations, including, for example, physical injuries or a medical condition.

By way of non-limiting example and with reference to FIG. 12A, any single or combination of user device 1202, processing device 1204, and database 1206 may store, in a memory, historical information associated with a user. For example, each user may be associated with a particular memory location, such as a data structure, that stores the historical information associated with that user.

Some disclosed embodiments may involve using at least one neural network to determine a personalized workout regime for at least one user, wherein the determined personalized workout regime corresponds to at least one variable. Using refers to employing or applying a tool, method, or system to achieve a task or outcome. A neural network refers to artificial intelligence and/or a computational model made of interconnected nodes or neurons that process data and learn patterns. For example, a neural network may include one or more machine learning algorithms, such as linear regression, Random Forest, Support Vector Machines, K-Nearest Neighbors, K-Means Clustering, Q-Learning, or any other suitable machine learning model. Further, a neural network may be implemented as a feedforward neural network (FNN), convolutional neural network (CNN), transformer, autoencoder, or any other suitable neural network model. Determining refers to arriving at an outcome, as described and exemplified elsewhere in this disclosure. For example, using a neural network may include inputting information into a neural network to determine a requested or desired output.

A workout regime refers to a structured, planned series of exercises or training sessions. For example, a workout regime may be designed to achieve specific fitness goals over time. Personalized refers to a characteristic of being tailored or customized to the specific needs, preferences, or characteristics of an individual. In some embodiments, the determined personalized workout regime may correspond to at least one variable. For example, a personalized workout regime for a user may include a series or set of exercises tailored to the user, such as based on a fitness goal, a performance indication, and/or a user preference associated with the user. For example, a neural network may receive a fitness goal variable indicating that a user wants to be able to perform thirty lateral raises and may use that fitness goal variable to determine a workout regime that, if followed and performed by the user, can assist the user in achieving that fitness goal. Thus, using at least one neural network to determine a personalized workout regime for a user by at least one processor may ensure that the neural network can create tailored workout plans for any given user based on at least one inputted variable associated with the user.

By way of non-limiting example and with reference to FIG. 12A, processing device 1204 may be configured to host or run a neural network. The neural network may be trained to create personalized workout plans for a given user based on information associated with the user. For example, a user may input a fitness goal, a performance indication, and/or a user preference associated with the user into user device 1202. User device 1202 may store the received information as one or more variables and may transmit the one or more variables, such as over network 1208, to processing device 1204. The neural network may accept the one or more variables as an input and may determine the personalized workout plan for the user.

Some disclosed embodiments may involve accessing a data structure storing a plurality of movement video clip segments for use as building blocks to construct a composite workout video corresponding to a personalized workout regime.

Accessing refers to gaining entry to, retrieving, or making use of something. A data structure refers to any collection of data values and relationships among them, as described and exemplified elsewhere in this disclosure. For example, a data structure may include a library. Accessing a data structure may include at least one processor retrieving or reading data stored in the data structure.

A movement refers to an act or process of changing position, location, or posture. For example, movement may include a shift or displacement of an object, body, or part thereof. Further, a movement may include a specific physical action, or pattern of actions, performed by an individual and may involve the contraction and extension of muscles to create a change in posture, position, or joint angle. A video clip refers to a short piece of video. For example, a video clip may span a few seconds or minutes and may be extracted from a longer recording. A segment refers to a distinct part or subdivision of a whole. Further, a movement video clip segment may depict performance of a single exercise movement, including a looped recording of the single exercise movement.

A building block refers to a basic unit, element, or component that can be combined with others to create something larger, more complex, or complete. For example, a plurality of movement video clips may be used as building blocks to create a longer movement video (i.e., a composite workout video) depicting one or more different exercise movements. Thus, accessing a data structure storing a plurality of movement video clip segments for use as building blocks to construct a composite workout video corresponding to a personalized workout regime refers to retrieving several movement video clips to construct a personalized workout regime for a user, including, for example, as determined by a neural network.

In some embodiments, each movement video clip segment may be associated with a targeted muscle group. Targeted refers to directed at a specific goal, area, or object. A muscle group refers to a set of one or more muscles that work together to perform a particular movement or function. For example, a muscle group may group muscles based on anatomy or functionality. A muscle group may include, for example, chest muscles or core muscles. For example, a targeted muscle group may include a muscle group that a user wishes to focus an exercise around. The user may input, into a user interface, an indication of one or more targeted muscle groups, and at least one processor may store the indication as a variable for inputting into a neural network, as described and exemplified elsewhere in this disclosure. Thus, when each movement video clip segment is associated with a targeted muscle group, each movement video clip may depict an exercise movement that focuses on or exercises a specific or particular muscle group.

In some embodiments, each of the plurality of movement video clip segments may depict an individual performing a motion. Depicting refers to representing, showing, or illustrating something. An individual refers to a person or object. A motion refers to a process or action of changing position or state. For example, a movement video clip segment depicting an individual performing a motion may include a video that shows a person performing an exercise movement.

In some embodiments, depicted individuals may vary across the plurality of movement video clip segments. Varying refers to changing or showing differences in form, amount, degree, or type over time or between instances. Across refers to spanning or extending over a space, range, or group. For example, varying across a plurality of movement video clip segments may include a change or difference in depicted content between video clip segments. Further, when depicted individuals vary across the plurality of movement video clip segments, a first video clip segment may depict a first person performing a first exercise movement and a second video clip segment may depict a second, different person performing a second exercise movement. Each video clip may depict a same or a different person compared to any other video clip.

In some embodiments, a composite workout video may include depictions of at least two differing individuals. Differing refers to a characteristic of exhibiting a difference. For example, differing individuals may include two or more individuals that differ in at least one way or manner, including by virtue of being two different people. Further, a composite workout video including depictions of at least two differing individuals may include a video made of one or more video clip segments that depicts two or more people each performing an exercise movement.

By way of non-limiting example and with reference to FIG. 12A, database 1206 may store one or more data structures that store a plurality of movement video clips. Processing device 1204 may be configured to perform neural network operations and may be configured to access the one or more data structures stored in database 1206. In some embodiments, database 1206 may be a separate memory device and may be operatively connected to processing device 1204 wirelessly via network 1208. In some embodiments, database 1206 and processing device 1204 may be implemented as a single device, with database 1206 being implemented as a memory of processing device 1204.

Some disclosed embodiments may involve using at least one neural network to select a subset of a plurality of movement video clip segments for constructing a composite workout video. Selecting refers to choosing an option or mode from a set of possibilities, as further described and exemplified elsewhere in this disclosure. A subset refers to a set whose elements are all contained within another set. Further, a subset may include one or more, including each, element of a set. Selecting a subset may include, for example, choosing one or more options from a list or set of options. Further, selecting a subset of a plurality of movement video clip segments may include choosing or retrieving two or more movement video clips segments from a set of video clip segments, which may be stored in a data structure. Thus, using at least one neural network to select a subset of a plurality of movement video clip segments for constructing a composite workout video by at least one processor may ensure that relevant or appropriate movement video clips segments are retrieved for use in constructing a composite workout video. The neural network may be trained, for example, to recognize or identify movement video clip segments associated with received variables, such as a fitness goal, a performance indication, or a user preference associated with a user.

By way of non-limiting example and with reference to FIG. 12A, a neural network running on processing device 1204 may determine two or more movement video clips that correspond to the received at least one variable-including, for example, at least one of a fitness goal, a performance indication, and/or a user preference associated with at least one user. The neural network may retrieve and/or create a copy of the determined two or more movement video clips in a memory, such as a memory of processing device 1204 and/or a memory location in database 1206.

In some embodiments, a composite workout video may be constructed to emphasize use of a particular piece of exercise equipment. Emphasizing refers to giving special importance, attention, and/or focus to something to make it stand out or be noticed. For example, emphasizing user of a particular piece of exercise equipment may include assigning weight or importance to movement video clips that depict a person using the particular piece of exercise equipment. Further, constructing a composite workout video to emphasize use of a particular piece of exercise equipment may include selecting, by a neural network, movement video clips that depict a person performing an exercise movement that includes use of the particular piece of exercise equipment.

By way of non-limiting example and with reference to FIG. 12A, a neural network running on processing device 1204 may select one or more movement video clips that correspond to a particular piece of exercise equipment. The neural network may retrieve and/or create a copy of the selected one or more movement video clips in a memory, such as a memory of processing device 1204 and/or a memory location in database 1206.

Some disclosed embodiments may involve stitching a selected subset of movement video clip segments into a composite workout video. Stitching refers to a process of combining multiple video clips, images, and/or pieces of media into a single sequence. For example, stitching a set of video clips together may include ordering the video clips sequentially to create a longer video that, when played, depicts the video clips in the sequential order. Thus, stitching a selected subset of movement video clip segments into a composite workout video refers to combining into a single workout video, several video clips. The composite workout video may be associated with an exercise session, and each of the movement video clip segments may be associated with a particular exercise set of the exercise session.

By way of non-limiting example and with reference to FIG. 12A, a neural network running on processing device 1204 may combine each selected movement video clip into a single composite workout video. The neural network may create and store the composite workout video in a memory, such as a local memory of processing device 1204 and/or database 1206.

In some embodiments, stitching a selected subset of movement video clip segments into a composite workout video may involve aggregating the subset of movement video clip segments without removing substantive content from the subset of movement video clip segments. Aggregating refers to collecting or combining multiple items, data points, or pieces of information into a single group or total. For example, aggregating the subset of movement video clip segments may include combining the subset of movement video clip segments into a composite workout video (e.g., stitching). Removing refers to taking away, eliminating, deleting, and/or making no longer present. Content refers to material or information contained within something. For example, content may include text, images, audio, and/or video.

Substantive refers to having real importance, value, or meaning. For example, substantive content of a movement video clip segment may include the portions of the movement video clip segment that depicts an individual performing an exercise movement. By contrast, non-substantive content of a movement video clip segment may include the portions of the movement video clip segment that does not depict an individual performing an exercise movement. For example, non-substantive content of a movement video clip segment may depict an individual resting between exercise repetitions or sets. Removing substantive content from the subset of movement video clip segments may include deleting or trimming the portions of the movement video clip segment that do not depict substantive content, such as an individual performing an exercise movement. Thus, aggregating the subset of movement video clip segments without removing substantive content from the subset of movement video clip segments refers to combining video clips without trimming or deleting from the clips content of value. Content lacking substantive value may be deleted or trimmed. In this way, the composite workout video focuses on the performance of the exercise movement(s) and does not distract the user with non-exercise movement related content.

By way of non-limiting example and with reference to FIG. 12A, a neural network running on processing device 1204 may analyze each selected movement video clip for substantive content, such as depictions of an individual performing an exercise movement. The neural network may remove content or portions from the selected movement video clips that do not contain any identified substantive content. The neural network may use the shortened, substantive content-focuses movement video clip segments for stitching to create a composite workout video.

In some embodiments, stitching a subset of movement video clip segments may involve smoothing transitions between a plurality of video clip segments. Smoothing refers to reducing abrupt changes or roughness to create a more gradual, fluid, or seamless effect. A transition refers to a visual effect or technique used to move smoothly from one video clip to another. It may help maintain narrative flow, avoid abrupt cuts, and enhance storytelling. Common transitions include cuts, fades, dissolves, wipes, and more complex effects like glitches or morphs. Further, smoothing a transition between video clip segments may include cross-dissolving or fading, cuts on action, wipes or slides, match cuts or graphic matches, layering overlapping segments with reduced opacity, or any other suitable transition smoothing technique.

By way of non-limiting example and with reference to FIG. 12A, a neural network running on processing device 1204 may introduce or insert a transition between consecutive video clip segments so that the composite workout video may more seamlessly flow from one video clip segment to the next. In this way, a user viewing the composite workout video may not be offput or distracted by hard or jarring cuts between video clip segments and instead may view the composite workout video as a single, seamless video.

In some embodiments, stitching a subset of a plurality of movement video clip segments may include using at least one neural network to determine a sequence for stitching the plurality of movement video clip segments. A sequence refers to a set of things, events, or steps arranged in a particular order. For example, a sequence for stitching the plurality of movement video clip segments may include an order the movement video clip segments should be played. Further, using at least one neural network to determine a sequence for stitching the plurality of movement video clip segments refers to the use of AI to present the video clip segments in a suitable order to the user. For example, the neural network may be trained to avoid sequencing a movement video clip segment depicting an individual performing a first exercise movement between two other movement video clip segments each depicting an individual performing a second exercise movement. Further, the neural network may be trained to sequence movement video clip segments each depicting an individual performing similar exercise movements, such as exercise movements that target a similar or same muscle group and/or that involve a same piece of exercise equipment, next to each other.

By way of non-limiting example and with reference to FIG. 12A, a neural network running on processing device 1204 may analyze each selected movement video clip to determine characteristics. For example, the characteristics may include a common muscle group, a common piece of exercise equipment, a similar movement, a same individual performing the exercise movements, any other suitable characteristic, or any combination of the foregoing. The neural network may determine a sequence of movement video clips that places similar movement video clips near each other and dissimilar movement video clips further from each other.

Some disclosed embodiments involve outputting a composite workout video for presentation to at least one user. Outputting refers to producing, delivering, or presenting information, data, or results. For example, outputting may include transmitting signals containing information or results from one device to another. Presentation refers to the act of displaying, showing, or making something visible to a user, as described and exemplified elsewhere in this disclosure. For example, outputting for presentation may include transmitting data from one device for display on another device. Thus, outputting a composite workout video for presentation to at least one user by at least one processor refers to conveying the composite workout video for viewing by the user. This may enable, for example, the user to follow along with a composite workout video while the user performs the exercise movements depicted in the composite workout video.

By way of non-limiting example and with reference to FIG. 12A, processing device 1204 may transmit a composite workout video created by a neural network to user device 1202 for display to a user. Processing device 1204 may transmit the composite workout video via network 1208 or via wired means (e.g., direct connection). By way of further non-limiting example and with reference to FIG. 12C, user device 1224 may display the composite workout video to user 1222. User 1222 may watch the composite workout video and perform similar exercise movements by interacting with exercise machine 1220. In some embodiments, an integrated display of exercise machine 1220 may display the composite workout video instead of or in addition to user device 1224.

In some embodiments, at least one user may include a plurality of users clustered according to a similarity measure. Clustered refers to grouping. For example, clustering may involve grouping a set of individuals based on a similarity between them. A similarity refers to something the members of the group have in common. For example, the similarity may refer to a quantifiable indication that relates two or more persons, based on characteristics, data points, or any other shared measure. A measure refers to quantitative metric or identifier used to evaluate, assess, or characterize someone or a trait, ability or attribute of someone. For example, a similarity measure may include any quantifiable value that indicates a likeness between items or data. Further, clustering according to a similarity measure may include grouping persons that each have a similarity measure within a predetermined range.

For example, a plurality of users clustered according to a similarity measure may include creating one or more groups of users that have similarity measures within a predetermined range or distance from each other. Further, a similarity measure for users may consider one or more of the following characteristics: a user demographic, activity pattern, exercise preference, age, gender, fitness level, performance ability, behavior, habit, health, weight, height, geographical location or and/or biometric data. An activity pattern may include an exercise frequency, duration, and/or intensity. An exercise preference may include a preferred piece of exercise equipment and/or a target muscle group. A performance may include an endurance level, a strength level, and/or an aggregate volume, as described and exemplified elsewhere in this disclosure. A behavior or habit may include a consistency in exercise routine and/or a typical time of day for workouts. Health or biometrics may include a heart rate response, sleep patterns, recovery rate, health conditions (e.g., diabetes, hypertension), and/or physical conditions (e.g., amputated limb). At least one processor may use any combination of the aforementioned characteristics to determine a similarity measure for each user. The at least one processor may then group or cluster users with similar similarity measures. In this way, the neural network may create composite workout videos for a user in a user group based on or similar to previously created composite workout videos for other users in the same user group.

By way of non-limiting example and with reference to FIG. 12A, processing device 1204 may be configured to determine a similarity measure for each of a plurality of users based on information associated with each user stored in a memory, such as database 1206. Processing device 1204 may further group or create groups for users with similarity measures within a predetermined range. For example, processing device 1204 may utilize k-means clustering, hierarchical clustering, or any other suitable clustering technique to group users based on associated similarity measures. A neural network may consider or utilize data associated with users of a same group when creating a composite workout video for a user. For example, the neural network may select similar movement video clips and may determine a similar sequence for a first user's composite workout video based on historically created composite workout videos for other users in the first user's group.

In some embodiments, automated composite video construction operations may include receiving real-time signals associated with sensed performance characteristics of at least one user. Real-time refers to something that occurs, is generated and/or transmitted with minimal delay such that the information is available immediately or nearly immediately. A signal refers to information encoded for transmission via a physical medium, as described and exemplified elsewhere in this disclosure. For example, a real-time signal may include signal generated and transmitted for processing without human-perceptible delay. A real-time signal may include a user's heart rate, motion, position, speed of movement, muscle activity, limb extension, or other physiological or biomechanical measurements. Sensed refers to a characteristic of information having been detected, measured, or captured. For example, sensing may include measuring information as detected by one or more sensors and/or one or more cameras. A performance characteristic refers to a quantifiable feature, metric, or attribute that reflects the execution, quality, or effectiveness. For example, a performance characteristic may include how well a user is performing an exercise. For example, a sensed performance characteristic may include measurements such as exercise repetition count, range of motion, speed, acceleration, power output, heart rate, or balance, as detected by one or more sensors and/or cameras operatively connected to an exercise machine and/or user device. Thus, receiving real-time signals associated with sensed performance characteristics of a user refers to data captured as a user exercise.

By way of non-limiting example and with reference to FIG. 12C, user device 1224 may include a camera 1226 configured to capture video data of user 1222 performing an exercise. Further, exercise machine 1220 may include one or more sensors, such as force sensors, infrared sensors, accelerometers, and/or electrocardiogram (ECG) sensors, configured to measure user performance of an exercise. Further, user 1222 may wear one or more sensors, such as incorporated into a smartwatch, which may be communicatively connected to user device 1224 and/or exercise machine 1220. Camera 1226 and the one or more sensors, including the wearable sensors, may measure data associated with the user's performance of an exercise and may transmit the measured data for processing (e.g., by processing device 1204 depicted in FIG. 12A). In this way, processing device 1204 may receive active feedback associated with the performance of an exercise by user 1222.

In some embodiments, automated composite video construction operations include using real-time signals to dynamically adjust a composite workout video. Dynamically refers to responding, adapting, or changing in real time or continuously based on current conditions, inputs, or feedback. Adjusting refers to modifying, calibrating, or altering a setting, parameter, or configuration. For example, dynamically adjusting may include modifying or altering something responsive to received real-time signals. Further, using real-time signals to dynamically adjust a composite workout video refers to changing the composite workout video in response to signals received as the user is working out. This may occur, in some embodiments, using a neural network to determine, based on the received real-time signals, if the composite workout video should be adjusted, for example, responsive to determining the user is performing the exercise too easily or failing to perform the exercise adequately, as further described and exemplified below.

In some embodiments, real-time signals may reflect a change in at least one of a fitness level or a fitness preference. Reflecting refers to indicating, representing, or providing an observable manifestation of a condition, state, or characteristic. A change refers to a modification, alteration, or difference in a condition, state, characteristic, or parameter over time. For example, a change in a fitness level may include a difference in a fitness level associated with present performance of an exercise movement by a user compared to a fitness level associated with a past performance of an exercise movement by the user. The present and past performance of the exercise movement may be during a same workout or exercise session. Further, real-time signals that reflect a change in a fitness level may include real-time signals that indicate a difference in fitness level as compared to a prior determined fitness level. At least one processor may compare the received real-time signals indicating a fitness level with previously received signals indicating a fitness level to determine if the fitness level of the user is different at present compared to at an earlier point during the workout. For example, a user may perform an exercise at a beginning of a workout at a first fitness level as determined by at least one processor based on received signals and may perform an exercise later during the same workout at a second fitness level as determined by at least one processor based on received signals. The fitness level may be represented as an efficiency percentage indicating how well a user is performing an exercise compared to a predetermined optimized or ideal form and/or performance.

A fitness preference refers to a user's choice, inclination, or priority regarding types of exercise, workout routines, intensity levels, or training modalities. For example, a change in a fitness preference may include a user's desire to focus on another a target muscle group or a user's preference for an alternative exercise. Further, real-time signals that reflect a change in a fitness preference may include receiving a user input indicating an updated or new user preference.

In some embodiments, dynamically adjusting an initial version of a composite workout video may include accommodating a change. Initial refers to a characteristic of being the first, original, or starting state of an item, process, or configuration. A version refers to a specific iteration, release, or form of an item, product, or content. For example, an initial version of a video may include a starting point or an original sequence of exercises, instructions, visual and audio content, and/or formatting before any edits, user customizations, or updates are applied. Accommodating refers to adjusting, modifying, or configuring an item, process, or system. For example, accommodating may include adjusting an item to meet the needs, preferences, or capabilities of a user or set of conditions. Thus, dynamically adjusting an initial version of a composite workout video may include accommodating a change in the outputted composite workout video to incorporate any changes as indicated by one or more real-time signals, as described and exemplified above, so that the user experiences a more personalized and dynamic workout.

By way of non-limiting example and with reference to FIG. 12C, prior to the start of or at the beginning of a workout, user 1222 may input one or more user preferences, as described and exemplified elsewhere in this disclosure, into a user interface of user device 1224. User device 1224 may transmit real-time signals indicating an initial fitness preference of a user to at least one processor (e.g., processing device 1204 depicted in FIG. 12A). The at least one processor may store the initial fitness preference in a memory, such as a temporary memory associated with the workout. As the user performs the exercises of the workout, camera 1226 and/or one or more sensors of exercise machine 1220 may measure and/or monitor the user's performance and may transmit real-time signals indicating an associated fitness level to at least one processor (e.g., processing device 1204 depicted in FIG. 12A). The at least one processor may store the received signals in a memory, such as the temporary memory associated with the workout. The at least one processor may compare or track progress of the fitness level associated with the user as the workout progresses. Further, during the workout, the user may interact with a user interface of user device 1224 to modify a user preference. For example, after performing a lateral raise exercise, the user may decide to update a user preference to indicate the user no longer wishes to perform that exercise movement. User device 1224 may send real-time signals to the at least one processor, which may store the received real-time signal indicating an updated fitness preference. In this way, at least one processor may have up-to-date or live feedback on the user's workout. The at least one processor may input the live feedback (e.g., real-time signals reflecting a change in a fitness level and/or a fitness preference) to a neural network. The neural network may analyze the received feedback and a created composite workout video to determine if any movement video clips in the composite workout video should be removed or any new movement video clips should be added to the composite workout video (e.g., while the composite workout video is playing on a display and/or during the workout). For example, as a user's fitness level decreases across the workout, the neural network may remove one or more initially stitched movement video clips from the composite workout video. Further, responsive to a real-time signal indicating a user no longer wishes to utilize a particular piece of exercise equipment, the neural network may remove one or more initially stitched movement video clips that depict an individual using that particular piece of exercise equipment from the composite workout video. Similarly, responsive to real-time signals indicating a user's fitness level is increasing, the neural network may stitch additional movement video clips to the composite workout video to challenge the user. Other non-limiting examples of dynamically adjusting a composite workout video are further described and exemplified below.

In some embodiments, accommodating a change may include adjusting at least one of an intensity level, a duration, a number of repetitions, or a pace of the dynamically adjusted composite workout video. An intensity level refers to quantifiable measure of the effort, exertion, or challenge required by an exercise or workout. An intensity level may be based on one or more factors, such as speed, resistance, load, or heart rate. An intensity level may be represented as a level, such as low, moderate, or high, or as a number, such as a percentage or any suitable number (e.g., intensity level of 50%, intensity level 3 out of 10, etc.). Further, an intensity level may correspond to an amount of effort exerted by a user to perform one or more exercises. For example, a higher intensity level may correspond to a user exerting more effort to complete the exercise movement compared to a lower intensity level. For example, adjusting an intensity level of a dynamically adjusted composite workout video may include increasing an intensity level or decreasing an intensity level associated with the composite workout video. A neural network may determine, based on received real-time signals, that the user is performing the exercise movements too easily and may stitch additional movement video clips or modify movement video clips already stitched in a composite workout video to increase a difficulty.

A duration refers to length of time. For example, a duration of a composite workout video may include a sum of the durations of the stitched movement video clips or a duration of the workout. For example, adjusting a duration of a dynamically adjusted composite workout video may include lengthening or shortening a duration associated with the composite workout video. A neural network may determine, based on received real-time signals, that the user wishes the workout to be longer and may stitch additional movement clips to lengthen the workout.

A repetition refers to a single complete performance of a specific exercise or movement. A number of repetitions may include a total count of times a specific exercise is performed. For example, a number of repetitions may include a total count within a single set or across a workout. For example, adjusting a number of repetitions of a dynamically adjusted composite workout video may include increasing or decreasing a number of repetitions for one or more exercises of a workout associated with the composite workout video. A neural network may determine, based on received real-time signals, that the user is performing the exercise movements too easily and may stitch additional movement video clips or modify movement video clips already stitched in a composite workout video to increase a difficulty.

A pace refers to a speed or rhythm. For example, a pace of an exercise movement may include how quickly the exercise movement is performed. Further, a pace of a workout may include how quickly each exercise is followed by another exercise. For example, a faster workout pace may include shorter rest or break time between exercises. For example, adjusting a pace of a dynamically adjusted composite workout video may include increasing or decreasing an exercise movement pace and/or a workout pace associated with the composite workout video. A neural network may determine, based on received real-time signals, that the user is performing the exercise movements too quickly and may modify a movement video clip to play more slowly to slow down the user's performance of the exercise movement. Further, a neural network may determine, based on received real-time signals, that the user is performing the exercise movements too easily and may modify a movement video clip to play more quickly to challenge the user.

By way of non-limiting example and with reference to FIG. 12C, camera 1226 and/or one or more sensors associated with exercise machine 1220 may be configured to measure and transmit real-time signals indicating a performance of an exercise movement by a user to at least one processor (e.g., processing device 1204 of FIG. 12A). The at least one processor may input the received real-time signals to a neural network. The neural network may be trained to analyze the received feedback and to determine if one or more characteristics of a composite workout video should be dynamically adjusted (e.g., while the composite workout video is playing on a display and/or during a workout). For example, the neural network may adjust at least one of an intensity level, a duration, a number of repetitions, or a pace of the dynamically adjusted composite workout video being played on a display (e.g., of user device 1224) to user 1222. For example, the neural network may stitch one or more additional movement video clips, remove one or more stitched movement video clips, speed up one or more stitched movement video clips, and/or slow down one or more stitched movement video clips.

In some embodiments, dynamically adjusting may include, after outputting, adding an additional movement video clip to the composite workout video. After outputting refers to a point in time or a stage in a process that occurs subsequent to the generation, presentation, or delivery of data, content, or results. Adding refers to including, inserting, or appending an element, component, or feature into an existing set, sequence, or system. Additional refers to a characteristic of being extra, supplementary, or beyond what is already present or provided. For example, adding an additional movement video clip to the composite workout video after outputting may include inserting or stitching a movement video clip into the composite workout video. In some embodiments, adding after outputting the composite workout video may include the composite workout video being outputted as a video stream. A video stream may refer to a continuous flow of video data sent from a source to a destination over a network. At least one processor may modify the video stream of the composite workout video so as to seamlessly insert one or more additional movement video clips. In some embodiments, adding after outputting the composite workout video may re-outputting an updated composite workout video to replace an initially outputted composite workout video. For example, at least one processor, after creating an updated composite workout video by adding one or more additional movement clips, may output, to a display, the updated composite workout video to replace the initially outputted composite workout video. The updated composite workout video may replace the initially outputted composite workout video at a common frame so as to seamlessly replace the initially outputted composite workout video.

In some embodiments, dynamically adjusting may include, after outputting, removing a movement video clip from a composite workout video. For example, removing a movement video clip from a composite workout video after outputting may include removing or deleting a movement video clip from the composite workout video. In some embodiments, adding after outputting the composite workout video may include the composite workout video being outputted as a video stream. At least one processor may modify the video stream of the composite workout video so as to seamlessly remove one or more movement video clips that have not yet been displayed (e.g., later in the sequence). In some embodiments, removing after outputting the composite workout video may re-outputting an updated composite workout video to replace an initially outputted composite workout video. For example, at least one processor, after creating an updated composite workout video by removing one or more movement clips, may output, to a display, the updated composite workout video to replace the initially outputted composite workout video. The updated composite workout video may replace the initially outputted composite workout video at a common frame so as to seamlessly replace the initially outputted composite workout video.

By way of non-limiting example and with reference to FIG. 12A, processing device 1204 may receive one or more real-time signals indicating a user performance of an exercise from one or more sensors (e.g., one or more sensors of exercise machine 1220 and/or camera 1226 as depicted in FIG. 12C). Processing device 1204 may input the received one or more real-time signals to a neural network. The neural network may be trained to analyze the received one or more real-time signals and may update an initially outputted composite workout video by adding one or more additional movement video clips to and/or removing one or more movement video clips from the initially outputted composite workout video. For example, the initially outputted composite workout video may be transmitted as a video stream from processing device 1204 to a display of user device 1202 via network 1208 and updating the initially outputted composite workout video may include replacing the initially outputted composite workout video with the updated composite workout video at a common frame so as to seamlessly replace the initially outputted composite workout video. Additionally or alternatively, processing device 1204 may output the updated composite workout video to user device 1202 via network 1208 to replace the initially outputted composite workout video at a common frame so as to seamlessly replace the initially outputted composite workout video.

In some embodiments, automated composite video construction operations may include receiving from a trainer at least one additional movement video clip segment missing from a data structure. A trainer refers to a person whose role is to instruct, guide, or coach individuals in performing exercises, improving fitness, or achieving physical training goals. For example, a trainer may be an administrative user configured to have access and modify a data structure storing the plurality of movement video clips. Missing refers to a characteristic of being absent, unavailable, or not present. For example, a movement video clip segment missing from a data structure may include a movement video clip segment depicting an exercise movement that is not depicted in any other movement video clip segment stored in the data structure. Further, receiving from a trainer at least one additional movement video clip segment missing from a data structure may include a trainer sending, via a processing device such as a personal computer or mobile computing device, a movement video clip segment depicting an individual performing an exercise movement that is not depicted in any movement video clip segment stored in the data structure.

In some embodiments, automated composite video construction operations may include incorporating at least one additional movement video clip segment into a composite workout video. Incorporating refers to including, integrating, or combining one thing into another. For example, incorporating at least one additional movement video clip segment into a composite workout video may include stitching or adding a movement video clip segment into a composite workout video. Thus, incorporating at least one additional movement video clip segment received from a trainer into the composite workout video refers to enabling a trainer to incorporate movement videos into a composite workout video.

By way of non-limiting example and with reference to FIG. 12C, a trainer (not depicted) may be assisting or coaching user 1222 during a workout. The trainer may be physically near user 1222 or may be remote and displayed on a display of user device 1224. User 1222 may ask the trainer to add an exercise movement to the displayed composite workout video. If the requested exercise movement is not already stored as a movement video clip segment in a data structure (e.g., database 1206 depicted in FIG. 12A), the trainer may upload a movement video clip segment depicting an individual performing that exercise movement to the data structure. For example, the trainer may use a personal computer or mobile device to transmit, via network 1208, the additional movement video clip segment to the data structure (e.g., database 1206). Processing device 1204 may retrieve and stitch the additional movement video clip segment into the composite workout video, as described and exemplified elsewhere in this disclosure.

FIG. 12D illustrate a flowchart of an example process for automated composite video construction, consistent with some disclosed embodiments. In some disclosed embodiments, process 1200D may be performed by at least one processor (e.g., processor 102 in FIG. 1) to perform operations or functions described herein. In some disclosed embodiments, some aspects of process 1200D may be implemented as software (e.g., program codes or instructions) that are stored in a memory (e.g., memory 104 in FIG. 1) or a non-transitory computer readable medium. In disclosed some embodiments, some aspects of process 1200D may be implemented as hardware (e.g., a specific-purpose circuit). In some disclosed embodiments, process 1200D may be implemented as a combination of software and hardware.

Referring to FIG. 12D, process 1200D may include a step 1242 of receiving at least one variable including at least one of a fitness goal, a performance indication, or a user preference associated with at least one user. By way of non-limiting example, in FIG. 12A, user device 1202 may receive, via a user interface, a user input that causes user device 1202 to create at least one variable including at least one of a fitness goal, a performance indication, or a user preference associated with the user. User device 1202 may transmit the at least one variable to processing device 1204.

Process 1200D may include a step 1244 of using at least one neural network to determine a personalized workout regime for at least one user. By way of non-limiting example, in FIG. 12A, processing device 1204 may be configured to run or host at least one neural network. The at least one neural network may be trained to determine a personalized workout regime for at least one user based on, for example, the received at least one variable.

Process 1200D may include a step 1246 of accessing a data structure storing a plurality of movement video clip segments for use as building blocks to construct a composite workout video corresponding to a personalized workout regime. By way of non-limiting example, in FIG. 12A, processing device 1204 may be configured to access a data structure of database 1206. The data structure may store a plurality of movement video clip segments.

Process 1200D may include a step 1248 of using at least one neural network to select a subset of a plurality of movement video clip segments for constructing a composite workout video. By way of non-limiting example, in FIG. 12A, at least one neural network running or operating on processing device 1204 may be trained to identify one or more movement video clip segments associated with the received at least one variable. Further, the neural network may be trained to select, including by extracting or creating a copy, a plurality of identified movement video clip segments stored in database 1206.

Process 1200D may include a step 1250 of stitching a selected subset of movement video clip segments into a composite workout video. By way of non-limiting example, in FIG. 12A, processing device 1204 may be configured to stitch the selected plurality of movement video clip segments into a composite workout video.

Process 1200D may include a step 1252 of outputting a composite workout video for presentation to at least one user. By way of non-limiting example, in FIG. 12A, processing device 1204 may be configured to output the composite workout video to a display. For example, processing device 1204 may transmit the composite workout video via network 1208 to user device 1202, and user device 1202 may present the workout video on a display to at least one user. Transmitting the composite workout video may include transmitting part of or the entire composite workout video. Transmitting the composite workout video may include streaming the composite workout video to user device 1202.

Some disclosed embodiments involve systems, methods, and non-transitory computer-readable media for gamifying physical exertion sessions by randomly altering aspects of the workout, particularly through the use of a randomization engine. The randomization engine modifies workout parameters dynamically, introducing elements of surprise and unpredictability to enhance the user experience. This approach is especially relevant for exercises with distinct phases, such as tempo, resistance, and holding positions, which involve movement against resistance and various thresholds.

The randomization engine works in conjunction with a smart algorithm to ensure that the randomized parameters align with the general characteristics of each exercise. Randomization refers to the arrangement of a set of items, here, exercise parameters, in an unpredictable and/or unsystematic order. General characteristics refer to key phases of an exercise (e.g., concentric, eccentric, starting, and holding phases) and associated thresholds, such as movement speed, resistance levels, and holding times. Before applying randomization, the algorithm identifies the structure of the exercise, including its distinct phases and thresholds. It then randomizes the workout parameters while adhering to predefined ranges that are appropriate for both the exercise type and the user's historical performance data or preferences. Predefined ranges refer to various parameters associated with an exercise, including a range of motion, a range of weights used for an exercise, and a range of speeds associated with completing an exercise.

For example, in a triceps pulldown exercise, the randomization engine may adjust the tempo of the eccentric and concentric phases, vary resistance levels during the movements, and introduce different holding times during the peak contraction phase. Similarly, in a squat exercise, the system might vary the tempo of the descent and ascent, introduce random holding times at the bottom phase, and adjust resistance levels to create an unpredictable yet structured workout experience. The smart algorithm ensures these variations remain within the identified thresholds to maintain the logic and effectiveness of the workout while avoiding injury. An identified threshold is defined and exemplified elsewhere in this disclosure.

By recognizing the natural structure and characteristics of each exercise, the system offers a dynamic and personalized training experience. The randomized modifications keep workouts engaging, challenging, and aligned with the user's fitness goals, while real-time feedback from sensors allows the system to adapt the workout further based on the user's performance.

In this disclosure, the term “random number generator” (RNG) is used broadly to refer to any system, algorithm, module, or mechanism capable of introducing variability or randomness into workout parameters. This term is not limited to a traditional numerical RNG, but rather encompasses a wide range of randomization or variation techniques that can dynamically alter various aspects of a workout session, such as tempo, resistance, rest periods, movement patterns, or exercise sequences.

For instance, the RNG can include a randomization engine, which may employ complex algorithms to generate randomized outputs based on predefined conditions. Similarly, a dynamic variation module may utilize real-time data to introduce changes to workout parameters in an unpredictable manner. Real-time data refers to information received from the user during an exercise and may include information related to a user's heart rate, exercise tempo, exercise resistance, and/or range of motion.

An adaptive randomization component may consider user-specific factors such as fitness level, fatigue, or progress to tailor the variability in a way that aligns with the user's fitness goals while still retaining an element of surprise.

Additionally, the adaptive randomization component may include a stochastic control system. A stochastic control system refers to any system that introduces randomness in a controlled fashion to ensure the workout remains effective and logical. An automated variation mechanism can implement randomness by varying the exercise parameters automatically, without requiring a predefined numerical sequence. Even a variability engine or dynamic adjustment system could serve the purpose of randomly modifying workout elements through the use of logic-based or condition-based variations, rather than strict numerical randomization.

Therefore, “random number generator” within the context of this disclosure refers to any system, process, or algorithm that introduces dynamic and unpredictable variations in workout parameters, whether based on numerical randomness, algorithmic control, adaptive logic, or other forms of automated variability.

In this disclosure, “basic characteristics” of an exercise routine refer to the fundamental components that define its structure and execution. These characteristics include, but are not limited to:

1: Exercise Phases: The distinct stages of an exercise movement, such as concentric (muscle shortening), eccentric (muscle lengthening), starting, and holding phases. Each phase contributes to the overall effectiveness and safety of the exercise.

2: Thresholds: Predefined limits or ranges associated with each phase of the exercise, such as maximal and minimal positions, speed, resistance, and holding times. Thresholds can be based on general exercise principles or tailored to the user's historical performance data and fitness level.

3: Values: Specific parameters within each phase, such as movement speed, resistance levels, holding times, and rest periods. These values are identified and analyzed by the system to ensure that any randomized modifications remain within safe and effective ranges.

Some disclosed embodiments involve smart algorithm-driven randomization. The system employs a smart algorithm that first analyzes the exercise type to identify its basic structure, which includes specific phases (e.g., concentric, eccentric, starting, and holding phases) and their associated characteristics, such as speed, resistance, and holding times. Each phase has predefined thresholds that define the safe and effective execution of the exercise. These thresholds can include general standards (based on common exercise principles) and user-specific limits (derived from the individual's historical performance data and/or preferences).

Before initiating randomization, the smart algorithm identifies the distinct phases of the selected exercise. For instance, in a triceps pulldown, the algorithm recognizes phases like the eccentric (controlled upward motion), concentric (downward pull), and peak contraction (holding at the bottom). Similarly, for squats, it identifies phases such as the descent (eccentric), bottom position (holding), and ascent (concentric). For each phase, the algorithm determines the associated values, including speed, resistance, and holding time, and establishes thresholds that are suitable for both the exercise type and the user's capabilities.

Once the exercise structure and thresholds are identified, the randomization engine modifies parameters within these constraints. For example, it might alter the tempo of the concentric and eccentric phases, change resistance levels during movement, or vary holding times in specific phases, such as the bottom of a squat or the peak contraction of a triceps pulldown. The smart algorithm ensures that these randomized modifications stay within the effective and safe ranges for the user's fitness level, avoiding excessive strain or injury.

Additionally, the algorithm may dynamically adapt to the user's real-time performance feedback from sensors on the exercise equipment. If the user struggles with a randomized parameter, such as a faster tempo during the concentric phase, the algorithm can adjust future randomizations to be more manageable. Conversely, if the user easily completes a randomized holding time at the peak contraction phase, the algorithm might increase the duration within the next set to introduce progressive overload.

By using a structured approach to identify exercise phases and associated values, the smart algorithm tailors the randomization to each exercise's natural characteristics and the user's specific abilities. This randomization process maintains the logic and purpose of the workout while enhancing engagement and variety, ensuring an effective yet unpredictable training experience.

By way of non-limiting example, a triceps pulldown exercise may consist of five distinct phases:

1. Starting Position: The user holds the handle with arms bent at the elbows, ready to begin the movement.

2. Eccentric Phase: The user slowly allows the handle to move upward, extending the elbows and controlling the resistance.

3. Bottom Phase: The handle reaches the highest point in the movement; the user's arms are fully extended.

4. Concentric Phase: The user pulls the handle downward, contracting the triceps muscles.

5. Peak Contraction: The handle is at the lowest point; the user holds the contraction momentarily before beginning the next repetition.

The phases 2 (Eccentric), 4 (Concentric), and 5 (Peak Contraction) involve key values such as speed, resistance, and holding time, each associated with specific thresholds that define the safe and effective execution of the exercise. These thresholds can be general (based on common exercise principles) and user-specific (based on the individual's historical performance data and fitness level).

In some disclosed embodiments, the smart algorithm may be applied to a triceps pulldown exercise as follows:

1. Identification of Exercise Characteristics: The smart algorithm first identifies the characteristics and thresholds associated with each phase of the triceps pulldown. For example:

Eccentric Phase: Generally, this phase requires a slow and controlled speed, with thresholds defined by the user's ability to control the upward motion against resistance.

Concentric Phase: This phase usually involves a faster, more forceful downward pull, with thresholds set for both speed and resistance levels to ensure safety and effectiveness.

Peak Contraction: Involves a holding time at the bottom, where the smart algorithm identifies the maximum and minimum duration the user can hold the contraction, considering their strength and fatigue levels.

2. Randomization of Parameters: Using the identified thresholds, the randomization engine introduces variability to each of these key phases while ensuring alignment with the exercise's natural resistance profile and the user's capabilities.

Eccentric Phase (Phase 2): The randomization engine selects a random speed within the user's effective range. For example, one repetition may involve a slow 4-second upward motion, while another randomizes to a faster 2-second tempo. The smart algorithm ensures that the selected speeds remain within the user's ability to control the resistance safely. Additionally, the resistance level during this phase can be randomized to provide a different challenge each time, again staying within user-specific thresholds.

Concentric Phase (Phase 4): The randomization engine selects a pace for the downward pull that varies across repetitions. For instance, one repetition might be a quick, forceful 1-second pull, while another is randomized to a slower, more controlled 3-second movement. The smart algorithm adjusts these randomized tempos to match the user's strength and current fatigue state. The resistance applied during this phase may also vary randomly within the user's safe threshold, creating an unpredictable yet manageable exertion level.

Peak Contraction (Phase 5): The randomization engine can introduce variability in the holding time at the bottom of the movement. For example, one repetition might require the user to hold the contraction for a random 2-second interval, while the next holds for a 1-second pause. The algorithm ensures that the randomized holding times do not exceed the user's maximal holding capacity, preventing potential strain or injury.

3. Optional Adaptive Randomization Based on Feedback: The sensors on the exercise equipment monitor the user's performance in real-time. For example, if the user struggles with the randomized tempo or resistance in the concentric phase, the smart algorithm adapts future randomizations to keep the difficulty within manageable limits. Similarly, if the user handles the randomized holding times during the peak contraction phase comfortably, the algorithm may gradually increase the holding threshold for future repetitions, adding a progressive challenge.

4. Presentation Through User Interface: The randomized parameters may be presented to the user via the display. The interface can display real-time prompts indicating the tempo for the eccentric phase, the resistance level for the concentric phase, and the holding time for the peak contraction. If using a gamified interface (for example as disclosed in U.S. Provisional Patent Appl. No. 63/496,605 incorporated herein by reference), a controllable element on the screen could move at a speed corresponding to the selected tempo, with pacing elements indicating when to slow down, speed up, or hold the contraction. The smart algorithm ensures that all randomizations stay within the defined thresholds, making the workout both unpredictable and tailored to the user's current fitness level.

By applying the randomization engine and smart algorithm in this manner, the triceps pulldown becomes a dynamic and engaging exercise. The user experiences variability in tempo, resistance, and holding time while staying within safe and effective exercise parameters, creating an exciting workout session that evolves with their progress.

By way of non-limiting example, a squat when performed with a resistance exercise machine, can be divided into four key phases:

1. Starting Position: The user stands upright with feet shoulder-width apart, holding the handles or a t-bar at shoulder height with legs extended.

2. Eccentric Phase: The user bends their knees and hips to lower the body into a squat, moving against the machine's resistance.

3. Bottom Phase: The user reaches the lowest point of the squat, briefly holding this position.

4. Concentric Phase: The user pushes through the heels to extend the legs, returning to the starting position while moving the resistance back up.

In some disclosed embodiments, the smart algorithm may be applied to a squat when performed with a resistance exercise machine as follows:

1. Identification of Characteristics: The smart algorithm identifies the full range of motion for the squat, including the maximal (bottom) and minimal (starting) positions, as well as speed and resistance thresholds associated with the concentric (upward) and eccentric (downward) movements. The algorithm may also consider user-specific characteristics, such as previous squat performance, strength level, and endurance.

Randomization: The randomization engine modifies the key exercise parameters within safe and effective thresholds identified for the squat:

Eccentric Phase: The randomization engine selects a tempo for the descent phase, varying between a slow, controlled 4-second descent and a faster 2-second descent. The algorithm ensures the randomized tempos align with the user's ability to control the downward movement, adjusting based on their fitness level. Additionally, the engine can vary the resistance applied during the descent, adding an extra layer of variability to challenge the user.

Bottom Phase: The engine introduces variability in the holding time at the bottom of the squat. One repetition may involve holding the bottom position for a random interval between 1 to 3 seconds. The smart algorithm ensures that this holding time remains within the user's safe threshold, factoring in their strength and endurance capabilities to prevent strain on the knees and lower back.

Concentric Phase: The engine randomizes the speed of the upward motion, alternating between a quick 1-second press and a more controlled 3-second extension back to the starting position. Resistance during this phase can also be varied. For example, one repetition might involve pushing against a heavier resistance level, while the next involves a lighter resistance, encouraging different muscle activation patterns. The algorithm ensures these randomized resistance levels do not exceed the user's safe lifting capacity.

2. Optional Adaptive Randomization Based on Feedback: Real-time sensor data from the resistance machine monitors the user's performance during each phase. If the user struggles to maintain form or control the speed during a randomized descent or ascent, the algorithm can adapt future randomizations to remain within manageable difficulty levels. Conversely, if the user handles the variation comfortably, the algorithm may gradually increase the complexity of randomizations in subsequent sets to introduce progressive overload.

3. Presentation Through User Interface: The randomized parameters are displayed to the user through the interface. For instance, prompts on the screen might indicate the tempo for the descent (“4-second slow squat”), the hold time at the bottom (“Hold for 2 seconds”), and the speed for the ascent (“Push up in 1 second”). In a gamified interface, a controllable element might move in sync with the user's tempo, with pacing elements providing visual cues on when to speed up, slow down, or hold the position. The algorithm adjusts the randomization in real time based on the user's response, creating a challenging yet tailored workout experience.

Other non-limiting examples of randomization for workout gamification may include:

1. Randomized Rest Periods: The randomization engine can modify rest periods between sets, selecting intervals within a range that corresponds to the exercise type and the user's fatigue levels. For example, the algorithm ensures that shorter rest periods do not compromise the user's recovery and the exercise's effectiveness.

2. Randomized Resistance Levels: The system adjusts resistance based on the identified characteristics of the exercise and the user's historical data. For instance, in a triceps pulldown, the randomization engine might increase or decrease the resistance within a range that the smart algorithm determines to be safe and effective based on the user's prior performance.

3. Random Exercise Sequence: For circuit workouts, the system identifies the exercises and their respective characteristics before introducing a randomized sequence that still provides a balanced workout.

In some embodiments, the electronic exercise machine, (e.g., as disclosed in the above-mentioned U.S. Provisional Patent Appl. No. 63/496,605), includes a “randomize” mode that can be selected as part of the device's workout options. When this mode is activated, the system identifies the structure of the selected workout and applies randomization to the selected parameters. The user can choose to view these modifications through either a regular interface or a gamified interface with a moving element.

The smart algorithm ensures that the randomization respects the exercise's natural thresholds, adapting to the user's history, performance data and/or preferences.

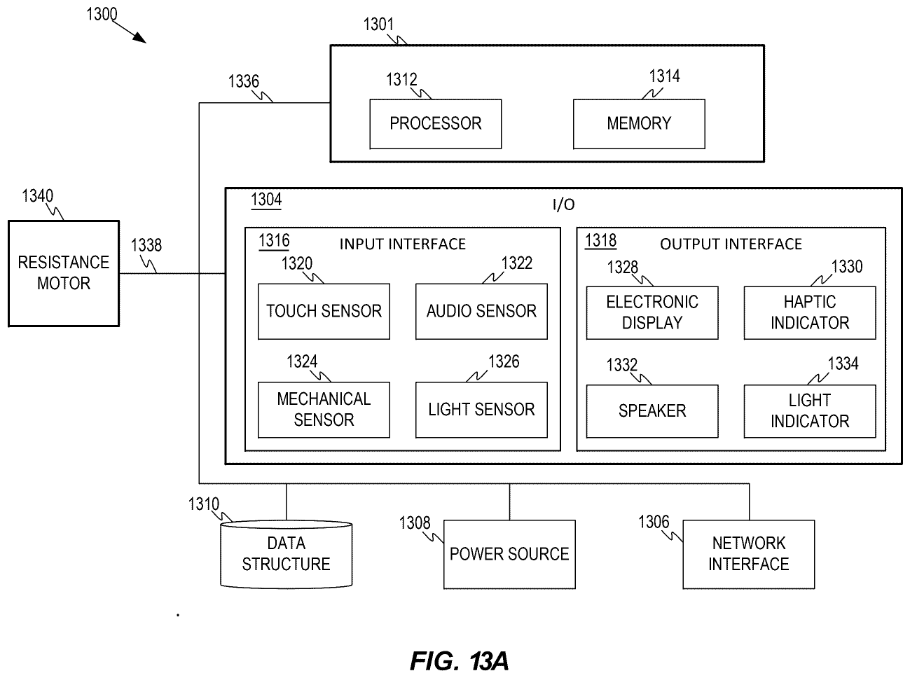

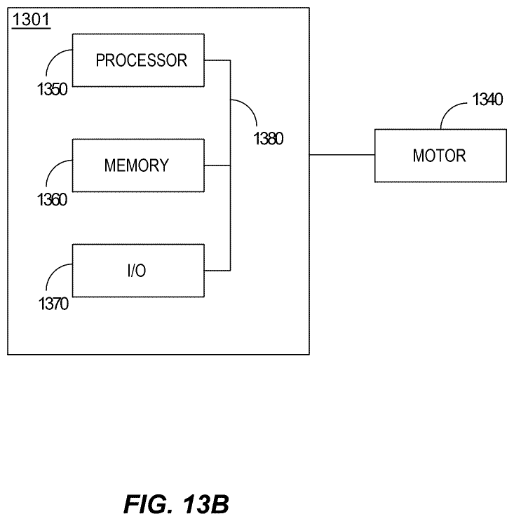

By way of a non-limiting example, FIG. 13A is a schematic diagram of a system architecture for randomizing a workout in an electronic exercise machine, consistent with some embodiments of the present disclosure. It is to be noted that FIG. 13A is a representation of just one embodiment, and it is to be understood that some illustrated elements might be omitted, and others added within the scope of this disclosure. For example, some elements of FIG. 13A may be grouped and/or housed separately. In some embodiments, circuitry associated with a resistance motor of an electronic exercise machine may be housed and/or positioned separately from at least one processor configured to control settings for operating the electronic exercise machine (e.g., a control unit may be located in proximity to a resistance motor and at least one processor may be located elsewhere, and may be in electronic communication with the control unit). While housed and/or located separately, the control unit and the at least one processor may be in communication via wired and/or wireless means. For example, a user may set a desired resistance weight via a software application installed on a mobile communications device. The mobile communications device may transmit an indication of the desired resistance weight to at least one processor. Based on the indication, the at least one processor may transmit a control signal to the control unit to cause the resistance motor to apply the desired resistance weight.

System architecture 1300 may include a control circuit 1301, an I/O (input-output) unit 1304, a network interface 1306, a power source 1308, and a data structure 1310. Control circuit 1301 may include at least one processor 1312 and a memory 1314. I/O unit 1304 may include an input interface 1316 and an output interface 1318. Input interface 1316 may include one or more of a touch sensor 1320, an audio sensor 1322, a mechanical sensor 1324, and a light sensor 1326, and/or any other type of sensor configured to receive an input. Output interface 1318 may include one or more of an electronic display 1328, a haptic indicator 1330, a speaker 1332, one or more light indicators 1334, and/or any other type of output interface. Control circuit 1301, I/O unit 1304, network interface 1306, power source 1308, and data structure 1310 may be interconnected via bus system 1336. Control circuit 1301 may be connected to a resistance motor 1340 via one or more wires and/or cables 1338. In some embodiments, one or more components of control circuit 1301 may be located inside a housing encasing resistance motor 1340, however this is not required.

For example, upon receiving a selection of an exercise routine to be performed using an electronic exercise machine via input interface 1316, at least one processor 1312 may retrieve data from memory 1314 associated with the selected exercise routine. Such data may include, for instance, settings, preferences, a history of prior performances of the selected exercise routine, and/or any other data associated with the selected exercise routine. The at least one processor 1312 may apply the retrieved data to control a current supplied to resistance motor 1340, to thereby control the resistance applied by resistance motor 1340 during performance of the selected exercise routine.

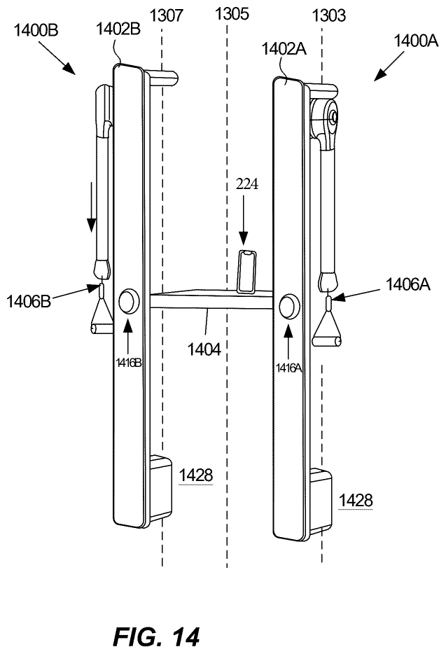

FIG. 13B is a block diagram of a controller for controlling an electronic exercise machine, consistent with some embodiments of the present disclosure. Components of FIG. 13B may be similar in description to the corresponding components of FIG. 13A. A controller 1301 of electronic exercise equipment 1500 may include at least one processor 1350, at least one memory 1360, and an input output (I/O) 1370) connected via a bus system 1380. I/O 1370 may include wired and/or wireless (e.g., one or more antennas) communications means enabling electronic communication between at least one processor 1350 and another processor and/or device via a communications network. For instance, at least one processor 1350 may communicate with personal communications device 1518 and/or another at least one processor 1350 configured with another instance of electronic exercise equipment 1500 (e.g., see FIG. 14 showing paired T-shaped wall-mounted gyms 1400A and 1400B) via a pairing interface such as I/O 1370. In some embodiments, at least one processor 1350 may communicate with a wearable extended reality appliance via I/O 1370. Some or all of controller 1301 may be located within a motor housing 1340, while some elements such as at least one processor 1350, at least one memory 1360, input output (I/O) 1370), and/or a bus system 1380 may be encased within other portions of the equipment.

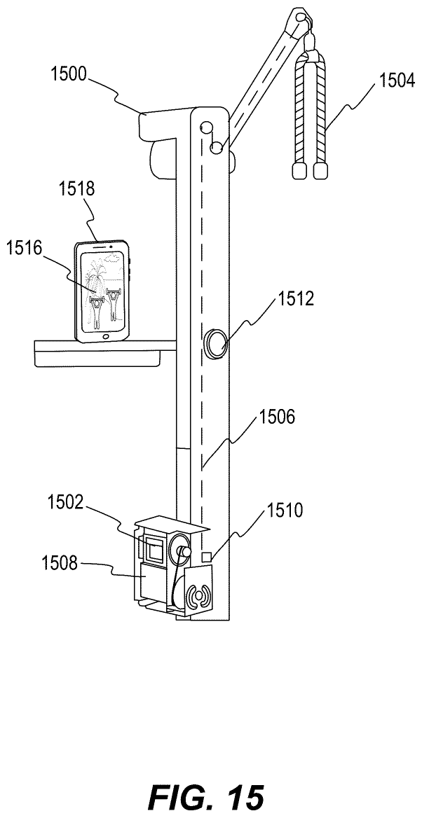

In a non-limiting example, FIG. 14 illustrates an exemplary configuration for two paired T-shaped wall-mounted gyms 1400A and 1400B, consistent with some disclosed embodiments. T-shaped wall-mounted gyms 1400A and 1400B may correspond electronic exercise equipment 1500, as described in reference to FIG. 15. FIG. 14 illustrates three wall studs 1303, 1305, and 1307, indicated as dashed lines. In some embodiments, T-bar 1404 may be configured to extend between and connect to an additional vertically wall-mountable beam 1402B mounted on a third stud 1307 adjacent to second stud 1305 and on a side of the second stud 1305 opposite the first stud 1303.

In some embodiments, vertically wall-mountable beam 1402A, the additional vertically wall-mountable beam 1402B, and the T-bar 1404 cooperate to form an H-configuration, with the T-bar 1404 configured to resist torquing of both the vertically wall-mountable beam 1402A and the additional vertically wall-mountable beam 1402B. FIG. 14 shows devices 1400A and 1400B each comprised of a vertical beam and joined by a single T-bar in an H-configuration (i.e., the T-bar of a single device becomes an H-bar when two devices share the T-bar).

By way of a non-limiting example, reference is made to FIG. 15 which illustrates an exemplary piece of electronic exercise equipment 1500, consistent with some disclosed embodiments. Electronic exercise equipment 1500 may include a resistance motor 1502 connected to an accessory 1504 via a cable 1506. Resistance motor 1502 may include one or more electromagnets configured to apply a variable electromagnetic field as resistance. For example, a level of resistance produced by resistance motor 1502 may correspond to an amount of weight (e.g., “digital weight”) needed to be overcome by muscles during performance of a weight-bearing exercise. Resistance motor 1502 may be associated with at least one processor configured to control a level of electrical current flowing therethrough, allowing the at least one processor to control attributes associated with resistance or digital weight produced by resistance motor 1502. Accessory 1504 refers to the portion of the electronic exercise equipment 1500 that a user grasps or otherwise interacts with. Accessory 1504 may be a bar, cable, grip, and/or other object used to complete an exercise. Cable 1506, along with resistance motor 1502, provides tension such that a user can complete one or more exercises.

Electronic exercise equipment 1500 may additionally include a computing device 1508, at least one sensor 1510, and a user interface 1512. Computing device 1508 may be configured to store and execute instructions directed to randomizing a user's exercise routine, consistent with disclosed embodiments. User interface 1512 may include one or more of an electronic display, a touch-sensitive screen, a microphone, a speaker, a haptic interface, a light emitting diode (LED), one or more adjustable dials, knobs, buttons, switches, and/or levers and/or any other type of manipulatable control enabling user inputs and/or information display. For example, a user may provide one or more inputs via a user interface 1512 associated with electronic exercise equipment 1500 to initiate, select, modify, share, and/or terminate an exercise routine. User interface 1512 may initiate signals to at least one processor 1312 associated with an electronic exercise machine 1500. In a similar manner, the at least one processor 1312 may transmit one or more signals to convey information via user interface 1512 to a user of an electronic exercise equipment 1500.

At least one processor 1312 of computing device 1508 may receive data for adjusting one or more settings of resistance motor 1502 and/or for providing feedback to a user. Feedback includes any information about the exercise equipment, the user's performance, equipment settings, a current exercise session, and any other information relevant to disclosed embodiments. Feedback may be audible, visual, and/or haptic, and may be relevant to the randomized exercise routine.

Audible feedback may include one or more audible cues that a user may hear. Audible feedback may include any sounds, buzzes, sirens, and/or other audible cues meant to convey information to the user. For example, user interface 1512 may produce a sound when it randomizes the user's exercise routine. Visual feedback can include any information about the exercise equipment, the user's performance, equipment settings, a current exercise session, and any other information relevant to disclosed embodiments. Visual feedback may include one or more navigating menus included in a user interface 1512 for the exercise equipment. In one example, user interface 1512 may flash or produce another discernable visual cue when randomizing an exercise routine. Haptic feedback is a tactile response, such as vibrations or other forces transmitted to the user through user interface 1512. User interface 1512 may include one or more components that produce a force that can be felt by the user, such as a vibration, tap, click, or other suitable touch-based types of feedback. The dial hardware may include one or more actuators, motors, or piezoelectric devices capable of creating a physical force associated with the haptic feedback. In one example, user interface 1512 may vibrate when randomizing an exercise routine.

In one example, the at least one processor may receive data from one or more of at least one sensor 1510, user interface 1512, a memory, user interface 1512, and/or a transceiver, and may provide feedback to a user via user interface 1512. In some embodiments, computing device 1508 may communicate (e.g., via pairing) with a personal communications device 1518, permitting a user to interact with electronic exercise equipment via personal communications device 1518. Personal communications device 1518 is a portable electronic instrument designed to facilitate information transmission to other devices or networks. Personal communications devices may, for example, use cellular or other wireless and/or wired networks to transmit information such as voice and/or other data. For example, such transmissions may be in the form of voice calls, text messages, internet access, and application usage.

Personal communications devices come in various forms, such as smartphones, tablets, laptop computers, IoT devices, wearable electronics (such as smart watches, smart rings, fitness trackers, smart glasses, smart clothing, smart jewelry, smart headphones, wearable digital assistants), and portable wireless hotspots. Depending on configuration and intended use, they may include features such as a touchscreen interface, a built-in camera, Wi-Fi, NFC, and/or Bluetooth connectivity, and GPS navigation. Personal communications device 1518 may include, for example, a mobile phone, a tablet, a wearable device, and/or any other type of personal communications device.

As shown in FIG. 15, user interface 1512 and/or personal communications device 1518 may present a “Randomize” mode 1516. The “Randomize” mode may be displayed on a user interface associated with personal communications device 1518. When the user selects this mode, the system activates the randomization engine, which dynamically modifies the workout parameters associated with the selected exercise routine. This mode may be presented alongside other selectable workout options. When selected, “Randomize” mode may provide feedback to the user as described and exemplified elsewhere in this disclosure.

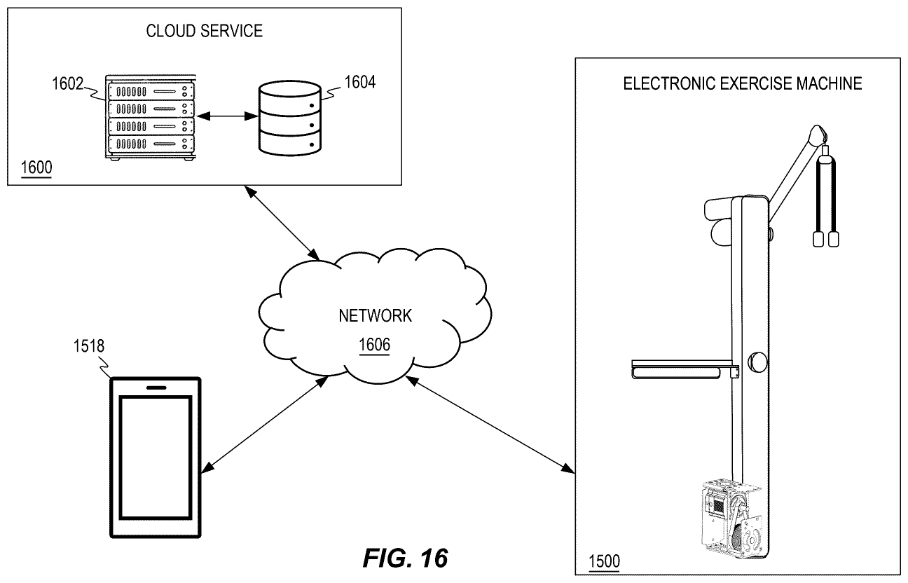

By way of example, FIG. 16 is a schematic illustration of a cloud service 1600 associated with wall-mountable electronic exercise machine 1500, consistent with some embodiments of the present disclosure. Cloud service 1600 includes at least one server 1602 (e.g., including at least one processor), and a data structure 1604 connected to a communications network 1606. Cloud service 1600, wall-mountable electronic exercise machine 1600 and mobile communications device 1518 may communicate via a communications network 1606.

In some embodiments, communications network 1606 may include a dedicated communications network, such as a Bluetooth communications channel connection personal communications device 1518 with at least one processor 1312 of electronic exercise machine 1500. In some embodiments, a light sensor (e.g., a camera) associated with mobile communications device 1518 may capture images (e.g., of a user performing an exercise routine with or without wall-mountable electronic exercise machine 1500). Cloud service 1600 may store and analyze the images or videos, for example, to allow a first user of a first instance of wall-mountable electronic exercise machine 1500 compete with a second user (e.g., of a second instance of wall-mountable electronic exercise machine 1500), to provide feedback and/or instructions to a user performing an exercise routine, and/or provide any other service associated with performances of exercise routines (e.g., with or without wall-mountable electronic exercise machine 1500).

Some disclosed embodiments involve systems, methods, and computer readable medium (e.g., memory 104 in FIG. 1) for executing voice-cloned guidance during exercise programs. At least one processor (e.g., processor 102) may receive from a trainee associated with an electronic exercise machine (e.g., exercise machine 200 in FIG. 2 and/or exercise machine 932 and/or 936 in FIG. 9B), a selection associated with a particular distinctive voice (e.g. voice pitch, accent, and/or style) for presenting exercise feedback (e.g., using speaker 326 in FIG. 3). The at least one processor may electronically receive sensor data (e.g., from one or more of touch sensor 310, audio sensor 312, mechanical sensor 314, an optical sensor 316, a voltage sensor 318, or a current sensor 320) associated with use by the trainee of the electronic exercise machine. The at least one processor may analyze the sensor data to determine trainee performance, and generate the exercise feedback based on the trainee performance (e.g. real-time corrections, performance summaries, and/or encouragement). The at least one processor may access a data pool (e.g., stored in data repository 404 in FIG. 4) containing characterizing information associated with a plurality of distinctive voices including characterizing information for the particular distinctive voice. The at least one processor may apply to the exercise feedback the characterizing information for the particular distinctive voice to thereby construct an audio file synthesizing the exercise feedback in the particular distinctive voice, and cause the audio file synthesizing the exercise feedback in the particular distinctive voice to be presented to the trainee (e.g., via speaker 326).

In some disclosed embodiments, the particular distinctive voice is associated with a celebrity trainer, and wherein the particular distinctive voice is a synthesized voice of the celebrity trainer. In some disclosed embodiments, the particular distinctive voice is associated with a professional trainer, and wherein the particular distinctive voice is a synthesized voice of the professional trainer. In some disclosed embodiments, the particular distinctive voice is a synthesized voice of a celebrity with a specialization in an exercise type selected by the trainee. In some disclosed embodiments, the exercise feedback is provided by an individual other than an individual possessing the particular distinctive voice. In some disclosed embodiments, the sensor data includes data from an image sensor, and wherein analyzing includes performing image recognition on the data from the image sensor to determine at least one of an exercise form or an exercise performance measure. In some disclosed embodiments, the sensor data includes cable movement information, the cable movement information including at least one of cable velocity, cable resistance, cable acceleration, or aggregated volume associated with a cable of the electronic exercise machine during a particular time frame.

In some disclosed embodiments, the synthesized voice feedback is generated using advanced voice cloning technologies, such as deep learning models, neural network-based text-to-speech systems, or generative adversarial networks.

In some disclosed embodiments, the method by which users select a distinctive voice and receive feedback is facilitated through a user-friendly interface. In some disclosed embodiments, the system may present a touchscreen menu or voice command options to the user, allowing them to select from a variety of available voices (e.g., professional trainers, celebrities, or custom voices). Users can scroll through a list of available voices or search for a specific trainer or celebrity by name, exercise type, or vocal characteristics (e.g., accent, tone). In other embodiments, users may be able to record their own voice or upload a voice file, which can then be synthesized by the system to provide personalized feedback in the user's own voice or the voice of someone they know.

To enhance an exercise experience, some disclosed embodiments include a hybrid gaming and exercise platform where a selected game and a selected exercise can be linked together. More specifically, a user may be able to select and/or make suggestions from a collection of exercises and a collection of games, enabling performance of the selected exercise to control the selected game. In this way, the user has the flexibility to match a preferred game with an exercise.

Embodiments are disclosed to cause a shift from a conventional user interface (UI) for exercise routines, that may be limited to displaying metrics such as a number of completed repetitions or a resistance level, to a gamified UI. The gamified UI may provide a more playful and engaging experience, e.g., using various graphic and/or sound indicators that add an additional entertaining aspect to an exercise routine. Some disclosed embodiments provide a wide variety of differing gamified UIs, either as ready-to-use gamified workouts or as add-ons that users may integrate into a chosen workout. Integrating a gamified UI with a particular exercise machine may permit games to be based on real-time data measured via the exercise machine.

By way of a non-limiting example, reference is made to FIG. 9B illustrating a plurality of users, each performing an exercise routine on an exercise machine, consistent with some disclosed embodiments. A first user 912 may use a first exercise machine 932 at a first location, and a second user 914 may use a second exercise machine 936 at a second location. First exercise machine 932, second exercise machine 936, a first mobile device 930, a second mobile communications device 934, and a trainer 902 may be in communication with cloud service 400 via communications network 406. First user 912 may perform an exercise routing using first exercise machine 932 at the first location, and receive feedback for performing the exercise routine via first mobile communications device 930. Second user 914 may perform an exercise routine using second exercise machine 936 at the second location, and may receive feedback for performing the exercise routine via second mobile communications device 934.

Some disclosed embodiments involve systems, methods, and computer readable medium for correlating a musical presentation with an electronic exercise equipment routine. At least one processor may identify a first exercise block including a first set of movement types (e.g., Block 1 including four sets of six repetitions of chest presses). At least one processor may determine a first exertion level (e.g., medium) for the first exercise block based on first information associated with the first set of movement types. At least one processor may identify a second exercise block including a second set of movement types (e.g., Block 2 including shoulder presses). At least one processor may determine a second exertion level (e.g., very high) for the second exercise block based on second information associated with the second set of movement types. At least one processor may access a data pool storing music. For instance, at least one processor may access music stored in data repository 404 via communications network 406. At least one processor may select a first music track from the data pool, the first music track having a first tempo corresponding to the first exertion level (e.g., medium), and streaming the first music track (e.g., over communications network 406) for presentation at a location of the exercise machine (e.g., exercise machine 200) during performance of the first exercise block (e.g., Block 1 including chest presses). At least one processor may select a second music track from the data pool, the second music track having a second tempo corresponding to the second exertion level (e.g., very high), and streaming the second music track (e.g., over communications network 406) for presentation at the location of the exercise machine during performance of the second exercise block (e.g., shoulder press). Additionally or alternatively, the operations may include generating the first and/or second music tracks having the first and/or second tempo, respectively, using artificial intelligence.

In some disclosed embodiments, at least one of the first information or the second information includes at least one of a specific exercise movement, a number of sets, a number of repetitions, an exercise duration, a user preference, or historical data associated with a user. In some disclosed embodiments, the historical data includes at least one of an average exercise pace, a time to complete a specific exercise movement, or at least one vital sign. In some disclosed embodiments, selecting and/or generating at least one of the first music track or the second music track includes selecting and/or generating based on at least one of a user preference, a particular music genre, or a particular musician. In some disclosed embodiments, selecting and/or generating of the first music track and the selecting and/or generating of the second music block are completed prior to the performance of the first exercise block. In some disclosed embodiments, the selecting and/or generating of the second music track is completed after initiation of the first exercise block. Some disclosed embodiments involve detecting a change in pace during performance of the first exercise block or the second exercise block, selecting a third music track from the music pool and/or generating a third music track, the third music track having a pace corresponding to the change in pace, and streaming the third music track for presentation at the location of the exercise machine. Some disclosed embodiments involve accessing a playlist containing a plurality of tracks, scanning the tracks to determine a tempo of each of the plurality of tracks, and storing a tempo indicator associated with each track, and wherein selecting the first music track or the second music track from the data pool includes matching the workout pace based on a corresponding stored tempo indicator. In some disclosed embodiments, the music is instrumental, and wherein the operations further comprise adjusting an associated tempo of the instrumental music to correspond to the first exertion level or the second exertion level. Some disclosed embodiments involve identifying a rest period (e.g. through predefined workout plans and/or real-time data), and selecting and/or generating a third music track having a third tempo including a restful interlude. The characteristics of the music selected for these rest periods could be lower tempo, calming melodies, etc. Some disclosed embodiments involve receiving a data stream from at least one sensor, wherein identifying the first exercise block or the second exercise block is based on the data stream. In some disclosed embodiments, the at least one sensor includes an image sensor, and the operations further include performing image movement analysis on the data stream to thereby determine the first exertion level or the second exertion level. In some disclosed embodiments, the at least one sensor is associated with a motor, and wherein the operations further include performing rotational movement analysis on the data stream to thereby determine the first exertion level or the second exertion level. In some disclosed embodiments, the at least one sensor is configured to detect cable movement, and wherein the operations further include performing cable movement analysis on the data stream to thereby determine the first exertion level or the second exertion level. In some disclosed embodiments, the data stream further reflects a workout intensity level and wherein the selected music is further chosen based on the workout intensity level. Some disclosed embodiments involve constructing and presenting a musical segue between the first tempo and the second tempo.

In some disclosed embodiments, the system is configured to collect feedback from users regarding the music tracks played during their workouts. After a workout session, users may rate or provide feedback on the music selections through the interface (e.g., a mobile app or exercise machine interface). This feedback could include ratings on how well the music matched their workout intensity, preferences for certain genres or tempos, or suggestions for improvements. In some disclosed embodiments, the collected feedback may then be analyzed by the system to refine future music recommendations and improve personalization. For instance, if a user consistently rates high-tempo music as motivating during high-intensity intervals, the system may prioritize selecting similar music for future high-exertion blocks. This feedback loop ensures that the music becomes increasingly tailored to the user's preferences over time.

In some disclosed embodiments, the system may be integrated with third-party music streaming platforms, such as Spotify®, Apple Music®, or YouTube Music®, to allow users to connect their personal music accounts and incorporate their playlists or favorite songs into their workout sessions. Users can select their preferred playlist, and the system will dynamically adjust the tempo, volume, or instrumental emphasis based on their workout intensity and energy levels.

In some disclosed embodiments, the system may track workout performance metrics alongside music adaptations, providing insights into how music influenced the workout. The system may generate reports that correlate music tempo changes with workout performance, such as improved pacing, increased repetition counts, or sustained energy levels during high-exertion blocks and analyze how music adaptations enhanced (or detracted from) the workout. For example, the system may highlight sections of the workout where music changes led to improved performance metrics, such as faster completion times or increased resistance levels.

In some disclosed embodiments, the users can save the personalized music tracks generated during their workout and share with others.

Some disclosed embodiments incorporate voice recognition with an exercise machine, thereby enabling a user to vocally increase or decrease a resistance during a set without interrupting the set to change resistance.

Some disclosed embodiments involve systems, methods, and computer readable medium for performing voice-induced resistance change operations. At least one processor may implement a first resistance force (e.g., using motor 202) via an electronically-controlled exercise machine (e.g., exercise machine 200). At least one processor may, while the first resistive force is countered by a user of the electronically-controlled exercise machine via interaction with an accessory (e.g., exercise interface 206) through which the first resistance force is exerted, monitor audio in an environment of the electronically-controlled exercise machine (e.g., using audio sensor 312). At least one processor may, during monitoring and while the first resistance force is countered by the user of the electronically-controlled exercise machine via the interaction with the accessory, receive an audio signal from the environment of the user (e.g., from audio sensor 312). At least one processor may process the received audio signal to identify a resistance force change command. At least one processor may implement the resistance force change command while the first resistance force is countered by the user of the electronically-controlled exercise machine via interaction with the accessory through which the first resistance force is exerted, to thereby change the first resistance force to a second resistance force while the user maintains force exertion on the accessory.

In some disclosed embodiments, the resistance force change command includes a direction to increase or decrease resistance by an amount identified in the resistance force change command. In some disclosed embodiments, at least one processor may compare the amount identified to a threshold, and when the amount identified exceeds the threshold, ignoring the resistance force change command. In some disclosed embodiments, at least one processor may compare the amount identified to a threshold, and when the amount identified exceeds the threshold, applying an alternate resistance change within the threshold. In some disclosed embodiments, the resistance force change command includes a direction to increase or decrease resistance in an absence of a specified amount, and wherein in response to the resistance force change command, implementing a change in resistance by a predetermined incremental amount. In some disclosed embodiments, the predetermined incremental amount is predefined by the user. In some disclosed embodiments, processing the received audio signal to identify the resistance force change command includes comparing vocal properties of the audio signal with stored vocal signatures to determine that a voice is authorized to alter settings. In some disclosed embodiments, the voice is authorized when, during comparing, the voice is recognized as being a voice of the user. In some disclosed embodiments, the voice is authorized when, during comparing, the voice is recognized as being a voice of an authorized trainer. In some disclosed embodiments, at least one processor may detect suboptimal performance and outputting an audible query prompting the user to articulate a change in resistance. In some disclosed embodiments, the first resistance force is associated with a mode, and wherein the resistance force change command conveys a request for a mode change. In some disclosed embodiments, at least one processor may activate the electronically-controlled exercise machine.

By way of a non-limiting example, in FIG. 9B, at least one server 402 may collect user characteristics from user 912 and 914 of distributed electronic exercise machines 932 and 936, respectively, using communications network 406. Each of distributed electronic exercise machines 932 and 936 may correspond to exercise machine 200.

Examples of inventive concepts are contained in the following clauses which are an integral part of this disclosure:

Clause 1. A computer readable medium containing instructions that when executed by at least one processor cause the at least one processor to perform operations for enabling variable workout gamification, the operations comprising:
providing first selectable indications of a plurality of candidate fitness movements;
receiving a first selection of at least one particular candidate fitness movement from the plurality of candidate fitness movements;
providing second selectable indications of a plurality of electronic games;
receiving a second selection of a particular electronic game from the plurality of electronic games;
associating the particular electronic game with the at least one particular candidate fitness movement;
enabling presentation of the particular electronic game via a display; and
enabling interaction with the particular electronic game in response to detection of the at least one particular candidate fitness movement.
   Clause 2. The computer readable medium of clause 1, wherein the detection of the at least one particular candidate fitness movement occurs by sensing cable movement, and wherein the operations further comprise sensing the cable movement.
   Clause 3. The computer readable medium of clause 2, wherein the sensing occurs via an image sensor.
   Clause 4. The computer readable medium of clause 2 or 3, wherein the sensing occurs via a sensor for determining rotation of a spool on which a cable associated with the cable movement is wound.
   Clause 5. The computer readable medium of any one of clauses 1-4, wherein the detection of the at least one particular candidate fitness movement occurs by sensing resistance, and wherein the operations further comprise sensing resistance to forces exerted by a motor.
   Clause 6. The computer readable medium of any one of clauses 1-5, wherein the operations enable, at discretion of a user, a plurality of electronic games to be associated with a single fitness movement.
   Clause 7. The computer readable medium of any one of clauses 1-6, wherein the operations enable, at discretion of a user, a plurality of fitness movements to be associated with a single electronic game.
   Clause 8. The computer readable medium of any one of clauses 1-7, wherein the fitness movement selection is received from a trainer and the electronic game selection is received from a user.
   Clause 9. The computer readable medium of any one of clauses 1-8, wherein the electronic game is enabled for play by two users of a common exercise machine.
   Clause 10. The computer readable medium of any one of clauses 1-9, wherein the electronic game is enabled for play by two users of different exercise machines.
   Clause 11. The computer readable medium of clause 10, wherein the different exercise machines are different in location and structure.
   Clause 12. The computer readable medium of clause 10 or 11, wherein the different exercise machines are different in location.
   Clause 13. The computer readable medium of any one of clauses 1-12, wherein the plurality of electronic games includes a gamification of the at least one particular candidate fitness movement.
   Clause 14. The computer readable medium of any one of clauses 1-13, wherein the plurality of electronic games are unassociated with the at least one particular candidate fitness movement.
   Clause 15. The computer readable medium of any one of clauses 1-14, wherein the particular electronic game includes a gamified drop set routine.
   Clause 16. The computer readable medium of any one of clauses 1-15, wherein the particular electronic game includes a feature for pacing the at least one particular candidate fitness movement.
   Clause 17. The computer readable medium of any one of clauses 1-16, wherein the particular electronic game alters the at least one particular candidate fitness movement according to a pattern.
   Clause 18. A system for enabling variable workout gamification, as recited alone in this clause or in combination with any of the preceding clauses, the system comprising:
at least one processor configured to:
   provide first selectable indications of a plurality of candidate fitness movements;
   receive a first selection of at least one particular candidate fitness movement from the plurality of candidate fitness movements;
   provide second selectable indications of a plurality of electronic games;
   receive a second selection of a particular electronic game from the plurality of electronic games;
   associate the particular electronic game with the at least one particular candidate fitness movement;
   enable presentation of the particular electronic game via a display; and
   enable interaction with the particular electronic game in response to detection of the at least one particular candidate fitness movement.
      Clause 19. A method for enabling variable workout gamification, as recited alone in this clause or in combination with any of the preceding clauses, the method comprising:
providing first selectable indications of a plurality of candidate fitness movements;
receiving a first selection of at least one particular candidate fitness movement from the plurality of candidate fitness movements;
providing second selectable indications of a plurality of electronic games;
receiving a second selection of a particular electronic game from the plurality of electronic games;
associating the particular electronic game with the at least one particular candidate fitness movement;
enabling presentation of the particular electronic game via a display; and
   enabling interaction with the particular electronic game in response to detection of the at least one particular candidate fitness movement.
   Clause 20. A computer readable medium, as recited alone in this clause or in combination with any of the preceding clauses, containing instructions that when executed by at least one processor cause the at least one processor to perform operations for automated group identification and aggregation of guidance, the operations comprising:
receiving associations between a plurality of trainees and a common wellness specialist;
receiving, over a plurality of communication channels, sensor data associated with performance of exercises by the plurality of trainees;
analyzing the sensor data to identify at least one subgroup within the plurality of trainees, wherein individual trainees within the at least one subgroup share at least one sensor-data-related commonality;
characterizing the at least one subgroup to the common wellness specialist;
receiving from the common wellness specialist, feedback associated with the at least one sensor-data-related commonality; and
providing over the plurality of communications channels the feedback to each trainee in the at least one subgroup.
   Clause 21. The computer readable medium of any of clauses 1-20, wherein the provision of the feedback to each trainee in the at least one subgroup occurs substantially simultaneously over the plurality of communications channels.
   Clause 22. The computer readable medium of any of clauses 1-21, further comprising, prior to receiving the feedback from the common wellness specialist, providing to the common wellness specialist, recommended feedback for providing to each trainee in the at least one subgroup.
   Clause 23. The computer readable medium of any of clauses 1-22, further comprising receiving at least one modification to the recommended feedback from the common wellness specialist.
   Clause 24. The computer readable medium of any of clauses 1-23, wherein characterizing the at least one subgroup to the common wellness specialist includes receiving input from the common wellness specialist.
   Clause 25. The computer readable medium of any of clauses 1-24, wherein characterizing the at least one subgroup is based on at least one of statistics of additional subgroups, or historical data.
   Clause 26. The computer readable medium of any of clauses 1-25, wherein the at least one sensor-data-related commonality is associated with a sensor data threshold.
   Clause 27. The computer readable medium of any of clauses 1-26, wherein the sensor data includes a plurality of performance-related resistance measurements.
   Clause 28. The computer readable medium of any of clauses 1-27, wherein the operations further include synthesizing a voice of the common wellness specialist and wherein providing over the plurality of communications channels the feedback to each trainee in the at least one subgroup includes providing the feedback in the synthesized voice of the common wellness specialist.
   Clause 29. The computer readable medium of any of clauses 1-28, wherein the feedback differs across the plurality of communications channels.
   Clause 30. The computer readable medium of any of clauses 1-29, wherein feedback differences are based on unique characteristics of each individual trainee in the at least one subgroup.
   Clause 31. The computer readable medium of any of clauses 1-30, wherein the operations further comprise retrieving from a data pool the unique characteristics of each individual trainee in the at least one subgroup.
   Clause 32. The computer readable medium of any of clauses 1-31, wherein the feedback is consistent across at least some of the plurality of communications channels.
   Clause 33. The computer readable medium of any of clauses 1-32, wherein at least a portion of the feedback is configured for receipt by an electronic exercise machine in order to cause an automatic adjustment to the electronic exercise machine.
   Clause 34. The computer readable medium of any of clauses 1-33, wherein the feedback is provided as a message or an email.
   Clause 35. The computer readable medium of any of clauses 1-34, wherein the feedback from the common wellness specialist is predetermined by the wellness specialist and stored in memory.
   Clause 36. The computer readable medium of any of clauses 1-35, wherein the operations further comprise retrieving the feedback from memory for provision over the plurality of communication channels.
   Clause 37. The computer readable medium of any of clauses 1-36, wherein retrieving and transmission occur automatically based on predetermined rules.
   Clause 38. A system for automated group identification and aggregation of guidance, as recited alone in this clause or in combination with any of the preceding clauses, the system comprising:
at least one processor configured to:
   receive associations between a plurality of trainees and a common wellness specialist;
   receive, over a plurality of communication channels, sensor data associated with performance of exercises by the plurality of trainees;
   analyze the sensor data to identify at least one subgroup within the plurality of trainees, wherein individual trainees within the at least one subgroup share at least one sensor-data-related commonality;
   characterize the at least one subgroup to the common wellness specialist;
   receive from the common wellness specialist, feedback associated with the at least one sensor-data-related commonality; and
   provide over the plurality of communications channels the feedback to each trainee in the at least one subgroup.
      Clause 39. A method for automated group identification and aggregation of guidance, as recited alone in this clause or in combination with any of the preceding clauses, the method comprising:
receiving associations between a plurality of trainees and a common wellness specialist;
receiving, over a plurality of communication channels, sensor data associated with performance of exercises by the plurality of trainees;
analyzing the sensor data to identify at least one subgroup within the plurality of trainees, wherein individual trainees within the at least one subgroup share at least one sensor-data-related commonality;
characterizing the at least one subgroup to the common wellness specialist;
receiving from the common wellness specialist, feedback associated with the at least one sensor-data-related commonality; and
providing over the plurality of communications channels the feedback to each trainee in the at least one subgroup.
   Clause 40. A computer readable medium, as recited alone in this clause or in combination with any of the preceding clauses, containing instructions that when executed by at least one processor cause the at least one processor to perform operations for enabling guest mode gaming on a common exercise machine, the operations comprising:
providing selectable indications of a plurality of candidate fitness movement types for performance on the common exercise machine;
receiving a selection of at least one of the candidate fitness movement types;
associating a game with the selected at least one candidate fitness movement type, the game having at least one interactive graphical element configured to move a plurality of times during gameplay in response to a plurality of fitness movements associated with the selected at least one candidate fitness movement type;
enabling presentation of the game via at least one display;
receiving a multi-exerciser mode selection enabling a plurality of individuals to perform the plurality of fitness movements;
identifying a first user of the common exercise machine;
receiving first signals characterizing a first set of the plurality of fitness movements performed by the first user on the common exercise machine;
correlating first graphical movements of the at least one graphical element with the first set of the plurality of fitness movements by the first user;
determining a first game success measure of the first user;
identifying a second user of the common exercise machine;
receiving second signals characterizing a second set of the plurality of fitness movements performed by the second user on the common exercise machine;
correlating second graphical movements of the at least one graphical element with the second set of the plurality of fitness movements by the second user;
determining a second game success measure of the second user; and
presenting the first game success measure and the second game success measure on the at least one display.
   Clause 41. The computer readable medium of any of clauses 1-40, wherein:
the operations further comprise pairing the common exercise machine with at least two mobile communications devices,
the at least one display includes at least two displays, and
presenting the first game success measure and the second game success measure on the at least one display includes presenting the first game success measure and the second game success measure on the at least two displays.
   Clause 42. The computer readable medium of any of clauses 1-41, wherein:
a first of the two mobile communications device is associated with an owner of the common exercise machine and is configured to automatically pair with the common exercise machine,
a second of the two mobile communications devices is associated with a guest, and
the second of the two mobile communications devices is configured to pair with the common exercise machine upon authorization by the first of the two mobile communications devices.
   Clause 43. The computer readable medium of any of clauses 1-42, wherein the operations further comprise:
retrieving, from a data pool, game histories associated with the first user and the second user; and
using the game histories to determine the first game success measure and the second game success measure.
   Clause 44. The computer readable medium of any of clauses 1-43, wherein the at least one display includes a common display of the common exercise machine
   Clause 45. The computer readable medium of any of clauses 1-44, wherein the operations further comprise:
providing selectable indications of a plurality of electronic games; and
receiving a selection of the game from the plurality of electronic games.
   Clause 46. A system for enabling guest mode gaming on a common exercise machine, as recited alone in this clause or in combination with any of the preceding clauses, the system comprising:
at least one processor configured to:
   provide selectable indications of a plurality of candidate fitness movement types for performance on the common exercise machine;
   receive a selection of at least one of the candidate fitness movement types;
   associate a game with the selected at least one candidate fitness movement type, the game having at least one interactive graphical element configured to move a plurality of times during gameplay in response to a plurality of fitness movements associated with the selected at least one candidate fitness movement type;
   enable presentation of the game via at least one display;
   receive a multi-exerciser mode selection enabling a plurality of individuals to perform the plurality of fitness movements;
   identify a first user of the common exercise machine;
   receive first signals characterizing a first set of the plurality of fitness movements performed by the first user on the common exercise machine;
   correlate first graphical movements of the at least one graphical element with the first set of the plurality of fitness movements by the first user;
   determine a first game success measure of the first user;
   identify a second user of the common exercise machine;
   receive second signals characterizing a second set of the plurality of fitness movements performed by the second user on the common exercise machine;
   correlate second graphical movements of the at least one graphical element with the second set of the plurality of fitness movements by the second user;
   determine a second game success measure of the second user; and
   present the first game success measure and the second game success measure on the at least one display.
      Clause 47. A method for enabling guest mode gaming on a common exercise machine, as recited alone in this clause or in combination with any of the preceding clauses, the method comprising:
providing selectable indications of a plurality of candidate fitness movement types for performance on the common exercise machine;
receiving a selection of at least one of the candidate fitness movement types;
associating a game with the selected at least one candidate fitness movement type, the game having at least one interactive graphical element configured to move a plurality of times during gameplay in response to a plurality of fitness movements associated with the selected at least one candidate fitness movement type;
enabling presentation of the game via at least one display;
receiving a multi-exerciser mode selection enabling a plurality of individuals to perform the plurality of fitness movements;
identifying a first user of the common exercise machine;
receiving first signals characterizing a first set of the plurality of fitness movements performed by the first user on the common exercise machine;
correlating first graphical movements of the at least one graphical element with the first set of the plurality of fitness movements by the first user;
determining a first game success measure of the first user;
identifying a second user of the common exercise machine;
receiving second signals characterizing a second set of the plurality of fitness movements performed by the second user on the common exercise machine;
correlating second graphical movements of the at least one graphical element with the second set of the plurality of fitness movements by the second user;
determining a second game success measure of the second user; and
presenting the first game success measure and the second game success measure on the at least one display.
   Clause 48. An exercise machine with an integrated holder for a mobile communications device, as recited alone in this clause or in combination with any of the preceding clauses, the exercise machine comprising:
a frame;
a load mechanism associated with the frame;
an exercise interface mechanically connected to the load mechanism, the exercise interface being configured to permit a user to exert a counterforce to a load exerted by the load mechanism, wherein the frame and the exercise interface are configured to define an exercise region adjacent the frame for occupation by the user exerting the counterforce;
an adjustable holder for the mobile communications device, the adjustable holder being associated with the frame, wherein the adjustable holder is configured to align with the frame to aim an image sensor of the mobile communications device such that when the mobile communications device is seated in the adjustable holder while aligned with the frame, the image sensor is aimed at the exercise region; and
at least one processor configured to transmit signals for aligning the adjustable holder with the frame.
   Clause 49. The exercise machine of any of clauses 1-48, wherein the frame includes a main body and a shelf extending from the main body, and wherein the holder is associated with the shelf.
   Clause 50. The exercise machine of any of clauses 1-49, wherein the holder is configured to support the mobile communications device.
   Clause 51. The exercise machine of any of clauses 1-50, wherein the holder is configured to accommodate a plurality of different mobile communications devices.
   Clause 52. The exercise machine of any of clauses 1-51, further comprising a charger for charging the mobile communications device when the mobile communications device is seated in the holder.
   Clause 53. The exercise machine of any of clauses 1-52, wherein the exercise machine is an electronic exercise machine configured to pair with the mobile communications device to thereby enable control of the electronic exercise machine via the mobile communications device.
   Clause 54. The exercise machine of any of clauses 1-53, wherein the exercise machine is an electronic exercise machine configured to pair with the mobile communications device and to receive images from the image sensor for use in connection with an exercise regime.
   Clause 55. The exercise machine of any of clauses 1-54, wherein the use includes monitoring exercise movement.
   Clause 56. The exercise machine of any of clauses 1-55, wherein the use includes providing instructions to the user.
   Clause 57. The exercise machine of any of clauses 1-56, wherein the use includes altering the exercise regime.
   Clause 58. The exercise machine of any of clauses 1-57, wherein the at least one processor is further configured to transmit signals for adjusting at least one image capture characteristic.
   Clause 59. The exercise machine of any of clauses 1-58, wherein the at least one image capture characteristic includes an alignment of the adjustable holder with the frame.
   Clause 60. The exercise machine of any of clauses 1-59, wherein the signals include recommendations to a user to adjust at least one of an angle of the adjustable holder relative to the frame, a physical positioning of the adjustable holder relative to the frame, or a location for seating the mobile communications device within the adjustable holder.
   Clause 61. The exercise machine of any of clauses 1-60, wherein the image capture characteristics are associated with the image sensor, and include at least one of an angle, a depth of view, or a selection of a particular image sensor from a plurality of image sensors associated with the mobile communications device.
   Clause 62. A system for aligning an adjustable holder for a mobile communications device with a frame of an exercise machine, as recited alone in this clause or in combination with any of the preceding clauses, the system comprising:
at least one processor configured to:
   receive first signals indicative of the mobile device seated in the adjustable holder, wherein the adjustable holder is associated with the frame;
   receive second signals indicative of a user exerting a counterforce to a load exerted by a load mechanism associated with the frame of the exercise machine, wherein the counterforce is exerted via an exercise interface mechanically connected to the load mechanism;
   determine from the second signals that the user is occupying an exercise region adjacent the frame and defined by the frame and the exercise interface;
   receive third signals indicative that an image sensor of the mobile communications device is at least partially aimed away from the exercise region;
   determine fourth signals for aligning the adjustable holder with the frame such that the image sensor of the mobile communications device is aimed at the exercise region while the mobile communications device remains seated in the adjustable holder; and
   transmit the fourth signals for aligning the adjustable holder with the frame to thereby aim the image sensor of the mobile communications device at the exercise region.
      Clause 63. The system of any of clauses 1-62, wherein the exercise machine is an electronic exercise machine configured to pair with the mobile communications device, and wherein the at least one processor is further configured to receive images from the image sensor for use in connection with an exercise regime.
      Clause 64. The exercise machine of any of clauses 1-63, wherein the use includes altering the exercise regime, and wherein the at least one processor is further configured to transmit fifth signals for adjusting at least one image capture characteristic.
      Clause 65. The exercise machine of any of clauses 1-64, wherein the at least one image capture characteristic includes an alignment of the adjustable holder with the frame.
      Clause 66. The exercise machine of any of clauses 1-65, wherein the fifth signals include recommendations to the user to adjust at least one of an angle of the adjustable holder relative to the frame, a physical positioning of the adjustable holder relative to the frame, or a location for seating the mobile communications device within the adjustable holder.
      Clause 67. A method for aligning an adjustable holder for a mobile communications device with a frame of an exercise machine, as recited alone in this clause or in combination with any of the preceding clauses, the method comprising:
receiving first signals indicative of the mobile device seated in the adjustable holder, wherein the adjustable holder is associated with the frame;
receiving second signals indicative of a user exerting a counterforce to a load exerted by a load mechanism associated with the frame of the exercise machine, wherein the counterforce is exerted via an exercise interface mechanically connected to the load mechanism;
determining from the second signals that the user is occupying an exercise region adjacent the frame and defined by the frame and the exercise interface;
receiving third signals indicative that an image sensor of the mobile communications device is at least partially aimed away from the exercise region;
determining fourth signals for aligning the adjustable holder with the frame such that the image sensor of the mobile communications device is aimed at the exercise region while the mobile communications device remains seated in the adjustable holder; and
transmitting the fourth signals for aligning the adjustable holder with the frame to thereby aim the image sensor of the mobile communications device at the exercise region.
   Clause 68. A computer readable medium, as recited alone in this clause or in combination with any of the preceding clauses, containing instructions that when executed by at least one processor cause the at least one processor to perform automated composite video construction operations, comprising:
receiving at least one variable including at least one of a fitness goal, a performance indication, or a user preference associated with at least one user;
using at least one neural network to determine a personalized workout regime for the at least one user, wherein the determined personalized workout regime corresponds to the at least one variable;
accessing a data structure storing a plurality of movement video clip segments for use as building blocks to construct a composite workout video corresponding to the personalized workout regime, wherein each movement video clip segment is associated with a targeted muscle group;
using the at least one neural network to select a subset of the plurality of movement video clip segments for constructing the composite workout video;
stitching the selected subset of movement video clip segments into the composite workout video; and
outputting the composite workout video for presentation to the at least one user.
   Clause 69. The computer readable medium of any of clauses 1-68, wherein the at least one variable includes at least one fitness goal determined based on stored historical information about the at least one user.
   Clause 70. The computer readable medium of any of clauses 1-69, wherein the historical information includes at least one of a range of motion, velocity, resistance, acceleration, endurance level, strength level, aggregate volume, user feedback, or time series data associated with the at least one user.
   Clause 71. The computer readable medium of any of clauses 1-70, wherein the at least one user includes a plurality of users clustered according to a similarity measure.
   Clause 72. The computer readable medium of any of clauses 1-71, wherein each of the plurality of movement video clip segments depicts an individual performing a motion.
   Clause 73. The computer readable medium of any of clauses 1-72, wherein depicted individuals vary across the plurality of movement video clip segments.
   Clause 74. The computer readable medium of any of clauses 1-73, wherein the composite workout video includes depictions of at least two differing individuals.
   Clause 75. The computer readable medium of any of clauses 1-74, wherein the operations further include receiving real-time signals associated with sensed performance characteristics of the at least one user, and using the real-time signals to dynamically adjust the composite workout video.
   Clause 76. The computer readable medium of any of clauses 1-75, wherein dynamically adjusting includes, after outputting, adding an additional movement video clip to the composite workout video.
   Clause 77. The computer readable medium of any of clauses 1-76, wherein dynamically adjusting includes, after outputting, removing a movement video clip from the composite workout video.
   Clause 78. The computer readable medium of any of clauses 1-77, wherein the real-time signals reflect a change in at least one of a fitness level or a fitness preference, and wherein dynamically adjusting an initial version of the composite workout video includes accommodating the change.
   Clause 79. The computer readable medium of any of clauses 1-78, wherein accommodating the change includes adjusting at least one of an intensity level, a duration, a number of repetitions, or a pace of the dynamically adjusted composite workout video.
   Clause 80. The computer readable medium of any of clauses 1-79, wherein the operations further comprise receiving from a trainer at least one additional movement video clip segment missing from the data structure, and incorporating the at least one additional movement video clip segment into the composite workout video.
   Clause 81. The computer readable medium of any of clauses 1-80, wherein stitching the selected subset of movement video clip segments into the composite workout video involves aggregating the subset of movement video clip segments without removing substantive content from the subset of movement video clip segments.
   Clause 82. The computer readable medium of any of clauses 1-81, wherein stitching the subset of movement video clip segments involves smoothing transitions between the plurality of video clip segments.
   Clause 83. The computer readable medium of any of clauses 1-82, wherein stitching the subset of the plurality of movement video clip segments includes using the at least one neural network to determine a sequence for stitching the plurality of movement video clip segments.
   Clause 84. The computer readable medium of any of clauses 1-83, wherein the at least one variable is associated with at least one of a fitness level, a desired workout type, or a workout constraint.
   Clause 85. The computer readable medium of any of clauses 1-84, wherein the user preference includes an indication of a particular piece of exercise equipment, and wherein the composite workout video is constructed to emphasize use of the particular piece of exercise equipment.
   Clause 86. A system for performing automated composite video construction operations, as recited alone in this clause or in combination with any of the preceding clauses, the system comprising:
at least one processor configured to:
   receive at least one variable including at least one of a fitness goal, a performance indication, or a user preference associated with at least one user;
   use at least one neural network to determine a personalized workout regime for the at least one user, wherein the determined personalized workout regime corresponds to the at least one variable;
   access a data structure storing a plurality of movement video clip segments for use as building blocks to construct a composite workout video corresponding to the personalized workout regime, wherein each movement video clip segment is associated with a targeted muscle group;
   use the at least one neural network to select a subset of the plurality of movement video clip segments for constructing the composite workout video;
   stitch the selected subset of movement video clip segments into the composite workout video; and
   output the composite workout video for presentation to the at least one user.
      Clause 87. A method for performing automated composite video construction operations, as recited alone in this clause or in combination with any of the preceding clauses, comprising:
receiving at least one variable including at least one of a fitness goal, a performance indication, or a user preference associated with at least one user;
using at least one neural network to determine a personalized workout regime for the at least one user, wherein the determined personalized workout regime corresponds to the at least one variable;
accessing a data structure storing a plurality of movement video clip segments for use as building blocks to construct a composite workout video corresponding to the personalized workout regime, wherein each movement video clip segment is associated with a targeted muscle group;
using the at least one neural network to select a subset of the plurality of movement video clip segments for constructing the composite workout video;
stitching the selected subset of movement video clip segments into the composite workout video; and
outputting the composite workout video for presentation to the at least one user.
   Clause 88. A non-transitory computer-readable medium, as recited alone in this clause or in combination with any of the preceding clauses, containing instructions that, when executed by at least one processor, cause the at least one processor to perform operations for executing a randomized exercise routine, the operations comprising:
receiving, from a user, a selection of an exercise routine associated with electronic exercise equipment;
identifying one or more basic characteristics of the selected exercise routine;
utilizing a randomization engine to randomly modify at least one exercise parameter associated with the selected exercise routine, wherein the at least one exercise parameter is selected from the group consisting of: a tempo, a resistance, a rest time, a holding time, and an exercise sequence, wherein the at least one exercise parameter is randomly modified based on the identified basic characteristics of the selected exercise routine;
building a randomized exercise routine comprising the at least one randomly modified exercise parameter; and
presenting the randomized exercise routine to the user.
   Clause 89. The non-transitory computer-readable medium of any of clauses 1-88, wherein the randomization engine modifies at least one exercise parameter associated with the selected exercise routine based on historical performance data of the user.
   Clause 90. The non-transitory computer-readable medium of any of clauses 1-89, wherein the basic characteristics include one or more of exercise phases, thresholds, or values.
   Clause 91. The non-transitory computer-readable medium of any of clauses 1-90, wherein the randomization engine includes a stochastic control system.
   Clause 92. A system for executing a randomized exercise routine, as recited alone in this clause or in combination with any of the preceding clauses, the system comprising:
at least one processor configured to:
   receive, from a user, a selection of an exercise routine associated with electronic exercise equipment;
   identify one or more basic characteristics of the selected exercise routine;
   utilize a randomization engine to randomly modify at least one exercise parameter associated with the selected exercise routine, wherein the at least one exercise parameter is selected from the group consisting of: a tempo, a resistance, a rest time, a holding time, and an exercise sequence, wherein the at least one exercise parameter is randomly modified based on the identified basic characteristics of the selected exercise routine;
   build a randomized exercise routine comprising the at least one randomly modified exercise parameter; and
   present the randomized exercise routine to the user.
      Clause 93. A method for executing a randomized exercise routine, as recited alone in this clause or in combination with any of the preceding clauses, the method comprising:
receiving, from a user, a selection of an exercise routine associated with electronic exercise equipment;
identifying one or more basic characteristics of the selected exercise routine;
utilizing a randomization engine to randomly modify at least one exercise parameter associated with the selected exercise routine, wherein the at least one exercise parameter is selected from the group consisting of: a tempo, a resistance, a rest time, a holding time, and an exercise sequence, wherein the at least one exercise parameter is randomly modified based on the identified basic characteristics of the selected exercise routine;
building a randomized exercise routine comprising the at least one randomly modified exercise parameter; and
presenting the randomized exercise routine to the user.
   Clause 94. A computer readable medium, as recited alone in this clause or in combination with any of the preceding clauses, containing instructions that when executed by at least one processor cause the at least one processor to perform operations for executing voice-cloned guidance during exercise programs, the operations comprising:
receiving from a trainee associated with an electronic exercise machine, a selection associated with a particular distinctive voice for presenting exercise feedback;
electronically receiving sensor data associated with use by the trainee of the electronic exercise machine;
analyzing the sensor data to determine trainee performance;
generating the exercise feedback based on the trainee performance;
accessing a data pool containing characterizing information associated with a plurality of distinctive voices including characterizing information for the particular distinctive voice;
applying to the exercise feedback the characterizing information for the particular distinctive voice to thereby construct an audio file synthesizing the exercise feedback in the particular distinctive voice; and
causing the audio file synthesizing the exercise feedback in the particular distinctive voice to be presented to the trainee.
   Clause 95. The computer readable medium of any of clauses 1-94, wherein the particular distinctive voice is associated with a celebrity trainer, and wherein the particular distinctive voice is a synthesized voice of the celebrity trainer.
   Clause 96. The computer readable medium of any of clauses 1-95, wherein the particular distinctive voice is associated with a professional trainer, and wherein the particular distinctive voice is a synthesized voice of the professional trainer.
   Clause 97. The computer readable medium of any of clauses 1-96, wherein the particular distinctive voice is a synthesized voice of a celebrity with a specialization in an exercise type selected by the trainee.
   Clause 98. The computer readable medium of any of clauses 1-97, wherein the exercise feedback is provided by an individual other than an individual possessing the particular distinctive voice.
   Clause 99. The computer readable medium of any of clauses 1-98, wherein the sensor data includes data from an image sensor, and wherein analyzing includes performing image recognition on the data from the image sensor to determine at least one of an exercise form or an exercise performance measure.
   Clause 100. The computer readable medium of any of clauses 1-99, wherein the sensor data includes cable movement information, the cable movement information including at least one of cable velocity, cable resistance, cable acceleration, or aggregated volume associated with a cable of the electronic exercise machine during a particular time frame.
   Clause 101. A system for executing voice-cloned guidance during exercise programs, as recited alone in this clause or in combination with any of the preceding clauses, the system comprising:
at least one processor configured to:
   receive from a trainee associated with an electronic exercise machine, a selection associated with a particular distinctive voice for presenting exercise feedback;
   electronically receive sensor data associated with use by the trainee of the electronic exercise machine;
   analyze the sensor data to determine trainee performance;
   generate the exercise feedback based on the trainee performance;
   access a data pool containing characterizing information associated with a plurality of distinctive voices including characterizing information for the particular distinctive voice;
   apply to the exercise feedback the characterizing information for the particular distinctive voice to thereby construct an audio file synthesizing the exercise feedback in the particular distinctive voice; and
   cause the audio file synthesizing the exercise feedback in the particular distinctive voice to be presented to the trainee.
      Clause 102. A method for executing voice-cloned guidance during exercise programs, as recited alone in this clause or in combination with any of the preceding clauses, the method comprising:
receiving from a trainee associated with an electronic exercise machine, a selection associated with a particular distinctive voice for presenting exercise feedback;
electronically receiving sensor data associated with use by the trainee of the electronic exercise machine;
analyzing the sensor data to determine trainee performance;
generating the exercise feedback based on the trainee performance;
accessing a data pool containing characterizing information associated with a plurality of distinctive voices including characterizing information for the particular distinctive voice;
applying to the exercise feedback the characterizing information for the particular distinctive voice to thereby construct an audio file synthesizing the exercise feedback in the particular distinctive voice; and
causing the audio file synthesizing the exercise feedback in the particular distinctive voice to be presented to the trainee.
   Clause 103. A computer readable medium containing instructions that when executed by at least one processor cause the at least one processor to correlate a musical presentation with an electronic exercise equipment routine, the operations comprising:
identifying a first exercise block including a first set of movement types;
determining a first exertion level for the first exercise block based on first information associated with the first set of movement types;
identifying a second exercise block including a second set of movement types;
determining a second exertion level for the second exercise block based on second information associated with the second set of movement types;
accessing a data pool storing music;
selecting a first music track from the data pool, the first music track having a first tempo corresponding to the first exertion level;
streaming the first music track for presentation at a location of the exercise machine during performance of the first exercise block;
selecting a second music track from the data pool, the second music track having a second tempo corresponding to the second exertion level; and
streaming the second music track for presentation at the location of the exercise machine during performance of the second exercise block.
   Clause 104. The computer readable medium of any of clauses 1-103, wherein at least one of the first information or the second information includes at least one of a specific exercise movement, a number of sets, a number of repetitions, an exercise duration, a user preference, or historical data associated with a user.
   Clause 105. The computer readable medium of any of clauses 1-104, wherein the historical data includes at least one of an average exercise pace, a time to complete a specific exercise movement, or at least one vital sign.
   Clause 106. The computer readable medium of any of clauses 1-105, wherein selecting at least one of the first music track or the second music track includes selecting based on at least one of a user preference, a particular music genre, or a particular musician.
   Clause 107. The computer readable medium of any of clauses 1-106, wherein the selecting of the first music track and the selecting of the second music block are completed prior to the performance of the first exercise block.
   Clause 108. The computer readable medium of any of clauses 1-107, wherein the selecting of the second music track is completed after initiation of the first exercise block.
   Clause 109. The computer readable medium of any of clauses 1-108, wherein the operations further comprise detecting a change in pace during performance of the first exercise block or the second exercise block, selecting a third music track from the music pool, the third music track having a pace corresponding to the change in pace, and streaming the third music track for presentation at the location of the exercise machine.
   Clause 110. The computer readable medium of any of clauses 1-109, wherein the operations further comprise accessing a playlist containing a plurality of tracks, scanning the tracks to determine a tempo of each of the plurality of tracks, and storing a tempo indicator associated with each track, and wherein selecting the first music track or the second music track from the data pool includes matching the workout pace based on a corresponding stored tempo indicator.
   Clause 111. The computer readable medium of any of clauses 1-110, wherein the music is instrumental, and wherein the operations further comprise adjusting an associated tempo of the instrumental music to correspond to the first exertion level or the second exertion level.
   Clause 112. The computer readable medium of any of clauses 1-111, wherein the operations further comprise identifying a rest period, and selecting a third music track having a third tempo including a restful interlude.
   Clause 113. The computer readable medium of any of clauses 1-112, further comprising receiving a data stream from at least one sensor, wherein identifying the first exercise block or the second exercise block is based on the data stream.
   Clause 114. The computer readable medium of any of clauses 1-113, wherein the at least one sensor includes an image sensor, and wherein the operations further include performing image movement analysis on the data stream to thereby determine the first exertion level or the second exertion level.
   Clause 115. The computer readable medium of any of clauses 1-114, wherein the at least one sensor is associated with a motor, and wherein the operations further include performing rotational movement analysis on the data stream to thereby determine the first exertion level or the second exertion level.
   Clause 116. The computer readable medium of any of clauses 1-115, wherein the at least one sensor is configured to detect cable movement, and wherein the operations further include performing cable movement analysis on the data stream to thereby determine the first exertion level or the second exertion level.
   Clause 117. The computer readable medium of any of clauses 1-116, wherein the data stream further reflects a workout intensity level and wherein the selected music is further chosen based on the workout intensity level.
   Clause 118. The computer readable medium of any of clauses 1-117, wherein the operations further comprise constructing and presenting a musical segue between the first tempo and the second tempo.
   Clause 119. A system for correlating a musical presentation with an electronic exercise equipment routine, as recited alone in this clause or in combination with any of the preceding clauses, the system comprising:
at least one processor to:
   identify a first exercise block including a first set of movement types;
   determine a first exertion level for the first exercise block based on first information associated with the first set of movement types;
   identify a second exercise block including a second set of movement types;
   determine a second exertion level for the second exercise block based on second information associated with the second set of movement types;
   access a data pool storing music;
   select a first music track from the data pool, the first music track having a first tempo corresponding to the first exertion level;
   stream the first music track for presentation at a location of the exercise machine during performance of the first exercise block;
   select a second music track from the data pool, the second music track having a second tempo corresponding to the second exertion level; and
   stream the second music track for presentation at the location of the exercise machine during performance of the second exercise block.
      Clause 120. A method for correlating a musical presentation with an electronic exercise equipment routine, as recited alone in this clause or in combination with any of the preceding clauses, the method comprising:
identifying a first exercise block including a first set of movement types;
determining a first exertion level for the first exercise block based on first information associated with the first set of movement types;
identifying a second exercise block including a second set of movement types;
determining a second exertion level for the second exercise block based on second information associated with the second set of movement types;
accessing a data pool storing music;
selecting a first music track from the data pool, the first music track having a first tempo corresponding to the first exertion level;
streaming the first music track for presentation at a location of the exercise machine during performance of the first exercise block;
selecting a second music track from the data pool, the second music track having a second tempo corresponding to the second exertion level; and
streaming the second music track for presentation at the location of the exercise machine during performance of the second exercise block.
   Clause 121. A computer readable medium, as recited alone in this clause or in combination with any of the preceding clauses, containing instructions that when executed by at least one processor cause the at least one processor to perform voice-induced resistance change operations, the operations comprising:
implementing a first resistance force via an electronically-controlled exercise machine;
while the first resistive force is countered by a user of the electronically-controlled exercise machine via interaction with an accessory through which the first resistance force is exerted, monitoring audio in an environment of the electronically-controlled exercise machine;
during monitoring and while the first resistance force is countered by the user of the electronically-controlled exercise machine via the interaction with the accessory, receiving an audio signal from the environment of the user;
processing the received audio signal to identify a resistance force change command; and
implementing the resistance force change command while the first resistance force is countered by the user of the electronically-controlled exercise machine via interaction with the accessory through which the first resistance force is exerted, to thereby change the first resistance force to a second resistance force while the user maintains force exertion on the accessory.
   Clause 122. The computer readable medium of any of clauses 1-121, wherein the resistance force change command includes a direction to increase or decrease resistance by an amount identified in the resistance force change command.
   Clause 123. The computer readable medium of any of clauses 1-122, wherein the operations further include comparing the amount identified to a threshold, and when the amount identified exceeds the threshold, ignoring the resistance force change command.
   Clause 124. The computer readable medium of any of clauses 1-123, wherein the operations further include comparing the amount identified to a threshold, and when the amount identified exceeds the threshold, applying an alternate resistance change within the threshold.
   Clause 125. The computer readable medium of any of clauses 1-124, wherein the resistance force change command includes a direction to increase or decrease resistance in an absence of a specified amount, and wherein in response to the resistance force change command, implementing a change in resistance by a predetermined incremental amount.
   Clause 126. The computer readable medium of any of clauses 1-125, wherein the predetermined incremental amount is predefined by the user.
   Clause 127. The computer readable medium of any of clauses 1-126, wherein processing the received audio signal to identify the resistance force change command includes comparing vocal properties of the audio signal with stored vocal signatures to determine that a voice is authorized to alter settings.
   Clause 128. The computer readable medium of any of clauses 1-127, wherein the voice is authorized when, during comparing, the voice is recognized as being a voice of the user.
   Clause 129. The computer readable medium of any of clauses 1-128, wherein the voice is authorized when, during comparing, the voice is recognized as being a voice of an authorized trainer.
   Clause 130. The computer readable medium of any of clauses 1-129, wherein the operations further include detecting suboptimal performance and outputting an audible query prompting the user to articulate a change in resistance.
   Clause 131. The computer readable medium of any of clauses 1-130, wherein the first resistance force is associated with a mode, and wherein the resistance force change command conveys a request for a mode change.
   Clause 132. The computer readable medium of any of clauses 1-131, wherein the operations further comprise activating the electronically-controlled exercise machine.
   Clause 133. A system for performing voice-induced resistance change operations, as recited alone in this clause or in combination with any of the preceding clauses, the system comprising:
at least one processor to:
   implement a first resistance force via an electronically-controlled exercise machine;
   while the first resistive force is countered by a user of the electronically-controlled exercise machine via interaction with an accessory through which the first resistance force is exerted, monitor audio in an environment of the electronically-controlled exercise machine;
   during monitoring and while the first resistance force is countered by the user of the electronically-controlled exercise machine via the interaction with the accessory, receive an audio signal from the environment of the user;
   process the received audio signal to identify a resistance force change command; and
   implement the resistance force change command while the first resistance force is countered by the user of the electronically-controlled exercise machine via interaction with the accessory through which the first resistance force is exerted, to thereby change the first resistance force to a second resistance force while the user maintains force exertion on the accessory.
      Clause 134. A method for performing voice-induced resistance change operations, as recited alone in this clause or in combination with any of the preceding clauses, the method comprising:
implementing a first resistance force via an electronically-controlled exercise machine;
while the first resistive force is countered by a user of the electronically-controlled exercise machine via interaction with an accessory through which the first resistance force is exerted, monitoring audio in an environment of the electronically-controlled exercise machine;
during monitoring and while the first resistance force is countered by the user of the electronically-controlled exercise machine via the interaction with the accessory, receiving an audio signal from the environment of the user;
processing the received audio signal to identify a resistance force change command; and
implementing the resistance force change command while the first resistance force is countered by the user of the electronically-controlled exercise machine via interaction with the accessory through which the first resistance force is exerted, to thereby change the first resistance force to a second resistance force while the user maintains force exertion on the accessory.

Disclosed embodiments may include any one of the following bullet-pointed features alone or in combination with one or more other bullet-pointed features, whether implemented as a system and/or method, by one or more hardware components disclosed herein, as well as by at least one processor or circuitry, and/or stored as executable instructions on non-transitory computer readable media or computer readable media.
operations for enabling variable workout gamification
providing first selectable indications of a plurality of candidate fitness movements
receiving a first selection of at least one particular candidate fitness movement from the plurality of candidate fitness movements
providing second selectable indications of a plurality of electronic games
receiving a second selection of a particular electronic game from the plurality of electronic games
associating the particular electronic game with the at least one particular candidate fitness movement
enabling presentation of the particular electronic game via a display
enabling interaction with the particular electronic game in response to detection of the at least one particular candidate fitness movement
the detection of the at least one particular candidate fitness movement occurs by sensing cable movement
sensing the cable movement
the sensing occurs via an image sensor
the sensing occurs via a sensor for determining rotation of a spool on which a cable associated with the cable movement is wound
the detection of the at least one particular candidate fitness movement occurs by sensing resistance
sensing resistance to forces exerted by a motor
the operations enable, at discretion of a user, a plurality of electronic games to be associated with a single fitness movement
the operations enable, at discretion of a user, a plurality of fitness movements to be associated with a single electronic game
the fitness movement selection is received from a trainer
the electronic game selection is received from a user
the electronic game is enabled for play by two users of a common exercise machine
the electronic game is enabled for play by two users of different exercise machines
the different exercise machines are different in location and structure
the different exercise machines are different in location
the plurality of electronic games includes a gamification of the at least one particular candidate fitness movement
the plurality of electronic games are unassociated with the at least one particular candidate fitness movement
the particular electronic game includes a gamified drop set routine
the particular electronic game includes a feature for pacing the at least one particular candidate fitness movement
the particular electronic game alters the at least one particular candidate fitness movement according to a pattern
operations for automated group identification and aggregation of guidance
receiving associations between a plurality of trainees and a common wellness specialist
receiving, over a plurality of communication channels, sensor data associated with
performance of exercises by the plurality of trainees
analyzing the sensor data to identify at least one subgroup within the plurality of trainees
individual trainees within the at least one subgroup share at least one sensor-data-related commonality
characterizing the at least one subgroup to the common wellness specialist
receiving from the common wellness specialist, feedback associated with the at least one sensor-data-related commonality
providing over the plurality of communications channels the feedback to each trainee in the at least one subgroup
the provision of the feedback to each trainee in the at least one subgroup occurs substantially simultaneously over the plurality of communications channels
prior to receiving the feedback from the common wellness specialist, providing to the common wellness specialist, recommended feedback for providing to each trainee in the at least one subgroup
receiving at least one modification to the recommended feedback from the common wellness specialist
characterizing the at least one subgroup to the common wellness specialist includes receiving input from the common wellness specialist
characterizing the at least one subgroup is based on at least one of statistics of additional subgroups, or historical data
the at least one sensor-data-related commonality is associated with a sensor data threshold
the sensor data includes a plurality of performance-related resistance measurements
synthesizing a voice of the common wellness specialist
providing over the plurality of communications channels the feedback to each trainee in the at least one subgroup includes providing the feedback in the synthesized voice of the common wellness specialist
feedback differs across the plurality of communications channels
feedback differences are based on unique characteristics of each individual trainee in the at least one subgroup
retrieving from a data pool the unique characteristics of each individual trainee in the at least one subgroup
the feedback is consistent across at least some of the plurality of communications channels
at least a portion of the feedback is configured for receipt by an electronic exercise machine in order to cause an automatic adjustment to the electronic exercise machine
the feedback is provided as a message or an email
the feedback from the common wellness specialist is predetermined by the wellness specialist and stored in memory
retrieving the feedback from memory for provision over the plurality of communication channels
retrieving and transmission occur automatically based on predetermined rules
operations for enabling guest mode gaming on a common exercise machine
providing selectable indications of a plurality of candidate fitness movement types for performance on the common exercise machine
receiving a selection of at least one of the candidate fitness movement types
associating a game with the selected at least one candidate fitness movement type, the game having at least one interactive graphical element configured to move a plurality of times during gameplay in response to a plurality of fitness movements associated with the selected at least one candidate fitness movement type
enabling presentation of the game via at least one display
receiving a multi-exerciser mode selection enabling a plurality of individuals to perform the plurality of fitness movements
identifying a first user of the common exercise machine
receiving first signals characterizing a first set of the plurality of fitness movements performed by the first user on the common exercise machine
correlating first graphical movements of the at least one graphical element with the first set of the plurality of fitness movements by the first user
determining a first game success measure of the first user
identifying a second user of the common exercise machine
receiving second signals characterizing a second set of the plurality of fitness movements performed by the second user on the common exercise machine
correlating second graphical movements of the at least one graphical element with the second set of the plurality of fitness movements by the second user
determining a second game success measure of the second user
presenting the first game success measure and the second game success measure on the at least one display
pairing the common exercise machine with at least two mobile communications devices
the at least one display includes at least two displays
presenting the first game success measure and the second game success measure on the at least one display includes presenting the first game success measure and the second game success measure on the at least two displays
a first of the two mobile communications device is associated with an owner of the common exercise machine and is configured to automatically pair with the common exercise machine
a second of the two mobile communications devices is associated with a guest
the second of the two mobile communications devices is configured to pair with the common exercise machine upon authorization by the first of the two mobile communications devices
retrieving, from a data pool, game histories associated with the first user and the second user
using the game histories to determine the first game success measure and the second game success measure
the at least one display includes a common display of the common exercise machine
providing selectable indications of a plurality of electronic games
receiving a selection of the game from the plurality of electronic games
An exercise machine with an integrated holder for a mobile communications device
a frame
a load mechanism associated with the frame
an exercise interface mechanically connected to the load mechanism
the exercise interface being configured to permit a user to exert a counterforce to a load exerted by the load mechanism
the frame and the exercise interface are configured to define an exercise region adjacent the frame for occupation by the user exerting the counterforce
an adjustable holder for the mobile communications device
the adjustable holder being associated with the frame
the adjustable holder is configured to align with the frame to aim an image sensor of the mobile communications device such that when the mobile communications device is seated in the adjustable holder while aligned with the frame, the image sensor is aimed at the exercise region
at least one processor configured to transmit signals for aligning the adjustable holder with the frame
the frame includes a main body and a shelf extending from the main body
the holder is associated with the shelf
the holder is configured to support the mobile communications device
the holder is configured to accommodate a plurality of different mobile communications devices
a charger for charging the mobile communications device when the mobile communications device is seated in the holder
the exercise machine is an electronic exercise machine configured to pair with the mobile communications device to thereby enable control of the electronic exercise machine via the mobile communications device
the exercise machine is an electronic exercise machine configured to pair with the mobile communications device
the exercise machine is an electronic exercise machine configured to receive images from the image sensor for use in connection with an exercise regime
the use includes monitoring exercise movement
the use includes providing instructions to the user
the use includes altering the exercise regime
the at least one processor is further configured to transmit signals for adjusting at least one image capture characteristic
the at least one image capture characteristic includes an alignment of the adjustable holder with the frame
the signals include recommendations to a user to adjust at least one of an angle of the adjustable holder relative to the frame, a physical positioning of the adjustable holder relative to the frame, or a location for seating the mobile communications device within the adjustable holder
the image capture characteristics are associated with the image sensor, and include at least one of an angle, a depth of view, or a selection of a particular image sensor from a plurality of image sensors associated with the mobile communications device
a system for aligning an adjustable holder for a mobile communications device with a frame of an exercise machine
at least one processor is configured to receive first signals indicative of the mobile device seated in the adjustable holder
the adjustable holder is associated with the frame
at least one processor is configured to receive second signals indicative of a user exerting a counterforce to a load exerted by a load mechanism associated with the frame of the exercise machine
the counterforce is exerted via an exercise interface mechanically connected to the load mechanism
at least one processor is configured to determine from the second signals that the user is occupying an exercise region adjacent the frame and defined by the frame and the exercise interface
at least one processor is configured to receive third signals indicative that an image sensor of the mobile communications device is at least partially aimed away from the exercise region
at least one processor is configured to determine fourth signals for aligning the adjustable holder with the frame such that the image sensor of the mobile communications device is aimed at the exercise region while the mobile communications device remains seated in the adjustable holder
at least one processor is configured to transmit the fourth signals for aligning the adjustable holder with the frame to thereby aim the image sensor of the mobile communications device at the exercise region
the exercise machine is an electronic exercise machine configured to pair with the mobile communications device
the at least one processor is further configured to receive images from the image sensor for use in connection with an exercise regime
the use includes altering the exercise regime
the at least one processor is further configured to transmit fifth signals for adjusting at least one image capture characteristic
the at least one image capture characteristic includes an alignment of the adjustable holder with the frame
the fifth signals include recommendations to the user to adjust at least one of an angle of the adjustable holder relative to the frame, a physical positioning of the adjustable holder relative to the frame, or a location for seating the mobile communications device within the adjustable holder
automated composite video construction operations
receiving at least one variable including at least one of a fitness goal, a performance indication, or a user preference associated with at least one user
using at least one neural network to determine a personalized workout regime for the at least one user
the determined personalized workout regime corresponds to the at least one variable
accessing a data structure storing a plurality of movement video clip segments for use as building blocks to construct a composite workout video corresponding to the personalized workout regime
each movement video clip segment is associated with a targeted muscle group
using the at least one neural network to select a subset of the plurality of movement video clip segments for constructing the composite workout video
stitching the selected subset of movement video clip segments into the composite workout video
outputting the composite workout video for presentation to the at least one user
the at least one variable includes at least one fitness goal determined based on stored historical information about the at least one user
the historical information includes at least one of a range of motion, velocity, resistance, acceleration, endurance level, strength level, aggregate volume, user feedback, or time series data associated with the at least one user
the at least one user includes a plurality of users clustered according to a similarity measure
each of the plurality of movement video clip segments depicts an individual performing a motion
depicted individuals vary across the plurality of movement video clip segments
the composite workout video includes depictions of at least two differing individuals
receiving real-time signals associated with sensed performance characteristics of the at least one user
using the real-time signals to dynamically adjust the composite workout video
dynamically adjusting includes, after outputting, adding an additional movement video clip to the composite workout video
dynamically adjusting includes, after outputting, removing a movement video clip from the composite workout video
the real-time signals reflect a change in at least one of a fitness level or a fitness preference
dynamically adjusting an initial version of the composite workout video includes accommodating the change
accommodating the change includes adjusting at least one of an intensity level, a duration, a number of repetitions, or a pace of the dynamically adjusted composite workout video
receiving from a trainer at least one additional movement video clip segment missing from the data structure
incorporating the at least one additional movement video clip segment into the composite workout video
stitching the selected subset of movement video clip segments into the composite workout video involves aggregating the subset of movement video clip segments without removing substantive content from the subset of movement video clip segments
stitching the subset of movement video clip segments involves smoothing transitions between the plurality of video clip segments
stitching the subset of the plurality of movement video clip segments includes using the at least one neural network to determine a sequence for stitching the plurality of movement video clip segments
the at least one variable is associated with at least one of a fitness level, a desired workout type, or a workout constraint
the user preference includes an indication of a particular piece of exercise equipment
the composite workout video is constructed to emphasize use of the particular piece of exercise equipment
operations for executing a randomized exercise routine
receiving, from a user, a selection of an exercise routine associated with electronic exercise equipment
identifying one or more basic characteristics of the selected exercise routine
utilizing a randomization engine to randomly modify at least one exercise parameter associated with the selected exercise routine
the at least one exercise parameter is selected from the group consisting of: a tempo, a resistance, a rest time, a holding time, and an exercise sequence
the at least one exercise parameter is randomly modified based on the identified basic characteristics of the selected exercise routine
building a randomized exercise routine comprising the at least one randomly modified exercise parameter
presenting the randomized exercise routine to the user
the randomization engine modifies at least one exercise parameter associated with the selected exercise routine based on historical performance data of the user
wherein the basic characteristics include one or more of exercise phases, thresholds, or values
the randomization engine includes a stochastic control system
operations for executing voice-cloned guidance during exercise programs
receiving from a trainee associated with an electronic exercise machine, a selection associated with a particular distinctive voice for presenting exercise feedback
electronically receiving sensor data associated with use by the trainee of the electronic exercise machine
analyzing the sensor data to determine trainee performance
generating the exercise feedback based on the trainee performance
accessing a data pool containing characterizing information associated with a plurality of distinctive voices including characterizing information for the particular distinctive voice
applying to the exercise feedback the characterizing information for the particular distinctive voice to thereby construct an audio file synthesizing the exercise feedback in the particular distinctive voice
causing the audio file synthesizing the exercise feedback in the particular distinctive voice to be presented to the trainee
the particular distinctive voice is associated with a celebrity trainer
the particular distinctive voice is a synthesized voice of the celebrity trainer
the particular distinctive voice is associated with a professional trainer
the particular distinctive voice is a synthesized voice of the professional trainer
the particular distinctive voice is a synthesized voice of a celebrity with a specialization in an exercise type selected by the trainee
the exercise feedback is provided by an individual other than an individual possessing the particular distinctive voice
the sensor data includes data from an image sensor
analyzing includes performing image recognition on the data from the image sensor to determine at least one of an exercise form or an exercise performance measure
the sensor data includes cable movement information
the cable movement information including at least one of cable velocity, cable resistance, cable acceleration, or aggregated volume associated with a cable of the electronic exercise machine during a particular time frame
operations for correlating a musical presentation with an electronic exercise equipment routine
identifying a first exercise block including a first set of movement types
determining a first exertion level for the first exercise block based on first information associated with the first set of movement types
identifying a second exercise block including a second set of movement types
determining a second exertion level for the second exercise block based on second information associated with the second set of movement types
accessing a data pool storing music
selecting a first music track from the data pool, the first music track having a first tempo corresponding to the first exertion level
streaming the first music track for presentation at a location of the exercise machine during performance of the first exercise block
selecting a second music track from the data pool, the second music track having a second tempo corresponding to the second exertion level
streaming the second music track for presentation at the location of the exercise machine during performance of the second exercise block
at least one of the first information or the second information includes at least one of a specific exercise movement, a number of sets, a number of repetitions, an exercise duration, a user preference, or historical data associated with a user
the historical data includes at least one of an average exercise pace, a time to complete a specific exercise movement, or at least one vital sign
selecting at least one of the first music track or the second music track includes selecting based on at least one of a user preference, a particular music genre, or a particular musician
selecting of the first music track and the selecting of the second music block are completed prior to the performance of the first exercise block
the selecting of the second music track is completed after initiation of the first exercise block
detecting a change in pace during performance of the first exercise block or the second exercise block, selecting a third music track from the music pool
the third music track having a pace corresponding to the change in pace
streaming the third music track for presentation at the location of the exercise machine
accessing a playlist containing a plurality of tracks, scanning the tracks to determine a tempo of each of the plurality of tracks
storing a tempo indicator associated with each track
selecting the first music track or the second music track from the data pool includes matching the workout pace based on a corresponding stored tempo indicator
the music is instrumental
adjusting an associated tempo of the instrumental music to correspond to the first exertion level or the second exertion level
identifying a rest period
selecting a third music track having a third tempo including a restful interlude
receiving a data stream from at least one sensor
identifying the first exercise block or the second exercise block is based on the data stream
the at least one sensor includes an image sensor
performing image movement analysis on the data stream to thereby determine the first exertion level or the second exertion level
the at least one sensor is associated with a motor
performing rotational movement analysis on the data stream to thereby determine the first exertion level or the second exertion level
the at least one sensor is configured to detect cable movement
performing cable movement analysis on the data stream to thereby determine the first exertion level or the second exertion level
the data stream further reflects a workout intensity level
the selected music is further chosen based on the workout intensity level
constructing and presenting a musical segue between the first tempo and the second tempo
voice-induced resistance change operations
implementing a first resistance force via an electronically-controlled exercise machine
while the first resistive force is countered by a user of the electronically-controlled exercise machine via interaction with an accessory through which the first resistance force is exerted, monitoring audio in an environment of the electronically-controlled exercise machine
during monitoring and while the first resistance force is countered by the user of the electronically-controlled exercise machine via the interaction with the accessory, receiving an audio signal from the environment of the user
processing the received audio signal to identify a resistance force change command
implementing the resistance force change command while the first resistance force is countered by the user of the electronically-controlled exercise machine via interaction with the accessory through which the first resistance force is exerted, to thereby change the first resistance force to a second resistance force while the user maintains force exertion on the accessory
the resistance force change command includes a direction to increase or decrease resistance by an amount identified in the resistance force change command
comparing the amount identified to a threshold
when the amount identified exceeds the threshold, ignoring the resistance force change command
comparing the amount identified to a threshold
when the amount identified exceeds the threshold, applying an alternate resistance change within the threshold
the resistance force change command includes a direction to increase or decrease resistance in an absence of a specified amount
in response to the resistance force change command, implementing a change in resistance by a predetermined incremental amount
the predetermined incremental amount is predefined by the user
processing the received audio signal to identify the resistance force change command includes comparing vocal properties of the audio signal with stored vocal signatures to determine that a voice is authorized to alter settings
the voice is authorized when, during comparing, the voice is recognized as being a voice of the user
the voice is authorized when, during comparing, the voice is recognized as being a voice of an authorized trainer
detecting suboptimal performance
outputting an audible query prompting the user to articulate a change in resistance
the first resistance force is associated with a mode
the resistance force change command conveys a request for a mode change
activating the electronically-controlled exercise machine

Systems and methods disclosed herein involve unconventional improvements over conventional approaches. Descriptions of the disclosed embodiments are not exhaustive and are not limited to the precise forms or embodiments disclosed. Modifications and adaptations of the embodiments will be apparent from consideration of the specification and practice of the disclosed embodiments. Additionally, the disclosed embodiments are not limited to the examples discussed herein.

The foregoing description has been presented for purposes of illustration. It is not exhaustive and is not limited to the precise forms or embodiments disclosed. Modifications and adaptations of the embodiments will be apparent from consideration of the specification and practice of the disclosed embodiments. For example, the described implementations include hardware and software, but systems and methods consistent with the present disclosure may be implemented as hardware alone.

The features and advantages of the disclosure are apparent from the detailed specification, and thus, it is intended that the appended claims cover all systems and methods falling within the true spirit and scope of the disclosure. As used herein, the indefinite articles “a” and “an” mean “one or more.” Similarly, the use of a plural term does not necessarily denote a plurality unless it is unambiguous in the given context. Words such as “and” or “or” mean “and/or” unless specifically directed otherwise. Further, since numerous modifications and variations will readily occur from studying the present disclosure, it is not desired to limit the disclosure to the exact construction and operation illustrated and described, and, accordingly, all suitable modifications and equivalents may be resorted to, falling within the scope of the disclosure.

Computer programs based on the written description and methods of this specification are within the skill of a software developer. The various functions, scripts, programs, or modules may be created using a variety of programming techniques. For example, programs, scripts, functions, program sections or program modules may be designed in or by means of languages, including JAVASCRIPT, C, C++, JAVA, PHP, PYTHON, RUBY, PERL, BASH, or other programming or scripting languages. One or more of such software sections or modules may be integrated into a computer system, non-transitory computer readable media, or existing communications software. The programs, modules, or code may also be implemented or replicated as firmware or circuit logic.

Moreover, while illustrative embodiments have been described herein, the scope may include any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application, which examples are to be construed as non-exclusive. Further, the steps of the disclosed methods may be modified in any manner, including by reordering steps or inserting or deleting steps. It is intended, therefore, that the specification and examples be considered as exemplary only, with a true scope and spirit being indicated by the following claims and their full scope of equivalents.

1-39. (canceled)

40. A computer readable medium containing instructions that when executed by at least one processor cause the at least one processor to perform operations for enabling guest mode gaming on a common exercise machine, the operations comprising:
providing selectable indications of a plurality of candidate fitness movement types for performance on the common exercise machine;
receiving a selection of at least one of the candidate fitness movement types;
associating a game with the selected at least one candidate fitness movement type, the game having at least one interactive graphical element configured to move a plurality of times during gameplay in response to a plurality of fitness movements associated with the selected at least one candidate fitness movement type;
enabling presentation of the game via at least one display;
receiving a multi-exerciser mode selection enabling a plurality of individuals to perform the plurality of fitness movements;
identifying a first user of the common exercise machine;
receiving first signals characterizing a first set of the plurality of fitness movements performed by the first user on the common exercise machine;
correlating first graphical movements of the at least one graphical element with the first set of the plurality of fitness movements by the first user;
determining a first game success measure of the first user;
identifying a second user of the common exercise machine;
receiving second signals characterizing a second set of the plurality of fitness movements performed by the second user on the common exercise machine;
correlating second graphical movements of the at least one graphical element with the second set of the plurality of fitness movements by the second user;
determining a second game success measure of the second user; and
presenting the first game success measure and the second game success measure on the at least one display.

41. The computer readable medium of claim 40, wherein:
the operations further comprise pairing the common exercise machine with at least two mobile communications devices,
the at least one display includes at least two displays, and
presenting the first game success measure and the second game success measure on the at least one display includes presenting the first game success measure and the second game success measure on the at least two displays.

42. The computer readable medium of claim 41, wherein:
a first of the two mobile communications device is associated with an owner of the common exercise machine and is configured to automatically pair with the common exercise machine,
a second of the two mobile communications devices is associated with a guest, and
the second of the two mobile communications devices is configured to pair with the common exercise machine upon authorization by the first of the two mobile communications devices.

43. The computer readable medium of claim 40, wherein the operations further comprise:
retrieving, from a data pool, game histories associated with the first user and the second user; and
using the game histories to determine the first game success measure and the second game success measure.

44. The computer readable medium of claim 40, wherein the at least one display includes a common display of the common exercise machine.

45. The computer readable medium of claim 40, wherein the operations further comprise:
providing selectable indications of a plurality of electronic games; and
receiving a selection of the game from the plurality of electronic games.

46. A system for enabling guest mode gaming on a common exercise machine, the system comprising:
at least one processor configured to:
provide selectable indications of a plurality of candidate fitness movement types for performance on the common exercise machine;
receive a selection of at least one of the candidate fitness movement types;
associate a game with the selected at least one candidate fitness movement type, the game having at least one interactive graphical element configured to move a plurality of times during gameplay in response to a plurality of fitness movements associated with the selected at least one candidate fitness movement type;
enable presentation of the game via at least one display;
receive a multi-exerciser mode selection enabling a plurality of individuals to perform the plurality of fitness movements;
identify a first user of the common exercise machine;
receive first signals characterizing a first set of the plurality of fitness movements performed by the first user on the common exercise machine;
correlate first graphical movements of the at least one graphical element with the first set of the plurality of fitness movements by the first user;
determine a first game success measure of the first user;
identify a second user of the common exercise machine;
receive second signals characterizing a second set of the plurality of fitness movements performed by the second user on the common exercise machine;
correlate second graphical movements of the at least one graphical element with the second set of the plurality of fitness movements by the second user;
determine a second game success measure of the second user; and
present the first game success measure and the second game success measure on the at least one display.

47. A method for enabling guest mode gaming on a common exercise machine, the method comprising:
providing selectable indications of a plurality of candidate fitness movement types for performance on the common exercise machine;
receiving a selection of at least one of the candidate fitness movement types;
associating a game with the selected at least one candidate fitness movement type, the game having at least one interactive graphical element configured to move a plurality of times during gameplay in response to a plurality of fitness movements associated with the selected at least one candidate fitness movement type;
enabling presentation of the game via at least one display;
receiving a multi-exerciser mode selection enabling a plurality of individuals to perform the plurality of fitness movements;
identifying a first user of the common exercise machine;
receiving first signals characterizing a first set of the plurality of fitness movements performed by the first user on the common exercise machine;
correlating first graphical movements of the at least one graphical element with the first set of the plurality of fitness movements by the first user;
determining a first game success measure of the first user;
identifying a second user of the common exercise machine;
receiving second signals characterizing a second set of the plurality of fitness movements performed by the second user on the common exercise machine;
correlating second graphical movements of the at least one graphical element with the second set of the plurality of fitness movements by the second user;
determining a second game success measure of the second user; and
presenting the first game success measure and the second game success measure on the at least one display.

48-93. (canceled)
